(19) United States
(12) Patent Application Publication
(10) Pub. No.: US 2018/0060959 A1
(43) Pub. Date: Mar. 1, 2018

(54) OPTION PRICING

(71) Applicant: David Gershon, Tel Aviv (IL)

(72) Inventor: David Gershon, Tel Aviv (IL)

(21) Appl. No.: 15/636,910

(22) Filed: Jun. 29, 2017

Related U.S. Application Data
(63) Continuation-in-part of application No. 15/485,503, filed on Apr. 12, 2017.
(60) Provisional application No. 62/381,179, filed on Aug. 30, 2016.

(51) Int. Cl. G06Q 40/04

(52) U.S. Cl. CPC G06Q 40/04

(57) ABSTRACT

Methods and systems are described herein for pricing options. In particular, the option price is obtained by satisfying consistency conditions. A new technique is described for pricing an option using minimal inputs, while achieving self-consistent and accurate results. Techniques for generating contingent probability density functions from volatility smile data are also described herein. Techniques are also described for calculating paths for non-vanilla options.

### CROSS-REFERENCE TO RELATED APPLICATIONS

This application is a continuation-in-part of U.S. patent application Ser. No. 15/485,503, filed Apr. 12, 2017, and claims the benefit of U.S. Provisional Patent Application No. 62/381,179, filed on Aug. 30, 2016; U.S. patent application Ser. No. 15/405,065, filed Jan. 12, 2017; and U.S. patent application Ser. No. 15/485,503, filed Apr. 12, 2017; the disclosures of which are all incorporated herein by reference in their entirety.

### BACKGROUND

The Black-Scholes (“BS”) model was a revolutionary breakthrough for pricing options. One feature introduced by the BS model was the concept of an option's implied volatility. The implied volatility of an option corresponds to the value of the volatility that yields an expected price of the option substantially matching the current market price of that option. The BS model allows for a one-to-one mapping of the price of a European option and the volatility reflected of that option price. The BS model originally assumed that an option's volatility was a number that characterized fluctuations of that option's underlying asset and, therefore, was independent of the strike point.

However, the stock market crash of 1987 imparted the wisdom that the BS model cannot be used with the same volatility (e.g., the same numerical value) to price options with different strikes. In response, the concept of a “volatility smile” was introduced. Volatility smile assigns a different volatility value to each strike so that the BS model generates a correct market price for the option. Typically, to obtain the volatility smile, market prices of options over a large range of strikes are used, where for each strike, the volatility used in the BS model is calculated to produce the market price, which is referred to as the “implied volatility” (the BS volatility that is implied from the price in the market). Generally speaking, mapping the implied volatility of an option against different strike prices for a given expiry, a “smile” shaped function is produced, as opposed to a flat function.

As celebrated as the BS module is, it was developed to describe a situation where the rate of fluctuations of the price of the underlying asset (e.g., the volatility) is constant throughout the life of the option, which is rarely the case in reality. Thus, one of the issues with the BS model is that it may generate various anomalies when being used to hedge the risk implied from the changes in the volatility in the market. For instance, in the BS model when all strikes trade at the same volatility, a seller of a strangle position—where both a call and put out of the money options (whose strikes are on opposite sides of the forward price) with a same expiry are sold—loses money (and the buyer makes money) from re-hedging against fluctuations in the volatility, and there is no compensation for it in the price of the strangle. Similarly, the seller of a collar or risk reversals strategy—where an option's position corresponds to being both long out of the money call and short out of the money put having the same expiry—loses money and the buyer makes money from re-hedging the changes in the volatility as the underlying asset's price fluctuates are all well-known issues that exist due to the BS model. Furthermore, the problem of option pricing is even more severe for complex (e.g., non-vanilla) options, where there is no real way to fix the BS model, and other alternatives fail to consistently produce market prices.

Therefore, there is still a need for a universal pricing model for options that can accurately describe and produce the volatility smile such that it reflects prices of options in financial markets. Further, there is still a need for a universal approach to all types of options that will accurately reflect the prices in financial markets.

### SUMMARY

In one embodiment, a method for pricing an option includes receiving, at a user device, option data for an option to be priced, the option data being received from a server. The method further includes receiving, at the user device, market data associated with an options market, the market data being received from the server, selecting a first input parameter value, determining, for the first input parameter value, a first value for a first function based, at least in part, on an expiry date of the option, determining, for the first input value, a second value for a second function based, at least in part, on the expiry date, determining that a magnitude of a difference between the first value and the second value is less than or equal to a predefined threshold convergence value, determining, for a first strike value, a volatility value associated with the first input parameter value, and generating, for the first strike value, a price of the option based, at least in part, on the first input value.

In the one embodiment, the market data includes at least one period of the term structure, corresponding to market data inputs, the market data inputs comprising an at-the-money (“ATM”) volatility, a twenty-five delta risk reversal, and a twenty-five delta butterfly.

In the one embodiment, where each of the at least three market data inputs are equal to one another such that a first at-the-money volatility at an inception date, a first twenty-five delta risk reversal at the inception date, and a first twenty-five delta butterfly at the inception date, respectively, a second at-the-money volatility at the expiry date, a second twenty-five delta risk reversal at the expiry date, and a second twenty-five delta butterfly at the expiry date.

In the one embodiment, where the options data includes at least one of: a strike of the option, a trade date of the option, the expiry date of the option, an indication of the option being either a call option or a put option, a payout payment date of the option, and a premium payment date of the option.

In the one embodiment, where the market data includes at least one of: a spot price of the option, a conversion forward price for a payout payment date of the option, and an interest rate for the payout payment date.

In the one embodiment, where the market data includes at least three market data inputs, the market data inputs corresponding to an at-the-money (“ATM”) volatility for the expiry date, a twenty-five delta risk reversal for the expiry data, and a twenty-five delta butterfly for the expiry date.

In the one embodiment, the method also including selecting, prior to determining the first function, an iteration level for the first function and the second function.

In the one embodiment, where the iteration corresponds to any positive number greater than zero.

In the one embodiment, where the method further includes determining, based on the market data received, at least one term structure for the option, the term structure comprising an at-the-money (“ATM”) volatility for the expiry date, a twenty-five delta risk reversal for the expiry date, and a twenty-five delta butterfly for the expiry date.

In the one embodiment, where the method further includes receiving at least one period of a term structure such that, for the expiry date, the first value and the second value substantially generate the price.

In the one embodiment, where the method further includes determining, prior to generating the price, that the option is one of a call option or a put option.

In one embodiment, a method for pricing a vanilla option is described. The method includes receiving, at a user device, option data associated with the vanilla option, the option data including at least an expiry date for the vanilla option, receiving, at the user device, market data associated with a current market environment with which the vanilla option is to be priced, the market data including, for the expiry date, at least an at-the-money (“ATM”) volatility, twenty-five delta risk reversal, and twenty-five delta butterfly, selecting a set of input values for use in calculating a first integral representation of a first parameter and a second integral representation of a second parameter, determining a first set of values for the first integral representation using the set, determining a second set of values for the second integral representation using the set, determining an input value from the set, the input value being associated with a first difference between a first value of the first set and a second value of the first set being less than a predefined convergence threshold value, and a second difference between a third value of the second set and a fourth value of the second set being less than the predefined convergence threshold value, determining a first parameter value and a second parameter value corresponding to the first parameter and the second parameter, respectively, for the input value, determining a strike value associated with an optimized volatility function associated with the input value, and generating a price of the vanilla option using the strike value, the volatility, and the expiry date.

In one embodiment, a method for pricing an option with an expiration is described. The method may include, amongst other features, receiving, at an electronic device, first pricing data representing a first strike and a first price for an option. The first price may correspond to the first strike for the expiration, and the first pricing data may be received from a financial data source. Second pricing data representing a second strike and a second price for the option may be received at the electronic device. The second price may correspond to the second strike for the expiration, and the second pricing data may be received from the financial data source. Third pricing data representing a third strike and a third price for the option may be received at the electronic device. The third price may correspond to the third strike for the expiration, and the third pricing data may be received from the financial data source. At least one first value for a first function may be generated. The at least one first value may be determined based, at least in part, on a plurality of input values, the first pricing data, the second pricing data, and the third pricing data. At least one second value for a second function may be generated. The at least one second value may be determined based, at least in part, on the plurality of input values, the first pricing data, the second pricing data, and the third pricing data. A price for the option at the expiration may then be generated based, at least in part, on the at least one first value and the at least one second value.

In another embodiment, an electronic device for pricing an option having an expiration is described. The electronic device may include memory and communications circuitry. The communications circuitry may be operable to receive, from a financial data source, first pricing data representing a first strike and a first price for an option, and the first price may correspond to the first strike for the expiration. The communications circuitry may further be operable to receive, from the financial data source, second pricing data representing a second strike and a second price for the option, and the second price may correspond to the second strike for the expiration. The communications circuitry may yet further be operable to receive, from the financial data source, third pricing data representing a third strike and a third price for the option, and the third price may correspond to the third strike for the expiration. The electronic device may further include at least one processor, where the at least one processor is operable to generate at least one first value for a first function. The at least one first value may be determined based, at least in part, on a plurality of input values, the first pricing data, the second pricing data, and the third pricing data. The at least one processor may be further operable to generate at least one second value for a second function. The at least one second value may be determined based, at least in part, on the plurality of input values, the first pricing data, the second pricing data, and the third pricing data. The at least one processor may be yet further operable to generate a price for the option at the expiration based, at least in part, on the at least one first value and the at least one second value.

### BRIEF DESCRIPTION OF THE DRAWINGS

The above and other features of the present invention, its nature and various advantages will be more apparent upon consideration of the following detailed description, taken in conjunction with the accompanying drawings in which:

FIG. 1 is an illustrative diagram of a system in accordance with various embodiments;

FIG. 2 is an illustrative block diagram of an exemplary device in accordance with various embodiments;

FIGS. 3A-C are illustrative graphs of a first shape function F_{A}(d₁) and a second shape function F_{B}(d₁) for a first approximation, in accordance with various embodiments;

FIGS. 4A and 4B are illustrative graphs for self-consistent shape functions F_{A}(d₁) and F_{B}(d₁) for swaptions in the zero level approximation, in accordance with various embodiments;

FIG. 5 is an illustrative flowchart of a process for determining zero-order functions A(d₁, T) and B(d₁, T), in accordance with various embodiments;

FIG. 6 is an illustrative flowchart of a process for determining an n-th order approximation for functions A(d₁, T) and B(d₁, T), in accordance with various embodiments;

FIG. 7 is an illustrative flowchart of an exemplary process for determining the vanilla volatility smile, in accordance with various embodiments;

FIGS. 8A-C are illustrative graphs of a first shape function F_{A}(d₁) and a second shape function F_{B}(d₁) for different values of N for various sets of market data, in accordance with various embodiments;

FIGS. 9A-C are illustrative graphs of a first shape function F_{A}(d₁) and a second shape function F_{B}(d₁) for swaptions for different values of N for various sets of market data, in accordance with various embodiments;

FIGS. 10A-D are illustrative graphs illustrating the influence of twenty-five delta risk reversal, twenty-five delta butterfly, and ATM volatility on a first shape function F_{A}(d₁) and a second shape function F_{B}(d₁), in accordance with various embodiments;

FIGS. 11A and 11B are illustrative graphs of a first shape function F_{A}(d₁) and a second shape function F_{B}(d₁) for different expiries using the same market data, in accordance with various embodiments;

FIGS. 12A-C are illustrative graphs of a first shape function F_{A}(d₁) and a second shape function F_{B}(d₁) for swaptions, in accordance with various embodiments;

FIGS. 13A-D are illustrative graphs of the volatility smile, in accordance with various embodiments;

FIGS. 14A and 14B are illustrative graphs describing the volatility smile for different values of N, in accordance with various embodiment;

FIGS. 15A-D are illustrative graphs of the density function and volatility smile, in accordance with various embodiments;

FIGS. 16A-D are illustrative graphs of an effect of different sets of market data on a first shape function F_{A}(d₁) and a second shape function F_{B}(d₁) for various swaptions, in accordance with various embodiments;

FIG. 16E is an illustrative graph showing the effect of annuity on a first shape function F_{A}(d₁) and a second shape function F_{B}(d₁) by comparing swaptions and FX options having similar market data, in accordance with various embodiments;

FIGS. 17A and 17B are illustrative graphs of term structures for a first shape function F_{A}(d₁) and a second shape function F_{B}(d₁) for two different values of N for one particular set of market data, in accordance with various embodiment;

FIG. 18 is an illustrative graph of the arbitrage free zones for a particular ATM volatility and expiry, in accordance with various embodiments;

FIGS. 19A-C are an illustrative graphs of the behavior of the forward implied local smile, where FIG. 19A is an illustrative graph of the ATM volatility σ₀(T, s, t), FIG. 19B is an illustrative graph of the behavior of the 25 Δ_{RR}(T, s, t), and FIG. 19C is an illustrative graph of the behavior of the 25 Δ_{Fly}(T, s, t), in accordance with various embodiments;

FIGS. 20A-F are illustrative graphs of the forward implied local smile for ATM volatility, risk reversal, and butterfly for N=9 spot price points, in accordance with various embodiments;

FIGS. 21A-C are illustrative graphs of the reduced number of input parameters variables, in accordance with various embodiments;

FIG. 22 is an illustrative flowchart of a process for determining an exotic option, in accordance with various embodiments;

FIG. 23 is an illustrative flowchart of a process for determining a price of a European Vanilla option having an expiration time T, in accordance with various embodiments;

FIG. 24A is an illustrative flowchart of a process for calculating a probability density function from a first time t to a second time T, in accordance with various embodiments;

FIG. 24B is an illustrative flowchart of a processing generating a probability density grid including a plurality of probability density functions, in accordance with various embodiments;

FIG. 25 is an illustrative flowchart of a process for calculating an implied forward local smile from a first time t to a second time T, in accordance with various embodiments;

FIG. 26 is an illustrative flowchart of a process for calculating a probability transfer density at any time and for any asset price to another time and another asset price, in accordance with various embodiments;

FIG. 27 is an illustrative flowchart of a process for pricing an exotic option, in accordance with various embodiments;

FIG. 28 is an illustrative flowchart of a process for determining term structures for an integral representation for determining an option's price in each step of the iteration process, in accordance with various embodiments;

FIG. 29 is an illustrative flowchart of a process for calculating a smile from conditions on the smile and integrals over time until expiration, in accordance with various embodiments;

FIG. 30 is an illustrative flowchart of a process for calculating a volatility smile from self-consistency conditions, in accordance with various embodiments;

FIG. 31 is an illustrative flowchart of a process for determining functions the volatility smile without using A or B, but by directly using the density function, in accordance with various embodiments; and

FIGS. 32A-D are illustrative graphs illustrating how log(S) versus X behaves, in accordance with various embodiments.

### DETAILED DESCRIPTION

Systems and methods for developing and utilizing a universal model for pricing options are described herein.

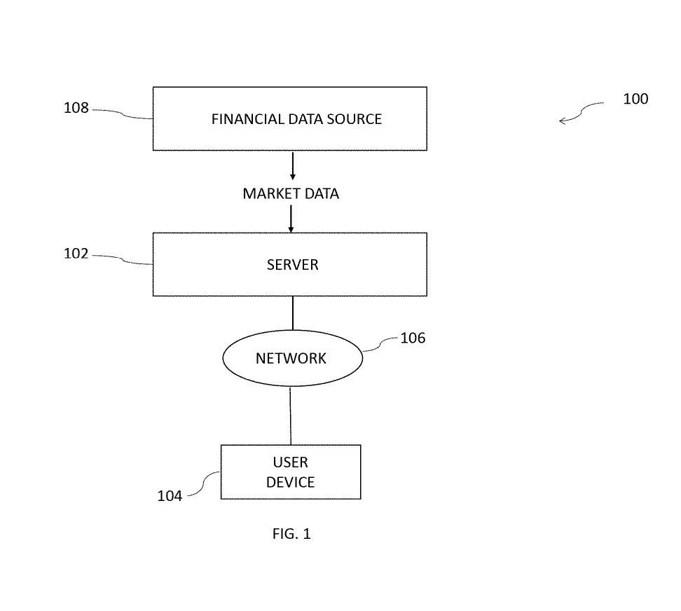

FIG. 1 is an illustrative diagram of a system in accordance with various embodiments. System 100 may include a server 102 and a user device 104, which may communicate with one another across a network 106. Although only one user device 104 and one server 102 are shown within FIG. 1, persons of ordinary skill in the art will recognize that any number of user devices, and/or servers may be used.

Server 102 may correspond to one or more servers capable of facilitating communications and/or servicing requests from user device 104. User device 104 may, in some embodiments, receive market data from server 102, as well as, or alternatively, from one or more additional device, via network 106. Similarly, user device 104 may send data to server 102, as well as, or alternatively, to one or more additional devices, via network 106. In some embodiments, network 106 may facilitate communications between one or more user device 104. In some embodiments, server 102 may be capable of receiving market data from financial data source 108. Financial data source 108, for example may correspond to one or more market sources (e.g., REUTERS, Bloomberg, ICE-SuperDerivatives, etc.) and/or directly from one or more options brokers. In some embodiments, server 102 may be populated by financial data source 108 using an applications programming interface (“API”) to provide real-time information associated with various types of market data.

Market data may, in some embodiments, correspond to a particular date. In this particular scenario, for example, the market data may include information about asset prices, securities, interest rates, dividend rates, volatility of options, differences between volatilities of options, and the like, for a given expiration date. As an illustrative example, one month market data may include interest rates for one month, the forward rate of assets for one month, the volatility for options expiring in one month, and the like. Typically, market data for a given data may also include the sport (e.g., current) prices of assets/securities.

Market data may also be provided without a specified date. In this particular scenario, the market data may include a general collection of market data for a general collection of expiration dates. However, these dates may not be organized or grouped in any particular manner. As an illustrative example, the market data may include a gold spot price, a Euro-Dollar forward rate for one month, a volatility for oil for two months, and the like.

Term structure data may, in some embodiments, include a collection of market data for a specific asset/security for some future dates. For example, term structure data for gold may include market data for gold for specific expiration dates (e.g., one month, three months, six months, and one year). The term structure data may include some or all of the market data. For example, term structure data of an ATM volatility may include the ATM volatility for options expiring on particular dates (e.g., one month, three months, six months, and one year). A full term structure, for instance, for options on assets may include such entities as a spot price of the asset, a forward price (Tᵢ), ATM volatility (Tᵢ), 25 Δ_{RR}(Tᵢ), 25 Δ_{Fly}(Tᵢ), interest rates (Tᵢ) for a number of future expiration dates (e.g., Tᵢ=1 month, 3 months, 6 months, and 1 year).

From given term structure data, it may be possible to obtain a good approximation of the market data for any expiration date using interpolation and/or extrapolation, as described in greater detail herein. For example, the market data for one week options may be obtained from the term structure data that includes 1 month, 3 month, and 6 month data, using extrapolation techniques. Similarly, 2 month market data may be obtained via interpolation between market data for one month and three months. In one non-limiting embodiment, the term structure data may include market data for only one expiration date. In this particular scenario, the additional term structure data may be extrapolated by assuming some behavior about the shape of the data included within the term structure data that is given as it relates to a time axis. As an illustrative example, if only a 3 month ATM volatility is given, then the shape of the ATM volatility may be assumed to behave as a square root of the expiration date (e.g., (expiry)^{1/2}). In other instances, the behavior may be assumed to be constant, which may be referred to as a “flat term structure.” If, in one embodiment, the butterfly is not known, one may use a typical butterfly for an asset in question. For example, for major currencies, the butterfly may be 0.25, for oil the butterfly may be 0.75, and for interest rates the butterfly may be 1.5, however persons of ordinary skill in the art will recognize that the aforementioned are merely illustrative.

Network 106 may correspond to any network, combination of networks, or network devices that may carry data communications. For example, network 106 may be any one or combination of local area networks (“LAN”), wide area networks (“WAN”), telephone networks, wireless networks, point-to-point networks, star networks, token ring networks, hub networks, ad-hoc multi-hop networks, or any other type of network, or any combination thereof. Network 106 may support any number of protocols such as WiFi (e.g., 802.11 protocol), Bluetooth, radio frequency systems (e.g., 900 MHZ, 1.4 GHZ, and 5.6 GHZ communication systems), cellular networks (e.g., GSM, AMPS, GPRS, CDMA, EV-DO, EDGE, 3GSM, DECT, IS-136/TDMA, iDen, LTE, or any other suitable cellular network protocol), infrared, TCP/IP (e.g., any of the protocols used in each of the TCP/IP layers), HTTP, BitTorrent, FTP, RTP, RTSP, SSH, Voice over IP (“VOIP”), or any other communication protocol, or any combination thereof. In some embodiments, network 106 may provide wired communications paths for user device 104.

User device 104 may correspond to any electronic device or system capable of communicating over network 106 with server 102 and/or with one or more additional devices. For example, user device 104 may be a portable media players cellular telephone, pocket-sized personal computer, personal digital assistant (“PDAs”), desktop computer, laptop computer, wearable electronic device, accessory device, and/or tablet computer. User device 104 may include one or more processors, storage, memory, communications circuitry, input/output interfaces, as well as any other suitable component, such a facial recognition module. Furthermore, one or more components of user device 104 may be combined or omitted.

Although examples of embodiments may be described for a user-server model with a server servicing requests of one or more user applications, persons of ordinary skill in the art will recognize that any other model (e.g., peer-to-peer) may be available for implementation of the described embodiments. For example, a user application executed on user device 104 may handle requests independently and/or in conjunction with server 102.

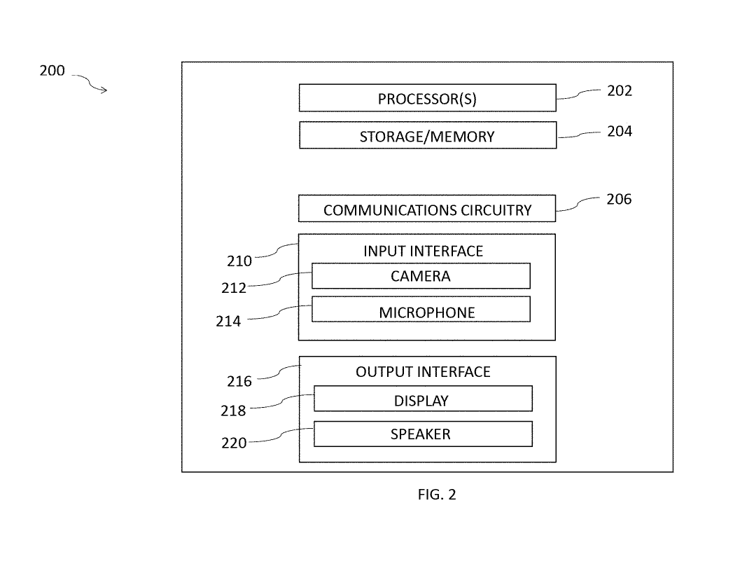

FIG. 2 is an illustrative block diagram of an exemplary device in accordance with various embodiments. Device 200 may, in some embodiments, correspond to user device 104 and/or server 102. It should be understood by persons of ordinary skill in the art, however, that device 200 is merely one example of a device that may be implemented within a server-device system (e.g., such as the server-device system of FIG. 1), and it is not limited to being only one part of the system. Furthermore, one or more components included within device 200 may be added or omitted.

In some embodiments, device 200 may include processor 202, storage 204, memory 206, communications circuitry 208, input interface 210, and output interface 216. Input interface 210 may, in some embodiments, include camera 212 and microphone 214. Output interface 216 may, in some embodiments, include display 218 and speaker 220. In some embodiments, one or more of the previously mentioned components may be combined or omitted, and/or one or more components may be added. For example, memory 204 and storage 206 may be combined into a single element for storing data. As another example, device 200 may additionally include a power supply, a bus connector, or any other additional component. In some embodiments, device 200 may include multiple instances of one or more of the components included therein. However, for the sake of simplicity, only one of each component has been shown within FIG. 2.

Processor 202 may include any suitable processing circuitry capable of controlling operations and functionality of user device 104 and/or server 102, as well as facilitating communications between various components within user device 104 and/or server 102. In some embodiments, processor(s) 202 may include at least one central processing unit (“CPU”), a graphic processing unit (“GPU”), one or more microprocessors, a digital signal processor, or any other type of processor, or any combination thereof. In some embodiments, processor(s) 202 may be capable of performing multi-threading or multi-computing, such as parallel computing functions. In some embodiments, the functionality of processor(s) 202 may be performed by one or more hardware logic components including, but not limited to, field-programmable gate arrays (“FPGA”), application specific integrated circuits (“ASICs”), application-specific standard products (“ASSPs”), system-on-chip systems (“SOCs”), and/or complex programmable logic devices (“CPLDs”). Furthermore, each of processor(s) 202 may include its own local memory, which may store program modules, program data, and/or one or more operating systems. However, processor(s) 202 may run an operating system (“OS”) for user device 104 and/or server 102, and/or one or more firmware applications, media applications, and/or applications resident thereon.

Storage/memory 204 may include one or more types of storage mediums such as any volatile or non-volatile memory, or any removable or non-removable memory implemented in any suitable manner to store data on user device 104 and/or server 102. For example, information may be stored using computer-readable instructions, data structures, and/or program modules. Various types of storage/memory may include, but are not limited to, hard drives, solid state drives, flash memory, permanent memory (e.g., ROM), electronically erasable programmable read-only memory (“EEPROM”), CD ROM, digital versatile disk (“DVD”) or other optical storage medium, magnetic cassettes, magnetic tape, magnetic disk storage or other magnetic storage devices, RAID storage systems, or any other storage type, or any combination thereof. Furthermore, storage/memory 204 may be implemented as computer-readable storage media (“CRSM”), which may be any available physical media accessible by processor(s) 202 to execute one or more instructions stored within storage/memory 204. In some embodiments, one or more applications (e.g., gaming, music, video, calendars, lists, etc.) may be run by processor(s) 202, and may be stored in memory 204.

Communications circuitry 206 may include any circuitry capable of connecting to a communications network (e.g., network 106) and/or transmitting communications (voice or data) to one or more devices (e.g., user device 104 and/or host device 108) and/or servers (e.g., server 102). Communications circuitry 208 may interface with the communications network using any suitable communications protocol including, but not limited to, Wi-Fi (e.g., 802.11 protocol), Bluetooth, radio frequency systems (e.g., 900 MHz, 1.4 GHz, and 5.6 GHz communications systems), infrared, GSM, GSM plus EDGE, CDMA, quadband, VOIP, or any other protocol, or any combination thereof.

Input interface 210 may include any suitable mechanism or component for receiving inputs from a user operating device 200. Input interface 210 may also include, but is not limited to, an external keyboard, mouse, joystick, musical interface (e.g., musical keyboard), or any other suitable input mechanism, or any combination thereof.

In some embodiments, user interface 210 may include camera 212. Camera 212 may correspond to any image capturing component capable of capturing images and/or videos. For example, camera 212 may capture photographs, sequences of photographs, rapid shots, videos, or any other type of image, or any combination thereof. In some embodiments, device 200 may include one or more instances of camera 212. For example, device 200 may include a front-facing camera and a rear-facing camera. Although only one camera is shown in FIG. 2 to be within device 200, it persons of ordinary skill in the art will recognize that any number of cameras, and any camera type may be included. Additionally, persons of ordinary skill in the art will recognize that any device that can capture images and/or video may be used. Furthermore, in some embodiments, camera 212 may be located external to device 200.

In some embodiments, device 200 may include microphone 214. Microphone 214 may be any component capable of detecting audio signals. For example, microphone 214 may include one more sensors or transducers for generating electrical signals and circuitry capable of processing the generated electrical signals. In some embodiments, user device may include one or more instances of microphone 214 such as a first microphone and a second microphone. In some embodiments, device 200 may include multiple microphones capable of detecting various frequency levels (e.g., high-frequency microphone, low-frequency microphone, etc.). In some embodiments, device 200 may include one or external microphones connected thereto and used in conjunction with, or instead of, microphone 214.

Output interface 216 may include any suitable mechanism or component for generating outputs from a user operating device 200. In some embodiments, output interface 216 may include display 218. Display 218 may correspond to any type of display capable of presenting content to a user and/or on a device. Display 218 may be any size and may be located on one or more regions/sides of device 200. For example, display 218 may fully occupy a first side of device 200, or may occupy a portion of the first side. Various display types may include, but are not limited to, liquid crystal displays (“LCD”), monochrome displays, color graphics adapter (“CGA”) displays, enhanced graphics adapter (“EGA”) displays, variable graphics array (“VGA”) displays, or any other display type, or any combination thereof. In some embodiments, display 218 may be a touch screen and/or an interactive display. In some embodiments, the touch screen may include a multi-touch panel coupled to processor 202. In some embodiments, display 218 may be a touch screen and may include capacitive sensing panels. In some embodiments, display 218 may also correspond to a component of input interface 210, as it may recognize touch inputs.

In some embodiments, output interface 216 may include speaker 220. Speaker 220 may correspond to any suitable mechanism for outputting audio signals. For example, speaker 220 may include one or more speaker units, transducers, or array of speakers and/or transducers capable of broadcasting audio signals and audio content to a room where device 200 may be located. In some embodiments, speaker 220 may correspond to headphones or ear buds capable of broadcasting audio directly to a user.

### I. Basic Definitions and Notations

In one embodiment, a vanilla option corresponds to a financial security that allows the holder of the option to buy or sell an underlying asset, security, or currency at a predefined price within a given amount of time. The holder, therefore, is not obligated to buy or sell, and therefore has the option to do so. A European vanilla option requires that the option can be exercised only on the expiration date and time of the option. An American vanilla option, however, allows for the option to be exercised on, or any time before, the expiry. In the BS model, a price of a European vanilla call option, P_{call}, and a price of a European Vanilla put option, Pₚᵤₜ may be defined using Equations 1 and 2, respectively:

P_{call}=Se^{-r}^{_{f}}^{T}N(d₁)−Ke^{-r}^{_{d}}^{T}N(d₂)=df[F·N(d₁)−K·N(d₂)] Equation 1;

Pₚᵤₜ=Ke^{-r}^{_{d}}^{T}N(−d₂)−Se^{-r}^{_{f}}^{T}N(−d₁)=df[K·N(−d₂)−F·N(−d₁)] Equation 2.

In Equations 1 and 2, d₁ and d₂ correspond to input values, which may be defined by

$${d}_{1} = \frac{log ( \frac{S}{K} ) + ( {r}_{d} - {r}_{f} ) T}{σ \sqrt{T}} + \frac{1}{2} σ \sqrt{T} = \frac{log ( \frac{F}{K} )}{σ \sqrt{T}} + \frac{1}{2} σ \sqrt{T} , and$$

$${d}_{2} = {d}_{1} - σ \sqrt{T} ,$$

where r_{d} and r_{f} are domestic and foreign interest rates, respectively, F is the forward price of an underlying asset at time T such that F=S e^{(r}^{_{d}}^{-r}^{_{f}}^{)T}, df is a domestic discount factor such that df=e^{-r}^{_{d}}^{T}, and N(x) is a cumulative normal distribution function. In equity options, the foreign interest rates r_{f} is replaced by the stock's dividend rate, and in commodities it is replaced by the cost of carry rate (storage).

Delta Δ corresponds to a change of a price of an option when the underlying asset changes infinitesimally. In practical terms, Delta may correspond to an amount of the underlying asset that has to be held (or sold) against an option in order to hedge a price of the option when the underlying asset's price changes slightly. The value of delta depends on a currency of the profit (loss), and if the hedger (e.g., an entity performing the hedging) needs to hedge a premium of an option. The Delta of a call option Δ_{Call} and a put option Δ_{Put} are described by Equations 3 and 4, respectively:

$$\begin{matrix}{Δ}_{Call} = \frac{{dP}_{Call}}{dS} = {e}^{- {r}_{f} T} N ( {d}_{1} ) ; & Equation 3 \\ {Δ}_{Put} = - {e}^{- {r}_{f} T} N ( - {d}_{1} ) . & Equation 4\end{matrix}$$

In the BS model, Vega (e.g., a change of a price of an option with respect to volatility), has a same expression for both call and put options, as shown by Equation 5:

$${Vega}_{call} = \frac{{dP}_{Call} ( σ )}{d σ} = {Vega}_{put} = \frac{{dP}_{Put} ( σ )}{d σ} = dfF \sqrt{T} n ( {d}_{1} ) . \qquad Equation 5$$

In Equation 5, n(d₁) is the normal density function (e.g., n(d₁)=Exp (−d₁²)/\sqrt{2π}). Therefore, as seen from Equation 5, Vega has a maximum value when the input value d₁=0.

Regardless of the pricing model, having prices P of an option for all strikes K (e.g., P(K)) allows the density function of the price of the underlying asset on the expiration day to be obtained. For example, the price of a call option with strike K at expiration time T is:

P_{Call}(K,T)=df∫₀^{∞}(S−K)⁺g(S,T)dS Equation 6.

In Equation 6, (S−K)⁺ is an operator defined as S−K when S>K and zero (e.g., 0) otherwise. Furthermore, in Equation 6, g(S, T) corresponds to the density function for the underlying asset at time T, and S corresponds to the spot price at time T. Therefore, by differentiating the integral twice with respect to strike K, it is seen that

$${g ( S , T ) = {( df )}^{- 1} \frac{{\partial }^{2} P ( K , T )}{\partial {K}^{2}} \vert}_{K = {S}^{′}}$$

where (df)⁻¹ corresponds to the inverse discount factor. Furthermore, g(K, T) must be strictly positive in order to be a valid probability density function.

By definition, an option pricing model should satisfy Equation 7:

$$\frac{{dP}_{Call} ( K )}{dK} < 0 and \frac{d ( {P}_{Put} ( K ) / K )}{dK} > 0. \qquad Equation 7$$

When applying the volatility smile, as described by the BS model where volatility σ is a function of strike K, (e.g., volatility is σ(K)), then the latest condition (e.g., Equation 7) indicates that the volatility σ(K) should obey Equation 8:

$$\frac{- N ( - {d}_{1} )}{n ( {d}_{1} )} \leq \frac{d σ}{dK} \sqrt{T} K \leq \frac{N ( {d}_{2} )}{n ( {d}_{2} )} . \qquad Equation 8$$

If an underlying asset of an option has a forward payment post expiry, then the BS formula of Equations 1 and 2 is modified by introducing an annuity An of the forward asset where the annuity's function is to discount the value of the asset to the expiry date. In this particular scenario, the BS model is typically referred to as the “Black Model.” As an illustrative example, the formula to calculate an option on swaps, called swaption, is shown by Equation 9:

P_{receiver}=Andf(FN(d₁)−KN(d₂); and

P_{payer}=Andf(K N(−d₂)−F N(−d₁)) Equation 9.

In Equation 9, F is the forward rate of the swap, or the current fixed rate of the underlying forward starting swap and An is the annuity. Using the forward price, F may be approximated as:

An=(df(T)−df(T+L))/F≈(1−1/(1+F/m)^{m}L) Equation 10.

In Equation 10, L is the duration of the swap in years, m is the compounding per year in swap rate, df(T) is the discount factor for time T, and df(T+L) is the discount factor for time T+L. For example, if the swap pays two semi-annual coupons per year, then m=2.

### II. Volatility Smile Trading in Different Options Markets

For each asset class in the options market, the most liquid options are typically either the At-The-Money (“ATM”) straddles (e.g., where call and put options have a same strike K) where the sum of the Delta of the call and the put is zero, the At-The-Money-Forward (“ATMF”) strike where the strike is the forward price, or the At-The-Money-Spot (“ATMS”) where the strike is the current spot price. Due to the importance of the volatility smile to market players, the vanilla options market for each asset class developed certain conventions, benchmark strikes, and strategies for trading the volatility smile such that traders are able to hedge their volatility smile risk. In options markets, there are liquid and commonly traded vanilla strategies. Such strategies include, for example, strangles, butterflies, and risk reversals. Risk reversals may, for instance, correspond to currencies, metals and equities. In the interest rates options market, the strategy is called “collars,” and in commodities and energy the strategy is called “fences.”

Strangles may be used to hedge the changes of Vega with respect to volatility. When a strangle trades against the ATM straddle, it is called a “butterfly strategy.” If the notional of the straddle is selected such that Vega of the four options is zero, then this may be referred to as a “Vega neutral butterfly.” Risk reversal strategies may assist in hedging the steepness of the volatility smile, otherwise known as skew, around a current spot or forward. In other words, a change of Vega when the underlying asset price moves up or down.

Below are a few exemplary options markets in each asset class.

### A. Currency (FX) Options Market

In the illustrative embodiment, it is common to trade delta neutral (e.g., the total Delta is zero) ATM volatility straddles because the price of this straddle is not sensitive to small spot movements. From Equations 3 and 4, for example, at delta neutral straddle, d₁=0. Therefore, this is the strike at which Vega has a maximum. For delta neutral straddle, the volatility traded is referred to as the pivot volatility σ₀. The delta neutral strike K₀, may be referred to as the pivot strike, such that the strike of the delta neutral straddle satisfies Equation 11:

K₀=e^{1/2σ}^{_{ATM}}^{²}^{T}F Equation 11.

To reduce an amount of delta hedging, another common convention is to trade all strikes greater than K₀ as call options, and all strikes below K₀ as put options at the inception of the trade. This is because the difference between a call option and a put option with the same strike K is essentially a forward trade, as seen by Equation 12:

Call(K)−Put(K)=df(F−K) Equation 12.

Equation 12 is satisfied regardless of the pricing model employed. Therefore, the implied volatility of a call option and a put option with the same strike is substantially the same. For the currency options market, it is typical to price and trade vanilla options using their implied volatility, and then using the BS formula to translate the volatility to the price of the option, otherwise known as the option's premium. Other strikes K are commonly referred to by their BS model Delta using those strikes' implied volatility (e.g., 10 Delta call strike).

At each benchmark expiry time, it is common to trade twenty-five delta risk reversal 25 Δ_{RR} (e.g., the Delta of the call is 25% and the Delta of the put is −25%) and twenty-five delta butterfly 25 Δ_{Fly}. The value of the twenty-five delta risk reversal is defined as 25 Δ_{RR}=σ(25 Δ_{Call})−σ(25 Δ_{Put}). The value of the twenty-five delta butterfly is defined as 25 Δ_{Fly}=(σ(25 Δ_{Call})+(σ(25 Δ_{Put}))/2−σ₀. In practice, the twenty-five delta butterfly 25 Δ_{Fly} trades by solving the strikes of the call and the put with same volatility to produce the traded butterfly value, however this is merely an exemplary means to determine the trade details when the individual volatility of the twenty-five delta call (e.g., 25 Δ_{Call}) and the twenty-five delta put (e.g., 25 Δ_{Put}) are not known.

Generally, hedging with a Vega neutral structure, where the total Vega of the structure is zero, is aimed to protect a portfolio from changes of the Vega of the portfolio that may be caused by changes of the volatility or the underlying asset price. For example, Vega neutral butterfly hedges the portfolio from changes of the Vega caused by changes of the volatility.

As an illustrative example, the delta neutral ATM volatility, 25 Δ_{RR}, and 25 Δ_{Fly} are typically very liquid for benchmark option maturities—1 day, 1 week, 1 month, 2 months, 3 months, 6 months, 9 months, 1 year, and 2 years—as most currency pairs are regularly quoted on financial market data terminals. For many currency pairs, 10 Δ_{RR} and 10 Δ_{Fly} are liquid and commonly traded as well. Persons of ordinary skill in the art will recognize that any suitable option maturity may be used by interpolation between quoted values.

### B. Equity Options Markets

In the equity options market, it may be common to trade several strikes. For instance, an At-The-Money-Spot (“ATMS”) straddle is a straddle with a strike equal to the current spot or stock price. In this instance, the ATMS straddle has a non-zero delta, and the current spot strike may be referred to as 100% spot. Additional liquid strikes may be set at 80%, 90%, 110%, and/or 120% of the current spot rate, however persons of ordinary skill in the art will recognize that this is merely exemplary. For short maturities, or less volatile stocks, strikes of 90%, 95%, 105%, and/or 110% may alternatively be used.

Additionally, in the equity options market, there may be risk reversals such as 90% against 110% risk reversal or 80% against 120% risk reversal, and, similarly, 90% and 110% strangles or 80% and 120% strangles. If the maturity is long in duration, then the ATMF straddle, where the strike is the forward rate, may be traded instead of, or in addition to, the ATMS. In this particular scenario, the strikes will be a percentage of the forward rate.

### C. The Metals Market

In the over-the-counter (“OTC”) market, it may be common to use similar conventions as with the currency market (e.g., see Section A). Thus, in the OTC market, the ATM volatility σ₀, 25 Δ_{RR}, and 25 Δ_{Fly} may be substantially similar to those of the currency market.

### D. The Energy and Agriculture Market

In the energy and agriculture market, the ATM volatility may be the ATMF, (e.g., the ATM volatility with the strike set as the forward rate at the expiration date). For exchange traded products, the benchmark dates correspond to the exchange dates for option expiries, and the forward rates are the exchange future rates.

### E. The Interest Rates Market

In an embodiment, the interest rates market includes two types of vanilla options: (i) Caps/Floors, and (ii) swaptions. Caps/Floors, which may represent call/put options, respectively, are options on the interbank lending rate, depending on the currency. For example, for the US Dollar this generally refers to the LIBOR rate (e.g., the London Interbank Offered Rate—average interest rate estimated by each of London's leading banks if they were to borrow from other banks), whereas for the Euro, this generally refers to the EURIBOR (e.g., Euro Interbank Offered Rate). Caps/Floors may be collections of vanilla call/put options referred to as caplets/floorlets, each having the same strike but different maturities. For example, a one year Cap may be four caplets with expiries 3, 6, 9, and 12 months from inception.

Additionally, the caps/floors market may trade fixed strikes in addition to the forward rate. For example, the fixed strikes may be 0.25%, 0.5%, 1.0%, 1.5%, 2.0%, 2.5%, or 3.0%, however persons of ordinary skill in the art will recognize that any suitable fixed strike may be used. Typically, collars and strangles will be combinations around the forward rate. For example, if the forward rate is 1.1255, then the cap with strike 1.5 will be against a floor with strike 1.0.

Swaptions, in one embodiment, may correspond to options on swaps that are plain vanilla options having a strike corresponding to the swap's fixed rate. The ATM strike in the swaptions market is the forward rate F of the swaption (e.g., the current swap rate of the underlying swap). The swaptions market commonly has liquidity for five strikes that are the forward rate F along with the forward rate plus or minus (±) some basis points (“bp”), where one bp is equivalent to 0.01%. Depending on the forward rate and the maturity, the plus/minus (±) basis points may vary. For example, the plus/minus (±) basis points may be 25 bp (e.g., 0.25%), 50 bp (e.g., 0.5%), 100 bp (e.g., 1.0%), 150 bp (e.g., 1.5%), or 200 bp (e.g., 2.0%), however persons of ordinary skill in the art will recognize that these are merely exemplary. Therefore, if the market trades 50 bp, 100 bp, or 200 bp collars and strangles, this may correspond to pairs of strikes of F−25 bp and F+25 bp, F−50 bp and F+50 bp, and F−100 bp and F+100 bp, respectively, where F is the current forward rate. In an environment where rates are very low, it is generally common to trade non-symmetric pairs, such as F−25 bp and F+75 bp.

If an interest rate is negative, then the Black model (e.g., the BS model with annuity), may be modified such that the Black formula is used while shifting the forward rate and the strike rate by a same constant. For example, instead of log(F/K) in d₁, the market may use log(F+X/K+X), where X may be chosen such that both F+X and K+X are positive for all relevant strikes (e.g., typically X<3.0%).

### III. New Volatility Smile Model

The BS Model and/or Black model may be used to determine volatility from options prices, and vice versa. As used herein, an intrinsic volatility of a European Vanilla option is the implied volatility from the BS model. In other words, given a price of an option, the intrinsic volatility corresponds to the volatility as if there were no smile. For a European Vanilla option, having an expiration T for all strikes K, the implied volatility smile described by the function σ(K, T) may be obtained by solving Equation 13:

P(K,T)=BS(K,T,σ(K,T)) Equation 13.

Equation 13, for instance, automatically satisfies various conditions, such as that the difference between a call option and a put option with the same strike and expiry satisfies Equation 12, and/or that the volatility of a call option and a put option with the same strike is the same. To determine how an option's price P changes with respect to the intrinsic volatility, the BS derivatives formula may be used, as seen by Equation 14:

ΔP(K,T)=Δσ(K,T)dBS(K,T,σ(K,T))/dσ(K,T);dP(K,T)/dσ(K,T)=Vega(K,T,σ(K,T))=dfF\sqrt{T}n(d₁(σ(K,T))) Equation 14.

From Equation 14, strike K₀, at which Vega is maximal, satisfies the condition that d₁(σ(K₀))=0. For simplicity, the time dependency is removed from the volatility σ, however persons of ordinary skill in the art will recognize that, in the illustrative embodiment, σ is still a function of T. As described herein, a pivot volatility σ(K₀), denoted by σ₀, may be referred to as a volatility corresponding to a maximum value for Vega at expiry T. For any option having a strike K, ζ(K) may be referred to as a difference between a price of an option, and the BS price using pivot volatility σ₀ as opposed to the intrinsic volatility, as described in Equation 15:

ζ(K)=P(K)−BS(K,σ₀)=BS(σ(K))−BS(σ₀) Equation 15.

By definition, at the pivot strike K₀, ζ(K₀)=0. Equation 15 depends on whether the option is a call option or a put option. However, from Equation 12, for a given strike K, ζ(K) is the same for both call option and put options. Vega, in the illustrative embodiment, depends on (d₁)², indicating that there are two different strikes for a single Vega value (e.g., d₁ and −d₁). In this particular instance, the larger value strike may be used for a call option (e.g., K_{Call}), whereas the lower value strike may be used for a put option (e.g., K_{Put}) such that Equation 16 is satisfied:

d₁(K_{CALL},σ(K_{call}))=−d₁(Kₚᵤₜ,σ(Kₚᵤₜ)) Equation 16.

In Equation 16, Kₚᵤₜ<K₀<K_{call}.

These two strike values, K_{Call} and K_{Put}, may be referred to as dual strikes. In other words, a strangle or risk reversal, where the Vega of a call option and a put option is the same, indicates that for a given call option's strike K_{call}, the put option's strike Kₚᵤₜ is its dual. In this particular scenario, when there is no annuity, the call option and the put option have an opposite Delta.

In one embodiment, hedging the impact of fluctuations of the volatility on a trader's portfolio may be done in three ways: (i) ATM straddles may be used to offset a total amount of Vega in the portfolio; (ii) Vega neutral butterfly may be used to offset a total amount of

$$\frac{d Vega}{d σ}$$

in the trader's portfolio; and (iii) risk reversal (which are automatically Vega Neutral) may be used to offset a total amount of

$$\frac{d Vega}{dS}$$

(or equivalently

$$\frac{d Delta}{d σ} \text{)}$$

for the trader's portfolio.

For d₁ strangle, where the call and the put have the opposite d₁,

$$\frac{d Vega}{d σ} and \frac{d Vega}{dS}$$

may be described by Equations 17 and 18, respectively:

$$\begin{matrix}\frac{d Vega}{d σ} ( Call ( {d}_{1} ) + Put ( - {d}_{1} ) ) = F \sqrt{T} n ( {d}_{1} ) {d}_{1}^{2} ( \frac{1}{{σ}_{c}} + \frac{1}{{σ}_{p}} ) ; & Equation 17 \\ \frac{d Vega}{d σ} ( Call ( {d}_{1} ) + Put ( - {d}_{1} ) ) = n ( {d}_{1} ) ( {d}_{1} ( \frac{1}{{σ}_{p}} - \frac{1}{{σ}_{c}} ) + 2 \sqrt{T} ) . & Equation 18\end{matrix}$$

For d₁ risk reversal, where the call and the put have the opposite d₁,

$$\frac{d Vega}{d σ} and \frac{d Vega}{dS}$$

may be described by Equations 19 and 20, respectively:

$$\begin{matrix}\frac{d Vega}{d S} ( Call ( {d}_{1} ) - Put ( - {d}_{1} ) ) = - n ( {d}_{1} ) {d}_{1} ( \frac{1}{{σ}_{c}} + \frac{1}{{σ}_{p}} ) ; & Equation 19 \\ \frac{d Vega}{d σ} ( Call ( {d}_{1} ) - Put ( - {d}_{1} ) ) = - F \sqrt{T} n ( {d}_{1} ) {d}_{1} ( {d}_{1} ( \frac{1}{{σ}_{p}} - \frac{1}{{σ}_{c}} ) + 2 \sqrt{T} ) . & Equation 20\end{matrix}$$

In an illustrative embodiment, Vega-neutral butterfly may be expressed by Equation 21:

$$Butterfly ( {d}_{1} ) = Strangle ( {d}_{1} ) - {e}^{- \frac{{d}_{1}^{2}}{2}} \times Straddle ( 0 ) . \qquad Equation 21$$

In this particular scenario, the pivot ATM straddle has

$$\frac{d Vega}{d σ} = 0 while \frac{d Vega}{dS} \neq 0.$$

In the Black model for swaptions, or any forward payment of an underlying asset, Vega is described using Equation 22:

$$Vega ( Black ) = An df F \sqrt{T} {e}^{- \frac{{d}_{1}^{2}}{2}} = An Vega ( BS ) . \qquad Equation 22$$

In the illustrative embodiment, the derivatives with respect to S may be replaced with the derivatives with respect to the forward price F. Therefore, the results of calculating

$$\frac{d Vega}{d σ} and \frac{d Vega}{d F}$$

of the strangle and risk reversal for swaptions yields the same expressions as in Equations 17, 19, and 20 multiplied by the annuity An(F) and instead of Equation 18, Equation 23 is obtained:

$$\frac{d Vega}{d F} ( Call ( {d}_{1} ) + Put ( - {d}_{1} ) ) = An N ( {d}_{1} ) ( {d}_{1} ( \frac{1}{{σ}_{p}} - \frac{1}{{σ}_{c}} ) + 2 ( \frac{\frac{dAn}{dF}}{An} F + \sqrt{T} ) ) . \qquad Equation 23$$

Looking at all risk reversals and Vega neutral butterflies, where the strike of a call and put option are each other's dual, a hedge against the impact of a shape of the smile may be obtained, whose effectiveness is dependent on d₁. Therefore, two determinations may be needed: (i) the effect of a price of d₁=D₁ butterfly verses a d₁=D₂ butterfly, and (ii) the effect of a price of d₁=D₁ risk reversal verses a d₁=D₂ risk reversal. In order to determine both (i) and (ii), a generalization may be made to a “generalized butterfly” having

$$\frac{d Vega}{d S} = 0$$

and a “generalized risk reversal” having

$$\frac{d Vega}{d σ} = 0.$$

To formulate the generalized butterfly, which is denoted as Butterfly′, the ATM straddle may be added to the Vega neutral butterfly, where the ATM straddle does not change an amount of

$$\frac{d Vega}{d σ}$$

of the butterfly, as described by Equation 24, where

$$α = {e}^{- \frac{{d}_{1}^{2}}{2}} \frac{{d}_{1}}{2 \sqrt{T}} ( \frac{1}{{σ}_{p}} - \frac{1}{{σ}_{c}} ) :$$

Butterfly′(d₁)=Butterfly(d₁)+αATM Straddle Equation 24.

In Equation 24,

$$\frac{d Vega}{d σ} ( {Butterfly}^{′} ( {d}_{1} ) ) = \frac{d Vega}{d σ} ( Strangle ( {d}_{1} ) ) , and$$

$$\frac{d Vega}{d S} ( {Butterfly}^{′} ( {d}_{1} ) ) = 0.$$

Similarly, the generalized risk reversal, which is denoted as RR′, may be described by Equation 25, where

$$W = - \frac{{d}_{1} ( {σ}_{c} - {σ}_{p} ) + 2 \sqrt{T} {σ}_{c} {σ}_{p}}{{σ}_{c} + {σ}_{p}} :$$

RR′(d₁)=RR(d₁)−WButterfly′(d₁) Equation 25.

In Equation 25, RR′(d₁)=RR (d₁)−W Strangle (d₁)−W

$${e}^{- \frac{{d}_{1}^{2}}{2}} ( \frac{{d}_{1}}{2 \sqrt{T}} ( \frac{1}{{σ}_{p}} - \frac{1}{{σ}_{c}} ) - 1 )$$

ATM straddle(0), and

$$\frac{d Vega}{d S} ( {RR}^{′} ( {d}_{1} ) ) = \frac{d Vega}{d S} ( RR ( {d}_{1} ) ) , and$$

$$\frac{d Vega}{d σ} ( {RR}^{′} ( {d}_{1} ) ) = 0 ,$$

thus yielding two orthogonal quantities. As described herein, two orthogonal quantities may correspond to volatility being plotted along a first axis and an underlying asset spot price being plotted along a second axis. One of the two orthogonal quantities has a Vega that only has non-zero derivatives with respect to the volatility, while the other quantity's Vega has only non-zero derivatives with respect to the underlying asset price (or forward rate in the case of interest rates). Otherwise, the other derivatives are zero.

Using the aforementioned orthogonality condition(s), the volatility smile may be implemented using Equations 26 and 27:

$$\begin{matrix}{ζ}_{{Butterfly}^{′}} ( {d}_{1} ) = {ζ}_{strangle} ( {d}_{1} ) = A ( {d}_{1} , T , {σ}_{0} ) \frac{d Vega}{d σ} ( Strangle ( {d}_{1} ) ) ; and & Equation 26 \\ {ζ}_{{RR}^{′}} ( {d}_{1} ) = {ζ}_{RR} ( {d}_{1} ) - W {ζ}_{strangle} ( {d}_{1} ) = B ( {d}_{1} , T , {σ}_{0} ) \frac{d Vega}{d S} ( RR ( {d}_{1} ) ) . & Equation 27\end{matrix}$$

In Equations 26 and 27, A(d₁, T, σ₀) and B(d₁, T, σ₀), which corresponds to the ratio between ζ_{Butterfly′} (d₁) and

$$\frac{d Vega}{d σ}$$

(Strangle(d₁)), and the ratio between ζ_{RR′} (d₁) and

$$\frac{d Vega}{d S}$$

(RR(d₁)), respectively, are functions to be determined. For a call option with higher strike K_{c}, and the dual put option with lower strike Kₚ, Equations 28 and 29 are respectively obtained (for simplicity, T and σ₀ are omitted in A and B):

$$\begin{matrix}{ζ}_{c} = F N ( {d}_{1} ) ( \frac{A ( {d}_{1} ) \sqrt{T} {( {d}_{1} )}^{2}}{{σ}_{c}} - A ( {d}_{1} ) {d}_{1} T - \frac{B ( {d}_{1} ) {d}_{1}}{2 F} ( \frac{1}{{σ}_{c}} + \frac{1}{{σ}_{p}} ) ) ; \\ and & Equation 28 \\ {ζ}_{p} = F N ( {d}_{1} ) ( \frac{A ( {d}_{1} ) \sqrt{T} {( {d}_{1} )}^{2}}{{σ}_{p}} + A ( {d}_{1} ) {d}_{1} T + \frac{B ( {d}_{1} ) {d}_{1}}{2 F} ( \frac{1}{{σ}_{c}} + \frac{1}{{σ}_{p}} ) ) . & Equation 29\end{matrix}$$

Alternatively, Equation 28 and 29 may be written as functions of d₁, as ζ_{c}=ζ(d₁), ζₚ=ζ(−d₁), σ_{c}=σ(d₁), and σₚ=σ(−d₁). For instance, as seen by Equations 30 and 31:

K(d₁)=FExp((−d₁+½σ(d₁)\sqrt{T})σ(d₁)\sqrt{T}) Equation 30; and

K(−d₁)=FExp((d₁+½σ(−d₁)\sqrt{T})σ(−d₁)\sqrt{T}) Equation 31.

Therefore, if A(d₁), B(d₁), and σ₀ are known, then for a given input value d₁, two equations (e.g., Equations 28 and 29) are produced to be simultaneously solved for σ(d₁) and σ(−d₁) to obtain K(d₁) and K(−d₁). For instance, for a given strike K, and for a known result of A(d₁) and B(d₁), d₁, and σ(d₁) may be determined, and therefore values for ζ_{c} and ζₚ may be obtained.

Alternatively, σ_{call}=σ_{call}(K_{c}, d₁) and σ_{Put}=σ_{Put}(Kₚ, −d₁) and therefore Equations 28 and 29 can be expressed as a function of d₁, K_{c}, and Kₚ. For example, for a given K_{c}, d₁ and Kₚ are solved simultaneously.

Using Equations 1, 2, and 15 in conjunction with Equations 28 and 29, an asymptotic behavior of A(d₁) and B(d₁) is obtained.

For instance, the fact is used that as d₁ becomes very large, σ²T<2|log F/K|, which results in A(d₁)→O(d₁⁻²) and B(d₁)→O(d₁⁻¹)) as d₁→∞.

In some embodiments, an additional modification to a may be used for an underlying asset with a forward payment (e.g., a swaption). For instance, this additional modification may be used when the Black model is to be used instead of the BS model. The additional modification may be described by Equation 32:

$$α Black = {e}^{- \frac{{d}_{1}^{2}}{2}} \frac{\frac{{d}_{1}}{2 \sqrt{T}} ( \frac{1}{{σ}_{p}} - \frac{1}{{σ}_{c}} )}{1 + \frac{1}{A} F \frac{dA}{dF}} . \qquad Equation 32$$

In this particular scenario, W, as described previously, remains unchanged, and Equations 26 and 27 may be translated similarly to Equations 28 and 29, respectively, with an additional multiplicative factor of the annuity An, as seen by Equations 33 and 34:

$$\begin{matrix}{ζ}_{c} = F N ( {d}_{1} ) ( \frac{A ( {d}_{1} ) \sqrt{T} {( {d}_{1} )}^{2}}{{σ}_{c}} - A ( {d}_{1} ) {d}_{1} T - \frac{B ( {d}_{1} ) {d}_{1}}{2 F} ( \frac{1}{{σ}_{c}} + \frac{1}{{σ}_{p}} ) ) An ; \\ and & Equation 33 \\ {ζ}_{p} = F N ( {d}_{1} ) ( \frac{A ( {d}_{1} ) \sqrt{T} {( {d}_{1} )}^{2}}{{σ}_{p}} + A ( {d}_{1} ) {d}_{1} T + \frac{B ( {d}_{1} ) {d}_{1}}{2 F} ( \frac{1}{{σ}_{c}} + \frac{1}{{σ}_{p}} ) ) An , & Equation 34.\end{matrix}$$

In some embodiments, the forward rate may be very small or negative such that prices for negatives strikes mapped to the BS (Black) model may not be possible. To overcome this, a shift may be applied, where instead of using forward rate F and strike K, a modified forward rate F+X₁ and a modified strike K+X₂ may be used for fixed positive constants X₁ and X₂. In particular, X₁ and X₂ may be selected such that X₁=X₂=X, where the constant X may be chosen such that it is large enough to encompass all negative strikes that trade in the market, however persons of ordinary skill in the art will recognize that any suitable optimization of the constant X may be employed. In this particular instance, Equation 13 may be modified to that of Equation 35:

P(K,T,F)=BS(K+X,T,F+X,σ_{shifted}(K,T,F)) Equation 35.

Furthermore, for a positive strike K and forward rate F, the shifted volatility may be related to the volatility for the non-shifted case, using Equation 36:

BS(K+X,F+X,σ_{shifted}(K,T))=BS(X,F,σ_{original}(K,T)) Equation 36.

For Equation 35, the pivot strike K₀ may be described by:

K_{0shifted}=FExp(−σ²_{0shifted}T/2)+X(1−EXP(−σ²_{0shifted}T/2)) Equation 37.

From Equations 28 and 29, or similarly from Equations 33 and 34, it may be understood that the difference between the intrinsic volatility and the pivot volatility is related to

$$\frac{d Vega}{d σ} and \frac{d Vega}{d S}$$

at inception. However, it is necessary to show that it is actually driven from

$$\frac{d Vega}{d σ} and \frac{d Vega}{d S}$$

in the various paths of the underlying asset, from inception through the life of the options of the structure, until expiry. This means that ζ_{Butterfly′} and ζ_{RR′} depend on

$$\frac{d Vega}{d σ} and \frac{d Vega}{d S}$$

during the life of the option, and the accumulated dependency is related to the dependency at inception.

In order to fully understand why a volatility smile must be present, a first assumption may be made, where the first assumption is that the interest rates are zero. The ATM volatility for an expiry T may be denoted by σ₀. Therefore, the market expectation value of the fluctuation of the underlying asset from a present time to expiry is σ₀, as the ATM volatility is expected to fluctuate until expiry. In one embodiment, the time to expiry T may be divided into N temporal intervals tᵢ, where tᵢ=iT/N. At each time tᵢ, the ATM volatility to expiry T is σ(tᵢ, T). The stochastic variable δσᵢ may be defined such that δσᵢ=σ(tᵢ, T)−σ(tᵢ₋₁, T), and the change of the underlying asset price from time tᵢ₋₁ to time tᵢ may be denoted by δsᵢ=sᵢ−sᵢ₋₁.

A specific Vega neutral d₁ butterfly with expiry T may first be considered. For example, a Vega hedged d₁ strangle may be considered. The strikes of the butterfly may correspond to K_{call}, Kₚᵤₜ, and K₀, where K₀ is the strike of the ATM option at inception. At each time tᵢ, and depending on sᵢ, an amount of Vega of the butterfly (e.g., the Vega neutral d₁ butterfly) may change as the ATM volatility σ(tᵢ, T) changes.

At time tᵢ, a change in the value of the butterfly (up to second order) from time tᵢ₋₁ due to a change in the volatility may be represented by Equation 38:

$$δ {Π}_{i} ( butterfly , {t}_{i} ) = Vega ( {t}_{i - 1} ) ) δ {σ}_{i} + \frac{1}{2} δ Vega ( {t}_{i} ) δ {σ}_{i} = Vega ( butterfly , {t}_{i - 1} ) δ {σ}_{i} + \frac{1}{2} \frac{d Vega}{d σ} ( butterfly , {t}_{i - 1} ) δ {σ}_{i}^{2} + \frac{1}{2} \frac{d Vega}{ds} ( butterfly , {t}_{i - 1} ) δ {σ}_{i} δ {s}_{i} . \qquad Equation 38$$

In Equation 38,

$$Vega ( butterfly , {t}_{i - 1} ) = Vega ( {K}_{call} , {t}_{i - 1} ) + Vega ( {K}_{put} , {t}_{i - 1} ) - 2 {e}^{- \frac{{d}_{1}^{2}}{2}} Vega ( {k}_{0} , {t}_{i - 1} ) .$$

Therefore, it may be assumed that for the infinitesimal time interval δt, the volatility smile moves in parallel to the ATM volatility.

The re-hedging strategy may be described in two ways. The first technique may be used to explain the re-hedging strategy in a simpler albeit less accurate manner. While the influence of the price of the underlying asset on all of the options is delta hedged, the volatility changes may be re-hedged with K₀ straddle only. At each time tᵢ, the hedger may buy or sell options with notional δnᵢ such that the total Vega of the d₁ strangle and the K₀ straddle is zero. In this particular scenario, Nᵢ may denote the total notional (e.g., amount) of the K₀ strike at time tᵢ. Therefore, at each time tᵢ, Nᵢ Vega (K₀ straddle, tᵢ)+Vega (d₁ strangle, tᵢ)=0. This causes the notional of the K₀ strike in the portfolio at time tᵢ to be Nᵢ=(Vega (K^{call}, tᵢ)+Vega (K^{put}, tᵢ))/2Vega (K₀, tᵢ). At inception (e.g., time t=0),

$${N}_{0} = {e}^{- \frac{{d}_{1}^{2}}{2}} .$$

Thus, the profit from re-heding the d₁ butterfly with the K₀ strike may be described by Equation 39:

$$δ Π i ( butterfly + {K}_{0} hedge , {t}_{i} ) = \frac{1}{2} \frac{d Vega}{d σ} ( {d}_{1} strangle , {t}_{i - 1} ) - {N}_{i - 1} \frac{d Vega}{d σ} ( {K}_{0} straddle , {t}_{i - 1} ) ) δ {σ}_{i}^{2} + \frac{1}{2} ( \frac{d Vega}{ds} ( {d}_{1} strangle , {t}_{i - 1} ) - {N}_{i - 1} \frac{d Vega}{ds} ( {K}_{0} straddle , {t}_{i - 1} ) ) δ {σ}_{i} δ {s}_{i} . \qquad Equation 39$$

The expected profit from holding the d₁ strangle until maturity while re-hedging the Vega with the option with strike K₀ up to second order due to changes in the volatility may be described by Equation 40:

$$E ( {\sum }_{i = 1}^{N} δ Π i ) = \frac{1}{2} E ( {\sum }_{i = 1}^{N} \frac{d Vega}{d σ} ( {d}_{1} strangle , {t}_{i - 1} ) - {N}_{i - 1} \frac{d Vega}{d σ} ( {K}_{0} straddle , {t}_{i - 1} ) ) δ {σ}_{i}^{2} + ( \frac{d Vega}{ds} ( {d}_{1} strangle , {t}_{i - 1} ) - \frac{d Vega}{ds} ( {K}_{0} strangle , {t}_{i - 1} ) δ {σ}_{i} δ {s}_{i} . \qquad Equation 40$$

Furthermore, Equation 41 may be used to describe Butterfly*(d₁,tᵢ):

butterfly*(d₁,tᵢ)=Call(K_{call})+Put(Kₚᵤₜ)−Nᵢ(Call(K₀)+Put(K₀)) Equation 41.

In one embodiment, δσᵢ and δsᵢ may be considered to be independent (or approximately independent) of Vega (d₁ strangle, tᵢ₋₁) and Vega (K₀, tᵢ₋₁). Therefore, Equation 41 may be expressed as:

$$E ( {\sum }_{i = 1}^{N} δ Π i ) \approx \frac{1}{2} E ( {\sum }_{i = 1}^{N} \frac{d Vega}{d σ} ( {butterfly}^{*} , {t}_{i - 1} ) ) E ( {\sum }_{i = 1}^{N} δ {σ}_{i}^{2} ) / N + \frac{1}{2} E ( {\sum }_{i = 1}^{N} \frac{d Vega}{ds} ( {butterfly}^{*} , {t}_{i - 1} ) E ( {\sum }_{i = 1}^{N} δ {σ}_{i} δ {s}_{i} ) / N . \qquad Equation 42$$

Using Equation 42, the relationships of Equations 43 and 44 may be defined:

Var(σ_{ATM})−E(Σᵢ₌₁^{N}δσᵢ²/N) Equation 43; and

Cov(σ_{ATM},s)=E(Σᵢ₌₁^{N}δσᵢδsᵢ/N) Equation 44.

As seen by Equation 43, Var(σ_{ATM}) may corresponds to the expected variance of the ATM volatility in a period from present time to maturity. Furthermore, as seen by Equation 44, Cov(σ_{ATM}, s) may correspond to the expected covariance of the ATM volatility and the underlying asset prior in the period.

Therefore, Equation 42 may be rewritten as Equation 45:

$$E ( {\sum }_{i = 1}^{N} δ Π i ) \approx \frac{1}{2} E ( {\sum }_{i = 1}^{N} \frac{d Vega}{d σ} ( {butterfly}^{*} , {t}_{i - 1} ) ) Var ( {σ}_{ATM} ) + \frac{1}{2} E ( {\sum }_{i = 1}^{N} \frac{d Vega}{ds} ( {butterfly}^{*} , {t}_{i - 1} ) ) Cov ( {σ}_{ATM} , s ) . \qquad Equation 45$$

The profit of the risk reversal with Vega re-hedging with K₀ strike may be calculated as well. For the risk reversal at time tᵢ, the total notional of the K₀ strike in the portfolio may be described by Equation 46, such that at inception (e.g., time t=0), N₀=0:

Nᵢ=(Vega(K^{call},tᵢ)−Vega(K^{put},tᵢ))/2Vega(K₀,tᵢ) Equation 46.

In the BS model, both Var(σ_{ATM})=0 and Cov(σ_{ATM}, s)=0. However, in reality Var(σ_{ATM})>0 and the expected value of the profit of the butterfly and the risk reversal represent their premiums over the BS model, respectively. Up to second order, the price of the d₁ Vega neutral butterfly may be decomposed into two contributing portions: the first contribution may correspond to the BS price with some constant volatility σ₀. This contribution takes into account the re-hedging of the option for changes in the underlying asset and includes the second order derivatives by the underlying asset, the latter of which may be equivalent to the time decay of the options. The second contribution may originate from the re-hedging of the Vega when the ATM volatility changes.

Therefore, if σ₀ is approximately the constant volatility element, the price of the d₁ butterfly may satisfy Equation 47:

$$ζ ( {d}_{1} butterfly ) = \frac{1}{2} E ( {\sum }_{i = 1}^{N} \frac{d Vega}{d σ} ( {butterfly}^{*} , {t}_{i - 1} ) ) Var ( {σ}_{0} ) + \frac{1}{2} E ( {\sum }_{i = 1}^{N} \frac{d Vega}{ds} ( {butterfly}^{*} , {t}_{i - 1} ) ) Cov ( {σ}_{0} , s ) . \qquad Equation 47$$

For d₁=0, or d₁=±infinity, then ζ(d₁ butterfly)=0, and is non-zero between, and thus the growing zeta forms the smile shape.

The inaccuracy in the calculation of the profit while re-hedging with K₀ via Equation 47 corresponds to the effect of the smile on the price of the strike K₀ being neglected. If the volatility merely fluctuates, then because buying and selling occurs at relatively small time intervals, these fluctuations may be justifiably neglected. However, if the volatility trends, then the error will accumulate. Therefore, to improve the accuracy of the calculation, the second re-hedging strategy may be utilized.

The second and more accurate re-hedging strategy with regard to changes of the ATM volatility σ(tᵢ, T) may correspond to a hedger, at time tᵢ, buying or selling ATM options whose ATM strike is denoted as K₀ⁱ such that an amount of Vega of the butterfly and the ATM hedge is zero. The previous ATM hedge with strike K₀ⁱ⁻¹, which may differ from K₀ⁱ, may be replaced by the hedger so that the previous ATM option hedge is replaced by the current ATM option. Therefore, at each time tᵢ, the full hedge may correspond to the current ATM option such that Vega (ATM hedge, tᵢ)=−Vega(butterfly, tᵢ).

In the example embodiment, the ATM options may have zero

$$\frac{d Vega}{d σ} ,$$

and therefore at time tᵢ, the replacement of the previous ATM hedge with strike K₀ⁱ⁻¹ by strike K₀ⁱ generates a profit as seen by Equation 48:

$$Profit = - Vega ( butterfly , {t}_{i - 1} ) ) δ {σ}_{i} + \frac{1}{2} \frac{d Vega}{ds} ( ATM hedge , {t}_{i - 1} ) δ {σ}_{i} δ {s}_{i} = - Vega ( butterfly , {t}_{i - 1} ) ) δ {σ}_{i} - \frac{1}{2} \frac{Vega ( butterfly , {t}_{i - 1} )}{{s}_{i - 1}} δ {σ}_{i} δ {s}_{i} . \qquad Equation 48$$

Up to second order, the profit from the change in the volatility of the butterfly and its Vega hedge may be represented by Equation 49:

$${δΠ}_{i} ( butterfly + ATM hedge , {t}_{i} ) = \frac{1}{2} \frac{d Vega}{d σ} ( butterfly , {t}_{i - 1} ) {δσ}_{i}^{2} + \frac{1}{2} [ \frac{d Vega}{ds} ( butterfly , {t}_{i - 1} ) - \frac{Vega ( butterfly , {t}_{i - 1} )}{{s}_{i - 1}} ] {δσ}_{i} δ {s}_{i} . \qquad Equation 49$$

The expected profit from holding the strangle until maturity while re-hedging with ATM option up to second order may therefore be described by Equation 50:

$$E ( {\sum }_{i = 1}^{N} {δΠ}_{i} ) = \frac{1}{2} E ( {\sum }_{i = 1}^{N} \frac{d Vega}{d σ} ( butterfly , {t}_{i - 1} ) {δσ}_{i}^{2} + [ \frac{d Vega}{ds} ( butterfly , {t}_{i - 1} ) - \frac{Vega ( butterfly , {t}_{i - 1} )}{{s}_{i - 1}} ] {δσ}_{i} δ {s}_{i} ) . \qquad Equation 50$$

In one embodiment, δσᵢ and δsᵢ may be considered to be independent (or approximately independent) of Vega (butterfly, tᵢ₋₁). Therefore, Equation 50 may be expressed as:

$$E ( {\sum }_{i = 1}^{N} {δΠ}_{i} ) \approx \frac{1}{2} E ( {\sum }_{i = 1}^{N} \frac{d Vega}{d σ} ( butterfly , {t}_{i - 1} ) ) Var ( {σ}_{ATM} ) + \frac{1}{2} E ( {\sum }_{i = 1}^{N} [ \frac{d Vega}{ds} ( butterfly , {t}_{i - 1} ) - \frac{Vega ( butterfly , {t}_{i - 1} )}{{s}_{i - 1}} ] ) Cov ( {σ}_{ATM} , s ) . \qquad Equation 51$$

The profit may be determined for d₁ risk reversal with re-hedging ATM options as well, as seen by Equation 52:

$$E ( {\sum }_{i = 1}^{N} {δΠ}_{i} ) \approx \frac{1}{2} E ( {\sum }_{i = 1}^{N} \frac{d Vega}{d σ} ( risk reversal , {t}_{i - 1} ) ) Var ( {σ}_{ATM} ) + \frac{1}{2} E ( {\sum }_{i = 1}^{N} [ \frac{d Vega}{ds} ( risk reversal , {t}_{i - 1} ) - \frac{Vega ( risk reversal , {t}_{i - 1} )}{{s}_{i - 1}} ] ) Cov ( {σ}_{ATM} , s ) . \qquad Equation 52$$

The volatility smile may be described in several ways. As a first approach, the volatility smile may be described with two d₁ objects: (i) Vega neutral butterfly, and (ii) risk reversal, and their value relative to the BS price with σ₀ may be obtained from the expected profit of the re-hedging. In one embodiment, a butterfly function and a risk reversal function may be defined by Equations 53 and 54:

$$\begin{matrix}Ϛ ( {d}_{1} butterfly ) = Ϛ ( {d}_{1} strangle ) = \frac{1}{2} E ( {\sum }_{i = 1}^{N} \frac{d Vega}{d σ} ( {butterfly}_{0} , {t}_{i - 1} ) ) Var ( {σ}_{ATM} ) + \frac{1}{2} E ( {\sum }_{i = 1}^{N} [ \frac{d Vega}{ds} ( {butterfly}_{0} , {t}_{i - 1} ) - \frac{Vega ( {butterfly}_{0} , {t}_{i - 1} )}{{s}_{i - 1}} ] ) Cov ( {σ}_{ATM} , s ) ; \\ and & Equation 53 \\ Ϛ ( {d}_{1} risk reversal ) = \frac{1}{2} E ( {\sum }_{i = 1}^{N} \frac{d Vega}{d σ} ( risk {reversal}_{0} , {t}_{i - 1} ) ) Var ( {σ}_{ATM} ) + \frac{1}{2} E ( {\sum }_{i = 1}^{N} [ \frac{d Vega}{ds} ( risk {reversal}_{0} , {t}_{i - 1} ) - \frac{Vega ( risk {reversal}_{0} , {t}_{i - 1} )}{{s}_{i - 1}} ] ) Cov ( {σ}_{ATM} , s ) . & Equation 54\end{matrix}$$

Using the approach of Equations 53 and 54, the whole volatility smile may be expressed using three parameters: Var(σ_{ATM}), Cov(σ_{ATM}, s), and σ₀. As described in the previous hedging strategy, the “smile” shape of the volatility as a function of the strike (hence the term “volatility smile”) may be understood as by consideration where the covariance is zero (e.g., Cov(σ_{ATM}, s)=0). For both d₁=0 or d₁=±infinity, ζ(d₁ butterfly)=0 and is non-zero between. The growing zeta as a function of d₁ forms the smile shape.

As a second and more accurate approach, a d₁=0 straddle (e.g., a call and put having strike K₀) may be used. Using the same “re-hedging” strategy with the concurrent ATM options at each time tᵢ, Equation 55 may be obtained:

$$E ( {\sum }_{i = 1}^{N} {δΠ}_{i} ( {K}_{0} ) ) = \frac{1}{2} E ( {\sum }_{i = 1}^{N} \frac{d Vega}{d σ} ( Straddle {K}_{0} , {t}_{i - 1} ) {δσ}_{i}^{2} + [ \frac{d Vega}{ds} ( Straddle {K}_{0} , {t}_{i - 1} ) - \frac{Vega ( Straddle {K}_{0} , {t}_{i - 1} )}{{s}_{i - 1}} ] {δσ}_{i} δ {s}_{i} ) . \qquad Equation 55$$

The price of the option with strike K₀ may be described as two decomposed elements: the first element is the price when the volatility is constant, and the second element is the expected profit/loss generated by re-hedging the option when the volatility changes. Therefore, the option price with strike K₀ (e.g., ζ(K₀)=0) may be expressed by:

$$\begin{matrix}P ( straddle {K}_{0} ) = BS ( straddle {K}_{0} , {σ}_{0} \\ = BS ( straddle {K}_{0} , {σ}_{0}^{′} ) + \\ \frac{1}{2} E ( {\sum }_{i = 1}^{N} \frac{d Vega}{d σ} \\ ( Straddle {K}_{0} , {t}_{i - 1} ) {δσ}_{i}^{2} + \\ [ \frac{d Vega}{ds} ( Straddle {K}_{0} , {t}_{i - 1} ) - \\ \frac{Vega ( Straddle {K}_{0} , {t}_{i - 1} )}{{s}_{i - 1}} ] {δσ}_{i} δ {s}_{i} ) .\end{matrix} \qquad Equation 56$$

In Equation 56, σ′₀ may correspond to a constant volatility, which may represent an element of the option that does not change in volatility throughout the life of the option. Equation 57 may be described as:

$$BS ( straddle {K}_{0} , {σ}_{0}^{′} ) = BS ( straddle {K}_{0} , {σ}_{0} ) + 2 Vega ( {K}_{0} , {σ}_{0} ) ( {σ}_{0}^{′} - {σ}_{0} ) + \frac{d Vega}{d σ} ( {K}_{0} , {σ}_{0} ) {( {σ}_{0}^{′} - {σ}_{0} )}^{2} . \qquad Equation 57$$

Therefore, based on

$$\frac{d Vega}{d σ} ( {K}_{0} , {σ}_{0} ) = 0$$

up to second order, the following approximation of the constant volatility σ′₀ may be obtained:

$${σ}_{0}^{′} \approx {σ}_{0} - \frac{1}{2} [ E {\sum }_{i = 1}^{N} \frac{d Vega}{d σ} ( Straddle {K}_{0} , {t}_{i - 1} ) Var ( {σ}_{ATM} ) + E {\sum }_{i = 1}^{N} [ \frac{d Vega}{d σ} ( Straddle {K}_{0} , {t}_{i - 1} ) - \frac{Vega ( Straddle {K}_{0} , {t}_{i - 1} )}{{s}_{i - 1}} ] Cov ( {σ}_{ATM} , s ) ] / ( df F \sqrt{\frac{T}{2 π}} ) . \qquad Equation 58$$

The correction to the BS price of the Vega neutral butterfly with the constant volatility σ′₀ may correspond to an expected value of the profit from the Vega neutral butterfly with its Vega re-hedging. Thus, the price of the d₁ butterfly may be expressed by Equation 59:

$$P ( {d}_{1} butterfly ) = BS ( {K}_{call} , {σ}_{0}^{′} ) + BS ( {K}_{put} , {σ}_{0}^{′} ) - 2 {e}^{- \frac{{d}_{1}^{2}}{2}} BS ( {K}_{0} , {σ}_{0}^{′} ) + \frac{1}{2} E ( {\sum }_{i = 1}^{N} \frac{d Vega}{d σ} ( {d}_{1} butterfly , {t}_{i - 1} ) ) Var ( {σ}_{ATM} ) + \frac{1}{2} E ( {\sum }_{i = 1}^{N} \frac{d Vega}{d σ} ( {d}_{1} butterfly , {t}_{i - 1} ) - Vega ( {d}_{1} butterfly , {t}_{i - 1} ) / {s}_{i - 1} ) Cov ( {σ}_{ATM} , s ) . \qquad Equation 59$$

Using the same approach as previously described, P(d₁ risk reversal) may be expressed by Equation 60:

$$P ( {d}_{1} risk reversal ) = BS ( {K}_{call} , {σ}_{0}^{′} ) - BS ( {K}_{put} , {σ}_{0}^{′} ) + \frac{1}{2} E ( {\sum }_{i = 1}^{N} \frac{d Vega}{d σ} ( RR , {t}_{i - 1} ) ) Var ( {σ}_{ATM} ) + \frac{1}{2} E ( {\sum }_{i = 1}^{N} ( \frac{d Vega}{d σ} ( RR , {t}_{i - 1} ) - Vega ( RR , {t}_{i - 1} ) / {s}_{i - 1} ) Cov ( {σ}_{ATM} , s ) . \qquad Equation 60$$

Equations 59 and 60 may describe the volatility smile under three assumptions:

(i) The option price may be approximated by decomposing the constant volatility element and the varying volatility element;

(ii) The varying volatility element may be calculated up to second order. Higher order terms may add contributions that are much smaller than the bid ask spread; and

(iii) The changes of the ATM volatility and the underlying asset at time tᵢ may be independent of the Vega of the option at time tᵢ₋₁.

The last assumption may, in some embodiments, be removed easily. However each of these assumptions can be relaxed by including more terms and dependencies.

Under these assumptions, the whole volatility smile may be described using only three “external” parameters: Var (σ_{ATM}), Cov(σ_{ATM}, s), and σ₀′.

At this stage a generalized butterfly may be defined, as seen by Equation 61:

Generalized(d₁butterfly)≡d₁butterfly′=(d₁butterfly)−α(d₁=0strangle) Equation 61.

In one embodiment, a may be chosen such that Equation 62 is obtained:

$$0 = BS ( {d}_{1} butterfly , {σ}_{0}^{′} ) - BS ( {d}_{1} butterfly , {σ}_{0} ) - α ( BS ( Straddle {k}_{0} , {σ}_{0} ) - BS ( Straddle {k}_{0} , {σ}_{0}^{′} ) ) + \frac{1}{2} E {\sum }_{i = 1}^{N} [ \frac{d Vega}{ds} ( {d}_{1} butterfly , {t}_{i - 1} ) - Vega ( {d}_{1} butterfly , {t}_{i - 1} ) / {s}_{i - 1} - α ( \frac{d Vega}{ds} ( {d}_{1} = 0 strangle , {t}_{i - 1} ) - Vega ( {d}_{1} = 0 strangle , {t}_{i - 1} ) / {s}_{i - 1} ) ] {δσ}_{i} δ {s}_{i} . \qquad Equation 62$$

Therefore, Equation 63 may be obtained:

$$\begin{matrix}{Ϛ}_{strangle} ( {d}_{1} ) = Ϛ ( {d}_{1} butterfly ) \\ \frac{1}{2} E ( {\sum }_{i = 1}^{N} \frac{d Vega}{d σ} \\ ( {butterfly}^{′} , {t}_{i - 1} ) {δσ}_{i}^{2} ) \\ \approx \frac{1}{2} E ( {\sum }_{i = 1}^{N} \frac{d Vega}{d σ} ( {butterfly}^{′} , {t}_{i - 1} ) ) \\ Var ( {σ}_{ATM} ) .\end{matrix} \qquad Equation 63$$

The generalized risk reversal′ may be defined next via Equation 64:

Generalized(d₁risk reversal)≡d₁risk reversal′=d₁risk reversal+ω(d₁butterfly′)+β(d₁=0strangle) Equation 64.

In Equation 64, the amount of the butterfly′—ω—and the amount of the d₁=0 strangle—β—are set such that they offset the amount of

$$\frac{dVega}{d σ}$$

of the risk reversal and the

$$\frac{dVega}{ds}$$

or the re-hedging with ATM options and the contribution from σ′₀. This may be described, for instance, by Equation 65:

$${ζ}_{{RR}^{′}} ( {d}_{1} ) = E ( {\sum }_{i = 1}^{N} \frac{dVega}{ds} ( {d}_{1} Risk Reversal , {t}_{i} ) ) δ {s}_{i} {δσ}_{i} / 2 \approx E ( {\sum }_{i = 1}^{N} \frac{dVega}{ds} ( {d}_{1} Risk Reversal , {t}_{i} ) ) Cov ( {σ}_{ATM} , s ) / 2. \qquad Equation 65$$

In one embodiment, ω and β may be chosen such that

$$Equation 66 \\ 0 = ω E ( {\sum }_{i = 1}^{N} \frac{dVega}{d σ} ( {d}_{1} {butterfly}^{′} , {t}_{i} ) ) + β E ( {\sum }_{i = 1}^{N} \frac{dVega}{d σ} ( {d}_{1} = 0 strangle , {t}_{i} ) ) + E ( {\sum }_{i = 1}^{N} \frac{dVega}{d σ} ( {d}_{1} Risk Reversal , {t}_{i} ) ) ;$$

$$and$$

$$Equation 67$$

$$0 = BS ( {d}_{1} risk reversal , {σ}_{0}^{′} ) - BS ( {d}_{1} risk reversal , {σ}_{0} ) - β ( BS ( Straddle k 0 , {σ}_{0} ) - BS ( Straddle k 0 , {σ}_{0}^{′} ) ) + ( β E ( {\sum }_{i = 1}^{N} \frac{dVega}{d σ} ( {d}_{1} = 0 strangle , {t}_{i} ) - Vega ( {d}_{1} = 0 strangle , {t}_{i} ) / {s}_{i - 1} ) - E ( {\sum }_{i = 1}^{N} Vega ( {d}_{1} Risk Reversal , {t}_{i} ) / {s}_{i - 1} ) ) Cov ( {σ}_{ATM} , s ) / 2.$$

In equations 66 and 67, profit at time tᵢ of the generalized risk reversal, as described by Equation 68, may be employed:

$${δΠ}_{i} ( Risk {Reversal}^{′} + ATM hedge , {t}_{i} ) = \frac{dVega}{d σ} ( Risk {Reversal}^{′} ) {δσ}_{i}^{2} / 2 + ( \frac{dVega}{ds} ( Risk {Reversal}^{′} , {t}_{i - 1} ) - Vega ( Risk {Reversal}^{′} , {t}_{i - 1} ) ) δ {s}_{i} {δσ}_{i} / 2. \qquad Equation 68$$

The general purpose, in the illustrative embodiment, may be to determine A(d₁) and B(d₁) for options of all asset classes. To begin, options of all asset classes, except interest rates, may be used to determine A(d₁) and B(d₁). Next, options for interest rates (e.g., swaptions) and options for forward start assets. This is due to the annuity during the life of the option being needed when determining A(d₁) and B(d₁).

At this stage, the implied probability density function to go from a first underlying asset price s₁ at time t₁ to a second underlying asset price s₂ at time t₂, g(s₁, t₁->s₂, t₂) is unknown from the vanilla option prices. Implementation of Equations 63 and 65, or Equations 51 and 52, may be performed in conjunction with Equations 28 and 29 and/or Equations 33 and 34 via the translation of the summations to integrals using the density function of the underlying asset g(s, t). The density function g(s, t) may correspond to

$$g ( s , t ) = {df}^{- 1} \frac{{\partial }^{2} P ( K , t )}{\partial {K}^{2}} {\vert}_{K = s} ,$$

which is obtained from the smile of the options with expiry t. The smile at time t may be represented as σ(s₀, K, t₀, t), and may be determined using Equations 28 and 29. By deriving with respect to K twice, the density function g(s, t), as seen by Equation 69, may be obtained:

$$Equation 69$$

$$g ( s , t ) = \frac{Fn ( {d}_{1} )}{{s}^{2} σ ( K , t ) \sqrt{t}} ( 1 + 2 s \sqrt{t} {d}_{1} \frac{d σ ( K , t )}{dK} + {ts}^{2} {d}_{1} ( {d}_{1} - σ ( K , t ) \sqrt{t} ) {( \frac{d σ ( K , t )}{dK} )}^{2} + {s}^{2} σ ( K , t ) t \frac{{\partial }^{2} σ ( K , t )}{\partial {K}^{2}} ) {\vert}_{K = s} .$$

To determine

$$\frac{dVega}{d σ} and \frac{dVega}{ds}$$

for spot s at time t, the smile at time t for options with expiry T (e.g., σₜ(K)=σ(s, K, t, T)) is used where the maturity period is T−t.

In one embodiment, for a given input value d₁, call and put options with an expiry T when the ATM volatility is σ₀ may allow the following quantities to be defined:

$$Equation 70 \\ E ( \frac{dVega}{d σ} {d}_{1} strangle ) = {\int }_{0}^{T} dt {\int }_{0}^{∞} dsg ( s , t ) [ \frac{dVega}{d σ} ( s , t , T , {σ}_{t} ( {K}_{call} , T ) , {K}_{call} ) + \frac{dVega}{d σ} ( s , t , T , {σ}_{t} ( {K}_{put} , T ) , {K}_{put} ) ] ; \\ E ( \frac{dVega}{d σ} {d}_{1} = 0 straddle ) = 2 {\int }_{0}^{T} dt {\int }_{0}^{∞} dsg ( s , t ) \frac{dVega}{d σ} ( s , t , T , {σ}_{t} ( {K}_{0} , T ) , {K}_{0} ) ; \\ E ( \frac{dVega}{ds} {d}_{1} strangle ) = {\int }_{0}^{T} dt {\int }_{0}^{∞} dsg ( s , t ) [ \frac{dVega}{ds} ( s , t , T , {σ}_{t} ( {K}_{call} , T ) , {K}_{call} ) + \frac{dVega}{ds} ( s , t , T , {σ}_{t} ( {K}_{put} , T ) , {K}_{put} ) ] ; \\ E ( \frac{dVega}{s} {d}_{1} strangle ) = {\int }_{0}^{T} dt {\int }_{0}^{∞} dsg ( s , t ) [ Vega ( s , t , T , {σ}_{t} ( {K}_{call} , T ) , {K}_{call} ) + Vega ( s , t , T , {σ}_{t} ( {K}_{put} , T ) , {K}_{put} ) ] ;$$

$$E ( \frac{dVega}{ds} {d}_{1} = 0 straddle ) = 2 {\int }_{0}^{T} dt {\int }_{0}^{∞} dsg ( s , t ) \frac{dVega}{ds} ( s , t , T , {σ}_{t} ( {K}_{0} , T ) , {K}_{0} ) \\ E ( \frac{Vega}{s} {d}_{1} = 0 straddle ) = 2 {\int }_{0}^{T} dt {\int }_{0}^{∞} dsg ( s , t ) \frac{1}{s} Vega ( s , t , T , {σ}_{t} ( {K}_{0} , T ) , {K}_{0} ) \\ E ( \frac{dVega}{d σ} {d}_{1} risk reversal ) = {\int }_{0}^{T} dt {\int }_{0}^{∞} dsg ( s , t ) [ \frac{dVega}{d σ} ( s , t , T , {σ}_{t} ( {K}_{call} , T ) , {K}_{call} ) - \frac{dVega}{d σ} ( s , t , T , {σ}_{t} ( {K}_{put} , T ) , {K}_{put} ) ] ; \\ E ( \frac{dVega}{ds} {d}_{1} risk reversal ) = {\int }_{0}^{T} dt {\int }_{0}^{∞} dsg ( s , t ) [ \frac{dVega}{ds} ( s , t , T , {σ}_{t} ( {K}_{call} , T ) , {K}_{call} ) - \frac{dVega}{ds} ( s , t , T , {σ}_{t} ( {K}_{put} , T ) , {K}_{put} ) ] ;$$

$$E ( \frac{Vega}{s} {d}_{1} risk reversal ) = {\int }_{0}^{T} dt {\int }_{0}^{∞} dsg ( s , t ) \frac{1}{s} [ Vega ( s , t , T , {σ}_{t} ( {K}_{call} , T ) , {K}_{call} ) - Vega ( s , t , T , {σ}_{t} ( {K}_{put} , T ) , {K}_{put} ) ] \\ E ( \frac{Vega ( d 1 strangle )}{Vega ( {K}_{0} )} \frac{dVega}{d σ} {K}_{0} straddle ) = {\int }_{0}^{T} dt {\int }_{0}^{∞} dsg ( s , t ) \frac{1}{2} [ Vega ( s , t , T , {σ}_{t} ( {K}_{call} , T ) , {K}_{call} ) + Vega ( s , t , T , {σ}_{t} ( {K}_{put} , T ) , {K}_{put} ) ] / Vega ( s , t , T , {σ}_{t} ( {K}_{0} , T ) , {K}_{0} ) \frac{dVega}{d σ} ( s , t , T , {σ}_{t} ( {K}_{0} , T ) , {K}_{0} ) \\ E ( \frac{Vega ( d 1 strangle )}{Vega ( {K}_{0} )} \frac{dVega}{ds} {K}_{0} straddle ) = {\int }_{0}^{T} dt {\int }_{0}^{∞} dsg ( s , t ) \frac{1}{2} [ Vega ( s , t , T , {σ}_{t} ( {K}_{call} , T ) , {K}_{call} ) + Vega ( s , t , T , {σ}_{t} ( {K}_{put} , T ) , {K}_{put} ) ] / Vega ( s , t , T , {σ}_{t} ( {K}_{0} , T ) , {K}_{0} ) \frac{dVega}{ds} ( s , t , T , {σ}_{t} ( {K}_{0} , T ) , {K}_{0} ) .$$

In Equation 70, as before, K_{call} and Kₚᵤₜ may correspond to the current strikes of the call and put options with d₁ and −d₁, respectively, for a given input value d₁. K₀ may correspond to the strike of a current delta neutral straddle. The summation over the time interval is replaced by integration over time from time t=0 (e.g., a present time) to expiry T.

In this particular scenario, A₀ may be defined as half of the expected variance of the ATM volatility from time t=0 to t=T, i.e. A₀≡Var(σ_{ATM})/2 and B₀ may be defined as half of the expected covariance of the ATM volatility and the undelying asset price from time t=0 to t=T (e.g., B₀≡Cov (σ_{ATM},s)/2).

Using these values, a translation may be performed using the exemplary first approach, as described above. For instance the translation of Equation 47 may be described by

$${ζ}_{butterfly} ( {d}_{1} ) = {A}_{0} ( E ( \frac{dVega}{d σ} {d}_{1} strangle ) - E ( \frac{Vega ( d 1 strangle )}{Vega ( {K}_{0} )} \frac{dVega}{d σ} {K}_{0} straddle ) ) + {B}_{0} ( E ( \frac{dVega}{ds} {d}_{1} strangle ) - E ( \frac{Vega ( d 1 strangle )}{Vega ( {K}_{0} )} \frac{dVega}{ds} {K}_{0} straddle ) ) . \qquad Equation 71$$

Equations 56, 59, and 60 may, in one embodiment, be translated as a set of three equations or, equivalently, the set of Equations 56, 63, and 64 may be used with their corresponding definitions of α, β, and ω.

The translation of Equation 63, therefore, may be expressed by Equation 72:

$${ζ}_{butterfly} ( {d}_{1} ) = A ( {d}_{1} , T , {σ}_{0} ) \frac{dVega}{d σ} ( {d}_{1} strangle ) = {A}_{0} ( E ( \frac{dVega}{d σ} {d}_{1} strangle ) - {e}^{- \frac{{d}_{1}^{2}}{2}} E ( \frac{dVega}{d σ} {d}_{1} = 0 straddle ) ) - α {A}_{0} E ( \frac{dVega}{d σ} {d}_{1} = 0 straddle ) . \qquad Equation 72$$

Equation 64 may be translated by Equation 73:

$${ζ}_{{RR}^{′}} ( {d}_{1} ) = {ζ}_{RR} - {ωζ}_{butterfly} ( {d}_{1} ) = B ( {d}_{1} , T , {σ}_{0} ) \frac{dVega}{ds} ( {d}_{1} risk reversal ) = {B}_{0} E ( \frac{dVega}{ds} {d}_{1} risk reversal ) . \qquad Equation 73$$

In Equation 73, α and ω can be expressed with the integrals in Equation 70 according to Equations 62, 66, and 67.

This may yield:

$$Equation 74$$

$$BS ( {K}_{0} straddle , {σ}_{0} ) = BS ( {K}_{0} straddle , {σ}_{0}^{′} ) + {A}_{0} E ( \frac{dVega}{d σ} {d}_{1} = 0 straddle ) + {B}_{0} ( E ( \frac{dVega}{ds} {d}_{1} = 0 straddle ) - E ( \frac{Vega}{s} {d}_{1} = 0 straddle ) ) ;$$

$$Equation 75$$

$$α = ( BS ( {d}_{1} strangle , {σ}_{0}^{′} ) - BS ( {d}_{1} strangle , {σ}_{0} ) + {B}_{0} ( E ( \frac{dVega}{ds} {d}_{1} strangle ) - {e}^{- \frac{{d}_{1}^{2}}{2}} E ( \frac{dVega}{ds} {d}_{1} = 0 straddle ) + E ( \frac{Vega}{s} {d}_{1} strangle ) - {e}^{- \frac{{d}_{1}^{2}}{2}} E ( \frac{Vega}{s} {d}_{1} = 0 straddle ) ) ) / ( BS ( {K}_{0} straddle , {σ}_{0}^{′} ) - BS ( {K}_{0} straddle , {σ}_{0} ) + {B}_{0} ( E ( \frac{dVega}{ds} {d}_{1} = 0 straddle ) - E ( \frac{Vega}{s} {d}_{1} = 0 straddle ) ) ) ;$$

$$Equation 76$$

$$β = [ BS ( {d}_{1} risk reversal , {σ}_{0}^{′} ) - BS ( {d}_{1} risk reversal , {σ}_{0} ) + {B}_{0} E ( \frac{Vega}{s} {d}_{1} risk reversal ) / ( ( BS ( {K}_{0} straddle , {σ}_{0}^{′} ) - BS ( {K}_{0} stradle , {σ}_{0} ) ) + {B}_{0} ( E ( \frac{dVega}{ds} {d}_{1} = 0 straddle ) - E ( \frac{Vega}{s} {d}_{1} = 0 straddle ) ) ) ; \\ Equation 77 \\ ω = - ( E ( \frac{dVega}{d σ} {d}_{1} risk reversal ) + β E ( \frac{dVega}{d σ} {d}_{1} = 0 straddle ) ) / ( E ( \frac{dVega}{d σ} {d}_{1} strangle ) - ( {e}^{- \frac{{d}_{1}^{2}}{2}} - α ) E ( \frac{dVega}{d σ} {d}_{1} = 0 straddle ) ) . \\ Using Equations 72 and 73 , \\ definitions for A ( {d}_{1} ) and B ( {d}_{1} ) may be obtained , \\ as seen by Equations 78 and 79 \text{:} \\ Equation 78 \\ A ( {d}_{1} ) = [ {A}_{0} ( E ( \frac{dVega}{d σ} {d}_{1} strangle ) - ( {e}^{- \frac{{d}_{1}^{2}}{2}} - α ) E ( \frac{dVega}{d σ} {d}_{1} = 0 straddle ) ) ] / \frac{dVega}{d σ} ( strangle ( {d}_{1} ) ) ; \\ and \\ Equation 79 \\ B ( {d}_{1} ) = {B}_{0} ( E ( \frac{dVega}{ds} {d}_{1} risk reversal ) / \frac{dVega}{dS} ( {d}_{1} risk reversal ) .$$

The functions A(d₁,t) and B(d₁,t) may be used in the integrals to determine the density function g(s, t), and to determine the smile at time t for expiry time T−t, and depend on the market conditions at time t. The functions A(d₁) and B(d₁) may be used in the integrals to determine the volatility smile at time t depending on the market conditions present at time t.

### IV. The Calculation of the Integrals

To determine A(d₁, T) and B(d₁, T), for expiration T, in some embodiments, the term structures of volatility (e.g., the market data for a set of expiry times tᵢ, where i=1, 2, . . . N, such that t_{N}=T) may be needed. For example, the market data may include σ₀(tᵢ), 25 Δ_{RR}(tᵢ), and 25 Δ_{Fly}(tᵢ), which correspond to the delta neutral ATM volatility, 25 delta risk reversal, and 25 delta butterfly for options expiring at time t=tᵢ. Furthermore, the probability density function g(s, t) may be determined using A(0, t, d₁) and B(0, t, d₁). To determine the forward smile at time t for an option expiring at T, A(t, T, d₁) and B(t, T, d₁) are determined. In the illustrative embodiment, A(t, T, d₁) and B(t, T, d₁) may depend on the ATM volatility σ₀(t), 25 Δ_{RR}(t), and 25 Δ_{Fly}(t) from time t to expiry T at the spot s. Thus, at each underlying spot price s and time t, for t<T, A(0, t, d₁), B(0, t, d₁), A(t, T, d₁) and B(t, T, d₁) will have to be used in order to determine the integrals.

In one embodiment, the price of a Vanilla (European) option is only determined by the probability density function of the underlying asset at expiry, and is independent of the details of the path to expiry. This means that the market data before expiry may not affect the price of the Vanilla option.

As a first step, the integrals may be approximated using some assumptions. For instance, since the vanilla option price may be independent of the term structures before expiry T, as a first assumption to calculate the volatility smile at expiry T, a constant term structure may be used. As an illustrative example, a current ATM volatility σ₀, 25 Δ_{RR}, and 25 Δ_{Fly} to maturity may be used through the life of the option. This may be referred to as a “flat” term structure in the market. As a second assumption, the volatility smile from time t to expiry T may be independent of the underlying asset's price. For example, it may be assumed that for any two underlying asset prices s₁ and s₂ at time t, σ(K, s₁, t)=σ(K s₂/s₁, s₂, t) for any strike K. This second assumption may be referred to as a “translational invariant smile.” Alternatively, different translational invariance conditions may be used. For example, the smile may depend on a difference between a strike and the underlying asset's price.

In one non-limiting embodiment, as a third assumption, the ATM volatility, 25 delta risk reversal, and 25 delta from time t to expiry may be assumed to be constant and equal to the values from time t=0 to expiry. In other words, {σ₀, 25 Δ_{RR}, 25 Δ_{Flu}} (0, t)={σ₀, 25 Δ_{RR}, 25 Δ_{Fly}} (t, T)={σ₀, 25 Δ_{RR}, 25 Δ_{Fly}} (0, T) for all times t<T. Therefore, for the flat term structures representation, the volatility of the 25 delta call and 25 delta put options is independent of the start time and the expiry time in the integral, as seen by Equations 80 and 81, respectively:

σ_{c25}=σ₀+½25Δ_{RR}+25Δ_{Fly} Equation 80; and

σₚ₂₅=σ₀−½RR_{25Δ}+Fly_{25Δ} Equation 81.

Thus, using Equations 80 and 81 and the translational invariant smile property, an approximation to the integral may be obtained, which is referred to as a “zero-level” approximation. The integral may be determined based on the smile being calculated for a minimum number of degrees of freedom. For example, only three volatility inputs may be needed to determine the smile. This may allow for A and B to be parameterized such that A=A(d₁, σ₀, 25 Δ_{RR}, 25 Δ_{Fly}, t) and B=B(d₀, σ₀, 25 Δ_{RR}, 25 Δ_{Fly}, t), with d₁(K, σ(K), s, t).

Using the aforementioned approximations, A and B may be represented using a time-dependent scale factor, which depends on a current time t to expiry T, and a shape function that is dependent on d₁, as seen by Equations 82 and 83:

A(t,T,d₁)=A₀(t,T)F_{A}(T−t,d₁) Equation 82; and

B(t,T,d₁)=B₀(t,T)F_{B}(T−t,d₁) Equation 83.

As an illustrative example, for t=0, Equations 82 and 83 become:

A(0,T,d₁)=A₀(0,T)F_{A}(T,d₁) Equation 84; and

B(0,T,d₁)=B₀(0,T)F_{B}(T,d₁) Equation 85.

In Equations 84 and 85, A₀(0, T) and B₀(0, T) may be determined using the term structure by requiring that F_{A}(T, d₁) and F_{B}(T, d₁) conform with Equations 26 and 27, respectively. In one particular, illustrative embodiment, if D₂₅ is defined as being d₁ corresponding to 25 Δ, then using Equation 3 and Table 1 (for a discount factor df=1, D₂₅=−0.67448975), and:

$$\begin{matrix}{ζ}_{strangle} ( {D}_{25} , T ) = {A}_{0} ( 0 , T ) {F}_{A} ( T , {D}_{25} ) \frac{\partial Strangle}{\partial σ} ( {D}_{25} ) ; & Equation 86 \\ and & \\ {ζ}_{{RR}^{′}} ( {D}_{25} , T ) = {B}_{0} ( 0 , T ) {F}_{B} ( T , {D}_{25} ) \frac{\partial RR}{\partial S} ( {D}_{25} ) . & Equation 87\end{matrix}$$

In this particular instance, the shape function may be normalized at 25 Δ such that it is unity at d₁=D₂₅ (e.g., F_{A}(T, D₂₅)=F_{B}(T,D₂₅)=1, and A₀(0, T) and B₀(0, T) may be solved for.

Table 1 describes the various spot Deltas for a call option versus input values d₁ for a discount factor of one. For instance, using Equations 3 and 4 with a normal distribution function N(x), values of d₁ may be obtained for various spot Delta values.

TABLE 1

| Delta (%) | d₁ |
|---|---|
| 50 | 0 |
| 40 | −0.25335 |
| 30 | −0.5244 |
| 25 | −0.67449 |
| 20 | −0.84162 |
| 15 | −1.03643 |
| 10 | −1.28155 |
| 5 | −1.64485 |
| 2 | −2.05375 |
| 1 | −2.32635 |
| 0.1 | −3.09023 |
| 0.01 | −3.71902 |

To determine A(0, T, d₁) and B(0, T, d₁), in some embodiments, an iterative process may be used. In some embodiments, first approximations for the shape functions F_{A}(d₁) and F_{B}(d₁) may be used consistent with the arbitrage-free asymptotic behavior and normalized at 25 delta, as described previously. Thus, the shape functions F_{A}(d₁) and F_{B}(d₁) may be, as a first estimate:

$$\begin{matrix}{F}_{A} ( {d}_{1} ) = \frac{1 + {q}_{a} {D}_{25}^{2}}{1 + {q}_{a} {d}_{1}^{2}} ; and & Equation 88 \\ {F}_{B} ( {d}_{1} ) = \frac{1 + {q}_{b} {D}_{25}^{2}}{1 + {q}_{b} {d}_{1}^{2}} . & Equation 89\end{matrix}$$

Using Equations 88 and 89, Equations 90 and 91 may be obtained for A and B:

$$\begin{matrix}A ( t , {d}_{1} ) = \frac{{A}_{0} ( t ) ( 1 + {q}_{a} {D}_{25}^{2} )}{1 + {q}_{a} {d}_{1}^{2}} ; and & Equation 90 \\ B ( t , {d}_{1} ) = \frac{{B}_{0} ( t ) ( 1 + {q}_{b} {D}_{25}^{2} )}{1 + {q}_{b} {d}_{1}^{2}} . & Equation 91\end{matrix}$$

In this particular scenario, the scale factors A₀(t) and B₀(t) prior to expiry, (e.g., t≦T) may be calculated using the same σ₀, 25 Δ_{RR}, 25 Δ_{Fly} as described by Equations 86 and 87.

To determine A and B using an iterative process, the integrals

$$〈 \frac{\partial Strangle}{\partial σ} 〉 ( {d}_{1} ) and 〈 \frac{\partial RR}{\partial S} 〉 ( {d}_{1} )$$

should be determined for each d₁ where d₁ determines the strikes K_{call} and Kₚᵤₜ by using the volatility smile at expiry T. The smile at expiry T is obtained by using the same shape functions F_{A}(d₁), F_{B}(d₁) used in the integrals, and A₀(T) and B₀(T) are obtained from Equations 90 and 91 (and Equations 26 and 27). In this particular instance, g(s, t) can be obtained from the volatility smile at time t using the calculated A₀(t) and B₀ (t). Furthermore, the Vega derivatives at time t and spot s may depend on the volatilities σ(s, t, K_{call}) and σ(s, t, Kₚᵤₜ), which may be determined using the forward smile from time t to expiry T. The forward term structures are determined by the shape functions and the calculated A₀(T−t) and B₀(T−t), as described previously.

First, the integrals may be determined using the first estimate shape functions, on a set of discrete values of d₁ (e.g., 0<Dₘᵢₙ≦d₁≦Dₘₐₓ, where Dₘᵢₙ=0.25 to Dₘᵢₙ=5 with step 0.25). Using Equations 42 and 43, new values for A(d₁, T) and B(d₁, T) may be obtained for the same set of d₁. A(d₁) and B(d₁) may be normalized, in one embodiment, and new shape functions F_{A}(d₁) and F_{B}(d₁) may be determined such that at 25 delta strikes, they are one. For example, shape functions F_{A}(d₁) and F_{B}(d₁) may be obtained using Equations 92 and 93:

$$\begin{matrix}{F}_{A} ( {d}_{1} ) = \frac{A ( T , {d}_{1} )}{A ( T , {D}_{25} )} ; and & Equation 92 \\ {F}_{B} ( {d}_{1} ) = \frac{B ( T , {d}_{1} )}{B ( T , {D}_{25} )} . & Equation 93\end{matrix}$$

For d₁ values between the discrete set where the calculation of the integrals were performed, an interpolation technique may be used to obtain A(d₁, T) and B(d₁, T). Using the newly obtained shape functions for A and B, the scaling factors A₀ (t) and B₀ (t) for all times t<T may be determined. In order to obtain F_{A}(d₁) and F_{B}(d₁) for d₁ in the vicinity of Dₘₐₓ in the next iteration, the integral over spot s should be performed in a range significantly larger than Dₘₐₓ. Thus, for d₁>Dₘₐₓ the asymptotic no arbitrage condition should be extrapolated such that the asymptotic form of the shape functions F(d₁)=α/d₁² may be used, and α may be determined via best fitting (e.g., a least-squared fit) the shape function at Dₘₐₓ and the last 2 points before. The new shapes of A and B may then be used for the integral instead of the initial A and B functions.

The iteration process may continue until convergence, where the shape functions stop changing. At this point, where F_{A}(d₁), F_{B}(d₁) converge, A and B may be referred to as being “self-consistent.” To improve convergence speed and reduce fluctuations, a standard stabilization procedure may be employed where, after the N-th iteration, the shape function F(d₁) may be obtained using F_{N}(d₁) as an input. Therefore, instead of using F(d₁) as an input for each of the N+1 iterations, the shape function of Equation 94 may be used.

F_{N+1}(d₁)=τF_{N}(d₁)+(1−τ)F(d₁) Equation 94.

In Equation 94, τ<1 and τ>0. Typically τ=0.25 may be appropriate for convergence within approximately 30 iterations, however this is merely illustrative. For steep volatility smiles (e.g., large 25 Δ_{RR} and/or 25 Δ_{Fly}), τ may be set smaller such that convergence may require more iterations. As an illustrative example, convergence may be defined using Equation 95:

|F_{A,B}^{N+1}(d₁)−F_{A,B}^{N}(d₁)|<0.001 Equation 95.

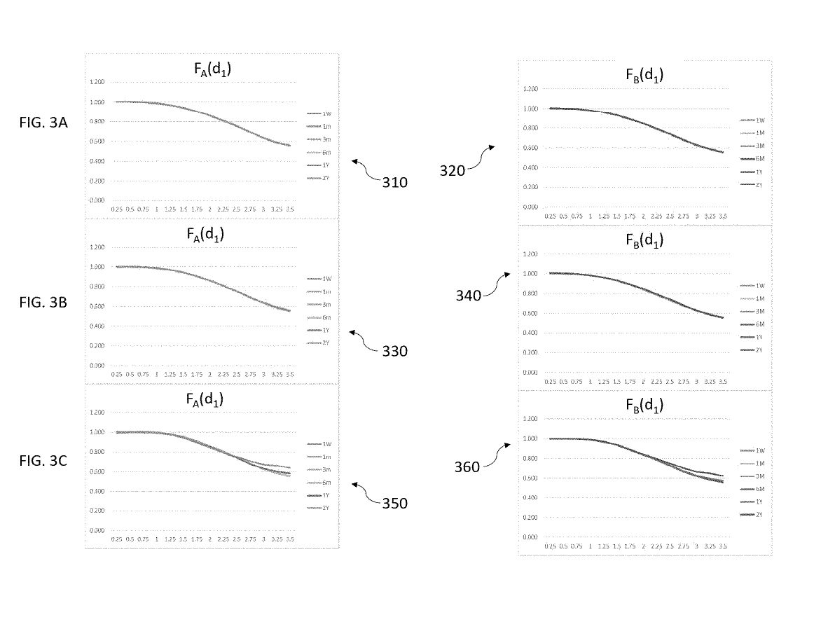

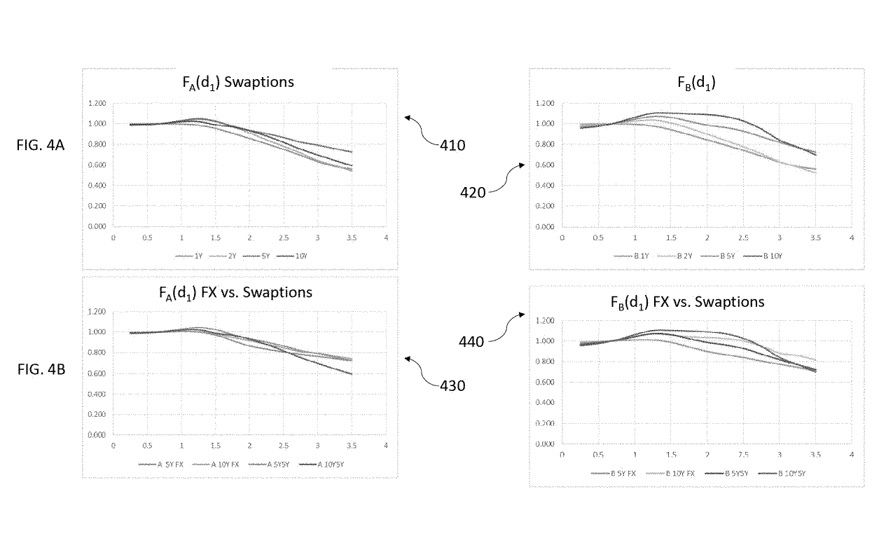

FIGS. 3A-C are illustrative graphs of a first shape function F_{A}(d₁) and a second shape function F_{B}(d₁) for a first approximation, in accordance with various embodiments. In one embodiment, the first approximation may correspond to a zero level approximation. As seen in FIGS. 3A-C and Tables 2-4, the shapes of F_{A}(d₁) and F_{B}(d₁) in the zero-level approximation are roughly the same at different maturities T (in years)= 1/52 (e.g., one week); 1/12 (e.g., one month); ¼ (e.g., three months); ½ (e.g., six months); 1 (e.g., one year); and 2 (e.g., two years) when the market conditions for these maturities are substantially the same. For instance, in graphs 310 and 320 of FIG. 3A, the ATM volatility, twenty-five delta risk reversal, and twenty-five delta butterfly correspond to {σ₀, 25 Δ_{RR}, 25 Δ_{Fly}}={10, 1, 0.25}. In graphs 330 and 340 of FIG. 3B, the ATM volatility, twenty-five delta risk reversal, and twenty-five delta butterfly correspond to {σ₀, 25 Δ_{RR}, 25 Δ_{Fly}}={15, 2, 0.5}. In graphs 350 and 360 of FIG. 3C, the ATM volatility, twenty-five delta risk reversal, and twenty-five delta butterfly correspond to {σ₀, 25 Δ_{RR}, 25 Δ_{Fly}}={25; 6; 1.2}.

TABLE 2

| | d₁ | 0.25 | 0.5 | 0.75 | 1 | 1.25 | 1.5 | 1.75 | 2 | 2.25 | 2.5 | 2.75 | 3 | 3.25 | 3.5 |
|---|---|---|---|---|---|---|---|---|---|---|---|---|---|---|---|
| 1 W | A | 0.997 | 1.000 | 0.999 | 0.990 | 0.972 | 0.944 | 0.906 | 0.859 | 0.807 | 0.748 | 0.683 | 0.629 | 0.588 | 0.557 |
| | B | 1.002 | 1.002 | 0.998 | 0.985 | 0.963 | 0.931 | 0.890 | 0.839 | 0.786 | 0.729 | 0.670 | 0.623 | 0.587 | 0.558 |
| 1 M | A | 0.997 | 1.000 | 0.999 | 0.990 | 0.972 | 0.944 | 0.906 | 0.858 | 0.806 | 0.747 | 0.683 | 0.629 | 0.588 | 0.557 |
| | B | 1.002 | 1.002 | 0.998 | 0.985 | 0.963 | 0.931 | 0.890 | 0.840 | 0.787 | 0.730 | 0.671 | 0.623 | 0.586 | 0.558 |
| 3 M | A | 0.998 | 1.000 | 0.999 | 0.990 | 0.972 | 0.943 | 0.905 | 0.857 | 0.805 | 0.747 | 0.684 | 0.629 | 0.587 | 0.556 |
| | B | 1.002 | 1.002 | 0.998 | 0.986 | 0.963 | 0.932 | 0.890 | 0.840 | 0.787 | 0.730 | 0.671 | 0.623 | 0.586 | 0.557 |
| 6 M | A | 0.998 | 1.000 | 0.999 | 0.990 | 0.971 | 0.943 | 0.905 | 0.856 | 0.804 | 0.746 | 0.684 | 0.628 | 0.587 | 0.555 |
| | B | 1.002 | 1.002 | 0.998 | 0.986 | 0.964 | 0.932 | 0.890 | 0.840 | 0.788 | 0.731 | 0.672 | 0.623 | 0.585 | 0.556 |
| 1 Y | A | 0.999 | 1.000 | 0.999 | 0.990 | 0.971 | 0.943 | 0.904 | 0.855 | 0.802 | 0.746 | 0.684 | 0.628 | 0.586 | 0.554 |
| | B | 1.002 | 1.002 | 0.998 | 0.986 | 0.964 | 0.933 | 0.891 | 0.841 | 0.789 | 0.733 | 0.674 | 0.623 | 0.585 | 0.556 |
| 2 Y | A | 1.000 | 1.001 | 0.998 | 0.989 | 0.971 | 0.942 | 0.902 | 0.852 | 0.800 | 0.744 | 0.683 | 0.627 | 0.584 | 0.553 |
| | B | 1.003 | 1.002 | 0.998 | 0.986 | 0.965 | 0.934 | 0.892 | 0.842 | 0.791 | 0.736 | 0.677 | 0.624 | 0.585 | 0.555 |

TABLE 3

| | d₁ | 0.25 | 0.5 | 0.75 | 1 | 1.25 | 1.5 | 1.75 | 2 | 2.25 | 2.5 | 2.75 | 3 | 3.25 | 3.5 |
|---|---|---|---|---|---|---|---|---|---|---|---|---|---|---|---|
| 1 W | A | 0.997 | 1.000 | 0.999 | 0.990 | 0.972 | 0.944 | 0.906 | 0.859 | 0.807 | 0.748 | 0.683 | 0.629 | 0.588 | 0.557 |
| | B | 1.002 | 1.002 | 0.998 | 0.985 | 0.963 | 0.931 | 0.890 | 0.839 | 0.786 | 0.729 | 0.670 | 0.623 | 0.587 | 0.558 |
| 1 M | A | 0.997 | 1.000 | 0.999 | 0.990 | 0.972 | 0.944 | 0.906 | 0.858 | 0.806 | 0.747 | 0.683 | 0.629 | 0.588 | 0.557 |
| | B | 1.002 | 1.002 | 0.998 | 0.985 | 0.963 | 0.931 | 0.890 | 0.840 | 0.787 | 0.730 | 0.671 | 0.623 | 0.586 | 0.558 |
| 3 M | A | 0.998 | 1.000 | 0.999 | 0.990 | 0.972 | 0.943 | 0.905 | 0.857 | 0.805 | 0.747 | 0.684 | 0.629 | 0.587 | 0.556 |
| | B | 1.002 | 1.002 | 0.998 | 0.986 | 0.963 | 0.932 | 0.890 | 0.840 | 0.787 | 0.730 | 0.671 | 0.623 | 0.586 | 0.557 |
| 6 M | A | 0.998 | 1.000 | 0.999 | 0.990 | 0.971 | 0.943 | 0.905 | 0.856 | 0.804 | 0.746 | 0.684 | 0.628 | 0.587 | 0.555 |
| | B | 1.002 | 1.002 | 0.998 | 0.986 | 0.964 | 0.932 | 0.890 | 0.840 | 0.788 | 0.731 | 0.672 | 0.623 | 0.585 | 0.556 |
| 1 Y | A | 0.999 | 1.000 | 0.999 | 0.990 | 0.971 | 0.943 | 0.904 | 0.855 | 0.802 | 0.746 | 0.684 | 0.628 | 0.586 | 0.554 |
| | B | 1.002 | 1.002 | 0.998 | 0.986 | 0.964 | 0.933 | 0.891 | 0.841 | 0.789 | 0.733 | 0.674 | 0.623 | 0.585 | 0.556 |
| 2 Y | A | 1.000 | 1.001 | 0.998 | 0.989 | 0.971 | 0.942 | 0.902 | 0.852 | 0.800 | 0.744 | 0.683 | 0.627 | 0.584 | 0.553 |
| | B | 1.003 | 1.002 | 0.998 | 0.986 | 0.965 | 0.934 | 0.892 | 0.842 | 0.791 | 0.736 | 0.677 | 0.624 | 0.585 | 0.555 |

TABLE 4

| | d₁ | 0.25 | 0.5 | 0.75 | 1 | 1.25 | 1.5 | 1.75 | 2 | 2.25 | 2.5 | 2.75 | 3 | 3.25 | 3.5 |
|---|---|---|---|---|---|---|---|---|---|---|---|---|---|---|---|
| 1 W | A | 0.992 | 0.996 | 1.000 | 0.997 | 0.982 | 0.952 | 0.908 | 0.858 | 0.805 | 0.743 | 0.678 | 0.626 | 0.587 | 0.557 |
| | B | 0.996 | 0.999 | 0.999 | 0.991 | 0.969 | 0.933 | 0.885 | 0.834 | 0.781 | 0.722 | 0.665 | 0.620 | 0.586 | 0.559 |
| 1 M | A | 0.993 | 0.997 | 1.000 | 0.997 | 0.981 | 0.951 | 0.907 | 0.857 | 0.803 | 0.742 | 0.678 | 0.625 | 0.586 | 0.556 |
| | B | 0.996 | 0.999 | 0.999 | 0.991 | 0.970 | 0.933 | 0.885 | 0.835 | 0.782 | 0.723 | 0.665 | 0.620 | 0.585 | 0.558 |
| 3 M | A | 0.994 | 0.997 | 1.000 | 0.996 | 0.980 | 0.950 | 0.905 | 0.854 | 0.801 | 0.741 | 0.677 | 0.624 | 0.585 | 0.554 |
| | B | 0.997 | 0.999 | 0.999 | 0.991 | 0.970 | 0.934 | 0.886 | 0.835 | 0.783 | 0.725 | 0.666 | 0.619 | 0.584 | 0.556 |
| 6 M | A | 0.996 | 0.998 | 1.000 | 0.995 | 0.980 | 0.948 | 0.902 | 0.852 | 0.799 | 0.740 | 0.677 | 0.623 | 0.583 | 0.555 |
| | B | 0.997 | 0.999 | 0.999 | 0.991 | 0.970 | 0.934 | 0.886 | 0.837 | 0.785 | 0.727 | 0.668 | 0.620 | 0.583 | 0.557 |
| 1 Y | A | 0.997 | 0.999 | 0.999 | 0.994 | 0.978 | 0.946 | 0.899 | 0.848 | 0.796 | 0.738 | 0.677 | 0.629 | 0.598 | 0.580 |
| | B | 0.998 | 0.999 | 0.999 | 0.991 | 0.971 | 0.935 | 0.888 | 0.839 | 0.787 | 0.731 | 0.672 | 0.626 | 0.595 | 0.576 |
| 2 Y | A | 1.000 | 1.000 | 0.999 | 0.993 | 0.976 | 0.942 | 0.893 | 0.842 | 0.792 | 0.747 | 0.701 | 0.666 | 0.653 | 0.631 |
| | B | 0.998 | 0.999 | 0.999 | 0.992 | 0.973 | 0.937 | 0.891 | 0.843 | 0.793 | 0.746 | 0.698 | 0.660 | 0.643 | 0.618 |

In the exemplary embodiment where options on forward starting assets are determined, annuity An is needed. Typically, in this particular scenario, the forward rate may be used instead of the spot rate. For instance, for swaptions, where the underlying asset is a swap that starts at the swaption's expiry and lasts a certain temporal period, the forward rate is the fixed rate of the underlying forward start swap. For example, the underlying of a 2Y5Y swaption is a swap that starts in 2 years and ends 5 years later. The forward rate of this swaption may be the current fixed rate of a swap that starts in 2 years and ends 5 years later. The integral representation of swaption, therefore, should be a function of the forward rate. Hence the integral over spot in Equation 38 may be replaced by the integral over the forward rate. Furthermore,

$$\frac{dVega}{dS}$$

may be replaced by

$$\frac{dVega}{dF} ,$$

d₁ may be expressed as a function of F, and instead of the density function g(S, T), the function g(F, T) is used. Furthermore, instead of a call and put representation, a receiver and payer of the fixed rate may be used, as described by Equations 96 and 97:

$$\begin{matrix}{ζ}_{strangle} ( {d}_{1} ) = {A}_{0} \int dt \int dFg ( F , t ) [ \frac{dVega}{d σ} ( F , t , T , {K}_{receiver} ) + \frac{dVega}{d σ} ( F , t , T , {K}_{payer} ) - 2 {e}^{- \frac{{d}_{1}^{2}}{2}} \frac{dvega}{d σ} ( F , t , T , {K}_{0} ) ] ; and & Equation 96 \\ {ζ}_{strangle} ( {d}_{1} ) ≡ {A}_{0} ( E ( \frac{dVega}{d σ} {d}_{1} strangle ) - {e}^{- \frac{{d}_{1}^{2}}{2}} E ( \frac{dVega}{d σ} {d}_{1} = 0 straddle ) ) . & Equation 97\end{matrix}$$

In Equations 96 and 97, α=0 was used for simplicity.

Furthermore, the annuity An in the Vega derivatives of Equations 22 and 23 may change with the time t, as seen by Equation 98:

An=An(F,t,T) Equation 98.

In the integral, the smile for the options at time t may be determined using Equations 33 and 34. Similarly, the risk reversal integral may be expressed using Equation 99:

$${ζ}_{{RR}^{′}} ( {d}_{1} ) = {B}_{0} \int dt \int dFg ( F , t ) [ \frac{dV ega}{dF} ( F , t , T , {K}_{receiver} ) - \frac{dVega}{dF} ( F , t , T , {K}_{payer} ) ] ≡ {B}_{0} ( E ( \frac{dVega}{dF} {d}_{1} risk reversal ) ) . \qquad Equation 99$$

In Equations 96 and 99, A₀ may be defined as half of the expected variance of the ATM volatility from time t=0 to t=T, (e.g., A₀ ≡Var (σ_{ATM})/2)) and B₀ may be defined as half of the expected covariance of the ATM volatility and the underlying asset forward rate of the forward paying asset (e.g. swap) from time t=0 to t=T (e.g., B₀ ≡Cov (σ_{ATM}, F)/2). In the exemplary embodiment, the price of vanilla options only depends on the underlying asset at expiry T, regardless of the path to expiry. For example, if the underlying swap of the swaptions starts at time T and lasts a temporal period L, then the underlying forward F in the integral continues to be the same swap. Therefore the density function g(F, t) for t<T may be determined from the second derivative of the price of a swaptions with expiry t and underlying swap that starts at T and last temporal period L. While this may correspond to a non-standard swaption in the market (e.g., a standard swaption has the swap starting at expiry), there is no need to have the market rate of the swaption at any point in the integral's determination.

In one embodiment, A(d₁) and B(d₁) for swaptions may be determined for the zero level approximation using a similar approach as previously done with flat term structure of volatility, but with annuity An that changes during the life of the options. In the exemplary embodiment, three volatility inputs may be used. The volatility inputs may correspond to any input from the market (e.g. ATMF, ATMF−50 bp, ATMF+150 bp), and the volatility inputs may be mapped to FX conventions of σ₀, 25 Δ_{RR}, and 25 Δ_{Fly}. To do this, the three parameters σ₀, 25 Δ_{RR}, and 25 Δ_{Fly} for expiry T are solved for such that, when calculating the price of the market input strikes (e.g., the ATMF, ATMF−50 bp, ATMF+150 bp), the given prices of the market may be obtained. As the set of integral representations converge quickly and are stable, the transformation from the three strikes and prices to σ₀, 25 Δ_{RR}, and 25 Δ_{Fly} is quite fast.

FIGS. 4A and 4B are illustrative graphs for self-consistent shape functions F_{A}(d₁) and F_{B}(d₁) for swaptions in the zero level approximation, in accordance with various embodiments. As seen from FIG. 4A and Table 5, self-consistent F_{A}(d₁) and F_{B}(d₁) for various swaptions with underlying swap of 5 years and expirations of 1 year, 2 years, 5 years, and 10 years, illustrate the influence of annuity An and expiration time on F_{A}(d₁) and F_{B}(d₁) (and thus A and B). In FIG. 4A, the same σ₀, 25 Δ_{RR}, 25 Δ_{Fly} are used. For instance, in graphs 410 and 420 of FIG. 4A, the ATM volatility, twenty-five delta risk reversal, and twenty-five delta butterfly correspond to {σ₀, 25 Δ_{RR}, 25 Δ_{Fly}}={20%, 6%, 0.85%}, the underlying is a 5 year swap, and the forward F=5%.

Furthermore, as seen from FIG. 4B and Table 5, a 5Y5Y swaption and a 10Y5Y swaption are compared to a 5 year FX option and a 10 year FX option with the same 5Y and 10Y forward and volatility input. For instance, in graphs 430 and 440 of FIG. 4B, the ATM volatility, twenty-five delta risk reversal, and twenty-five delta butterfly correspond to {σ₀, 25 Δ_{RR}, 25 Δ_{Fly}}={22%, 6%, 0.85%}, and the forward F=5%.

TABLE 5

| d₁ | 0.25 | 0.5 | 0.75 | 1 | 1.25 | 1.5 | 1.75 | 2 | 2.25 | 2.5 | 2.75 | 3 | 3.25 | 3.5 |
|---|---|---|---|---|---|---|---|---|---|---|---|---|---|---|
| A | 0.999 | 0.999 | 0.999 | 0.997 | 0.984 | 0.954 | 0.907 | 0.857 | 0.805 | 0.751 | 0.693 | 0.632 | 0.587 | 0.562 |
| B | 0.997 | 0.998 | 0.999 | 0.995 | 0.978 | 0.942 | 0.894 | 0.844 | 0.794 | 0.743 | 0.687 | 0.629 | 0.587 | 0.562 |
| A | 0.983 | 0.989 | 1.004 | 1.026 | 1.040 | 1.021 | 0.970 | 0.910 | 0.844 | 0.781 | 0.716 | 0.642 | 0.596 | 0.544 |
| B | 0.977 | 0.987 | 1.005 | 1.026 | 1.034 | 1.008 | 0.957 | 0.900 | 0.839 | 0.777 | 0.709 | 0.631 | 0.581 | 0.526 |
| A | 0.985 | 0.990 | 1.004 | 1.028 | 1.047 | 1.024 | 0.975 | 0.934 | 0.903 | 0.865 | 0.820 | 0.792 | 0.758 | 0.725 |
| B | 0.970 | 0.983 | 1.007 | 1.043 | 1.071 | 1.061 | 1.023 | 0.986 | 0.963 | 0.928 | 0.873 | 0.820 | 0.771 | 0.725 |
| A | 0.992 | 0.994 | 1.002 | 1.019 | 1.020 | 0.988 | 0.969 | 0.932 | 0.880 | 0.818 | 0.753 | 0.697 | 0.644 | 0.594 |
| B | 0.956 | 0.975 | 1.010 | 1.061 | 1.103 | 1.103 | 1.097 | 1.089 | 1.070 | 1.026 | 0.948 | 0.841 | 0.774 | 0.699 |

TABLE 6

| | 0.25 | 0.5 | 0.75 | 1 | 1.25 | 1.5 | 1.75 | 2 | 2.25 | 2.5 | 2.75 | 3 | 3.25 | 3.5 |
|---|---|---|---|---|---|---|---|---|---|---|---|---|---|---|
| d₁ | | | | | | | | | | | | | | |
| A 5 Y FX | 0.994 | 0.996 | 1.001 | 1.005 | 1.001 | 0.972 | 0.918 | 0.866 | 0.834 | 0.807 | 0.782 | 0.765 | 0.744 | 0.724 |
| B 5 Y FX | 0.987 | 0.993 | 1.002 | 1.011 | 1.011 | 0.987 | 0.943 | 0.898 | 0.869 | 0.840 | 0.807 | 0.776 | 0.745 | 0.716 |
| A 10 Y FX | 0.989 | 0.993 | 1.003 | 1.019 | 1.026 | 0.984 | 0.947 | 0.917 | 0.883 | 0.847 | 0.811 | 0.792 | 0.767 | 0.742 |
| B 10 Y FX | 0.971 | 0.983 | 1.007 | 1.041 | 1.069 | 1.056 | 1.041 | 1.034 | 1.024 | 1.000 | 0.952 | 0.882 | 0.860 | 0.817 |
| d1 | | | | | | | | | | | | | | |
| A 5 Y 5 Y | 0.985 | 0.990 | 1.004 | 1.028 | 1.047 | 1.024 | 0.975 | 0.934 | 0.903 | 0.865 | 0.820 | 0.792 | 0.758 | 0.725 |
| B 5 Y 5 Y | 0.970 | 0.983 | 1.007 | 1.043 | 1.071 | 1.061 | 1.023 | 0.986 | 0.963 | 0.928 | 0.873 | 0.820 | 0.771 | 0.725 |
| A 10 Y 5 Y | 0.992 | 0.994 | 1.002 | 1.019 | 1.020 | 0.988 | 0.969 | 0.932 | 0.880 | 0.818 | 0.753 | 0.697 | 0.644 | 0.594 |
| B 10 Y 5 Y | 0.956 | 0.975 | 1.010 | 1.061 | 1.103 | 1.103 | 1.097 | 1.089 | 1.070 | 1.026 | 0.948 | 0.841 | 0.774 | 0.699 |

### V. Probability Consistency Condition for A and B

As described above, in the first approximation (e.g., the zero-level approximation), the integral representation employed two assumptions: (i) the forward smile used from time t to expiry T is taken as being the same smile from time t=0 to time t, and (ii) the translational invariance of the smile. However, this may lead to some probability inconsistency issues. For example, the option smile at time t, determined by using the smile at time t₁<t and the implied smile from time t₁ to time t, or determined by using the smile at time t₂<t and the implied smile from time t₂ to time t, may produce slightly different results. Thus, as described herein are various techniques for obtaining probability consistency and improving the accuracy of the integral calculation to the level required to use in financial markets, such that the translation invariant assumption may be overcome.

In some embodiments, the forward implied smile may be determined using the translational invariant assumption while preserving probability consistency. In the translational invariant assumption, the forward implied smile may correspond to a weighted average (or expected value) over the spot range of an implied local forward smile, which may provide a good estimate for an expected forward term structure. This may be because the forward implied smile may use a smile with an A(d₁) and B(d₁) that are consistent with the underlying asset's implied forward density function and maintains the probability consistency.

Given a term structure of the volatility (e.g. ATM volatility σ₀, 25 Δ_{RR}, and 25 Δ_{Fly}), if the functions A(d₁, t), B (d₁, t) and A(d₁, T), B (d₁, T) are known for some t prior to expiry T, then the volatility smile at expiry t and the volatility smile at expiry time T are both known. This may allow the implied forward smile from time t to expiry T, (e.g., ATM volatility σ₀, 25 Δ_{RR}, and 25 Δ_{Fly} and A(d₁, t, T), B(d₁, t, T)) to be determined. The density function of the underlying asset may be described as g_{tT} (s, t→S, T), corresponding to a change of the underlying asset's price s at time t to the underlying asset's price S at time T. Thus, in this particular scenario, the density function may be described by Equation 100:

g(s₀,0→S,T)=∫ds g₀ₜ(s₀,0→s,t)g_{tT}(s,t→S,T) Equation 100.

The density function for time t, g(s₀, 0→S, t), may be determined using the smile with A(d₁,t), B(d₁,t), and the market data to time t, yielding Equation 101:

$${g}_{0 t} ( {s}_{0} , 0 -> s , t ) = {df ( t )}^{- 1} \frac{{\partial }^{2} P ( K , t , {s}_{0} )}{\partial {K}^{2}} {\vert}_{K = s} . \qquad Equation 101$$

Furthermore, the density function at expiry T may correspond to Equation 102:

$$g ( {s}_{0} , 0 -> S , T ) = {df ( T )}^{- 1} \frac{{\partial }^{2} P ( K , T , {s}_{0} )}{\partial {K}^{2}} {\vert}_{K = S} . \qquad Equation 102$$

The density function g_{tT}(s, t→S, T) uniquely determines the forward smile σ(K) as the option price is calculated by integrating over the density. By having σ(K), d₁ may be determined for each strike, thereby producing σ₀, σ_{c 25}, and σ_{p 25}. Using Equations 28 and 29, therefore, A(d₁,t,T) and B(d₁,t,T) may be determined for any d₁.

In order to find the density function g_{tT}(s,t→S,T), the cumulative distribution of both densities in the convolution of Equation 100 may be mapped to a normal distribution, and the mapping of the unknown density being such that the density of the convolution of Equation 100 may correspond to the target density. Using the translational invariant assumption, the cumulative distribution of g_{tT}(s,t→S,T) may be described as G_{tT}(log(S/s)), and a one-to-one mapping to a Normal distribution function N(x) may be used, as seen by Equation 103:

G_{tT}(log(S/s₀))≡N(X_{tT}) Equation 103.

And therefore:

X_{tT}≡N⁻¹(G_{tT}(log(S/s₀)) Equation 104.

In Equation 103, at any s≠s₀,

$${G}_{tT} ( log ( S / s ) = {G}_{tT} ( log ( \frac{S}{{s}_{0}} ) - log ( \frac{s}{{s}_{0}} ) ) .$$

In some embodiments, the function X_{tT} may be a monotonically increasing function of log S in order to have a valid distribution function, allowing log S(X_{tT}) to be used to define the inverse of Equation 104 as Equation 105:

log S=G_{tT}⁻¹(N(X_{tT}))+log s₀ Equation 105.

There are several ways to obtain the function log S(X_{tT}). For example, the strictly positive function V_{tT} (X) may be denoted as:

V_{tT}(X)=d log S(X_{tT})/dX_{tT} Equation 106.

This may allow for Equations 107 and 108, which is valid for any S at time T such that:

log S(X_{tT})=∫₀^{X}^{_{tT}}V_{tT}(x)dx+log F_{tT} X_{tT}≧0 Equation 107; and

log S(X_{tT})=−∫_{X}_{_{tT}}⁰V_{tT}(x)dx+log F_{tT}X_{tT}<0 Equation 108.

In Equations 107 and 108, F_{tT}=s₀ e^{(r}^{ₗ}^{-r}^{ᵣ}⁾^{_{tT}}^{(T-t)}. Similarly, the cumulative density of g₀ₜ(s₀, 0->s, t) corresponds to G₀ₜ(log(s/s₀)≡N(Xₜ) or Xₜ≡N⁻¹(G₀ₜ(log(s/s₀)), and V₀ₜ (X)=d log s (Xₜ)/dXₜ. Since the density g₀ₜ is known, V₀ₜ is known. Therefore, for a call option, Equation 109 may be used:

P(K,T,s₀)=∫_{-∞}^{∞}dxₜ∫_{-∞}^{∞}dx_{tT}n(xₜ)n(x_{tT})(e^{log s(x}^{ₜ}^{,x}^{_{tT}}⁾−K)⁺dxₜdx_{tT} Equation 109.

In Equation 109, log S (xₜ,x_{tT})=∫₀^{X}^{ₜ}V₀ₜ(x)dx+∫₀^{X}^{_{tT}}V_{tT}(x)dx+log F, and F is the forward rate for expiry, and if any of the Xₜ, X_{tT} is negative, then the integral is from X to zero with a negative pre-sign.

Although the integral over X is from −∞ to ∞, bounds may be used in practice such that −X_{b}<X<X_{b}, and V(X) may be defined on a finite domain of X. Accordingly, V_{tT}(X) may be represented on N points in the X domain, where Xᵢ=−X_{b}+2X_{b}*i/N−1, for i=0, 1, . . . , N−1. The larger 25 Δ_{RR} and 25 Δ_{Fly} are, the larger N may be. As an illustrative example, X_{b}=5, and N=13 (for small 25 Δ_{RR} and 25 Δ_{Fly} it may be enough to have N=11). Vᵢ may be defined as Vᵢ=V(Xᵢ), and Vᵢ may be solved for (where Vᵢ is selected such that it is strictly positive). For instance, monotonic Akima spline interpolation may be used between the Vᵢ's to generate V(X)>0 for all X. Although not dictated by any actual limitations, a certain level of smoothness for V(X) may be requested, especially for large X, which are very illiquid and therefore unknown market territory. Using standard Levenberg-Marquardt algorithm (“LMA”) optimization techniques as known by persons of ordinary skill in the art, V_{tT} may be solved for such that Equation 109 produces the known smile at time T.

Furthermore, using standard LMA techniques to solve for Vᵢ's which minimizes the target function S(V) defined as, and using the numerically calculated P(K, T, s₀), which may be denoted by \hat{P}(K, T, V), Equation 110 may be obtained:

S(v)=Σ_{Ki}[(P(Ki,T)−\hat{P}(Ki,T,V))Vega(Ki,T)]²+ΣᵢCᵢ Equation 110.

In Equation 110, the summation is over a large set of strikes Ki's selected to cover a wide range of strikes around the ATM strike and Cᵢ are smoothness conditions defined below. Since P(K, T) is known, the strikes may, for example, be selected by deltas. For example, Kᵢ may be selected from delta=0.01 corresponding to X=−5 to the ATM and cover both sides of the ATM strike, multiplying by Vega(Kᵢ, T) in order to give higher weight to the area of the ATM strike than the low delta strikes. Vega, in the illustrated embodiment, may be calculated from the known smile P(K, T). The smoothness condition of V(X) may, for instance, be described using Equation 111:

$${C}_{i} = ɛ \sqrt{1 + {X}_{i}^{2}} \frac{{V}_{i + 1}^{2} - {V}_{i}^{2}}{( {X}_{i + 1} - {X}_{i} ) {V}^{2}} . \qquad Equation 111$$

In Equation 111, V corresponds to a scale factor of V(X), which may be the ATM volatility. As an illustrative example, ε=0.0000005. Furthermore, the factor \sqrt{1+Xᵢ²} may add weight in the area distant from the ATM such that the quality of the fit is not affected in the market region.

After solving for V(X), the implied forward volatility smile σ(K, T, t, s) of the options starting at time t for P(K, T, t, s) may be determined, and may be used to calculate the implied shape functions A(d₁, t), B(d₁, t).

The implied forward smile determination may be used to improve the first approximation technique where instead of using flat forward term structures, the implied forward smile from time t to expiry T is used.

### VI. Determination of Path Independent Self-Consistent A(d₁), B(d₁)

In Some Embodiments, a Determination of a Probability-consistent, A(d₁) and B(d₁) may be determined. To do this, a temporal interval may be set such that the time to expiry T is segmented into equal and finite steps (e.g., δt=T/N). Thus, N temporal intervals, from t=0 to t=T may be obtained having temporal durations of t₁, t₂, . . . t_{N}=T, and the density function, for example, from time t=0 to time t=t₁ may correspond to g₁ (s₀, 0->s₁, t₁).

A term structure may be determined such that, at any time tᵢ, a forward term structure from time tᵢ to tᵢ₊₁ will be the same. This allows the probability density function g(s, t->S, t+δt) to be the same for any time t. The density function for time t=0 to time t=t₂, g₂ (s₀, 0->s₂, t₂), is an integral of the density function g₁ from time t=0 to time t=t₁, as seen from Equation 112:

g₂(s₀,0→s₂,t₂)=∫ds g₁(s₀,0→s,t₁)g₁(s,t₁→s₂,t₂) Equation 112.

Similarly, Equation 113 may be a generalized version of Equation 112 for all temporal durations:

gₙ(s₀,0→sₙ,tₙ)=∫ds gₙ₋₁(s₀,0→s,tₙ₋₁)g₁(s,tₙ₋₁→sₙ,tₙ) Equation 113.

For any value j, Equation 113 may be described by:

gₙ(s₀,0→sₙ,tₙ)=∫ds gₙ₋ⱼ(s₀,0→s,tₙ₋ⱼ)gⱼ(s,tₙ₋ⱼ→sₙ,tₙ) Equation 114.

In both Equations 113 and 114, the probability to reach time T is path independent, so long as the temporal interval δt is small enough.

The density function g₁ (0, t₁) is defined as the kernel density, as all of the density functions within the period from time t=0 to time t=T will be determined using g₁. Thus, the forward density from time tⱼ to time tⱼ₊ₙ will be the same as from time t=0 to time t=tₙ, and therefore:

gₙ(s₀,0→s,tₙ)=g_{j,j+n}(s₀,tⱼ→s,tⱼ₊ₙ) Equation 115.

To reduce the number of calculations needed to generate all of the probability density functions gₙ, N is selected to be N=2^{m} for any integer value m.

The probability density function gₙ(s₀, 0->sₙ, tₙ) may be determined, and the corresponding term structures σ₀ (tₙ), 25 Δ_{RR} (tₙ), 25 Δ_{Fly} (tₙ), A(d₁, tₙ), B(d₁, tₙ) may also be determined. Thus, the full forward term structures may also be obtained

$$( e . g . , {σ}_{{0}_{{t}_{n}}} ( T - {t}_{n} ) , 25 {Δ}_{{RR}_{{t}_{n}}} ( T - {t}_{n} ) , 25 {Δ}_{{Fly}_{{t}_{n}}} ( T - {t}_{n} ) , \\ {A}_{{t}_{n}} ( {d}_{1} , T - {t}_{n} ) , {B}_{{t}_{n}} ( {d}_{1} , T - {t}_{n} ) ) .$$

Using the term structures and the forward term structures obtained from the density function in the integral representation, A(T) and B(T) may be obtained using the iterative process by obtaining convergence of the integral.

The iterative process may begin by obtaining the kernel density from the smile at expiry T. The probability density function g₁(s₀, 0->s₁, t₁) for the first temporal duration t₁ may be determined using the probability density function g_{T}(s₀, 0, ->S, T) for expiry T. This may be performed by using Equation 116:

g₂ⱼ(s₀,0→s₂ⱼ,t₂ⱼ)=∫ds gⱼ(s₀,0→s,tⱼ)gⱼ(s,tⱼ→s₂ⱼ,t₂ⱼ) Equation 116.

In Equation 116, the probability density function is the same along both halves of the temporal duration (e.g., first half and second half). In some embodiments, the terminal distribution of the asset at expiry T may be set as T=2^{m} t₁, and the density for half of the temporal duration may then be t=2^{m-1} t₁. Therefore, in the recursive process, at each value for m, the density function is determined for time t=2^{m-1} t₁ from the density for t=2^{m} t₁, until the probability density function for the first g₁ for the first temporal duration t₁ is reached. To do this, the cumulative function Gⱼ may be defined for the j-th probability density function gⱼ(s₀, 0->sⱼ, tⱼ). A one-to-one mapping to a Normal cumulative distribution function N(x) may be used such that Gⱼ(log (sⱼ/s₀)≡N(Xⱼ), yielding Equation 117:

Xⱼ≡N⁻¹(Gⱼ(log(sⱼ/s₀))) Equation 117.

The function Vⱼ(X) may be defined by Equation 118, and restricted to be strictly positive:

Vⱼ(Xⱼ)=d log sⱼ(Xⱼ)/dXⱼ Equation 118.

There are several ways to solve the function log s(Xⱼ). For example, the price of the call option may be described by Equation 119:

PCall(K,2jt,s₀)=∫_{-∞}^{∞}dX′ⱼ∫_{-∞}^{∞}dX″ⱼn(X″ⱼ)n(X′ⱼ)(e^{log s}^{₂ⱼ}^{(x′}^{ⱼ}^{,x″}^{ⱼ}⁾−K)⁺ Equation 119.

In Equation 119, log S₂ⱼ(X′ⱼ,X″ⱼ)=∫₀^{X}′^{j}Vⱼ(x)dx+∫₀^{X}″^{j}Vⱼ(x)dx+log F₂ⱼ (if X′<0, then the first integral is from X′ to zero, and if X″<0, then the second integral is from X″ to zero). In the recursive process, when Equation 119 is ready to be solved for j<N/2, then V₂ⱼ(x) is already known from the mapping of the function G₂ⱼ(log(S₂ⱼ/s₀)) to normal distribution X₂ⱼ≡N⁻¹(G₂ⱼ(log(S₂ⱼ/s₀)) from the previous calculation. Hence, the probability density function g₂ⱼ is obtained from g₄ⱼ. Thus, the price of the call option may now be referred to using Equation 120:

P_{Call}(K,2jt,s₀)=∫_{-∞}^{∞}dX₂ⱼ(e^{log}^{₂ⱼ}^{(X}^{₂ⱼ}⁾−K)⁺n(X₂ⱼ₎ Equation 120.

In Equation 120, log S₂ⱼ(X₂ⱼ)=∫₀^{X}^{₂ⱼ}V₂ⱼ(x)dx+log F₂ⱼ, and F₂ⱼ=s₀ e^{(r}^{ₗ}^{-r}^{ᵣ}⁾^{₂ⱼ}^{2jt}. In the first iteration 2j=N, so G₂ⱼ=G_{T}, which may be obtained from the smile at time T, which also corresponds to the smile of the previous integral calculation, or the first assumption of A(T) and B(T) in the first iteration.

In order to determine Vⱼ(x), Equations 119 and 120 may be set equal to one another, and Levenberg-Marquardt optimization techniques may be applied. As done for the calculation of the implied forward smile, the target function may be defined by Equation 121:

S(V)=Σ_{Ki}(P(Ki,2jt,s₀)−\hat{P}(Ki,2jt,Vⱼ,s₀))Vega(Ki,2jt))²+ΣᵢCᵢ Equation 121.

In Equation 121, \hat{P}(Ki, 2jt, Vj, s₀) obtained from the convolution of Equation 119, and the prices P(Ki,2jt,s₀) are calculated using the known V₂ⱼ from the previous iteration. Equation 121 is minimized to solved for Vⱼ(X) on the N-grid of Xᵢ in a finite domain where −X_{b}<X<X_{b} (e.g., −5<X<5). As in Equation 110, Vega is defined for weighting, and the Cᵢ's are the smoothness condition, as defined in Equation 111.

A different process may be used, in some embodiments, to find log s/s₀ (Xⱼ). For example, given the function G_{T}, the function log S/s₀ (X_{N}) may be calculated directly by applying the function Inverse-Normal distribution. Using well-known properties of normal distributions, if X behaves according to normal distribution with mean m and variance Q then the convolution of X with itself has a normal distribution with mean 2m and variance 2Q. By definition, the mean of X_{N} is zero, and therefore a good approximation for the function log S/s₀ (X_{N/2}) may be, for example, log S/s₀ (X_{N})/\sqrt{2}. A good approximation of the function log S/s₀ (Xⱼ) may, for example, be the function Log S/s₀ (X_{N})/\sqrt{N/j}. These approximations may be used, in one embodiment, for all values of j, or they may be used as a “first guess” in the LMA procedure mentioned before. If this approximation is used, then the selection of N=2^{m} may not be needed as all of the density functions gₙ may be obtained directly from g_{T}.

To determine A(d₁, T) and B(d₁, T), the integral representation may be combined with the probability density function approach, harnessing the temporal intervals δt=T/N such that the same probability density function and volatility smile representation are used throughout the life of the option for each time interval δt. An iterative process may then be employed. The iterative process may begin by a first assumption for A(d₁, T) and B(d₁, T) where the zero-level approximation values for A(d₁, T) and B(d₁, T), as determined previously with constant term structure and forward term structure, are used. Next, the volatility smile may be determined for time t=T. The probability density function at time t=T may then be determined (e.g., g_{T}(s₀, 0->S, T), using Equation 102.

After determining g_{T}, the segmentation of temporal intervals may be determined by selecting a value for m for N=2^{m}, where the temporal interval corresponds to δt=T/N. The probability density function may then be determined using a recursion process, such that determining g₁(s₀, 0->s₁, t₁) also encompasses determining the probability density function for all powers of 2 (e.g., g₂_{^{m-1}} (s₀, 0→s₂_{^{m-1}}, t₂_{^{m-1}}), . . . , g₄ (s₀, 0→s₄, t₄), g₂(s₀, 0→s₂, t₂)). Using Equation 113, a full range of probability density functions may be generated (e.g., g₁, g₂, . . . , g_{N}). As mentioned previously, if an approximation of the function log S/s₀ (Xⱼ) is set as being the function log S/s₀ (X_{N}) \sqrt{N/j}, then g₁, g₂, . . . , g_{N} may be obtained directly from g_{T}.

The implied term structures and shape functions correspond to each of the probability density functions g₁, g₂, . . . , g_{N} may be determined next. For instance, using gⱼ, the option prices expiring at time tⱼ may be determined for any strike. Having the smile at time tⱼ therefore allows for σ₀(tⱼ), 25 Δ_{RR}(tⱼ), 25 Δ_{Fly}(tⱼ), A(d₁, tⱼ), and B((d₁, tⱼ) to be determined. Therefore, σ₀(tⱼ), 25 Δ_{RR} (tⱼ), 25 Δ_{Fly} (tⱼ), A(d₁, tⱼ), and B((d₁, tⱼ) may each be determined for j=1, 2, . . . , N. Furthermore, this calculation automatically provides the forward term structure from time t=tⱼ to time t=T,

$${A}_{{t}_{j}} ( {d}_{1} , T - {t}_{j} ) , {B}_{{t}_{j}} ( {d}_{1} , T - {t}_{j} ) , {σ}_{{0}_{{t}_{n}}} ( T - {t}_{n} ) , 25 {Δ}_{{RR}_{{t}_{j}}} ( T - {t}_{j} ) , and$$

$$25 {Δ}_{{Fly}_{{t}_{j}}} ( T - {t}_{j} ) ,$$

for j=1, 2, ..., N−1.

Using the implied term structure and the forward term structure in the integral representation for j=1, 2, . . . N−1, A(d₁, T) and B(d₁, T) may be determined using Equations 70, 72, and 73.

The first assumption of A(d₁, T) and B(d₁, T) may, in some embodiments, be viewed as the N=0 case as the time to expiration T is not dissected. New values of A(d₁, T) and B(d₁, T), which were obtained from the integrals, may be used to recalculate the probability density functions g₁, g₂, . . . , g_{N} that correspond to the volatility smile generated by the new values of A(d₁, T) and B(d₁, T). The probability density functions may then be used to determine the term structure of the smile, σ₀(tⱼ), 25 Δ_{RR}(tⱼ), 25 Δ_{Fly}(tⱼ), A(d₁, tⱼ), and B(d₁, tⱼ) for all j=1, 2, . . . , N−1, which may then be used in the integral representation to determine A(d₁, T) and B(d₁, T). In some embodiments, the number of temporal intervals N may be increased through the iterations to achieve faster calculations. For instance, N may initially be set at a low value (e.g., N=2 or 3), and may be increased later at subsequent iterations.

The iteration process may continue until convergence of A(d₁, T) and B(d₁, T) is obtained. Upon reaching convergence, the self-consistent values of A and B are determined for the probability consistent approach. The convergence in the M-th iteration, therefore, may be represented by Equation 122 for the shape functions:

|F_{A,B}^{M+1}(d₁)−F_{A,B}^{M}(d₁)|<0.001 Equation 122.

The aforementioned iteration technique allows for the time step to be controlled versus the expiry time in order to control the calculation time, while still preserving the desired accuracy.

Alternatively, instead of the convergence of F_{A,B}^{M+1}(d₁) in Equation 122, the convergence of the probability density function g_{T} may be used. In one embodiment, the convergence of g_{T} may be defined such that for any spot s, the difference between the current value of g_{T} and a previous iteration value of g_{T} is less than a threshold value. For example, the threshold value may be 0.001 such that convergence may be obtained for |g_{T}^{M+1}(log s)−g_{T}^{M}(log s)|<0.001. Alternatively, in one embodiment, convergence may be defined via the cumulative density function G_{T} where for any spot s, a difference between a current value of G_{T} and a previous iteration value of G_{T} is less than a threshold value. For example, in this particular scenario, the threshold value may be 0.01, and therefore convergence may be obtained for |G_{T}^{M+1}(log s)−G_{T}^{M}(log s)|<0.01. In yet another embodiment, a difference in prices of options within a set of strikes {Kᵢ} may be used to determine convergence. In this particular scenario, convergence may be defined such that a difference in a price of each of the options associated with a current g_{T} and a previous iteration g_{T} may be less than a threshold value. For example, the threshold value may be 0.001, such that convergence may be obtained for |P^{M+1}(Ki)−P^{M}(Ki)|<0.001. Persons of ordinary skill in the art will recognize that there may be many different ways to examine convergence, and the aforementioned are merely exemplary. After each step in the iteration process, as described herein, the values obtained for ζ_{Fly}(d₁) in Equation 72 and ζ_{RR′}(d₁) in Equation 73 for all input values d₁ of the set of input values {d₁} may be obtained. By adding the BS price with the pivot volatility, the price for the options with strikes corresponding to {d₁} and {−d₁} may be obtained in order to calculate the density function g_{T} that is implied from the new volatility smile and using Equation 102. Therefore, in some embodiments, the calculations of A(d₁) and B(d₁) are not required in order to obtain the smile.

In some embodiments, the method used in section III above (titled “III. New Volatility Smile Model”) can be used to derive European Vanilla option prices as the path integral for the case where the volatility is constant. In those cases, when calculating the path integral in the same approach used in Section III, the result density function g(s,t) can be the log normal distribution function and hence the method leads to the BS model without any pre-determined assumption on the probability of the underlying asset. In this case, start by dividing the time to expiry T into N time intervals tᵢ=iT/N. At each time i, the change in the underlying asset price from time tᵢ₋₁ to tᵢ is denoted δsᵢ=sᵢ−sᵢ₋₁.

The next step would be to consider a specific d₁ strangle with expiry T which, by definition, is Delta neutral. Strikes of the butterfly can be denoted as K_{call}, Kₚᵤₜ. The change in the value of the strangle (up to a second order) from time tᵢ₋₁ to time tᵢ is:

$$\begin{matrix}δΠ i ( strangle , {t}_{i} ) = Theta ( {t}_{i - 1} ) ( {t}_{i} - {t}_{i - 1} ) + Delta ( {t}_{i - 1} ) δ {s}_{i} + \frac{1}{2} δDelta ( {t}_{i - 1} ) δ {s}_{i} = Theta ( {t}_{i - 1} ) δ {t}_{i} + Delta ( strangle , {t}_{i - 1} ) δ {s}_{i} + \frac{1}{2} Gamma ( strangle , {t}_{i - 1} ) δ {s}_{{i}^{2}} . & Equation 123 \\ where \text{:} \\ Gamma ( strangle , {t}_{i - 1} ) = Gamma ( {K}_{call} , {t}_{i - 1} ) + Gamma ( {K}_{put} , {t}_{i - 1} ) \\ and \\ Theta ( {t}_{i} ) = \frac{d Π ( strangle , {t}_{i} )}{dt} \\ Gamma ( {t}_{i} ) = \frac{d Delta ( strangle , {t}_{i} )}{ds} . & Equation 124\end{matrix}$$

The re-hedging strategy for changes in the underlying asset can be as follows. At time tᵢ, the hedger can buy or sell a certain amount of the underlying asset at the market price sᵢ so that the total amount of Delta of the strangle and the hedge is zero. Therefore the amount of the hedge can be the opposite of the Delta of the strangle and, up to a second order, the total profit/loss from the strangle and the hedge can be determined to be:

δΠi(strangle+hedge,tᵢ)=Theta(tᵢ₋₁)(tᵢ−tᵢ₋₁)+½Gamma(strangle,tᵢ₋₁)δsᵢ² Equation 125.

The profit/loss from time i to i+1 can be realized at time i+1 (i.e., on a cash basis). In the re-hedging process, the hedger can either borrow money at interest rate rᵢ to buy the underlying asset or lend money at interest rate rᵢ after selling the underlying asset. Therefore, when taking into account the funding cost, up to second order the profit/loss in Equation 125 due to Delta re-hedging can become:

dfᵢ½Gamma(strangle,tᵢ₋₁)δsᵢ²
where dfᵢ is the discount factor from inception to tᵢ. For example, the contribution from Theta can be discounted by the discount fracture to maturity df_{T}.
Therefore the expected profit from holding the strangle until maturity while re-hedging with the underlying asset can be:

$$E ( {\sum }_{i = 1}^{N} δΠ i ( butterfly + hedge ) = E ( {\sum }_{i = 1}^{N} {df}_{i} Gamma ( strangle , {t}_{i - 1} ) δ {s}_{{i}^{2}} / 2 + {df}_{T} Theta ( {t}_{i - 1} ) δ {t}_{i} ) = E ( {\sum }_{i = 1}^{N} {df}_{i} \frac{1}{2} {s}_{i}^{2} Gamma ( strangle , {t}_{i - 1} ) {( \frac{δ {s}_{i}}{{s}_{i}} )}^{2} + {df}_{T} Theta ( {t}_{i - 1} ) δ {t}_{i} . \qquad Equation 126$$

Now, if δsᵢ is independent of sᵢ then:

$$E ( {\sum }_{i = 1}^{N} δΠ i ) = \frac{1}{2} E ( {\sum }_{i = 1}^{N} {df}_{i} {s}_{i - 1}^{2} Gamma ( strangle , {t}_{i - 1} ) ) E ( {\sum }_{i = 1}^{N} {( \frac{δ {s}_{i}}{{s}_{i - 1}} )}^{2} / N ) + {df}_{T} E ( {\sum }_{i = 1}^{N} Theta ( {t}_{i - 1} ) δ {t}_{i} ) = \frac{1}{2} {σ}^{2} E ( {\sum }_{i = 1}^{N} {df}_{i} {s}_{i - 1}^{2} Gamma ( strangle , {t}_{i - 1} ) ) + {df}_{T} E ( {\sum }_{i = 1}^{N} Theta ( {t}_{i - 1} ) δ {t}_{i} ) \\ where {σ}^{2} ≡ \frac{1}{N} E {\sum }_{i = 1}^{N} {( \frac{δ {s}_{i}}{{s}_{i - 1}} )}^{2} . \qquad Equation 127$$

σ² is the expected variance of the return of the underlying asset in the period from inception (the time of calculating the option) until maturity. Hence the price of the strangle at inception can be determined by:

P(d1strangle)=Π(strangle,t=0)=½σ²E(Σᵢ₌₀^{N-1}dfᵢsᵢ²Gamma(strangle,tᵢ))+df_{T}E(Σᵢ₌₁^{N-1}Theta(tᵢ)δtᵢ₊₁) Equation 128.

Similarly the profit for the d₁ risk reversal with re-hedging can be calculated using the underlying asset. However, since risk reversal has non-zero delta, a delta hedged risk reversal needs to be considered. In this case:

Π(Delta hedged d₁ risk reversal,t=0)=P_{Call}(K_{call})−P_{Put}(Kₚᵤₜ)−s₀Delta(K_{call})+s₀Delta(Kₚᵤₜ)=½σ²E(Σᵢ₌₀^{N-1}dfᵢsᵢ² Gamma(risk reversal,tᵢ))+df_{T}E(Σᵢ₌₀^{N-1} Theta(tᵢ)δtᵢ₊₁)(and Delta(Kₚᵤₜ)=−Delta(K_{call})) Equation 129.

Equations 128 and 129 can be translated to the path integral form to obtain:

P(strangle d₁)=∫₀^{T}dt∫₀^{∞}ds g(s,t)[df(t)[df(t)½σ²s²(Gamma(s,t,T,σₜ(K_{call},T),K_{call})+Gamma(s,t,T,σₜ(Kₚᵤₜ,T),Kₚᵤₜ))+df(T)(Theta(s,t,T,σₜ(K_{call},T),K_{call})+Theta Gamma(s,t,T,σₜ(Kₚᵤₜ,T),Kₚᵤₜ))] Equation 130.

P(risk reversal d₁)−s₀ Delta(risk reversal d₁))=∫₀^{T}dt∫₀^{∞}ds g(s,t)[df(t)½σ²s²(Gamma(s,t,T,δₜ(K_{call},T),K_{call})−Gamma(s,t,T,σₜ(Kₚᵤₜ,T),Kₚᵤₜ))+df(t)(Theta(s,t,T,σₜ(K_{call},T),K_{call})−Theta Gamma(s,t,T,σₜ(Kₚᵤₜ,T),Kₚᵤₜ))] Equation 131.

Where P(strangle) and P(risk reversal) are the prices of the strangle and risk reversal respectively, at inception. Next, follow the procedure in Section III above to solve for g(s,T). If the density function for maturity g(s,T) is:

$$g ( s , T ) = \frac{1}{σ s \sqrt{2 π T}} {e}^{- {( log \frac{s}{{s}_{0}} - T ( r + {σ}^{2} / 2 ) )}^{2} / ( 2 {σ}^{2} T )} . \qquad Equation 132$$

then for every tⱼ<T the density function that satisfy equations 113, 114, 115 satisfies:

$$g ( s , {t}_{j} ) = \frac{1}{σ s \sqrt{2 π {t}_{j}}} {e}^{- {( lo g \frac{s}{{s}_{0}} - {t}_{j} ( r + {σ}^{2} / 2 ) )}^{2} / ( 2 {σ}^{2} {t}_{j} )} \\ g ( s , {t}_{j} , {s}_{T} , T , ) = \frac{1}{σ {s}_{T} \sqrt{2 π ( T - {t}_{j} )}} {e}^{- {( lo g \frac{{s}_{T}}{s} - ( T - {t}_{j} ) ( r + {σ}^{2} / 2 ) )}^{2} / ( 2 {σ}^{2} ( T - {t}_{j} ) )} . \qquad Equation 133$$

and g(s,tⱼ, s_{T},T,) is the forward density function at the underlying asset price s from time tⱼ to T.

When substituting equation 133 into the integrals in equations 130 and 131, and using P_{call}(s,K_{call},t,T)=df(T−t)∫₀^{∞}ds_{T}(s_{T}−K)⁺g(s,t, s_{T},T,) and Pₚᵤₜ(s,Kₚᵤₜ,t,T)=df(T−t)∫₀^{∞}ds_{T}(K−s_{T})⁺g(s,t, s_{T},T,), then the BS prices of the d₁ strangles and d₁ risk reversals may be obtained. Therefore, without any assumption on the stochastic behavior of the underlying asset a conclusion may be reached that when the change in the underlying asset δsᵢ is independent of the underlying asset price sᵢ and no additional factor affects the price of the option (e.g., the variance of the change of the price of the underlying asset does not change), then up to second order the option price is the BS price.

Next, expand the method for the case that the variance of the changes in the underlying asset price changes over time. In order to calculate the price of a d₁ butterfly the expected value of the butterfly under the following hedging strategy can be calculated: At each time tᵢ, the Delta with the underlying asset can be re-hedged and the Vega with the ATM (d₁=0) straddle which has zero Delta can also be re-hedged. Hence the Vega re-hedging does not affect the Delta hedging of the butterfly buy, it adds to the Gamma and Theta of the butterfly in Equation 128.

Since at each time tᵢ the Vega (ATM hedge)=−Vega (butterfly), therefore the notional (amount) of the ATM straddle at time tᵢ can be determined by:

−Vega(butterfly)/Vega(d₁=0 straddle)=−Vega(butterfly)\sqrt{2Π}/(2Fdf\sqrt{T−tᵢ}) Equation 134.

The Gamma and Theta of the ATM straddle hedge satisfy the following equations:

$$\begin{matrix}Gamma ( ATM hedge , {t}_{i} ) = - Vega ( butterfly , {t}_{i} ) / {σ}_{i} {s}_{i}^{2} ( T - {t}_{i} ) . \\ and \text{:} & Equation 135 \\ Theta ( ATM hedge , {t}_{i} ) = \frac{1}{2} Vega ( butterfly , {t}_{i} ) ( \frac{{σ}_{i}}{T - {t}_{i}} - r {e}^{\frac{1}{2} {σ}_{i}^{2} ( T - {t}_{i} )} / \sqrt{T - {t}_{i}} ) ( 1 - 2 N ( {σ}_{i} \sqrt{T - {t}_{i}} ) ) . & Equation 136\end{matrix}$$

In equations 135 and 136 σᵢ is the ATM volatility at time tᵢ. By taking into account all the contributions, a resultant equation can be obtained. For example if we take zero interest rates (r=0 or dfᵢ=1 for all i) then we get simple expressions

$$P ( {d}_{1} butterfly ) = \frac{1}{2} {σ}^{2} E ( {\sum }_{i = 0}^{N - 1} {s}_{i}^{2} ( Gamma ( butterfly , {t}_{i} ) - Vega ( butterfly , {t}_{i} ) / {σ}_{i} {s}_{i}^{2} ( T - {t}_{i} ) ) + E ( {\sum }_{i = 0}^{N - 1} ( Theta ( butterfly , {t}_{i} ) + \frac{1}{2} Vega ( butterfly , {t}_{i} ) \frac{{σ}_{i}}{T - {t}_{i}} ( 1 - 2 N ( {σ}_{i} \sqrt{T - {t}_{i}} ) ) δ {t}_{i} ) + \frac{1}{2} Var ( {σ}_{ATM} ) E ( {\sum }_{i = 0}^{N - 1} \frac{dVega}{d σ} ( butterfly , {t}_{i} ) ) + \frac{1}{2} Cov ( {σ}_{ATM , S} ) E ( {\sum }_{i = 0}^{N - 1} ( \frac{dVega}{ds} ( butterfly , {t}_{i} ) - Vega ( butterfly , {t}_{i} ) / {s}_{i} ) . \qquad Equation 137$$

And similarly, the delta hedged d₁ risk reversal may be determined by:

$$P ( {d}_{1} risk reversal ) - 2 {s}_{0} Delta ( {d}_{1} ) = \frac{1}{2} {σ}^{2} E ( {\sum }_{i = 0}^{N - 1} {s}_{i}^{2} ( Gamma ( risk reversal , {t}_{i} ) - Vega ( risk reversal , {t}_{i} ) / {σ}_{i} {s}_{i}^{2} ( T - {t}_{i} ) ) + E ( {\sum }_{i = 0}^{N - 1} ( Theta ( risk reversal , {t}_{i} ) + \frac{1}{2} Vega ( risk reversal , {t}_{i} ) \frac{{σ}_{i}}{T - {t}_{i}} ( 1 - 2 N ( {σ}_{i} \sqrt{T - {t}_{i}} ) ) δ {t}_{i} ) + \frac{1}{2} Var ( {σ}_{ATM} ) E ( {\sum }_{i = 0}^{N - 1} \frac{dVega}{d σ} ( risk reversal , {t}_{i} ) ) + \frac{1}{2} Cov ( {σ}_{ATM , S} ) E ( {\sum }_{i = 0}^{N - 1} ( \frac{dVega}{ds} ( risk reversal , {t}_{i} ) - Vega ( risk reversal , {t}_{i} ) / {s}_{i} ) . \qquad Equation 138$$

Equations 130 and 131 should thus be modified accordingly. In order to check the consistency between the expressions for the case of constant volatility and non-constant volatility it can be seen that when using constant volatility (i.e., σᵢ=σ for all i and the density function is determined using Equation 133) in Equations 137 and 138 they reduce to Equations 128 and 129, respectively. Continuing using for simplicity r=0 then for the butterfly and risk reversal

½σ²sᵢ²Gamma(ATM hedge,tᵢ)+Theta(ATM hedge,tᵢ)=½Vega(butterfly or risk reversal,tᵢ)re^{1/2σ}^{²}^{(T-t}^{ᵢ}⁾(1−2N(σ\sqrt{T−tᵢ}))/\sqrt{T−tᵢ})=0 Equation 139.

Accordingly, instead of solving for g(s,T) in the equations for ζ(d₁ butterfly) and ζ (d₁ risk reversal) in equations 53 and 54 respectively or in equations 63 and 65 respectively, expressed in the integral form in equations 71 and 72, it can be solved for from Equations 137 and 138 which represent the price of the strangles and risk reversals.

In some embodiments, the kernel for swaptions may be determined by replacing S(t) with the forward rate of the underlying asset at time t for a maturity T, with F(t). The probability density function may therefore be described by Equation 123:

gₙ(F₀,0→Fₙ,tₙ) Equation 140.

In Equation 140, Fₙ may correspond to the forward rate at time t=tₙ of a forward starting swap that starts after time t=T−tₙ, and also having the same temporal duration L. The kernel for swaptions, therefore, corresponds to g₁, as seen in Equation 141:

g₁(F₀,0→F₁,t₁) Equation 141.

Thus, for swaptions, the determination of A and B is substantially the same as previously described, except that the Annuity An also needs to be accounted, such as when determining the probability density function of the forward rate F.

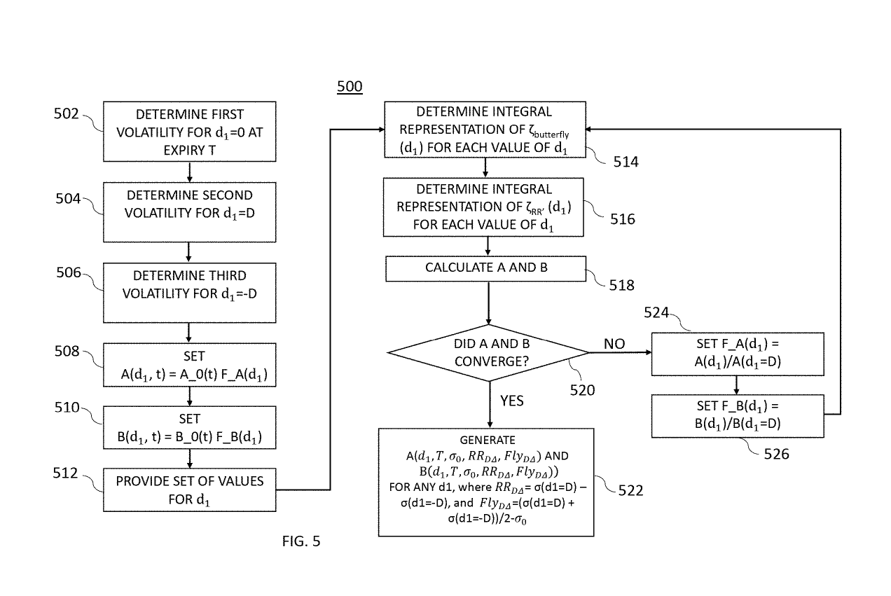

FIG. 5 is an illustrative flowchart of a process for determining zero-order functions A(d₁, T) and B(d₁, T), in accordance with various embodiments. Process 500, in an illustrative, non-limiting embodiment, may begin at step 502. At step 502, a first volatility may be determined. For instance, volatility σ₀ may be determined for an input value d₁=0 at expiry time T. As mentioned previously, in one embodiment, σ₀ may be referred to as the pivot volatility, which may correspond to a volatility for a maximum value of Vega. At step 504, a second volatility may be determined. The second volatility, for instance, may correspond to the volatility for the input value d₁=D. At step 506, a third volatility may be determined. The third volatility, for instance, may correspond to the volatility for the input value d₁=−D. In some embodiments, Equations 3 and 4 may be used, respectively, to describe D_{ΔCall} and D_{ΔPut}. In some embodiments, D may correspond to 25 Δ, such that 0.25=e^{-r}^{_{f}}^{T} N(D), however this is merely exemplary. In some embodiments, Δ_{RR} or Δ_{Fly} may be used alternatively. For example, risk reversal may correspond to 25 Δ_{RR}=σ(25 Δ_{Call})−σ(25 Δ_{Put}) while 25 Δ_{Fly}=((σ(25 Δ_{Call})+σ(25 Δ_{Put}))/2−σ₀.

At steps 508 and 510, first function A(d₁, t) and second function B(d₁, t) may be set such that A(d₁, t)=A₀(t) F_{A}(d₁) and B(d₁, t)=B₀(t) F_{B}(d₁), respectively. First and second functions A(d₁, t) and B(d₁, t) which may, for a particular d₁ at expiry time T, be described using the shape functions F_{A} and F_{B}. In this particular scenario, F_{A} and F_{B} may be independent of the expiration time t.

At step 512, a set of input values for d₁ may be provided. For example, a set of values for d₁ may be preselected by server 102 and/or user device 104, or may be received with the market data obtained by server 102. In some embodiments, the set of input values may be predefined by an individual, and programmed for user device 104 such that the set of input values is capable of being called upon when performing process 500. As an illustrative embodiment, d₁ may correspond to values such as d₁=0.1 to 5.0, and may be selected in increments of 0.25. However, persons of ordinary skill in the art will recognize that this is merely exemplary, and any suitable values for d₁, and/or any suitable increments thereof, may be used.

At steps 514 and 516, integral representations for ζ_{butterfly} (d₁) and ζ_{RR′} (d₁) may be determined for each input value d₁ of the set. For example, the integral representations may be calculated by user device 104 based on the provided set of input values for d₁ provided at step 512. The integral representations, in an illustrative embodiment, may be determined by an iterative process performed by user device 104 and/or server 102. The iterative process may, for example, begin by using a first approximation for F_{A} and F_{B}, where

$${F}_{A} ( {d}_{1} ) = \frac{1 + {q}_{a} {D}_{25}^{2}}{1 + {q}_{a} {d}_{1}^{2}} , and {F}_{B} ( {d}_{1} ) = \frac{1 + {q}_{b} {D}_{25}^{2}}{1 + {q}_{b} {d}_{1}^{2}}$$

for constant qₐ and q_{b} (e.g., 0.3). Next, the integral representations may be determined, using user device 104, by defining A(d₁) and B(d₁) such that they, respectively, correspond to the integral representations of

$${ζ}_{butterfly} ( {d}_{1} ) / \frac{\partial Strangle}{\partial σ} ( {d}_{1} ) and {ζ}_{{RR}^{′}} ( {d}_{1} ) / \frac{\partial RR}{\partial S} ( {d}_{1} ) .$$

At step 518, A and B may be calculated. For example, using the integral representations of ζ_{Fly} and ζ_{RR′}, A(d₁) and B(d₁) may be determined.

At step 520, a determination may be made as to whether or not convergence was reached for A(d₁) and B(d₁). Convergence may be said to have occurred when first and second parameters A(d₁) and B(d₁) stop changing in value. As seen from Equation 122, convergence may correspond to a particular input set of values {d₁} where a difference between a first value of shape functions F_{A} and a second value of shape function F_{B} is less than, or equal to, a predefined convergence threshold value. For example, the convergence threshold value may correspond to 0.01, however this is merely exemplary, and any suitable convergence threshold value may be employed.

If, at step 520, it is determined by user device 104 that convergence has been reached, then process 500 may proceed to step 522. At step 522, first parameter A(d₁,T, σ₀, RR_{DΔ}, Fly_{DΔ}) and second parameter B(d₁,T,σ₀, RR_{DA}, Fly_{DA})) may be generated for any value of d₁ included within the set. In particular, RR_{DΔ} may correspond to a difference between a volatility for d₁=D and d₁=−D, respectively (e.g., RR_{DΔ}=σ(d₁=D)−τ(d₁=−D)), and Fly_{DΔ} may correspond to a difference between half of a summation of the volatility for d₁=D and d₁=−D, and the pivot volatility σ₀ (e.g., Fly_{DΔ}=(σ(d₁=D)+σ(d₁=−D))/2−σ₀). Furthermore, d₁=D corresponds to the call option delta (e.g.,

$${Δ}_{Call} = \frac{{dP}_{Call}}{dS} = {e}^{- {r}_{f} T} N ( D ) ) .$$

If, however, at step 520, user device 104 determines that convergence for first and second parameters A(d₁) and B(d₁) was not reached (e.g., a difference between shape functions F_{A} and F_{B} is greater than the predefined convergence threshold value), then process 500 may proceed to step 524. At step 524, the shape function for F_{A} may be redefined at user device 104. Furthermore, at step 526, the shape function for F_{B} may be redefined by user device 104. In some embodiments, shape function F_{A} may be normalized using the value of the first parameter when d₁=D. For instance, shape function F_{A} may be set such that F_{A}(d₁)=A(d₁)/A(d₁=D). As an illustrative example, for D correspond to twenty-five delta call/put, F_{A}(d₁)=A(d₁)/A(D₂₅). Furthermore, in some embodiments, shape function F_{B} may be normalized using the value of the first parameter when d₁=D. For instance, shape function F_{B} may be set such that F_{B} (d₁)=B(d₁)/B(d₁=D). As an illustrative example, for D correspond to twenty-five delta call/put, then F_{B}(d₁)=B(d₁)/B(D₂₅). After redefining F_{A} and F_{B}, process 500 may return to step 514 (and step 516), where the integral representations for ζ_{butterfly}

$$( {d}_{1} ) / \frac{\partial Strangle}{\partial σ} ( {d}_{1} ) and {ζ}_{{RR}^{′}} ( {d}_{1} ) / \frac{\partial RR}{\partial S} ( {d}_{1} )$$

may be determined, and process 500 may repeat until user device 104 determines that convergence is reached at step 520.

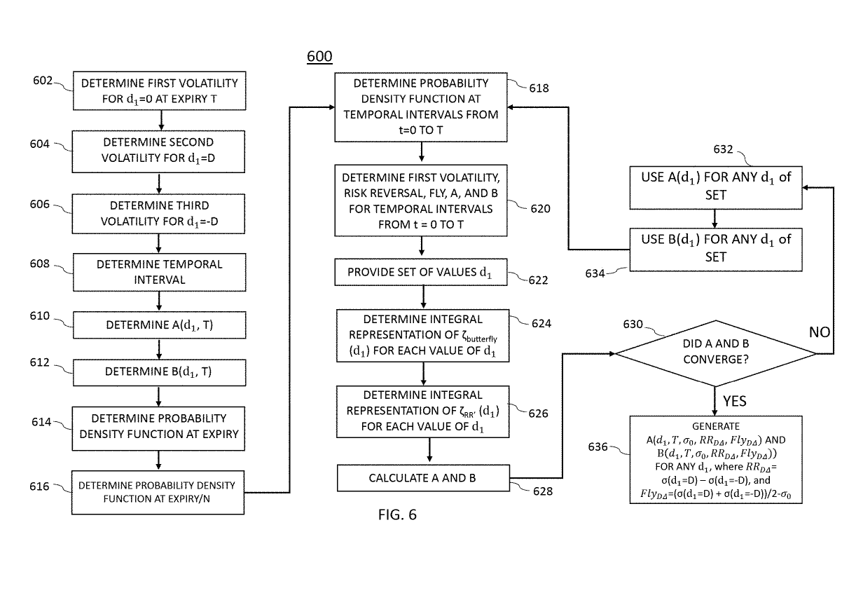

FIG. 6 is an illustrative flowchart of a process for determining an n-th order approximation for functions A(d₁, T) and B(d₁, T), in accordance with various embodiments. Process 600 may begin at step 602. At step 602, a first volatility may be determined for an input value d₁=0 at expiration time T. For instance, a first volatility σ₀ may be determined by user device 104 based on market data received from server 102. At step 604, a second volatility, for d₁=D may be determined. For example, σ(Δ_{call}) may be determined by user device 104, corresponding to the volatility for D delta call

$$( {Δ}_{Call} = \frac{{dP}_{Call}}{dS} = {e}^{- {r}_{f} T} N ( D ) ) .$$

At step 606, a third volatility for d₁=−D may be determined. For example, σ(Δ_{Put}) may be determined by user device 104 for delta put. In some embodiments, steps 602, 604, and 606 may be substantially similar to steps 502, 504, and 506 of FIG. 5, and the previous descriptions may apply.

At step 608, a temporal interval may be determined. For example, user device 104 may determine the temporal interval, or the temporal interval may be predefined by server 102 and/or financial data source 108. The temporal interval, in an illustrative embodiment, may correspond to a segmentation of the amount of time from time t=0 to expiration divided by a factor N. In some embodiments, in order to shorten the calculation time, N may be defined such that N=2ⁿ, where n is an integer value (e.g., n=0, 1, 2, 3, . . . ), however persons of ordinary skill in the art will recognize that any value for N may be used. After selecting an appropriate value for n, N may be determined, and used to divide the time to expiry. For instance, the temporal interval δt may correspond to: δt=T/N or δt=T/2ⁿ. N may be any integer value (e.g., 1, 2, 4, . . . , N). For example, if n=10, N=1024 and therefore the time to expiry is segmented into 1024 temporal intervals. The temporal intervals may be used such that the probability density function g₁(s, t) is able to be determined. The probability density function g(s₁, t->s₂, t+δt) is the same for all.

At step 610, first function A(d₁, T) may be determined, and at step 612, second function B(d₁, T) may be determined. In some embodiments, first and second functions A(d₁, T) and B(d₁, T) may be determined using an iterative approach performed by user device 104, as described in greater detail above. In some embodiments, as a first step in the iteration, first and second functions A(d₁, T) and B(d₁, T) may be determined using the zero-level approximation described previously with reference to FIG. 5.

At step 614, the probability density function may be determined by user device 104 for expiry time T from the option prices of different strikes. For instance, the probability density function may be determined for spot s₀ at time t=0, to spot s at time=T. At step 616, the probability density function may be determined by user device 104 for expiry time T divided by N (the time interval). For instance, the probability density function for g(s₀, 0->s₁, δt) may be determined using the determined probability density function at expiry T from step 614 via a recursion process. At step 618, the probability density function may be determined for each temporal interval from time t=0 to time t=T. For instance, user device 104 may determine the probability density function's values for g(s₁, 0->s₂, mδt), for m=2, 3, 4, . . . , N−1. Upon determining the probability density functions values at step 618, user device 104 may use the probability density function values to determine the term structures: first volatility σ₀, risk reversal, butterfly, first function A, and second function B for temporal intervals from time t=0 to T at step 620. For instance, for each mδt, user device 104 may determine term structures σ₀(mδt), D Δ_{RR}(mδt), D Δ_{Fly}(mδt), A(d₁, mδt), and B(d₁, mδt).

At step 622, a set of input values d₁ may be provided. For instance, the set of input values d₁ may be provided by user device 104. Values for d₁ may be selected for calculating the integral representations of ζ_{butterfly} (d₁) and ζ_{RR′} (d₁). Persons of ordinary skill in the art will recognize that any suitable number of values for d₁ may be selected. For instance, 10 different values for d₁ may be chosen, however this is merely exemplary. In one embodiment, at least five different values for d₁ may be selected. As an illustrative embodiment, values for d₁ may correspond to d₁=0.25, 0.5, 0.75, . . . , 3.5, however any suitable increment may be used. In some embodiments, step 622 of FIG. 6 may be substantially similar to step 512 of FIG. 5, and the previous description may apply.

At step 624, values for the integral representations for ζ_{butterfly} (d₁) may be determined for each input value d₁ from the set of values of d₁ provided at step 622. The integral representations for ζ_{butterfly}(d₁) may be determined using the term structures σ₀(mδt), Δ_{RR} (mδt), Δ_{Fly} (mδt), A(d₁, mδt), and B(d₁, mδt) determined at step 620, for instance. Similarly, at step 626, values for the integral representations for ζ_{RR′} (d₁) may be determined for each value of d₁ from the set of values of d₁ provided at step 622. The integral representation for ζ_{RR′} (d₁) may then be determined by also using the term structures σ₀(mδt), D Δ_{RR}(mδt), D Δ_{Fly}(mδt), A(d₁, mδt), and B(d₁, mδt) determined at step 620.

In some embodiments, first parameter A(d₁, T) may be defined using the integral representation of

$${ζ}_{butterfly} ( {d}_{1} ) / \frac{\partial Strangle}{\partial σ} ( {d}_{1} ) ,$$

and second parameter B(d₁, T) may be defined using the integral representation of ζ_{RR′}

$$( {d}_{1} ) / \frac{\partial RR}{\partial S} ( {d}_{1} ) ,$$

respectively. At step 628, A(d₁) and B(d₁) may be calculated. For instance, A(d₁) and B(d₁) may be calculated using ζ_{Flu} and ζ_{RR′}. In some embodiments, step 628 of FIG. 6 may be substantially similar to step 518 of FIG. 5, and the previous description may apply.

At step 630, a determination may be made as to whether or not convergence has been reached for A and B. For example, a determination may be made as to whether or not a difference between values corresponding to shape functions F_{A} and F_{B} are less than or equal to a predefined threshold convergence value. If, at step 630, convergence was reached for A and B, then process 600 may proceed to step 636 where A(d₁,T,σ₀, RR_{DΔ}, Fly_{DΔ}) and B(d₁,T,σ₀,RR_{DΔ},Fly_{DΔ}) may be generated by user device 104 for any value of d₁ included within the set. In some embodiments, step 636 of FIG. 6 may be substantially similar to step 522 of FIG. 5, and the previous descriptions may apply.

If, at step 630, convergence for first and second functions A and B was not reached, then process 600 may proceed to step 632. At steps 632 and 634, user device 104 may use the last redefined values for first and second functions A(d₁) and B(d₁) for any d₁ from the set of values of d₁, and process 600 may return to step 618 and step 620 where the probability density functions may be determined.

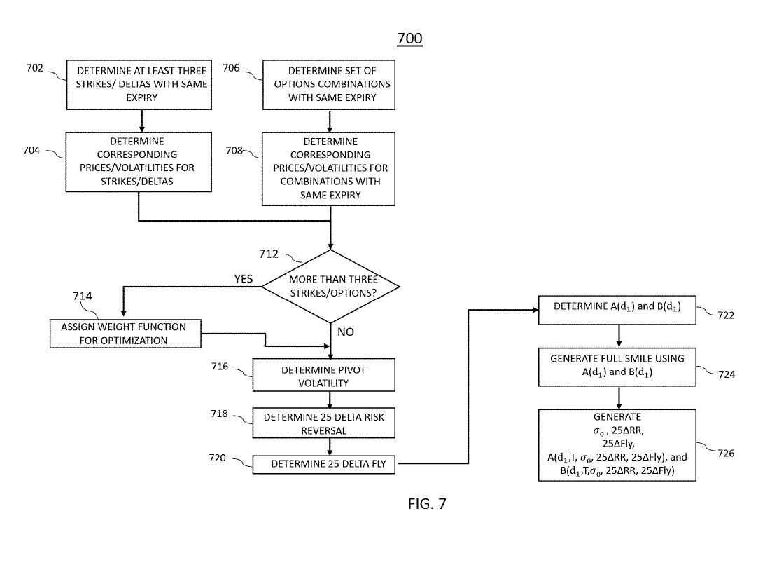

FIG. 7 is an illustrative flowchart of an exemplary process for determining the vanilla volatility smile, in accordance with various embodiments. Process 700, in one embodiment, may begin at step 702. At step 702, at least three strikes and/or deltas, having a same expiry T, may be determined. At step 704, prices and/or volatilities corresponding to the at least three strikes and/or deltas may also be determined. For example, a set of strikes and prices (e.g., strikes Kᵢ and prices P(Kᵢ), for i≧3) of exchange prices may be determined. As another example, a set of strikes Kᵢ and volatilities σ(Kᵢ) for exchange prices may be determined, where i≧3. As yet another example, a set of deltas and prices (e.g., Δᵢ and prices P(Δᵢ) for i≧3) or deltas and volatilities (e.g., Δᵢ and σ(Δᵢ) for i≧3) for over-the-counter or off-exchange trading (“OTC”) market may be determined.

Alternatively, process 700 may begin at step 706. At step 706, a set of options combinations having the same expiry T may be determined. At step 708, a corresponding set of prices and/or volatilities for the combinations with the same expiry may be determined. For example, a set of σ₀, σ(10 Δ_{call})−σ(10 Δ_{Put}), and σ(10 Δ_{Call})+σ(10 Δ_{Put}) may be determined, or the forward price, price (100 bp wide collar), and price 200 bp wide strangle) may be determined such that each value has a same expiration.

Process 700 may proceed from either step 704, 708, or 710, to step 712. At step 712, a determination may be made as to whether or not more than three strikes/deltas were used at step 702, or if more than three options were used at step 710. If so, then process 700 may proceed to step 714, where a weight may be assigned for the optimization. For example, the weight may be a function of Vega such that more weight is assigned to strikes K proximate to ATM. As another example, the weight may be assigned to be unity in the strike range where liquidity is high, and very small elsewhere. If, however, at step 712, it is determined that there are three strikes/options combinations, then process 700 may proceed to step 716, as described previously.

At step 716, the pivot volatility σ₀ may be determined using the values determined at steps 702 and 704, 706 and 708, or 710. At step 718, the twenty-five delta risk reversal 25 Δ_{RR} may be determined using the values determined at steps 702 and 704, 706 and 706, or 710. At step 720, the twenty-five delta butterfly 25 Δ_{Fly} may be determined the values determined at steps 702 and 704, 706 and 708, or 710. In some embodiments, steps 716-720 may be performed simultaneously, however persons of ordinary skill in the art will recognize that this is merely exemplary.

For each set of σ₀, 25 Δ_{RR}, and 25 Δ_{Fly}, the values of A(d₁) and B(d₁) to any order of accuracy or at convergence level may be determined, at step 722. For instance, by using σ₀, 25 Δ_{RR}, and 25 Δ_{Fly}, the full volatility smile may be obtained, as described in greater detail above. A(d₁) and B(d₁), for instance, may be determined to any order approximation (e.g., zero-level approximation, n-level approximation), or at convergence (e.g., where A and B stop changing significantly). In some embodiments, A(d₁) and B(d₁) may be determined beforehand for many sets of {σ₀, 25 Δ_{RR}, 25 Δ_{Fly}} and maturities, to simplify and expedite the optimization process.

At step 724, the full volatility smile may be generated using A(d₁) and B(d₁). After obtaining the full volatility smile, process 700 may proceed to step 726, where values for σ₀, 25 Δ_{RR}, 25 Δ_{Fly}, A(d₁, T, σ₀, 25 Δ_{RR}, 25 Δ_{Fly}) and B(d₁, T, σ₀, 25 Δ_{RR}, 25 Δ_{Fly}) may be determined.

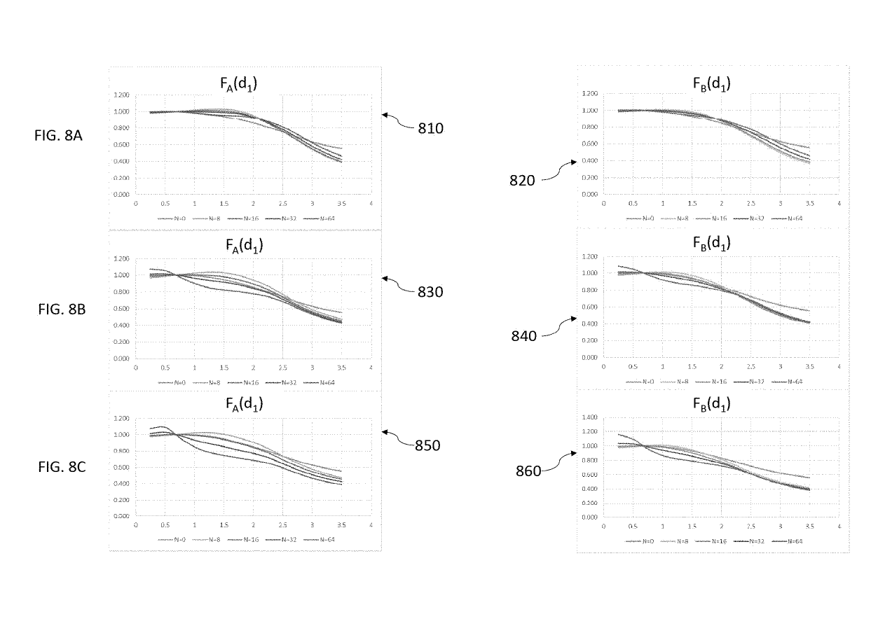

FIGS. 8A-C are illustrative graphs of a first shape function F_{A}(d₁) and a second shape function F_{B}(d₁) for different values of N for various sets of market data, in accordance with various embodiments. In FIGS. 8A-C, the effect of N on the shape of functions F_{A}(d₁) and F_{B}(d₁) is described. In FIGS. 8A-C, graphs of first and second functions F_{A}(d₁) and F_{B}(d₁) are shown for three different market data input values with the same expiry time. For instance, graphs 810 and 820 of FIG. 8A may correspond to first market data input values having σ₀=10, 25 Δ_{RR}=1, and 25 Δ_{Fly}=0.25. Graphs 830 and 840 of FIG. 8B may correspond to second market data values having σ₀=18, 25 Δ_{RR}=3, and 25 Δ_{Fly}=0.75. Graphs 850 and 860 may correspond to third market data input values having σ₀=25, 25 Δ_{RR}=6, and 25 Δ_{Fly}=1.5. For each of the market data input values, the expiry may be equal. For example, in this particular instance, the expiry may be set at three months. The various graphs of functions F_{A}(d₁) and F_{B}(d₁) are therefore shown with values of N ranging between 0 (e.g., no divisions of δt) and 64 (e.g., 64 divisions of δt). As seen from FIGS. 8A-C, first and second functions F_{A}(d₁) and F_{B}(d₁), and therefore A and B respectively, for N=32 and N=64 are very similar. Therefore, for an expiration less than three months, the convergence of first and second functions F_{A}(d₁) and F_{B}(d₁) may be found at N=32 for market data yielding market data within the vicinity of the exemplary input conditions. Tables 7-9 may further describe the exemplary graphs of FIGS. 8A-C.

TABLE 7

| | d₁ | 0.25 | 0.5 | 0.75 | 1 | 1.25 | 1.5 | 1.75 | 2 | 2.25 | 2.5 | 2.75 | 3 | 3.25 | 3.5 |
|---|---|---|---|---|---|---|---|---|---|---|---|---|---|---|---|
| N = 0 | F_{A} | 1.001 | 1.001 | 0.998 | 0.988 | 0.968 | 0.940 | 0.905 | 0.861 | 0.810 | 0.754 | 0.693 | 0.633 | 0.588 | 0.556 |
| | F_{B} | 1.005 | 1.003 | 0.997 | 0.984 | 0.961 | 0.930 | 0.892 | 0.845 | 0.793 | 0.738 | 0.680 | 0.626 | 0.586 | 0.557 |
| N = 8 | F_{A} | 0.980 | 0.990 | 1.004 | 1.018 | 1.027 | 1.026 | 1.007 | 0.952 | 0.864 | 0.762 | 0.651 | 0.544 | 0.456 | 0.387 |
| | F_{B} | 0.985 | 0.994 | 1.003 | 1.007 | 1.003 | 0.984 | 0.944 | 0.873 | 0.783 | 0.688 | 0.588 | 0.496 | 0.422 | 0.368 |
| N = 16 | F_{A} | 0.987 | 0.994 | 1.003 | 1.010 | 1.012 | 1.007 | 0.987 | 0.936 | 0.855 | 0.761 | 0.655 | 0.551 | 0.463 | 0.394 |
| | F_{B} | 0.989 | 0.996 | 1.002 | 1.002 | 0.993 | 0.972 | 0.934 | 0.869 | 0.787 | 0.700 | 0.605 | 0.514 | 0.440 | 0.384 |
| N = 32 | F_{A} | 0.990 | 0.997 | 1.001 | 1.001 | 0.996 | 0.989 | 0.974 | 0.934 | 0.866 | 0.782 | 0.683 | 0.580 | 0.492 | 0.422 |
| | F_{B} | 0.992 | 0.998 | 1.001 | 0.996 | 0.983 | 0.963 | 0.931 | 0.879 | 0.810 | 0.735 | 0.646 | 0.555 | 0.478 | 0.418 |
| N = 64 | F_{A} | 0.995 | 1.003 | 0.999 | 0.982 | 0.964 | 0.955 | 0.950 | 0.926 | 0.878 | 0.812 | 0.722 | 0.623 | 0.536 | 0.464 |
| | F_{B} | 0.999 | 1.004 | 0.998 | 0.982 | 0.961 | 0.943 | 0.922 | 0.885 | 0.833 | 0.772 | 0.690 | 0.600 | 0.523 | 0.460 |

TABLE 8

| | d₁ | 0.25 | 0.5 | 0.75 | 1 | 1.25 | 1.5 | 1.75 | 2 | 2.25 | 2.5 | 2.75 | 3 | 3.25 | 3.5 |
|---|---|---|---|---|---|---|---|---|---|---|---|---|---|---|---|
| N = 0 | F_{A} | 0.995 | 0.999 | 0.999 | 0.992 | 0.975 | 0.946 | 0.905 | 0.855 | 0.802 | 0.742 | 0.679 | 0.628 | 0.587 | 0.555 |
| | F_{B} | 1.000 | 1.001 | 0.998 | 0.987 | 0.965 | 0.932 | 0.887 | 0.836 | 0.783 | 0.725 | 0.668 | 0.622 | 0.586 | 0.557 |
| N = 8 | F_{A} | 0.971 | 0.986 | 1.006 | 1.024 | 1.034 | 1.028 | 0.996 | 0.941 | 0.869 | 0.770 | 0.670 | 0.589 | 0.525 | 0.477 |
| | F_{B} | 0.975 | 0.989 | 1.005 | 1.011 | 1.002 | 0.971 | 0.917 | 0.847 | 0.764 | 0.665 | 0.577 | 0.508 | 0.456 | 0.418 |
| N = 16 | F_{A} | 0.986 | 0.995 | 1.002 | 1.002 | 0.996 | 0.980 | 0.945 | 0.893 | 0.827 | 0.737 | 0.642 | 0.563 | 0.503 | 0.456 |
| | F_{B} | 0.988 | 0.995 | 1.002 | 0.997 | 0.977 | 0.941 | 0.889 | 0.823 | 0.746 | 0.654 | 0.566 | 0.497 | 0.445 | 0.407 |
| N = 32 | F_{A} | 1.012 | 1.013 | 0.994 | 0.965 | 0.938 | 0.916 | 0.885 | 0.843 | 0.790 | 0.713 | 0.624 | 0.547 | 0.487 | 0.441 |
| | F_{B} | 1.012 | 1.009 | 0.996 | 0.971 | 0.942 | 0.910 | 0.867 | 0.814 | 0.753 | 0.673 | 0.587 | 0.515 | 0.460 | 0.418 |
| N = 64 | F_{A} | 1.073 | 1.053 | 0.977 | 0.901 | 0.849 | 0.824 | 0.805 | 0.777 | 0.743 | 0.685 | 0.607 | 0.534 | 0.475 | 0.430 |
| | F_{B} | 1.083 | 1.046 | 0.980 | 0.919 | 0.881 | 0.859 | 0.831 | 0.793 | 0.749 | 0.683 | 0.602 | 0.529 | 0.470 | 0.424 |

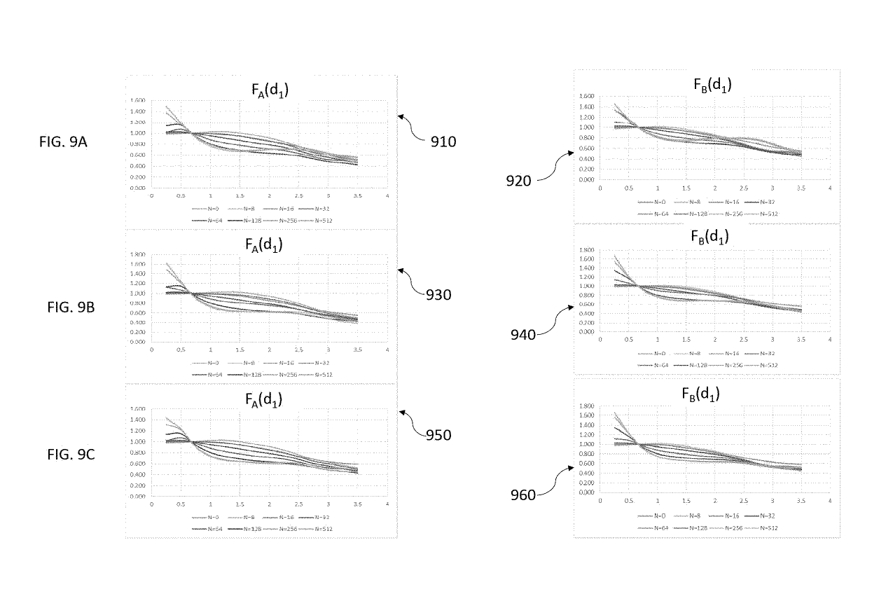

FIGS. 9A-C are illustrative graphs of a first shape function F_{A}(d₁) and a second shape function F_{B}(d₁) for swaptions for different values of N for various sets of market data, in accordance with various embodiments. FIGS. 9A-C demonstrates the effect of N on the shape of F_{A}(d₁) and F_{B}(d₁), similarly to FIGS. 8A-C, but for a greater expiry time. In FIGS. 9A-C, graphs of first and second functions F_{A}(d₁) and F_{B}(d₁) are shown for three different sets of market data input values. For instance, graphs 910 and 920 of FIG. 9A may correspond to first market data input values having σ₀=10, 25 Δ_{RR}=1, and 25 Δ_{Fly}=0.25. Graphs 930 and 940 of FIG. 9B may correspond to second market data input values having σ₀=18, 25 Δ_{RR}=3, and 25 Δ_{Fly}=0.75. Graphs 950 and 960 of FIG. 9C may correspond to third market data input values having σ₀=25, 25 Δ_{RR}=6, and 25 Δ_{Fly}=1.5. For each of the market data input values, the expiry may be equal. For example, in this particular instance, the expiry may be set at one year. The various graphs of functions F_{A}(d₁) and F_{B}(d₁) are therefore shown with values of N ranging between 0 (e.g., no divisions of δt) and 256 (e.g., 256 divisions of δt). As seen from FIGS. 9A-C, convergence of functions F_{A}(d₁) and F_{B}(d₁) may be found at N=128. Tables 10-12 may further describe the exemplary graphs of FIG. 9A-C.

TABLE 10

| | d₁ | 0.25 | 0.5 | 0.75 | 1 | 1.25 | 1.5 | 1.75 | 2 | 2.25 | 2.5 | 2.75 | 3 | 3.25 | 3.5 |
|---|---|---|---|---|---|---|---|---|---|---|---|---|---|---|---|
| N = 0 | F_{A} | 1.001 | 1.002 | 0.998 | 0.987 | 0.968 | 0.940 | 0.904 | 0.860 | 0.808 | 0.753 | 0.693 | 0.634 | 0.588 | 0.555 |
| | F_{B} | 1.005 | 1.003 | 0.997 | 0.984 | 0.961 | 0.931 | 0.892 | 0.845 | 0.794 | 0.740 | 0.682 | 0.627 | 0.586 | 0.556 |
| N = 8 | F_{A} | 0.982 | 0.989 | 1.005 | 1.021 | 1.026 | 1.001 | 0.957 | 0.910 | 0.844 | 0.758 | 0.676 | 0.627 | 0.570 | 0.519 |
| | F_{B} | 0.974 | 0.988 | 1.005 | 1.016 | 1.002 | 0.961 | 0.911 | 0.853 | 0.773 | 0.685 | 0.607 | 0.559 | 0.553 | 0.528 |
| N = 16 | F_{A} | 1.003 | 1.002 | 0.999 | 0.992 | 0.977 | 0.943 | 0.895 | 0.853 | 0.797 | 0.721 | 0.645 | 0.599 | 0.546 | 0.498 |
| | F_{B} | 0.990 | 0.996 | 1.002 | 0.997 | 0.969 | 0.925 | 0.875 | 0.825 | 0.755 | 0.673 | 0.597 | 0.547 | 0.540 | 0.514 |
| N = 32 | F_{A} | 1.020 | 1.023 | 0.990 | 0.946 | 0.907 | 0.867 | 0.821 | 0.784 | 0.740 | 0.676 | 0.604 | 0.557 | 0.506 | 0.460 |
| | F_{B} | 1.026 | 1.021 | 0.991 | 0.952 | 0.912 | 0.871 | 0.830 | 0.795 | 0.739 | 0.668 | 0.594 | 0.540 | 0.520 | 0.487 |
| N = 64 | F_{A} | 1.016 | 1.067 | 0.971 | 0.879 | 0.818 | 0.776 | 0.739 | 0.711 | 0.681 | 0.631 | 0.566 | 0.516 | 0.503 | 0.473 |
| | F_{B} | 1.116 | 1.082 | 0.965 | 0.876 | 0.825 | 0.791 | 0.759 | 0.740 | 0.706 | 0.653 | 0.584 | 0.527 | 0.493 | 0.452 |
| N = 128 | F_{A} | 1.136 | 1.146 | 0.937 | 0.801 | 0.729 | 0.685 | 0.652 | 0.634 | 0.617 | 0.583 | 0.531 | 0.484 | 0.459 | 0.426 |
| | F_{B} | 1.348 | 1.161 | 0.930 | 0.803 | 0.746 | 0.718 | 0.694 | 0.686 | 0.669 | 0.632 | 0.574 | 0.522 | 0.485 | 0.481 |
| N = 256 | F_{A} | 1.377 | 1.159 | 0.931 | 0.790 | 0.716 | 0.686 | 0.686 | 0.699 | 0.701 | 0.691 | 0.661 | 0.597 | 0.525 | 0.461 |
| | F_{B} | 1.348 | 1.135 | 0.942 | 0.824 | 0.767 | 0.757 | 0.777 | 0.795 | 0.790 | 0.781 | 0.749 | 0.671 | 0.584 | 0.508 |
| N = 512 | F_{A} | 1.493 | 1.190 | 0.918 | 0.763 | 0.688 | 0.666 | 0.675 | 0.697 | 0.712 | 0.715 | 0.693 | 0.633 | 0.563 | 0.500 |
| | F_{B} | 1.452 | 1.161 | 0.930 | 0.801 | 0.742 | 0.732 | 0.756 | 0.785 | 0.794 | 0.797 | 0.767 | 0.689 | 0.604 | 0.530 |

TABLE 11

| | d₁ | 0.25 | 0.5 | 0.75 | 1 | 1.25 | 1.5 | 1.75 | 2 | 2.25 | 2.5 | 2.75 | 3 | 3.25 | 3.5 |
|---|---|---|---|---|---|---|---|---|---|---|---|---|---|---|---|
| N = 0 | F_{A} | 0.997 | 0.999 | 0.999 | 0.992 | 0.974 | 0.945 | 0.902 | 0.851 | 0.798 | 0.740 | 0.678 | 0.626 | 0.584 | 0.553 |
| | F_{B} | 1.000 | 1.001 | 0.998 | 0.988 | 0.966 | 0.933 | 0.888 | 0.838 | 0.785 | 0.728 | 0.670 | 0.622 | 0.585 | 0.555 |
| N = 8 | F_{A} | 0.984 | 0.991 | 1.004 | 1.017 | 1.026 | 1.021 | 0.986 | 0.939 | 0.877 | 0.790 | 0.696 | 0.615 | 0.551 | 0.501 |
| | F_{B} | 0.984 | 0.991 | 1.004 | 1.011 | 1.008 | 0.983 | 0.935 | 0.878 | 0.806 | 0.715 | 0.623 | 0.548 | 0.491 | 0.447 |
| N = 16 | F_{A} | 1.005 | 1.004 | 0.998 | 0.991 | 0.983 | 0.969 | 0.932 | 0.885 | 0.830 | 0.753 | 0.664 | 0.586 | 0.526 | 0.480 |
| | F_{B} | 1.003 | 0.999 | 1.000 | 0.996 | 0.982 | 0.954 | 0.907 | 0.853 | 0.790 | 0.707 | 0.618 | 0.543 | 0.485 | 0.441 |
| N = 32 | F_{A} | 1.020 | 1.023 | 0.990 | 0.946 | 0.907 | 0.867 | 0.821 | 0.784 | 0.740 | 0.676 | 0.604 | 0.557 | 0.506 | 0.460 |
| | F_{B} | 1.026 | 1.021 | 0.991 | 0.952 | 0.912 | 0.871 | 0.830 | 0.795 | 0.739 | 0.668 | 0.594 | 0.540 | 0.520 | 0.487 |
| N = 64 | F_{A} | 1.131 | 1.071 | 0.969 | 0.886 | 0.834 | 0.805 | 0.783 | 0.754 | 0.725 | 0.677 | 0.608 | 0.537 | 0.480 | 0.436 |
| | F_{B} | 1.143 | 1.064 | 0.972 | 0.906 | 0.873 | 0.854 | 0.829 | 0.799 | 0.768 | 0.717 | 0.638 | 0.559 | 0.494 | 0.439 |
| N = 128 | F_{A} | 1.136 | 1.146 | 0.937 | 0.801 | 0.729 | 0.685 | 0.652 | 0.634 | 0.617 | 0.583 | 0.531 | 0.484 | 0.459 | 0.426 |
| | F_{B} | 1.348 | 1.161 | 0.930 | 0.803 | 0.746 | 0.718 | 0.694 | 0.686 | 0.669 | 0.632 | 0.574 | 0.522 | 0.485 | 0.481 |
| N = 256 | F_{A} | 1.493 | 1.211 | 0.909 | 0.744 | 0.667 | 0.637 | 0.625 | 0.615 | 0.604 | 0.585 | 0.544 | 0.485 | 0.429 | 0.381 |
| | F_{B} | 1.552 | 1.193 | 0.917 | 0.771 | 0.704 | 0.688 | 0.689 | 0.680 | 0.674 | 0.661 | 0.619 | 0.553 | 0.490 | 0.435 |
| N = 512 | F_{A} | 1.627 | 1.235 | 0.898 | 0.725 | 0.649 | 0.630 | 0.629 | 0.628 | 0.628 | 0.618 | 0.581 | 0.526 | 0.472 | 0.424 |
| | F_{B} | 1.667 | 1.209 | 0.910 | 0.761 | 0.697 | 0.681 | 0.686 | 0.685 | 0.688 | 0.682 | 0.636 | 0.574 | 0.515 | 0.463 |

TABLE 12

| | d₁ | 0.25 | 0.5 | 0.75 | 1 | 1.25 | 1.5 | 1.75 | 2 | 2.25 | 2.5 | 2.75 | 3 | 3.25 | 3.5 |
|---|---|---|---|---|---|---|---|---|---|---|---|---|---|---|---|
| N = 0 | F_{A} | 0.994 | 0.997 | 1.000 | 0.995 | 0.978 | 0.944 | 0.896 | 0.845 | 0.791 | 0.731 | 0.676 | 0.635 | 0.607 | 0.590 |
| | F_{B} | 0.996 | 0.999 | 0.999 | 0.991 | 0.969 | 0.931 | 0.883 | 0.834 | 0.780 | 0.722 | 0.669 | 0.630 | 0.602 | 0.584 |
| N = 8 | F_{A} | 0.982 | 0.989 | 1.005 | 1.021 | 1.026 | 1.001 | 0.957 | 0.910 | 0.844 | 0.758 | 0.676 | 0.627 | 0.570 | 0.519 |
| | F_{B} | 0.974 | 0.988 | 1.005 | 1.016 | 1.002 | 0.961 | 0.911 | 0.853 | 0.773 | 0.685 | 0.607 | 0.559 | 0.553 | 0.528 |
| N = 16 | F_{A} | 1.003 | 1.002 | 0.999 | 0.992 | 0.977 | 0.943 | 0.895 | 0.853 | 0.797 | 0.721 | 0.645 | 0.599 | 0.546 | 0.498 |
| | F_{B} | 0.990 | 0.996 | 1.002 | 0.997 | 0.969 | 0.925 | 0.875 | 0.825 | 0.755 | 0.673 | 0.597 | 0.547 | 0.540 | 0.514 |
| N = 32 | F_{A} | 1.020 | 1.023 | 0.990 | 0.946 | 0.907 | 0.867 | 0.821 | 0.784 | 0.740 | 0.676 | 0.604 | 0.557 | 0.506 | 0.460 |
| | F_{B} | 1.026 | 1.021 | 0.991 | 0.952 | 0.912 | 0.871 | 0.830 | 0.795 | 0.739 | 0.668 | 0.594 | 0.540 | 0.520 | 0.487 |
| N = 64 | F_{A} | 1.016 | 1.067 | 0.971 | 0.879 | 0.818 | 0.776 | 0.739 | 0.711 | 0.681 | 0.631 | 0.566 | 0.516 | 0.503 | 0.473 |
| | F_{B} | 1.116 | 1.082 | 0.965 | 0.876 | 0.825 | 0.791 | 0.759 | 0.740 | 0.706 | 0.653 | 0.584 | 0.527 | 0.493 | 0.452 |
| N = 128 | F_{A} | 1.136 | 1.146 | 0.937 | 0.801 | 0.729 | 0.685 | 0.652 | 0.634 | 0.617 | 0.583 | 0.531 | 0.484 | 0.459 | 0.426 |
| | F_{B} | 1.348 | 1.161 | 0.930 | 0.803 | 0.746 | 0.718 | 0.694 | 0.686 | 0.669 | 0.632 | 0.574 | 0.522 | 0.485 | 0.481 |
| N = 256 | F_{A} | 1.311 | 1.213 | 0.908 | 0.742 | 0.668 | 0.640 | 0.616 | 0.604 | 0.595 | 0.572 | 0.528 | 0.484 | 0.453 | 0.448 |
| | F_{B} | 1.572 | 1.221 | 0.905 | 0.751 | 0.682 | 0.658 | 0.640 | 0.634 | 0.631 | 0.605 | 0.561 | 0.517 | 0.482 | 0.461 |
| N = 512 | F_{A} | 1.429 | 1.229 | 0.901 | 0.730 | 0.657 | 0.640 | 0.627 | 0.622 | 0.623 | 0.607 | 0.570 | 0.534 | 0.512 | 0.485 |
| | F_{B} | 1.662 | 1.225 | 0.903 | 0.749 | 0.681 | 0.657 | 0.642 | 0.641 | 0.643 | 0.624 | 0.583 | 0.544 | 0.517 | 0.512 |

To see that convergence is reached at N=128, the values of F_{A}(d₁) obtained with N=128 are compared to values of F_{A}(d₁) obtained with N=64 (or N=256) for all input values d₁ with the same market data in order to determine if the difference in the values is less than a predefined convergence threshold value (e.g., 0.03) for all input values d₁. Similarly, values of F_{B}(d₁) obtained with N=128 are compared to values of F_{B}(d₁) obtained with N=64 (or N=256) for all input values d₁ with the same market data in order to determine if the difference in the values are less than a predefined convergence threshold value (e.g., 0.03) for all input values d₁. If, for example, the values at N=256 are very close to the values at N=128 for all d₁ for both F_{A}(d₁) and F_{B}(d₁), then N=128 may be said to be accurate. If the values of N=128 are the same as those for N=64, then N=64 is said to be accurate enough, and convergence is achieved at N=64 or smaller. However, if the values at N=64 are different from the values at N=128, then convergence is said to be achieved at N=128.

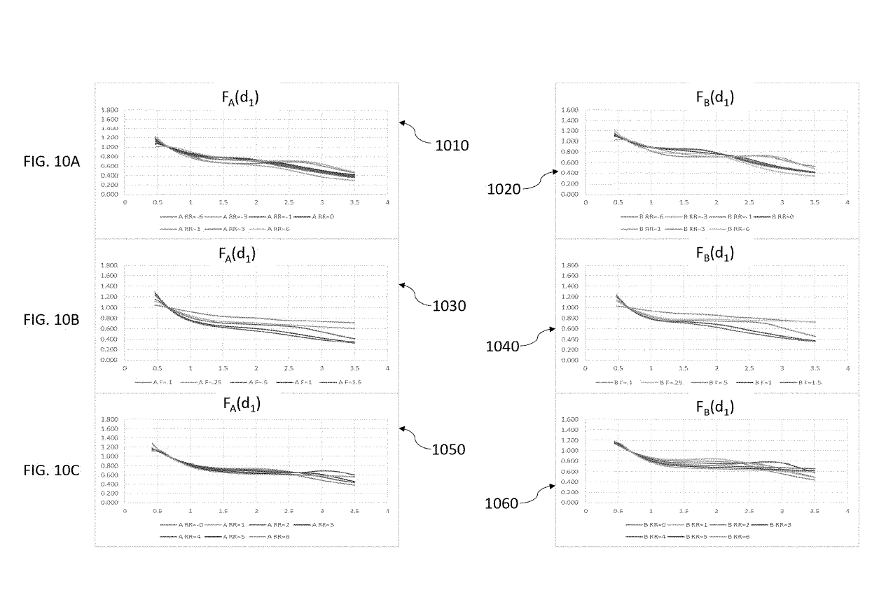

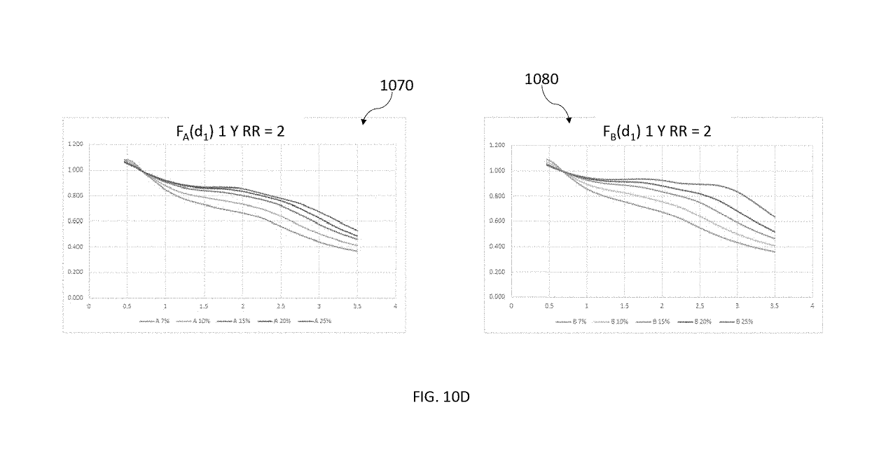

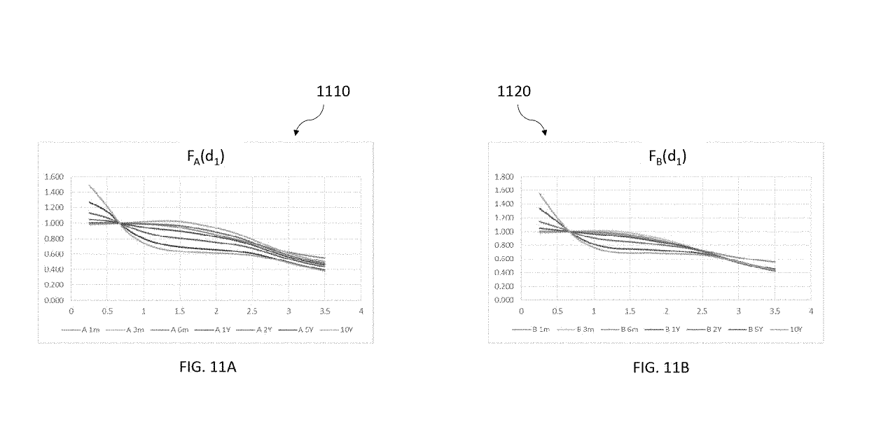

FIGS. 10A-D are illustrative graphs illustrating the influence of twenty-five delta risk reversal, twenty-five delta butterfly, and ATM volatility on a first shape function F_{A}(d₁) and a second shape function F_{B}(d₁), in accordance with various embodiments. In FIG. 10A, graphs of functions F_{A}(d₁) and F_{B}(d₁) are shown for seven different values of 25 Δ_{RR}—three positive values, three negative values, and zero—for a fixed σ₀ and 25 Δ_{Fly}. In this illustrative graph, N=128. For instance, graphs 1010 and 1020 of FIG. 10A correspond to first market data, where σ₀=15, 25 Δ_{Fly}=0.75, and seven values of 25 Δ_{RR} are compared (e.g., 25 Δ_{RR}=−6, −3, −1, 0, 1, 3, 6), where the behavior of functions F_{A}(d₁) and F_{B} (d₁) can be seen for where a sign of 25 Δ_{RR} flips (e.g., 25 Δ_{RR}=−1 to 1).

In FIG. 10B, graphs of functions F_{A}(d₁) and F_{B} (d₁) are shown for five different values of 25 Δ_{Fly}, for a fixed σ₀ and 25 Δ_{RR}. For instance, graphs 1030 and 1040 of FIG. 10B corresponds to second market data where σ₀=15, 25 Δ_{RR}=2.5, and 25 Δ_{Fly}=0.1, 0.25, 0.5, 1.0, and 1.5.

In FIG. 10C, graphs of functions F_{A}(d₁) and F_{B} (d₁) are shown for seven different values of 25 Δ_{RR}—all zero or greater—for a fixed σ₀ and 25 Δ_{Fly}. For instance, graphs 1050 and 1060 of FIG. 10C correspond to third market data, where σ₀=18, 25 Δ_{Fly}=0.5, and 25 Δ_{RR}=0, 1, 2, 3, 4, 5, and 6. For each of the market data input values, the expiry in the graphs are equal. For example, in this particular instance, the expiry may be set at one year.

In FIG. 10D, graphs of functions F_{A}(d₁) and F_{B} (d₁) are shown for different values of σ₀ for fixed 25 Δ_{RR} and 25 Δ_{Fly}. For instance, graphs 1070 and 1080 of FIG. 10D correspond to fourth market data, where σ₀=7%, 10%, 15%, 20%, 25%, and where 25 Δ_{RR}=2%, 25 Δ_{Fly}=0.5% and the expiry is 1 year.

Tables 13-15 may further describe the exemplary graphs of FIGS. 10A-C.

TABLE 13

| d₁ | 0.25 | 0.5 | 0.75 | 1 | 1.25 | 1.5 | 1.75 | 2 | 2.25 | 2.5 | 2.75 | 3 | 3.25 | 3.5 |
|---|---|---|---|---|---|---|---|---|---|---|---|---|---|---|
| F_{A} RR = −6 | 0.872 | 1.081 | 0.965 | 0.807 | 0.712 | 0.671 | 0.658 | 0.659 | 0.673 | 0.689 | 0.674 | 0.607 | 0.524 | 0.456 |
| F_{B} RR = −6 | 0.976 | 1.088 | 0.962 | 0.816 | 0.738 | 0.711 | 0.707 | 0.702 | 0.714 | 0.726 | 0.713 | 0.650 | 0.580 | 0.529 |
| F_{A} RR = −3 | 1.560 | 1.184 | 0.920 | 0.776 | 0.700 | 0.664 | 0.645 | 0.619 | 0.580 | 0.514 | 0.437 | 0.375 | 0.329 | 0.294 |
| F_{B} RR = −3 | 1.452 | 1.149 | 0.936 | 0.825 | 0.779 | 0.772 | 0.767 | 0.725 | 0.661 | 0.566 | 0.474 | 0.409 | 0.369 | 0.346 |
| F_{A} RR = −1 | 1.493 | 1.143 | 0.938 | 0.824 | 0.763 | 0.736 | 0.725 | 0.699 | 0.638 | 0.568 | 0.505 | 0.450 | 0.402 | 0.361 |
| F_{B} RR = −1 | 1.387 | 1.109 | 0.953 | 0.875 | 0.847 | 0.845 | 0.837 | 0.785 | 0.691 | 0.603 | 0.534 | 0.481 | 0.439 | 0.407 |
| F_{A} RR = 0 | 1.392 | 1.122 | 0.947 | 0.845 | 0.789 | 0.765 | 0.753 | 0.720 | 0.659 | 0.592 | 0.529 | 0.472 | 0.422 | 0.378 |
| F_{B} RR = 0 | 1.316 | 1.092 | 0.960 | 0.891 | 0.864 | 0.858 | 0.842 | 0.785 | 0.698 | 0.618 | 0.549 | 0.493 | 0.446 | 0.407 |
| F_{A} RR = 1 | 1.266 | 1.100 | 0.957 | 0.863 | 0.810 | 0.786 | 0.769 | 0.734 | 0.681 | 0.617 | 0.553 | 0.495 | 0.443 | 0.398 |
| F_{B} RR = 1 | 1.247 | 1.083 | 0.964 | 0.897 | 0.867 | 0.856 | 0.835 | 0.784 | 0.710 | 0.633 | 0.565 | 0.508 | 0.459 | 0.417 |
| F_{A} RR = 3 | 1.114 | 1.080 | 0.966 | 0.870 | 0.810 | 0.778 | 0.750 | 0.723 | 0.692 | 0.638 | 0.568 | 0.504 | 0.453 | 0.415 |
| F_{B} RR = 3 | 1.152 | 1.077 | 0.967 | 0.887 | 0.848 | 0.824 | 0.794 | 0.762 | 0.723 | 0.661 | 0.583 | 0.513 | 0.456 | 0.412 |
| F_{A} RR = 6 | 0.854 | 1.017 | 0.993 | 0.900 | 0.823 | 0.769 | 0.731 | 0.712 | 0.707 | 0.708 | 0.699 | 0.645 | 0.552 | 0.466 |
| F_{B} RR = 6 | 0.936 | 1.029 | 0.988 | 0.889 | 0.812 | 0.759 | 0.720 | 0.705 | 0.709 | 0.724 | 0.732 | 0.684 | 0.584 | 0.481 |

TABLE 14

| d₁ | 0.25 | 0.5 | 0.75 | 1 | 1.25 | 1.5 | 1.75 | 2 | 2.25 | 2.5 | 2.75 | 3 | 3.25 | 3.5 |
|---|---|---|---|---|---|---|---|---|---|---|---|---|---|---|
| F_{A} RR = .1 | 1.065 | 1.040 | 0.983 | 0.920 | 0.868 | 0.833 | 0.816 | 0.804 | 0.780 | 0.756 | 0.751 | 0.737 | 0.723 | 0.710 |
| F_{B} RR = .1 | 1.049 | 1.029 | 0.988 | 0.942 | 0.906 | 0.886 | 0.876 | 0.858 | 0.826 | 0.811 | 0.789 | 0.767 | 0.746 | 0.726 |
| F_{A} RR = .25 | 1.113 | 1.098 | 0.958 | 0.844 | 0.774 | 0.736 | 0.718 | 0.707 | 0.686 | 0.671 | 0.654 | 0.637 | 0.621 | 0.605 |
| F_{B} RR = .25 | 1.169 | 1.097 | 0.958 | 0.853 | 0.795 | 0.779 | 0.783 | 0.779 | 0.769 | 0.762 | 0.755 | 0.748 | 0.741 | 0.734 |
| F_{A} RR = .5 | 1.228 | 1.132 | 0.943 | 0.814 | 0.742 | 0.706 | 0.691 | 0.679 | 0.663 | 0.646 | 0.609 | 0.542 | 0.471 | 0.413 |
| F_{B} RR = .5 | 1.270 | 1.125 | 0.946 | 0.830 | 0.772 | 0.760 | 0.758 | 0.746 | 0.737 | 0.732 | 0.699 | 0.623 | 0.536 | 0.459 |
| F_{A} RR = 1 | 1.468 | 1.190 | 0.918 | 0.766 | 0.688 | 0.652 | 0.629 | 0.605 | 0.574 | 0.525 | 0.472 | 0.424 | 0.382 | 0.347 |
| F_{B} RR = 1 | 1.496 | 1.173 | 0.925 | 0.798 | 0.746 | 0.735 | 0.714 | 0.685 | 0.639 | 0.576 | 0.515 | 0.462 | 0.415 | 0.376 |
| F_{A} RR = 1.5 | 1.610 | 1.214 | 0.907 | 0.746 | 0.666 | 0.627 | 0.592 | 0.560 | 0.520 | 0.476 | 0.432 | 0.391 | 0.354 | 0.321 |
| F_{B} RR = 1.5 | 1.617 | 1.191 | 0.918 | 0.787 | 0.734 | 0.712 | 0.675 | 0.633 | 0.574 | 0.519 | 0.470 | 0.429 | 0.392 | 0.359 |

TABLE 15

| d₁ | 0.25 | 0.5 | 0.75 | 1 | 1.25 | 1.5 | 1.75 | 2 | 2.25 | 2.5 | 2.75 | 3 | 3.25 | 3.5 |
|---|---|---|---|---|---|---|---|---|---|---|---|---|---|---|
| F_{A} RR = −0 | 1.571 | 1.158 | 0.931 | 0.808 | 0.743 | 0.712 | 0.704 | 0.710 | 0.693 | 0.631 | 0.558 | 0.490 | 0.431 | 0.382 |
| F_{B} RR = 0 | 1.390 | 1.112 | 0.952 | 0.865 | 0.827 | 0.824 | 0.839 | 0.844 | 0.802 | 0.718 | 0.633 | 0.558 | 0.495 | 0.441 |
| F_{A} RR = 1 | 1.333 | 1.121 | 0.948 | 0.838 | 0.778 | 0.750 | 0.745 | 0.747 | 0.727 | 0.684 | 0.624 | 0.557 | 0.495 | 0.441 |
| F_{B} RR = 1 | 1.288 | 1.101 | 0.956 | 0.870 | 0.831 | 0.827 | 0.840 | 0.841 | 0.809 | 0.757 | 0.688 | 0.614 | 0.547 | 0.490 |
| F_{A} RR = 2 | 1.264 | 1.115 | 0.950 | 0.838 | 0.774 | 0.742 | 0.730 | 0.722 | 0.702 | 0.675 | 0.632 | 0.566 | 0.495 | 0.435 |
| F_{B} RR = 2 | 1.256 | 1.104 | 0.955 | 0.857 | 0.809 | 0.799 | 0.803 | 0.795 | 0.776 | 0.761 | 0.723 | 0.648 | 0.566 | 0.493 |
| F_{A} RR = 3 | 1.185 | 1.118 | 0.949 | 0.827 | 0.759 | 0.722 | 0.704 | 0.691 | 0.673 | 0.662 | 0.651 | 0.614 | 0.542 | 0.462 |
| F_{B} RR = 3 | 1.237 | 1.116 | 0.950 | 0.838 | 0.780 | 0.765 | 0.762 | 0.752 | 0.748 | 0.765 | 0.786 | 0.763 | 0.683 | 0.580 |
| F_{A} RR = 4 | 1.094 | 1.127 | 0.945 | 0.812 | 0.739 | 0.700 | 0.677 | 0.661 | 0.647 | 0.646 | 0.667 | 0.697 | 0.677 | 0.599 |
| F_{B} RR = 4 | 1.222 | 1.133 | 0.942 | 0.815 | 0.750 | 0.732 | 0.723 | 0.713 | 0.703 | 0.694 | 0.685 | 0.675 | 0.666 | 0.658 |
| F_{A} RR = 5 | 1.020 | 1.134 | 0.942 | 0.799 | 0.720 | 0.677 | 0.650 | 0.634 | 0.624 | 0.611 | 0.599 | 0.587 | 0.576 | 0.564 |
| F_{B} RR = 5 | 1.203 | 1.144 | 0.938 | 0.800 | 0.729 | 0.706 | 0.693 | 0.684 | 0.672 | 0.662 | 0.651 | 0.640 | 0.630 | 0.620 |
| F_{A} RR = 6 | 0.987 | 1.145 | 0.937 | 0.782 | 0.700 | 0.657 | 0.630 | 0.617 | 0.611 | 0.602 | 0.593 | 0.585 | 0.576 | 0.567 |
| F_{B} RR = 6 | 1.188 | 1.160 | 0.931 | 0.779 | 0.701 | 0.677 | 0.663 | 0.657 | 0.646 | 0.637 | 0.627 | 0.617 | 0.608 | 0.598 |

As an illustrative example, if A and B are known for two sets of market data, then A and B can also be calculated for a set of market data between the two sets of market data using interpolation techniques. This approach yields a substantially reasonable approximation for A and B.

As a first example, A and B are calculated for a first set of market data: σ₀=15, 25 Δ_{RR}=2.5, and 25 Δ_{Fly}=1. In this particular example, two additional sets of market data are known: (i) a second set of market data having σ₀=15, 25 Δ_{RR}=2.5, and 25 Δ_{Fly}=0.5; and (ii) a third set of market data having σ₀=15, 25 Δ_{RR}=2.5, and 25 Δ_{Fly}=1.5. Furthermore, for the first, second, and third sets of market data, expiration is one year. The first set of market data, therefore, has the same values for σ₀ and 25 Δ_{RR} as the second and third sets of market data, while 25 Δ_{Fly} for the first set of market data resides between the values of the second and third sets of market data. Using the first, second, and third sets of market data, Table 16 is produced for values of d₁.

TABLE 16

| d₁ | 0.25 | 0.5 | 0.75 | 1 | 1.25 | 1.5 | 1.75 | 2 | 2.25 | 2.5 | 2.75 | 3 | 3.25 | 3.5 |
|---|---|---|---|---|---|---|---|---|---|---|---|---|---|---|
| A F = .5 | 1.228 | 1.132 | 0.943 | 0.814 | 0.742 | 0.706 | 0.691 | 0.679 | 0.663 | 0.646 | 0.609 | 0.542 | 0.471 | 0.413 |
| B F = .5 | 1.270 | 1.125 | 0.946 | 0.830 | 0.772 | 0.760 | 0.758 | 0.746 | 0.737 | 0.732 | 0.699 | 0.623 | 0.536 | 0.459 |
| A F = 1 | 1.468 | 1.190 | 0.918 | 0.766 | 0.688 | 0.652 | 0.629 | 0.605 | 0.574 | 0.525 | 0.472 | 0.424 | 0.382 | 0.347 |
| B F = 1 | 1.496 | 1.173 | 0.925 | 0.798 | 0.746 | 0.735 | 0.714 | 0.685 | 0.639 | 0.576 | 0.515 | 0.462 | 0.415 | 0.376 |
| A F = 1.5 | 1.610 | 1.214 | 0.907 | 0.746 | 0.666 | 0.627 | 0.592 | 0.560 | 0.520 | 0.476 | 0.432 | 0.391 | 0.354 | 0.321 |
| B F = 1.5 | 1.617 | 1.191 | 0.918 | 0.787 | 0.734 | 0.712 | 0.675 | 0.633 | 0.574 | 0.519 | 0.470 | 0.429 | 0.392 | 0.359 |

Using the values obtained from Table 16, interpolation techniques, such as linear interpolation, can be used to calculate A and B, which are then compared with the values for A and B obtained directly, as seen from Table 17.

TABLE 17

| d₁ | 0.25 | 0.5 | 0.75 | 1 | 1.25 | 1.5 | 1.75 | 2 | 2.25 | 2.5 | 2.75 | 3 | 3.25 | 3.5 |
|---|---|---|---|---|---|---|---|---|---|---|---|---|---|---|
| A | 1.468 | 1.190 | 0.918 | 0.766 | 0.688 | 0.652 | 0.629 | 0.605 | 0.574 | 0.525 | 0.472 | 0.424 | 0.382 | 0.347 |
| Acalc | 1.419 | 1.173 | 0.925 | 0.780 | 0.704 | 0.666 | 0.641 | 0.619 | 0.592 | 0.561 | 0.520 | 0.467 | 0.413 | 0.367 |
| B | 1.496 | 1.173 | 0.925 | 0.798 | 0.746 | 0.735 | 0.714 | 0.685 | 0.639 | 0.576 | 0.515 | 0.462 | 0.415 | 0.376 |
| Bcalc | 1.443 | 1.158 | 0.932 | 0.808 | 0.753 | 0.736 | 0.716 | 0.689 | 0.655 | 0.625 | 0.585 | 0.526 | 0.464 | 0.409 |

As seen from Table 18, the calculated values for A and B are substantially similar to the values of A and B obtained from interpolation (e.g., linear interpolation) of the surrounding sets of market data.

TABLE 18

| | | | | | | | | | | | | | | |
|---|---|---|---|---|---|---|---|---|---|---|---|---|---|---|
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |

[symbol]

indicates data missing or illegible when filed

As a second example, A and B are calculated for a first set of market data—σ₀=18, 25 Δ_{RR}=1, and 25 Δ_{Fly}=0.5, with an expiration of 1 year—using a linear interpolation technique and comparing the calculated values of A and B to the values of A and B obtained directly. A second set of market data has σ₀=18, 25 Δ_{RR}=0, and 25 Δ_{Fly}=0.5, and a third set of market data has σ₀=18, 25 Δ_{RR}=2, and 25 Δ_{Fly}=0.5. Table 19 illustrates the values of A and B obtained for different values of d₁.

TABLE 19

| d₁ | 0.25 | 0.5 | 0.75 | 1 | 1.25 | 1.5 | 1.75 | 2 | 2.25 | 2.5 | 2.75 | 3 | 3.25 | 3.5 |
|---|---|---|---|---|---|---|---|---|---|---|---|---|---|---|
| A RR = 0 | 1.856 | 1.211 | 0.909 | 0.759 | 0.687 | 0.657 | 0.652 | 0.658 | 0.649 | 0.598 | 0.530 | 0.465 | 0.409 | 0.361 |
| B RR = 0 | 1.592 | 1.156 | 0.933 | 0.817 | 0.769 | 0.764 | 0.787 | 0.804 | 0.781 | 0.706 | 0.619 | 0.536 | 0.465 | 0.408 |
| A RR = 1 | 1.515 | 1.169 | 0.927 | 0.790 | 0.722 | 0.696 | 0.693 | 0.696 | 0.683 | 0.648 | 0.595 | 0.533 | 0.475 | 0.423 |
| B RR = 1 | 1.436 | 1.141 | 0.939 | 0.825 | 0.774 | 0.766 | 0.782 | 0.792 | 0.772 | 0.729 | 0.668 | 0.597 | 0.533 | 0.479 |
| A RR = 2 | 1.395 | 1.167 | 0.928 | 0.784 | 0.713 | 0.686 | 0.678 | 0.673 | 0.664 | 0.647 | 0.618 | 0.562 | 0.496 | 0.436 |
| B RR = 2 | 1.396 | 1.150 | 0.935 | 0.807 | 0.746 | 0.731 | 0.738 | 0.739 | 0.732 | 0.728 | 0.709 | 0.649 | 0.574 | 0.505 |

Using the values obtained from Table 19, linear interpolation techniques can be used to calculate A and B, which are then compared with the values for A and B obtained directly, as seen from Table 20.

TABLE 20

| d₁ | 0.25 | 0.5 | 0.75 | 1 | 1.25 | 1.5 | 1.75 | 2 | 2.25 | 2.5 | 2.75 | 3 | 3.25 | 3.5 |
|---|---|---|---|---|---|---|---|---|---|---|---|---|---|---|
| A | 1.515 | 1.169 | 0.927 | 0.790 | 0.722 | 0.696 | 0.693 | 0.696 | 0.683 | 0.648 | 0.595 | 0.533 | 0.475 | 0.423 |
| Acalc | 1.626 | 1.189 | 0.918 | 0.772 | 0.700 | 0.671 | 0.665 | 0.665 | 0.656 | 0.623 | 0.574 | 0.514 | 0.453 | 0.399 |
| B | 1.436 | 1.141 | 0.939 | 0.825 | 0.774 | 0.766 | 0.782 | 0.792 | 0.772 | 0.729 | 0.668 | 0.597 | 0.533 | 0.479 |
| Bcalc | 1.494 | 1.153 | 0.934 | 0.812 | 0.757 | 0.747 | 0.762 | 0.771 | 0.756 | 0.717 | 0.664 | 0.592 | 0.520 | 0.456 |

As seen from Table 21, the calculated values for A and B are substantially similar to the values of A and B obtained from interpolation of the surrounding sets of market data.

TABLE 21

| | | | | | | | | | | | | | | |
|---|---|---|---|---|---|---|---|---|---|---|---|---|---|---|
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |

[symbol]

indicates data missing or illegible when filed

Tables 16-18 and Tables 19-21 illustrate that it is possible to pre-calculate tables of A and B for large sets of market data and then, using interpolation, obtain relatively good approximations for values of A and B residing between the values of A and B that are already obtained. However, persons of ordinary skill in the art will recognize that although in the aforementioned example a linear interpolation technique is employed, any suitable interpolation technique (e.g., a cubic spline interpolation) may be used.

FIGS. 11A and 11B are illustrative graphs of a first shape function F_{A}(d₁) and a second shape function F_{B}(d₁) for different expiries using the same market data, in accordance with various embodiments. In the illustrative embodiment, graphs 1110 and 1120 correspond to market data input values chosen where σ₀=18, 25 Δ_{RR}=3, and 25 Δ_{Fly}=0.75, however this is merely exemplary. Various different expiries may be used, such as, and without limitation, 1 month, 3 months, 6 months, 1 year, 2 years, 5 years, and 10 years. As illustrated by FIGS. 11A and 11B, for expiries up to 1 year, both first and second functions F_{A}(d₁) and F_{B}(d₁) are substantially independent of the expiration time. However, beyond one year, both functions F_{A}(d₁) and F_{B}(d₁) change moderately with expiry. Furthermore, in the exemplary embodiment, N is selected to be 256, however persons of ordinary skill in the art will recognize that any suitable value for N may be used.

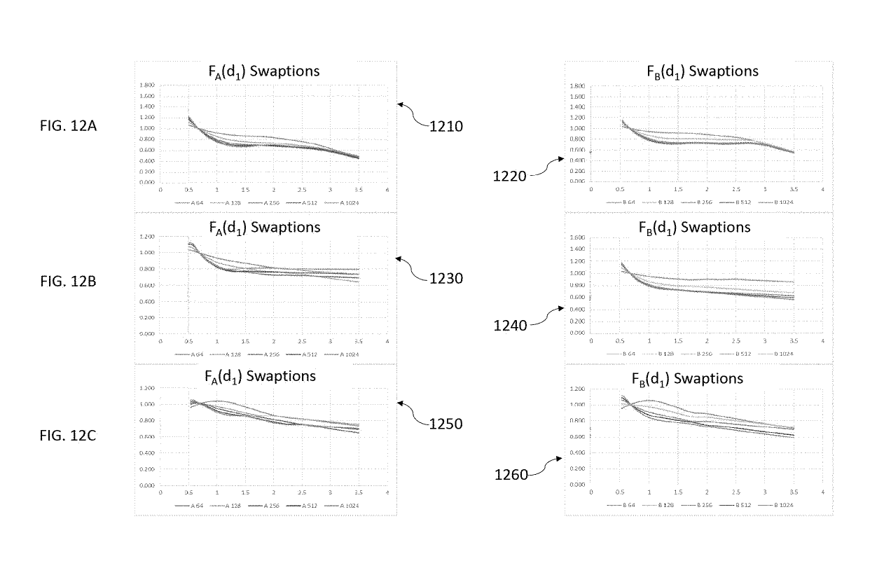

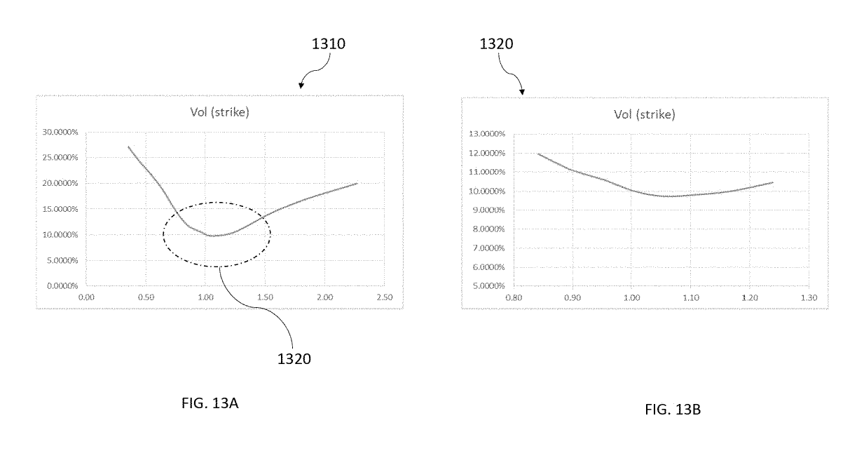

FIGS. 12A-C are illustrative graphs of a first shape function F_{A}(d₁) and a second shape function F_{B}(d₁) for swaptions, in accordance with various embodiments. For instance, three different sets of term structures are used for these swaptions graphs. In the non-limiting embodiment, functions F_{A}(d₁) and F_{B}(d₁) correspond to interest rates for 5Y5Y swaptions (e.g., swaptions with expiry 5 years and underlying swap of 5 years). In the illustrative example, the 5Y5Y swaption forward rate corresponds to 5%, and the 5 year discounting rate corresponds to 4%. In FIGS. 12A-C, graphs of functions F_{A}(d₁) and F_{B}(d₁) are shown for three different sets of term structures as related to different values of N (e.g., N=64, 126, 256, 512, and 1024). The market data, for instance, are substantially similar to that of FIGS. 8A-C. For example, graphs 1210 and 1220 of FIG. 12A may correspond to first term structures, where σ₀=10, 25 Δ_{RR}=1, and 25 Δ_{Fly}=0.25. Graphs 1230 and 1240 of FIG. 12B may correspond to second term structures, where σ₀=18, 25 Δ_{RR}=3, and 25 Δ_{Fly}=0.75. Graphs 1250 and 1260 of FIG. 12C may correspond to third term structures, where σ₀=25, 25 Δ_{RR}=6, and 25 Δ_{Fly}=1.5. As seen from FIGS. 12A-C, first and second functions F_{A}(d₁) and F_{B}(d₁) converge for N=256. As such, the influence of annuity An on A and B is substantially small. Tables 22-24 may further describe the exemplary graphs of FIGS. 12A-C.

TABLE 22

| | d₁ | 0.25 | 0.5 | 0.75 | 1 | 1.25 | 1.5 | 1.75 | 2 | 2.25 | 2.5 | 2.75 | 3 | 3.25 | 3.5 |
|---|---|---|---|---|---|---|---|---|---|---|---|---|---|---|---|
| N = 64 | F_{A} | 1.128 | 1.055 | 0.976 | 0.914 | 0.876 | 0.859 | 0.851 | 0.830 | 0.795 | 0.757 | 0.703 | 0.628 | 0.550 | 0.485 |
| | F_{B} | 1.114 | 1.042 | 0.982 | 0.942 | 0.922 | 0.915 | 0.906 | 0.884 | 0.856 | 0.832 | 0.786 | 0.708 | 0.619 | 0.541 |
| N = 128 | F_{A} | 1.257 | 1.109 | 0.953 | 0.846 | 0.785 | 0.754 | 0.739 | 0.729 | 0.706 | 0.681 | 0.649 | 0.591 | 0.520 | 0.455 |
| | F_{B} | 1.248 | 1.098 | 0.958 | 0.865 | 0.818 | 0.807 | 0.807 | 0.803 | 0.790 | 0.789 | 0.777 | 0.720 | 0.642 | 0.565 |
| N = 256 | F_{A} | 1.375 | 1.159 | 0.931 | 0.792 | 0.723 | 0.698 | 0.689 | 0.676 | 0.659 | 0.637 | 0.615 | 0.570 | 0.506 | 0.443 |
| | F_{B} | 1.388 | 1.147 | 0.936 | 0.810 | 0.749 | 0.733 | 0.737 | 0.733 | 0.726 | 0.730 | 0.733 | 0.698 | 0.629 | 0.558 |
| N = 512 | F_{A} | 1.464 | 1.188 | 0.919 | 0.766 | 0.696 | 0.679 | 0.688 | 0.683 | 0.665 | 0.647 | 0.629 | 0.585 | 0.522 | 0.459 |
| | F_{B} | 1.490 | 1.172 | 0.926 | 0.788 | 0.727 | 0.714 | 0.723 | 0.717 | 0.707 | 0.714 | 0.720 | 0.682 | 0.614 | 0.545 |
| N = 1024 | F_{A} | 1.541 | 1.210 | 0.909 | 0.747 | 0.676 | 0.663 | 0.686 | 0.697 | 0.677 | 0.660 | 0.643 | 0.601 | 0.538 | 0.476 |
| | F_{B} | 1.583 | 1.193 | 0.917 | 0.774 | 0.714 | 0.707 | 0.723 | 0.721 | 0.703 | 0.709 | 0.716 | 0.681 | 0.612 | 0.543 |

TABLE 23

| | d₁ | 0.25 | 0.5 | 0.75 | 1 | 1.25 | 1.5 | 1.75 | 2 | 2.25 | 2.5 | 2.75 | 3 | 3.25 | 3.5 |
|---|---|---|---|---|---|---|---|---|---|---|---|---|---|---|---|
| N = 64 | F_{A} | 1.039 | 1.037 | 0.984 | 0.935 | 0.900 | 0.872 | 0.840 | 0.816 | 0.798 | 0.805 | 0.797 | 0.797 | 0.796 | 0.796 |
| | F_{B} | 1.067 | 1.034 | 0.985 | 0.947 | 0.921 | 0.905 | 0.893 | 0.902 | 0.897 | 0.904 | 0.888 | 0.880 | 0.869 | 0.858 |
| N = 128 | F_{A} | 0.985 | 1.072 | 0.969 | 0.882 | 0.836 | 0.808 | 0.779 | 0.769 | 0.751 | 0.735 | 0.710 | 0.687 | 0.664 | 0.642 |
| | F_{B} | 1.166 | 1.098 | 0.958 | 0.862 | 0.813 | 0.790 | 0.782 | 0.766 | 0.751 | 0.737 | 0.722 | 0.708 | 0.694 | 0.680 |
| N = 256 | F_{A} | 0.833 | 1.106 | 0.954 | 0.837 | 0.783 | 0.767 | 0.740 | 0.726 | 0.726 | 0.719 | 0.712 | 0.705 | 0.699 | 0.692 |
| | F_{B} | 1.283 | 1.151 | 0.935 | 0.810 | 0.753 | 0.729 | 0.706 | 0.684 | 0.662 | 0.641 | 0.621 | 0.602 | 0.583 | 0.564 |
| N = 512 | F_{A} | 0.808 | 1.126 | 0.946 | 0.822 | 0.775 | 0.777 | 0.768 | 0.766 | 0.761 | 0.756 | 0.750 | 0.745 | 0.740 | 0.735 |
| | F_{B} | 1.362 | 1.178 | 0.923 | 0.792 | 0.738 | 0.724 | 0.703 | 0.687 | 0.670 | 0.654 | 0.638 | 0.623 | 0.608 | 0.594 |
| N = 1024 | F_{A} | 0.779 | 1.127 | 0.946 | 0.832 | 0.796 | 0.810 | 0.814 | 0.813 | 0.805 | 0.788 | 0.769 | 0.761 | 0.748 | 0.736 |
| | F_{B} | 1.381 | 1.191 | 0.918 | 0.784 | 0.735 | 0.727 | 0.709 | 0.697 | 0.684 | 0.672 | 0.660 | 0.648 | 0.637 | 0.625 |

TABLE 24

| | d₁ | 0.25 | 0.5 | 0.75 | 1 | 1.25 | 1.5 | 1.75 | 2 | 2.25 | 2.5 | 2.75 | 3 | 3.25 | 3.5 |
|---|---|---|---|---|---|---|---|---|---|---|---|---|---|---|---|
| N = 64 | F_{A} | 0.866 | 0.953 | 1.020 | 1.043 | 1.021 | 0.966 | 0.914 | 0.866 | 0.834 | 0.820 | 0.798 | 0.777 | 0.756 | 0.736 |
| | F_{B} | 0.855 | 0.944 | 1.023 | 1.055 | 1.023 | 0.961 | 0.904 | 0.890 | 0.856 | 0.824 | 0.793 | 0.763 | 0.734 | 0.706 |
| N = 128 | F_{A} | 0.725 | 0.985 | 1.006 | 0.972 | 0.937 | 0.894 | 0.861 | 0.856 | 0.838 | 0.820 | 0.803 | 0.786 | 0.770 | 0.753 |
| | F_{B} | 0.946 | 1.009 | 0.996 | 0.972 | 0.938 | 0.892 | 0.849 | 0.845 | 0.823 | 0.801 | 0.779 | 0.759 | 0.738 | 0.719 |
| N = 256 | F_{A} | 0.466 | 0.985 | 1.006 | 0.948 | 0.908 | 0.871 | 0.843 | 0.812 | 0.783 | 0.754 | 0.726 | 0.700 | 0.674 | 0.650 |
| | F_{B} | 0.955 | 1.061 | 0.974 | 0.908 | 0.867 | 0.827 | 0.793 | 0.791 | 0.774 | 0.757 | 0.740 | 0.724 | 0.708 | 0.692 |
| N = 512 | F_{A} | 0.456 | 1.008 | 0.995 | 0.918 | 0.879 | 0.854 | 0.820 | 0.784 | 0.759 | 0.752 | 0.737 | 0.722 | 0.707 | 0.693 |
| | F_{B} | 0.927 | 1.087 | 0.964 | 0.872 | 0.834 | 0.806 | 0.781 | 0.745 | 0.731 | 0.708 | 0.685 | 0.663 | 0.642 | 0.622 |
| N = 1024 | F_{A} | 0.326 | 1.027 | 0.987 | 0.902 | 0.863 | 0.852 | 0.814 | 0.774 | 0.750 | 0.749 | 0.737 | 0.725 | 0.714 | 0.702 |
| | F_{B} | 0.914 | 1.117 | 0.951 | 0.839 | 0.798 | 0.778 | 0.757 | 0.725 | 0.706 | 0.681 | 0.658 | 0.635 | 0.613 | 0.592 |

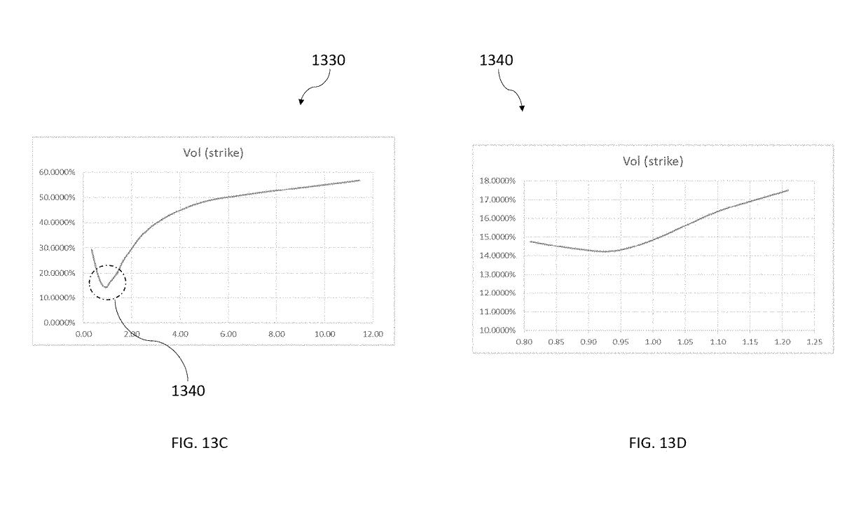

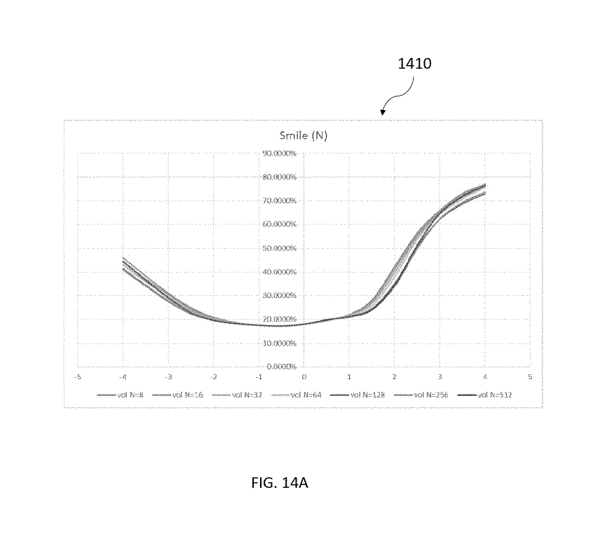

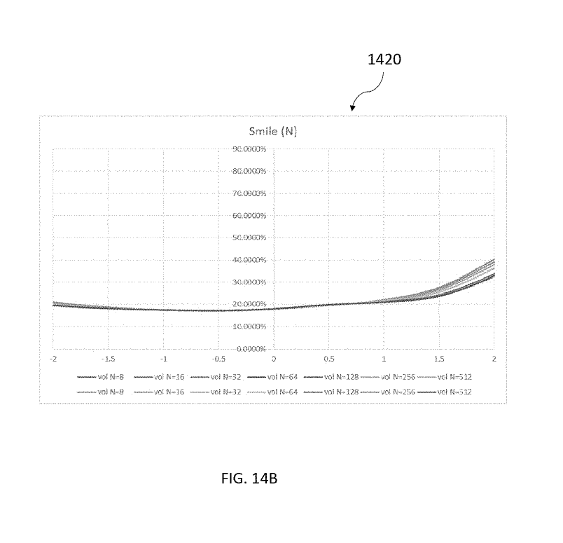

FIGS. 13A-D are illustrative graphs of the volatility smile, in accordance with various embodiments. In graphs 1310 and 1320 of FIGS. 13A and 13B, expiry is 1 year, and σ₀=10, 25 Δ_{RR}=1, and 25 Δ_{Fly}=0.25. Table 25 corresponds to volatility smile values for varying values of strikes and d₁. In particular, graphs 1320 corresponds to a zoomed-in portion of graph 1310 associated with the volatility smile in the liquid area around the ATM volatility. As seen from graph 1320, the minimum point corresponds to K≈1.10. In graphs 1330 and 1340 of FIGS. 13C and 13D, expiry is also set at 1 year, and σ₀=15, 25 Δ_{RR}=2.5, and 25 Δ_{Fly}=0.5. Table 26 corresponds to volatility smile values for varying values of strikes and d₁. In particular, graph 1340 corresponds to a zoomed-in portion of graph 1330 associated with a minimum value for the volatility smile. As seen from graph 1340, the minimum point corresponds to K≈0.94.

TABLE 25

| −d₁ | −3 | −2.000 | −1.500 | −1.000 | −0.500 | 0.000 | 0.500 | 1.000 | 1.500 | 2.000 | 3.000 | 4.000 |
|---|---|---|---|---|---|---|---|---|---|---|---|---|
| delta | 99.87% | 97.72% | 93.32% | 84.13% | 69.15% | 50.00% | 30.85% | 15.87% | 6.68% | 2.28% | 0.13% | 0.00% |
| logS | −0.639 | −0.275 | −0.172 | −0.105 | −0.047 | 0.005 | 0.053 | 0.103 | 0.155 | 0.214 | 0.432 | 0.820 |
| S | 0.53 | 0.76 | 0.84 | 0.90 | 0.95 | 1.01 | 1.05 | 1.11 | 1.17 | 1.24 | 1.54 | 2.27 |
| Vol | 22.1109% | 14.2320% | 11.9441% | 11.0885% | 10.5810% | 10.0000% | 9.7388% | 9.8185% | 9.9998% | 10.4514% | 14.0710% | 19.9983% |

TABLE 26

| −d₁ | −3 | −2.000 | −1.500 | −1.000 | −0.500 | 0.000 | 0.500 | 1.000 | 1.500 | 2.000 | 3.000 | 4.000 |
|---|---|---|---|---|---|---|---|---|---|---|---|---|
| delta | 99.87% | 97.72% | 93.32% | 84.13% | 69.15% | 50.00% | 30.85% | 15.87% | 6.68% | 2.28% | 0.13% | 0.00% |
| logS | −0.588 | −0.300 | −0.210 | −0.134 | −0.061 | 0.011 | 0.095 | 0.190 | 0.314 | 0.569 | 1.537 | 2.436 |
| S | 0.56 | 0.74 | 0.81 | 0.87 | 0.94 | 1.01 | 1.10 | 1.21 | 1.37 | 1.77 | 4.65 | 11.42 |
| Vol | 20.2904% | 15.5866% | 14.7576% | 14.3902% | 14.2521% | 15.0000% | 16.3617% | 17.4857% | 19.6552% | 26.6742% | 47.4753% | 56.8523% |

FIGS. 14A and 14B are illustrative graphs describing the volatility smile for different values of N, in accordance with various embodiment. In particular, graph 1420 of FIG. 14B corresponds to a zoomed-in view of a narrow spot of graph 1410 of FIG. 14A. Graph 1420 corresponds to a narrow range of the spot that is more relevant for the market. In FIGS. 14A and 14B, expiry is 2 years, and σ₀=18, 25 Δ_{RR}=3, and 25 Δ_{Fly}=0.75. Table 27 corresponds to volatility smile values for varying values of N and d₁. In the illustrative embodiment, in the liquid strike range, the differences between the volatilities that correspond to different values of N are quite small.

TABLE 27

| | delta | | | | | | | |
|---|---|---|---|---|---|---|---|---|
| | 100.00% | 99.87% | 97.72% | 93.32% | 84.13% | 69.15% | 50.00% | 30.85% |
| −d₁ | −4 | −3 | −2.00 | −1.50 | −1.00 | −0.50 | 0.000 | 0.500 |
| vol | 0.459554 | 0.309939 | 0.20841 | 0.186679 | 0.17487 | 0.172881 | 0.18 | 0.195179 |
| N = 8 | | | | | | | | |
| vol | 0.444210 | 0.303423 | 0.205833 | 0.185762 | 0.174782 | 0.172843 | 0.18 | 0.195316 |
| N = 16 | | | | | | | | |
| vol | 0.431501 | 0.293931 | 0.202724 | 0.184575 | 0.174764 | 0.172721 | 0.18 | 0.195617 |
| N = 32 | | | | | | | | |
| vol | 0.447120 | 0.286708 | 0.199842 | 0.18346 | 0.175005 | 0.172408 | 0.18 | 0.196236 |
| N = 64 | | | | | | | | |
| vol | 0.411116 | 0.275323 | 0.196666 | 0.182759 | 0.175498 | 0.171844 | 0.18 | 0.1974 |
| N = 128 | | | | | | | | |
| vol | 0.415463 | 0.278276 | 0.195835 | 0.182508 | 0.175521 | 0.171425 | 0.18 | 0.198349 |
| N = 256 | | | | | | | | |
| vol | 0.444198 | 0.291127 | 0.196954 | 0.18247 | 0.175392 | 0.171296 | 0.18 | 0.198623 |
| N = 512 | | | | | | | | |

| | delta | | | | | |
|---|---|---|---|---|---|---|
| | 15.87% | 6.68% | 2.28% | 0.62% | 0.13% | 0.00% |
| −d₁ | 1.000 | 1.500 | 2.000 | 2.500 | 3.000 | 4.000 |
| vol | 0.220658 | 0.280707 | 0.422685 | 0.563101 | 0.659547 | 0.770027 |
| N = 8 | | | | | | |
| vol | 0.219854 | 0.275348 | 0.411486 | 0.555132 | 0.652853 | 0.767931 |
| N = 16 | | | | | | |
| vol | 0.218417 | 0.267722 | 0.39739 | 0.546855 | 0.647471 | 0.757083 |
| N = 32 | | | | | | |
| vol | 0.216085 | 0.257788 | 0.379632 | 0.535901 | 0.642558 | 0.75725 |
| N = 64 | | | | | | |
| vol | 0.21267 | 0.24544 | 0.350483 | 0.506727 | 0.621739 | 0.730046 |
| N = 128 | | | | | | |
| vol | 0.210876 | 0.240278 | 0.338977 | 0.498363 | 0.623423 | 0.737258 |
| N = 256 | | | | | | |
| vol | 0.210589 | 0.240419 | 0.343046 | 0.512133 | 0.646482 | 0.763856 |
| N = 512 | | | | | | |

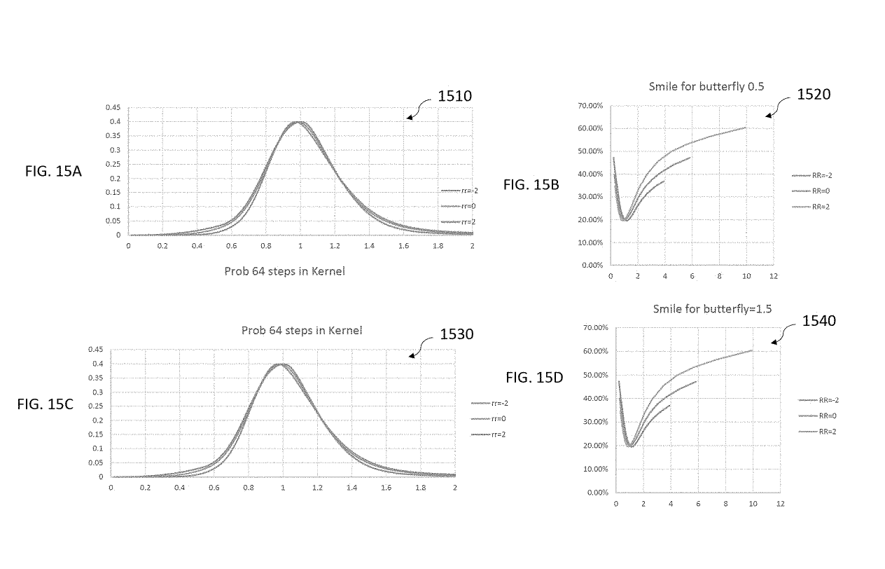

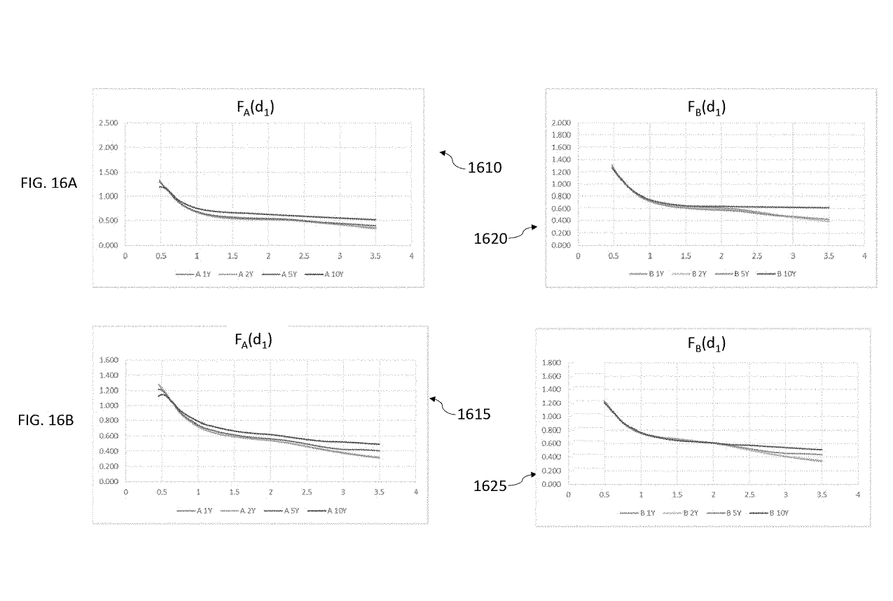

FIGS. 15A-D are illustrative graphs of the density function and volatility smile, in accordance with various embodiments. FIGS. 15A and 15C illustrate a shape of the density function g(s, T) for different values of 25 Δ_{RR} and 25 Δ_{Fly}, and FIGS. 15B and 15D illustrate a resulting volatility smile, respectively.

Graph 1510 of FIG. 15A compares three instances of the density function g(s, T), where expiry is 1 year, the ATM volatility is 20%, 25 Δ_{Fly} is 0.5%, and 25 Δ_{RR}=−2, 0, and 2. Graphs 1520 of FIG. 15B illustrates the volatility for the same market data as that of FIG. 15A (e.g., expiry is 1 year, the ATM volatility is 20%, 25 Δ_{Fly} is 0.5%, and 25 Δ_{RR}=−2, 0, and 2). Graph 1530 of FIG. 15C compares three instances of the density function g(s, T), where expiry is 1 year, the ATM volatility is 20%, 25 Δ_{Fly} is 1.5%, and 25 Δ_{RR}=−2, 0, and 2. Graph 1540 of FIG. 15D illustrates the volatility smile for the same market data as that of FIG. 15C (e.g., expiry is 1 year, the ATM volatility is 20%, 25 Δ_{Fly} is 1.5%, and 25 Δ_{RR}=−2, 0, and 2.

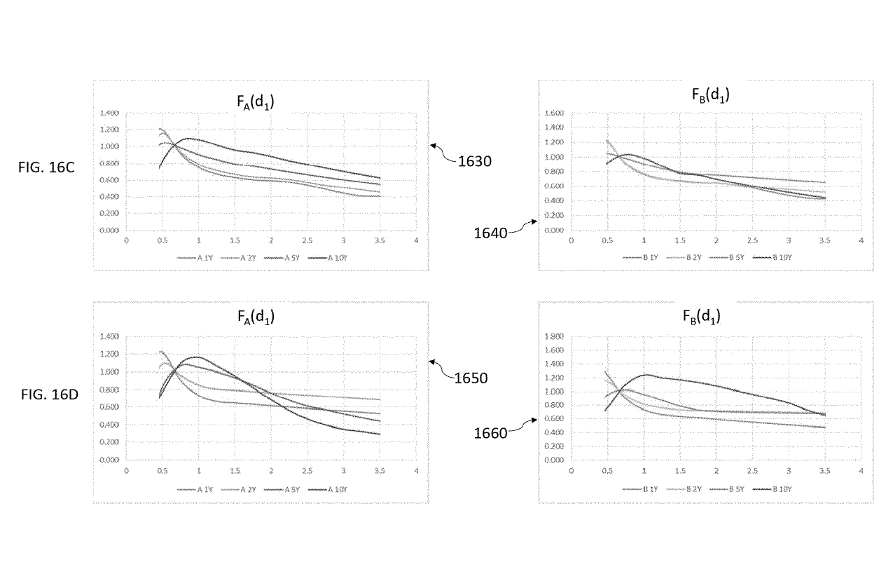

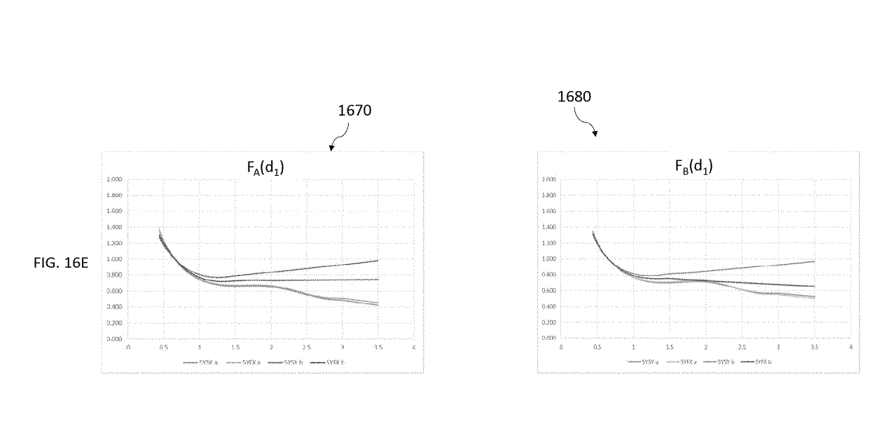

FIGS. 16A-D are illustrative graphs of an effect of different sets of market data on a first shape function F_{A}(d₁) and a second shape function F_{B}(d₁) for various swaptions, in accordance with various embodiments. FIG. 16E is an illustrative graph showing the effect of annuity on a first shape function F_{A}(d₁) and a second shape function F_{B} (d₁) by comparing swaptions and FX options having similar market data, in accordance with various embodiments. FIGS. 16A-D, for instance, demonstrate an effect of an expiration on a shape of functions F_{A}(d₁) and F_{B}(d₁) for swaptions with the same underlying swap. Graphs 1610-1660 of FIGS. 16A-D include illustrative plots of a 1Y5Y swaption, a 2Y5Y swaption, a 5Y5Y swaption, and a 10Y5Y swaption with the same set of market data for all swaptions, thereby allowing the effect of the maturity on the shape of A and B to be viewed.

Graphs 1610 and 1620 of FIG. 16A correspond to first market data where σ₀=10, 25 Δ_{RR}=3, and 25 Δ_{Fly}=1, with N=1024. Graphs 1615 and 1625 of FIG. 16B, σ₀=10, 25 Δ_{RR}=3, and 25 Δ_{Fly}=1, with N=128. As seen from FIGS. 16A and 16B, the differences between graphs 1610 and 1615, and between graphs 1620 and 1625, is insignificant for values of d₁ below 2.5.

Graphs 1630 and 1640 of FIG. 16C correspond to second market data, where σ₀=20, 25 Δ_{RR}=6, and 25 Δ_{Fly}=1.5 with N=1024.

Graphs 1650 and 1660 of FIG. 16D corresponds to third market data, where σ₀=30, 25 Δ_{RR}=8, and 25 Δ_{Fly}=2 with N=1024.

FIG. 16E is an illustrative graph showing the effect of annuity on a first shape function F_{A}(d₁) and a second shape function F_{B}(d₁) by comparing swaptions and FX options having similar market data, in accordance with various embodiments. Graphs 1670 and 1680 of FIG. 16E illustrates A and B for a 5Y5Y swaption as compared to a 5Y FX option with the same market data in order to demonstrate the effect of annuity on functions F_{A}(d₁) and F_{B}(d₁). For example, two sets of market data are used withN=1024. The first set of market data includes σ₀=20, 25 Δ_{RR}=2, and 25 Δ_{Fly}=1 with Forward=5%. The second set of market data includes σ₀=25, 25 Δ_{RR}=−4, and 25 Δ_{Fly}=2 and Forward F=5%. As seen by the first set of market data, there is very little effect from the annuity and in the second set of market data, the effect is significant for input values d₁ above 1.

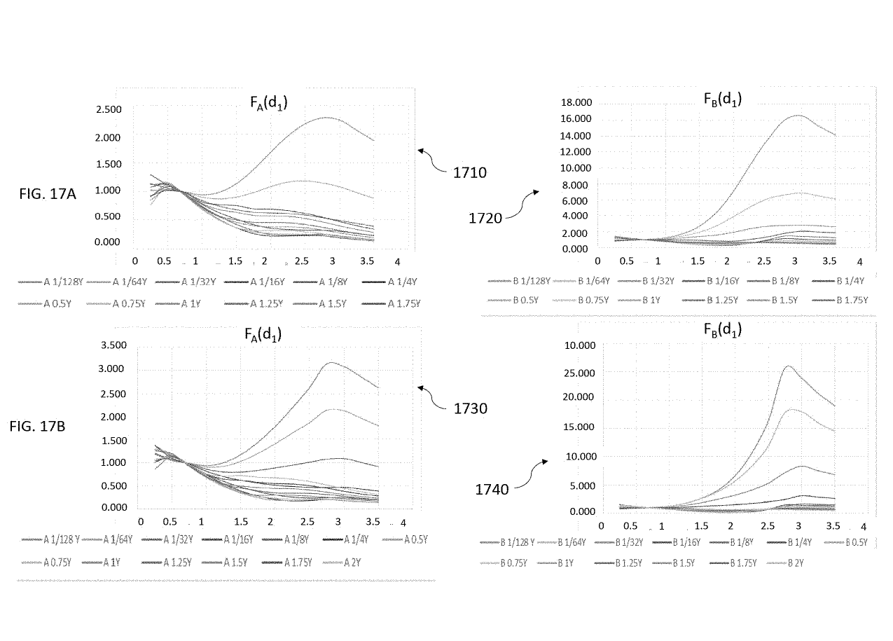

FIGS. 17A and 17B are illustrative graphs of term structures for a first shape function F_{A}(d₁) and a second shape function F_{B}(d₁) for two different values of N for one particular set of market data, in accordance with various embodiment. For instance, in graphs 1710 and 1720 of FIG. 17A, N=128, whereas in graphs 1730 and 1740 of FIG. 17B, N=256. The term structures that may be used correspond to σ₀=18, 25 Δ_{RR}=3, and 25 Δ_{Fly}=0.75, where expiry corresponds to 2 years. In the illustrative embodiment, the kernel for N=128 corresponds to a time period of 2Y/128, which is approximately equal to 5.7 days. The kernel for N=256, however, corresponds to a time period of approximately 2.9 days (e.g., 2Y/256). As seen from graphs 1710, 1720, 1730, and 1740, the shape of parameters A and B corresponding to the kernel's time period are steeper than the shapes of functions F_{A}(d₁) and F_{B}(d₁) closer to maturity. This is due to functions F_{A}(d₁) and F_{B}(d₁), and thus functions A and B, compensating for the use of the translational invariant smile. As the expiry increases, the shape of functions F_{A}(d₁) and F_{B}(d₁) will, therefore, change gradually from the kernel's shape towards a smooth shape for functions F_{A}(d₁) and F_{B}(d₁), as seen previously.

Tables 28 and 29 describe values for both parameters A and B for various expiries T, ATM volatilities σ₀, 25 Δ_{RR}, 25 Δ_{Fly}, and d₁ values for N=128 and N=256, respectively.

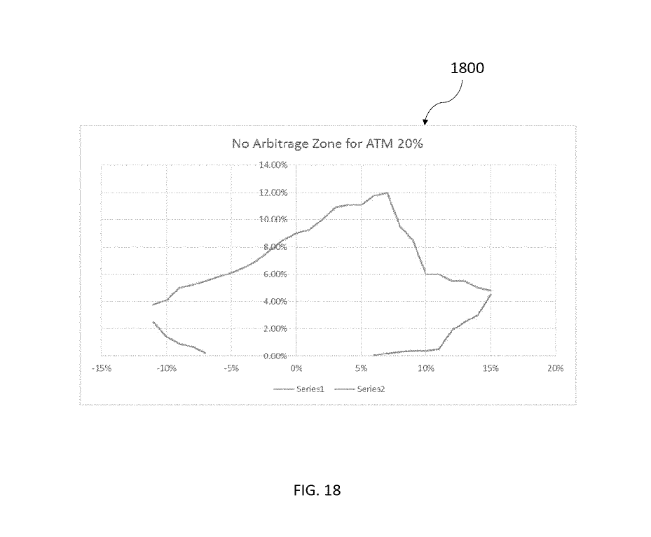

FIG. 18 is an illustrative graph of the arbitrage free zones, in accordance with various embodiments. Graph 1800 of FIG. 18, for instance, demonstrates the zones of 25 Δ_{RR} and 25 Δ_{Fly} for a given ATM volatility, such as ATM volatility σ₀ being 20%, and expiry is one year. The horizontal axis of graph 1800 corresponds to 25 Δ_{RR}, and the vertical axis corresponds to 25 Δ_{Fly}. For example, as seen in graph 1800, at 25 Δ_{RR}<−12% or 25 Δ_{RR}>15% there is always arbitrage for any 25 Δ_{Fly}. Similarly, for 25 Δ_{Fly}>12% there is always arbitrage.

As an illustrative example, no arbitrage corresponds to the density function being strictly positive for all times in the integral representation. For no arbitrage zones, parameters A and B are able to be generated for N as large as desired, and all of the density functions are, therefore, strictly positive. For instance, in Equations 46 and 47, 25 Δ_{RR} should not be too large otherwise a negative volatility may be obtained, and therefore ranges of values for 25 Δ_{RR} and 25 Δ_{Fly} may be determined such that the density function g remains positive. As seen from graph 1800 of FIG. 18, the market data ranges that have even been seen in history (e.g., 25 Δ_{RR} and 25 Δ_{Fly} for a given ATM volatility σ₀), are well within the bounds of the no arbitrage zone. For instance, 25 Δ_{RR} has never exceeded even 40% of ATM volatility σ₀, and 25 Δ_{Fly} has never reached 25% of ATM volatility σ₀.

The process described above to obtain the volatility smile from three (3) input prices included the following steps. First, the functions A(d₁) and B(d₁) may be defined, as described by Equations 26 and 27. Next, ζ_{butterfly′} and ζ_{RR′} may be expressed in an integral form, as described, for example, by Equations 72 and 73. The integrals may be expressed through the density function g_{T} using the fact that the integrals are path independent. Finally, the self-consistent representations A(d₁) and B(d₁) were obtained such that they satisfy Equations 72 and 73 via iteration. This process may be advantages in that tables of A(d₁) and B(d₁) may be generated in advance at a high accuracy level.

In some embodiments, instead of using Equations 26 and 27, different functions and description may be selected. For example, instead of using Equations 26 and 27, different functions C(d1) and D(d1) may be defined where

$${ζ}_{strangle} ( {d}_{1} ) = C ( {d}_{1} , T , {σ}_{0} )$$

$$\frac{dVega}{d σ} ( Strangle ( {d}_{1} ) ) + D ( {d}_{1} , T , {σ}_{0} ) \frac{dVega}{dS} ( Strangle ( {d}_{1} ) )$$

$$and$$

$${ζ}_{RR} ( {d}_{1} ) = C ( {d}_{1} , T , {σ}_{0} ) \frac{dVega}{d σ} ( RR ( {d}_{1} ) ) + D ( {d}_{1} , T , {σ}_{0} ) \frac{dVega}{dS} ( RR ( {d}_{1} ) ) .$$

Using Equations 59 and 60, together with Equation 56, the functions C(d₁) and D(d₁) may be obtained.

Moreover, the calculation of ζ_{butterfly′} and ζ_{RR′} may be obtained without any assumptions on the description of Equation 26 and 27, but directly from solving for the self-consistent density function g_{T} that satisfies, for instance, the left side of Equations 72 and 73, or other formulation of the smile in any combination of the integrals defined in Equation 70. By receiving input data representing three inputs, such as option prices or volatilities for the expiration date, the pivot volatility, the variance of the pivot volatility in Equation 43, which is the first scaling parameter for the first integral, and the covariance of the pivot volatility with the underlying asset price or forward interest rates in Equation 44, which is the second scaling parameter for the second integral, may be obtained. The self-consistent density function, therefore, may satisfy the condition that when using the density function derived from the volatility smile that correspond to ζ_{butterfly′} and ζ_{RR′} for all {d₁} in the integral representation of ζ_{butterfly′} and ζ_{RR′}, the same values of ζ_{butterfly′} and ζ_{RR′} may be generated for all {d₁}, and the density function g_{T} may define the smile uniquely. However, providing tables of density function for different market conditions may be difficult even if a mapping to a normal distribution variable is provided. Therefore, the functions A(d₁) and B(d₁), or any other function or any other suitable form, may assist in producing an easy description of the smile.

### V. Comparison of Data Model to Actual Market Data

As shown previously, the volatility smile may be determined for a given expiry T using at least three volatilities/prices as inputs. Furthermore, both A(d₁, t) and B(d₁, t) are capable of being determined as accurately as required.

In the illustrative embodiments, parameters A and B tend to converge quickly. The price difference between using A and B for a value of N that converges, as compared to a previous value of N before convergence is obtained, is rather small, and typically within the market bid/ask spread. Therefore, by determining A and B for the relevant market prices of all kinds of vanilla options, option prices may be calculated and compared to traded prices in the market.

In order to explore the accuracy of the described techniques for pricing options, a comparison between option prices in the market and Equations 28 and 29, or for swaptions as shown by Equations 33 and 34, using the small temporal intervals δt for the kernel probability density function and the integral representation in Equation 41, or for swaptions Equations 62 and 65, may be described. In the exemplary embodiment, liquid assets are chosen to ensure that the market is described without distortions that would otherwise result from a lack of liquidity. Tables 30-66 describe the various comparisons of the model for all of the different asset classes (e.g., currencies, commodities, equities, interest rate swaptions, etc.). The data used in Tables 30-66 was taken from the last close rates of the year (e.g., Dec. 31, 2015), which are the rates that all trading houses use to close the year (e.g., the rate used to determine the official annual profits/losses of the trading activity). Therefore, these values are particularly accurate as brokers that provide the data typically ensure that these values truly reflect the market prices as of the close time.

In the illustrative embodiment, both major and emerging market currency pairs for FX, all liquid interest rate currencies, both American and European major stock indices—a particularly liquid stock that never pays dividend and therefore its exchange traded options may be regarded as European options, exchanged traded Brent crude oil options—the most liquid type of oil option, exchange traded gold, and copper, are all described herein.

EUR/USD for a spot of 1.0861.

TABLE 30

| T = 1 | | | | | |
|---|---|---|---|---|---|
| Month (31 | Forward = | | | | |
| Days) | 1.08692 | | | | |
| | ATM σ₀ | 25 Δ_{RR} | 25 Δ_{Fly} | 10 Δ_{RR} | 10 Δ_{Fly} |
| Market | 9.725 | −0.45 | 0.175 | −0.8 | 0.5 |
| Model | | −0.45 | 0.175 | −.0847 | 0.601 |
| | ATM | 10 Δ_{Put} | 25 Δ_{Put} | 25 Δ_{Call} | 10 Δ_{Call} |
| Market Vol | 9.725 | 1.025 | 10.125 | 9.675 | 9.903 |
| Model Vol | 9.725 | 10.625 | 10.125 | 9.675 | 9.825 |
| T = 3 | | | | | |
| Month (92 | Forward = | | | | |
| Days) | 1.08867 | | | | |
| | ATM σ₀ | 25 Δ_{RR} | 25 Δ_{Fly} | 10 Δ_{RR} | 10 Δ_{Fly} |
| Market | 9.975 | −1.05 | 0.2 | −1.7 | 0.6 |
| Model | 9.975 | −1.05 | 0.2 | −1.774 | 0.662 |
| | ATM | 10 Δ_{Put} | 25 Δ_{Put} | 25 Δ_{Call} | 10 Δ_{Call} |
| Market Vol | 9.975 | 11.425 | 10.7 | 9.65 | 9.725 |
| Model Vol | 9.975 | 11.524 | 10.7 | 9.65 | 9.750 |
| T = 1 | | | | | |
| Year (365 | Forward = | | | | |
| Days) | 1.10012 | | | | |
| | ATM σ₀ | 25 Δ_{RR} | 25 Δ_{Fly} | 10 Δ_{RR} | 10 Δ_{Fly} |
| Market | 10.1 | −1.725 | 0.275 | −2.875 | 0.9 |
| Model | 10.1 | −1.725 | 0.275 | −2.892 | 0.901 |
| | ATM | 10 Δ_{Put} | 25 Δ_{Put} | 25 Δ_{Call} | 10 Δ_{Call} |
| Market Vol | 10.1 | 12.4375 | 11.2375 | 9.5125 | 9.5625 |
| Model Vol | 10.1 | 12.447 | 11.2375 | 9.5125 | 9.555 |

USD/JPY for a spot of 120.32.

TABLE 31

| T = 1 | | | | | |
|---|---|---|---|---|---|
| Month (34 | Forward = | | | | |
| Days) | 120.243 | | | | |
| | ATM σ₀ | 25 Δ_{RR} | 25 Δ_{Fly} | 10 Δ_{RR} | 10 Δ_{Fly} |
| Market | 7.45 | −0.95 | 0.35 | −1.8 | 1.025 |
| Model | 7.45 | −0.95 | 0.35 | −1.73 | 1.058 |
| | ATM | 10 Δ_{Put} | 25 Δ_{Put} | 25 Δ_{Call} | 10 Δ_{Call} |
| Market Vol | 7.45 | 9.375 | 8.275 | 7.325 | 7.575 |
| Model Vol | 7.45 | 9.374 | 8.275 | 7.325 | 7.642 |
| T = 3 | | | | | |
| Month (92 | Forward = | | | | |
| Days) | 120.022 | | | | |
| | ATM σ₀ | 25 Δ_{RR} | 25 Δ_{Fly} | 10 Δ_{RR} | 10 Δ_{Fly} |
| Market | 8.025 | −0.7 | 0.375 | −1.35 | 1.175 |
| Model | 8.025 | −0.7 | 0.375 | −1.38 | 1.205 |
| | ATM | 10 Δ_{Put} | 25 Δ_{Put} | 25 Δ_{Call} | 10 Δ_{Call} |
| Market Vol | 8.025 | 9.875 | 8.75 | 8.05 | 8.525 |
| Model Vol | 8.025 | 9.921 | 8.75 | 8.05 | 8.540 |
| T = 1 | | | | | |
| Year (369 | Forward = | | | | |
| Days) | 119.077 | | | | |
| | ATM σ₀ | 25 Δ_{RR} | 25 Δ_{Fly} | 10 Δ_{RR} | 10 Δ_{Fly} |
| Market | 9.05 | −0.275 | 0.65 | −0.45 | 2.225 |
| Model | 9.05 | −0.275 | 0.65 | −0.422 | 2.209 |
| | ATM | 10 Δ_{Put} | 25 Δ_{Put} | 25 Δ_{Call} | 10 Δ_{Call} |
| Market Vol | 9.05 | 11.5 | 9.8375 | 9.5625 | 11.05 |
| Model Vol | 9.05 | 11.470 | 9.8375 | 9.5625 | 11.048 |

EUR/JPY for a spot of 130.6

TABLE 32

| T = 1 | | | | | |
|---|---|---|---|---|---|
| Month (34 | Forward = | | | | |
| Days) | 130.612 | | | | |
| | ATM σ₀ | 25 Δ_{RR} | 25 Δ_{Fly} | 10 Δ_{RR} | 10 Δ_{Fly} |
| Market | 8.25 | −0.75 | 0.275 | −1.325 | 0.775 |
| Model | 8.25 | −0.75 | 0.275 | −1.34 | 0.82 |
| | ATM | 10 Δ_{Put} | 25 Δ_{Put} | 25 Δ_{Call} | 10 Δ_{Call} |
| Market Vol | 8.25 | 9.742 | 8.9 | 8.15 | 8.3625 |
| Model Vol | 8.25 | 9.742 | 8.9 | 8.15 | 8.401 |
| T = 3 | | | | | |
| Month (92 | Forward = | | | | |
| Days) | 130.585 | | | | |
| | ATM σ₀ | 25 Δ_{RR} | 25 Δ_{Fly} | 10 Δ_{RR} | 10 Δ_{Fly} |
| Market | 8.925 | −1.05 | 0.35 | −1.9 | 1.05 |
| Model | 8.925 | −1.05 | 0.35 | −1.78 | 1.088 |
| | ATM | 10 Δ_{Put} | 25 Δ_{Put} | 25 Δ_{Call} | 10 Δ_{Call} |
| Market Vol | 8.925 | 10.925 | 9.8 | 8.75 | 9.025 |
| Model Vol | 8.925 | 10.903 | 9.8 | 8.75 | 9.123 |
| T = 1 | | | | | |
| Year (369 | Forward = | | | | |
| Days) | 130.516 | | | | |
| | ATM σ₀ | 25 Δ_{RR} | 25 Δ_{Fly} | 10 Δ_{RR} | 10 Δ_{Fly} |
| Market | 10.3 | −1.8 | 0.6 | −3.3 | 1.975 |
| Model | 10.3 | −1.8 | 0.6 | −3.21 | 1.962 |
| | ATM | 10 Δ_{Put} | 25 Δ_{Put} | 25 Δ_{Call} | 10 Δ_{Call} |
| Market Vol | 10.3 | 13.867 | 11.8 | 10 | 10.657 |
| Model Vol | 10.3 | 13.925 | 11.8 | 10 | 10.625 |

EUR/GBP for a spot of 0.7369.

TABLE 33

| T = 1 | | | | | |
|---|---|---|---|---|---|
| Month (34 | Forward = | | | | |
| Days) | 0.7374 | | | | |
| | ATM σ₀ | 25 Δ_{RR} | 25 Δ_{Fly} | 10 Δ_{RR} | 10 Δ_{Fly} |
| Market | 8.775 | 0.2 | 0.2 | 0.35 | 0.55 |
| Model | 8.775 | 0.2 | 0.2 | 0.38 | 0.66 |
| | ATM | 10 Δ_{Put} | 25 Δ_{Put} | 25 Δ_{Call} | 10 Δ_{Call} |
| Market Vol | 8.775 | 9.15 | 8.875 | 9.075 | 9.5 |
| Model Vol | 8.775 | 9.245 | 8.875 | 9.075 | 9.625 |
| T = 3 | | | | | |
| Month (92 | Forward = | | | | |
| Days) | 0.73853 | | | | |
| | ATM σ₀ | 25 Δ_{RR} | 25 Δ_{Fly} | 10 Δ_{RR} | 10 Δ_{Fly} |
| Market | 9.15 | 0.325 | 0.25 | 0.55 | 0.775 |
| Model | 9.15 | 0.325 | 0.25 | 0.58 | 0.813 |
| | ATM | 10 Δ_{Put} | 25 Δ_{Put} | 25 Δ_{Call} | 10 Δ_{Call} |
| Market Vol | 9.15 | 9.65 | 9.2375 | 9.5625 | 10.2 |
| Model Vol | 9.15 | 9.673 | 9.2375 | 9.5625 | 10.253 |
| T = 1 | | | | | |
| Year (369 | Forward = | | | | |
| Days) | 0.74517 | | | | |
| | ATM σ₀ | 25 Δ_{RR} | 25 Δ_{Fly} | 10 Δ_{RR} | 10 Δ_{Fly} |
| Market | 10.525 | 0.6 | 0.425 | 1.15 | 1.4 |
| Model | 10.525 | 0.6 | 0.425 | 1.15 | 1.426 |
| | ATM | 10 Δ_{Put} | 25 Δ_{Put} | 25 Δ_{Call} | 10 Δ_{Call} |
| Market Vol | 10.525 | 11.35 | 10.65 | 11.25 | 12.5 |
| Model Vol | 10.525 | 11.376 | 10.65 | 11.25 | 12.526 |

EUR/CHF for a spot of 1.0889.

TABLE 34

| T = 1 | | | | | |
|---|---|---|---|---|---|
| Month (34 | Forward = | | | | |
| Days) | 1.08828 | | | | |
| | ATM σ₀ | 25 Δ_{RR} | 25 Δ_{Fly} | 10 Δ_{RR} | 10 Δ_{Fly} |
| Market | 6.2 | −0.4 | 0.35 | −0.7 | 0.975 |
| Model | 6.2 | −0.4 | 0.35 | −0.68 | 1.06 |
| | ATM | 10 Δ_{Put} | 25 Δ_{Put} | 25 Δ_{Call} | 10 Δ_{Call} |
| Market Vol | 6.2 | 7.525 | 6.75 | 6.35 | 6.825 |
| Model Vol | 6.2 | 7.600 | 6.75 | 6.35 | 6.920 |
| T = 3 | | | | | |
| Month (92 | Forward = | | | | |
| Days) | 1.0872 | | | | |
| | ATM σ₀ | 25 Δ_{RR} | 25 Δ_{Fly} | 10 Δ_{RR} | 10 Δ_{Fly} |
| Market | 6.775 | −0.725 | 0.525 | −1.325 | 1.6 |
| Model | 6.775 | −0.725 | 0.525 | −1.295 | 1.671 |
| | ATM | 10 Δ_{Put} | 25 Δ_{Put} | 25 Δ_{Call} | 10 Δ_{Call} |
| Market Vol | 6.775 | 9.0375 | 7.6625 | 6.9375 | 7.7125 |
| Model Vol | 6.775 | 9.11 | 7.6625 | 6.9375 | 7.799 |
| T = 1 | | | | | |
| Year (369 | Forward = | | | | |
| Days) | 1.08144 | | | | |
| | ATM σ₀ | 25 Δ_{RR} | 25 Δ_{Fly} | 10 Δ_{RR} | 10 Δ_{Fly} |
| Market | 7.7 | −2.05 | 0.75 | −3.85 | 2.525 |
| Model | 7.7 | −2.05 | 0.75 | −3.69 | 2.555 |
| | ATM | 10 Δ_{Put} | 25 Δ_{Put} | 25 Δ_{Call} | 10 Δ_{Call} |
| Market Vol | 7.7 | 12.15 | 9.475 | 7.425 | 8.410 |
| Model Vol | 7.7 | 9.11 | 9.475 | 7.425 | 8.36 |

USD/KRW for a spot of 1175.9.

TABLE 35

| T = 1 | | | | | |
|---|---|---|---|---|---|
| Month (34 | Forward = | | | | |
| Days) | 1176.15 | | | | |
| | ATM σ₀ | 25 Δ_{RR} | 25 Δ_{Fly} | 10 Δ_{RR} | 10 Δ_{Fly} |
| Market | 9.85 | 0.8 | 0.2 | 1.45 | 0.6 |
| Model | 9.85 | 0.8 | 0.2 | 1.46 | 0.68 |
| | ATM | 10 Δ_{Put} | 25 Δ_{Put} | 25 Δ_{Call} | 10 Δ_{Call} |
| Market Vol | 9.85 | 9.725 | 9.65 | 10.45 | 11.175 |
| Model Vol | 9.85 | 9.804 | 9.65 | 10.45 | 11.262 |
| T = 3 | | | | | |
| Month (92 | Forward = | | | | |
| Days) | 1177.9 | | | | |
| | ATM σ₀ | 25 Δ_{RR} | 25 Δ_{Fly} | 10 Δ_{RR} | 10 Δ_{Fly} |
| Market | 10.6 | 1.45 | 0.325 | 2.7 | 0.9 |
| Model | 10.6 | 1.45 | 0.325 | 2.56 | 0.96 |
| | ATM | 10 Δ_{Put} | 25 Δ_{Put} | 25 Δ_{Call} | 10 Δ_{Call} |
| Market Vol | 10.6 | 10.15 | 10.2 | 11.65 | 12.85 |
| Model Vol | 10.6 | 10.280 | 10.2 | 11.65 | 12.840 |
| T = 1 | | | | | |
| Year (369 | Forward = | | | | |
| Days) | 1179.38 | | | | |
| | ATM σ₀ | 25 Δ_{RR} | 25 Δ_{Fly} | 10 Δ_{RR} | 10 Δ_{Fly} |
| Market | 11.3 | 2.8 | 0.55 | 5 | 1.6 |
| Model | 11.3 | 2.8 | 0.55 | 4.89 | 1.62 |
| | ATM | 10 Δ_{Put} | 25 Δ_{Put} | 25 Δ_{Call} | 10 Δ_{Call} |
| Market Vol | 11.3 | 10.475 | 10.45 | 13.25 | 15.365 |
| Model Vol | 11.3 | 10.4 | 10.45 | 13.25 | 15.39 |

EUR/PLN for a spot of 4.2635.

TABLE 36

| T = 1 | | | | | |
|---|---|---|---|---|---|
| Month (34 | Forward = | | | | |
| Days) | 4.26975 | | | | |
| | ATM σ₀ | 25 Δ_{RR} | 25 Δ_{Fly} | 10 Δ_{RR} | 10 Δ_{Fly} |
| Market | 6.75 | 0.475 | 0.2 | 0.8 | 0.625 |
| Model | 6.75 | 0.475 | 0.2 | 0.86 | 0.71 |
| | ATM | 10 Δ_{Put} | 25 Δ_{Put} | 25 Δ_{Call} | 10 Δ_{Call} |
| Market Vol | 6.75 | 6.975 | 6.7125 | 7.1875 | 7.775 |
| Model Vol | 6.75 | 7.030 | 6.7125 | 7.1875 | 7.890 |
| T = 3 | | | | | |
| Month (92 | Forward = | | | | |
| Days) | 4.2813 | | | | |
| | ATM σ₀ | 25 Δ_{RR} | 25 Δ_{Fly} | 10 Δ_{RR} | 10 Δ_{Fly} |
| Market | 6.75 | 0.85 | 0.275 | 1.6 | 0.875 |
| Model | 6.75 | 0.85 | 0.275 | 1.51 | 0.91 |
| | ATM | 10 Δ_{Put} | 25 Δ_{Put} | 25 Δ_{Call} | 10 Δ_{Call} |
| Market Vol | 6.75 | 6.825 | 6.6 | 7.45 | 8.425 |
| Model Vol | 6.75 | 6.905 | 6.6 | 7.45 | 8.415 |
| T = 1 | | | | | |
| Year (369 | Forward = | | | | |
| Days) | 4.3339 | | | | |
| | ATM σ₀ | 25 Δ_{RR} | 25 Δ_{Fly} | 10 Δ_{RR} | 10 Δ_{Fly} |
| Market | 7.15 | 1.65 | 0.45 | 3.15 | 1.35 |
| Model | 7.15 | 1.65 | 0.45 | 2.98 | 1.391 |
| | ATM | 10 Δ_{Put} | 25 Δ_{Put} | 25 Δ_{Call} | 10 Δ_{Call} |
| Market Vol | 7.15 | 6.925 | 6.775 | 8.425 | 10.075 |
| Model Vol | 7.15 | 7.051 | 6.775 | 8.425 | 10.031 |

Tables 30-36 show comparisons between option prices (in volatility) traded in the market, and the price (in volatility) generated by the disclosed model for various currency pairs including EUR/USD, USD/JPY, EUR/JPY, EUR/GBP, EUR/CHF, USD/KRW, and EUR/PLN, respectively, for various expiries. The market data available for use corresponds to the ATM volatility σ₀, and the volatilities of 25 Δ_{Call}, 25 Δ_{Put}, 10 Δ_{Call}, and 10 Δ_{Put}. In the exemplary embodiment, the ATM volatility σ₀, and the volatilities of 25 Δ_{Call} and 25 Δ_{Put} may be used. Using the model, the values for 10 Δ_{Call} and 10 Δ_{Put} may be determined, and then compared to the market data of 10 Δ_{Call} and 10 Δ_{Put} for 1 month, 3 month, and 1 year expiries. For example, looking at EUR/USD at 3 month expiry, the 10 Δ_{Call}=0.5 (10 Δ_{RR})+10 Δ_{Fly}+σ₀=9.750. The actual value of 10 Δ_{Call} from market data is 9.725, indicating that the model is substantially accurate using the limited number of input parameters.

When determining the delta reference for the various market conversions of Tables 30-36 for example, if the USD is the first currency listed (e.g., USD/JPY), then the delta should be calculated, in one embodiment, such that the premium of the option may be hedged as well and therefore added to the option BS delta. Thus, Equations 3 and 4, in this particular scenario, are not applicable, and even the market ATM volatility does not yield a d₁=0 strike. Thus, the ATM volatility σ₀, and the volatilities of 25 Δ_{Call}, and 25 Δ_{Put} may be solved for, which may allow for the volatility smile to be determined.

Tables 37-40 describe a comparison to the model of the disclosed concept for pricing an option to a particular commodity market, such as Gold call options, having maturities ranging between 1 month and 1 year. The maturities are selected to be as close as possible to the maturities described for FX options mentioned previously.

TABLE 37

| Strike | Exchange Data | Model Data |
|---|---|---|
| 700 | 360.2 | 360.146 |
| 750 | 310.2 | 310.146 |
| 800 | 260.2 | 260.148 |
| 850 | 210.2 | 210.160 |
| 900 | 160.2 | 160.222 |
| 950 | 110.4 | 110.449 |
| 1000 | 61.5 | 61.504 |
| 1050 | 20.1 | 20.033 |
| 1100 | 2.6 | 2.646 |
| 1150 | 0.4 | 0.326 |

For Table 37, expiry is Jan. 29, 2016, the model of the disclosed concept is determined with forward rate set at 1060.146, the ATM volatility σ₀ is 11.63, 25 Δ_{RR} is −0.7, and 25 Δ_{Fly} is 0.3. As seen from Table 37, the model data and the market data are substantially similar, indicating the model's accuracy.

TABLE 38

| Strike | Exchange Data | Model Data |
|---|---|---|
| 700 | 360.8 | 360.54 |
| 750 | 310.8 | 310.73 |
| 800 | 260.9 | 261.06 |
| 850 | 211.4 | 211.57 |
| 900 | 162.4 | 162.50 |
| 950 | 115.1 | 114.93 |
| 1000 | 71.5 | 71.48 |
| 1050 | 36.5 | 36.50 |
| 1100 | 15 | 15.09 |
| 1150 | 5.8 | 5.85 |

For Table 38, expiry is Mar. 31, 2016, the model of the disclosed concept is determined with forward rate set at 1060.351, the ATM volatility σ₀ is 14.53, 25 Δ_{RR} is −1.26, and 25 Δ_{Fly} is 0.6.

TABLE 39

| Strike | Exchange Data | Model Data |
|---|---|---|
| 700 | 362.5 | 362.86 |
| 750 | 313 | 313.48 |
| 800 | 264 | 264.36 |
| 850 | 215.9 | 215.86 |
| 900 | 169.3 | 168.87 |
| 950 | 125.1 | 124.79 |
| 1000 | 85.3 | 85.48 |
| 1050 | 52.9 | 53.10 |
| 1100 | 30.2 | 30.07 |
| 1150 | 16.6 | 16.56 |

For Table 39, expiry is Jun. 30, 2016, the model of the disclosed concept is determined with forward rate set at 1061.575, the ATM volatility τ₀ is 15.57, 25 Δ_{RR} is −1.47, and 25 Δ_{Fly} is 0.72.

TABLE 40

| Strike | Exchange Data | Model Data |
|---|---|---|
| 700 | 367.0 | 367.66 |
| 750 | 318.8 | 319.02 |
| 800 | 271.7 | 271.47 |
| 850 | 226.3 | 225.76 |
| 900 | 183.0 | 182.80 |
| 950 | 143.7 | 143.58 |
| 1000 | 108.7 | 109.07 |
| 1050 | 79.8 | 80.01 |
| 1100 | 57.0 | 56.78 |
| 1150 | 39.6 | 39.30 |

For Table 40, expiry is Dec. 30, 2016, the model of the disclosed concept is determined with forward rate set at 1065.499, the ATM volatility σ₀ is 16.93, 25 Δ_{RR} is −0.91, and 25 Δ_{Fly} is 0.34.

Tables 41-43 describe a comparison to the model of the disclosed concept for pricing an option to a particular commodity market, such as Copper call options, having maturities ranging between 1 month and 6 months. The maturities are selected to be as close as possible to the maturities described for FX options mentioned previously.

TABLE 41

| Strike | Exchange Data | Model Data |
|---|---|---|
| 0.25 | 1.8800 | 1.87993 |
| 0.5 | 1.6300 | 1.62993 |
| 0.75 | 1.3800 | 1.37993 |
| 1 | 1.1300 | 1.12993 |
| 1.25 | 0.8800 | 0.87995 |
| 1.3 | 0.8300 | 0.82998 |
| 1.35 | 0.7800 | 0.78001 |
| 1.4 | 0.7300 | 0.73007 |
| 1.45 | 0.6800 | 0.68014 |
| 1.5 | 0.6300 | 0.63024 |
| 1.55 | 0.5800 | 0.58038 |
| 1.6 | 0.5300 | 0.53057 |
| 1.65 | 0.4805 | 0.48082 |
| 1.7 | 0.4305 | 0.43114 |
| 1.75 | 0.3810 | 0.38157 |
| 1.8 | 0.3320 | 0.33219 |
| 1.82 | 0.3125 | 0.31253 |
| 1.83 | 0.3030 | 0.30273 |
| 1.84 | 0.2930 | 0.29296 |
| 1.85 | 0.2835 | 0.28321 |

For Table 41, expiry is Jan. 31, 2016, the model of the disclosed concept is determined with forward rate set at 2.12992, the ATM volatility σ₀ is 21.75, 25 Δ_{RR} is −2.33, and 25 Δ_{Fly} is 0.48.

TABLE 42

| Strike | Exchange Data | Model Data |
|---|---|---|
| 0.25 | 1.8915 | 1.89054 |
| 0.5 | 1.6415 | 1.64054 |
| 0.75 | 1.3915 | 1.39057 |
| 1 | 1.1415 | 1.14076 |
| 1.05 | 1.0915 | 1.09087 |
| 1.1 | 1.0415 | 1.04101 |
| 1.15 | 0.9915 | 0.99119 |
| 1.2 | 0.9415 | 0.94142 |
| 1.25 | 0.8915 | 0.89169 |
| 1.3 | 0.8415 | 0.84199 |
| 1.35 | 0.7915 | 0.79235 |
| 1.4 | 0.7415 | 0.74276 |
| 1.45 | 0.692 | 0.69326 |
| 1.5 | 0.6425 | 0.64386 |
| 1.55 | 0.5935 | 0.59465 |
| 1.6 | 0.5445 | 0.54571 |
| 1.65 | 0.4965 | 0.49717 |
| 1.7 | 0.449 | 0.44923 |
| 1.75 | 0.4025 | 0.40216 |
| 1.8 | 0.357 | 0.35625 |

For Table 42, expiry is Mar. 31, 2016, the model of the disclosed concept is determined with forward rate set at 2.14054, the ATM volatility σ₀ is 24.44, 25 Δ_{RR} is −2.58, and 25 Δ_{Fly} is 0.57.

TABLE 43

| Strike | Exchange Data | Model Data |
|---|---|---|
| 0.25 | 1.8965 | 1.89300 |
| 0.5 | 1.6465 | 1.64304 |
| 0.75 | 1.3965 | 1.39334 |
| 1 | 1.1465 | 1.14456 |
| 1.05 | 1.0965 | 1.09495 |
| 1.1 | 1.0465 | 1.04538 |
| 1.15 | 0.9965 | 0.99586 |
| 1.2 | 0.9465 | 0.94641 |
| 1.25 | 0.8965 | 0.89704 |
| 1.3 | 0.8465 | 0.84779 |
| 1.35 | 0.7965 | 0.79871 |
| 1.4 | 0.7465 | 0.74986 |
| 1.45 | 0.697 | 0.70132 |
| 1.5 | 0.648 | 0.65318 |
| 1.55 | 0.5995 | 0.60561 |
| 1.6 | 0.552 | 0.55875 |
| 1.65 | 0.5055 | 0.51280 |
| 1.7 | 0.46 | 0.46794 |
| 1.75 | 0.416 | 0.42441 |
| 1.8 | 0.3745 | 0.38239 |

For Table 43, expiry is Jun. 30, 2016, the model of the disclosed concept is determined with forward rate set at 2.143, the ATM volatility σ₀ is 24.66, 25 Δ_{RR} is −2.7, and 25 Δ_{Fly} is 0.6.

Table 44-48 describe a comparison to the model for pricing an option to a particular commodity market, such as Brent options, having maturities closest to 1 month, 3 months, 1 year, 2 years, and 5 years. Some of these maturities are selected to be similar to those of the FX options described above. As seen from Tables 44-48, the model data and the market data are substantially similar, indicating the model's accuracy.

TABLE 44

| Strike | Exchange Data | Model Data |
|---|---|---|
| 20 | 17.68 | 17.67 |
| 25 | 12.69 | 12.702 |
| 30 | 7.82 | 7.816 |
| 35 | 3.47 | 3.478 |
| 40 | 0.9 | 0.893 |
| 45 | 0.18 | 0.183 |
| 50 | 0.05 | 0.053 |
| 55 | 0.02 | 0.024 |
| 60 | 0.01 | 0.014 |

For Table 44, expiry is Jan. 26, 2016, the model of the disclosed concept is determined with the forward rate set at 37.6569, the ATM volatility σ₀ is 44.65, 25 Δ_{RR} is −3.71, and 25 Δ_{Fly} is 1.43.

TABLE 45

| Strike | Exchange Data | Model Data |
|---|---|---|
| 20 | 19.44 | 19.437 |
| 25 | 14.54 | 14.544 |
| 30 | 9.91 | 9.900 |
| 35 | 5.91 | 5.912 |
| 40 | 3.01 | 3.006 |
| 45 | 1.36 | 1.362 |
| 50 | 0.61 | 0.605 |
| 55 | 0.29 | 0.279 |
| 60 | 0.15 | 0.142 |

For Table 45, expiry is Mar. 24, 2016, the model of the disclosed concept is determined with the forward rate set at 39.37, the ATM volatility σ₀ is 43.26, 25 Δ_{RR} is −2.89, and 25 Δ_{Fly} is 1.22.

TABLE 46

| Strike | Exchange Data | Model Data |
|---|---|---|
| 20 | 25.65 | 25.686 |
| 25 | 20.93 | 20.923 |
| 30 | 16.47 | 16.440 |
| 35 | 12.42 | 12.419 |
| 40 | 8.99 | 9.005 |
| 45 | 6.29 | 6.280 |
| 50 | 4.27 | 4.255 |
| 55 | 2.86 | 2.875 |
| 60 | 1.95 | 1.959 |

For Table 46, expiry is Dec. 22, 2016, the model of the disclosed concept is determined with the forward rate set at 45.49, the ATM volatility σ₀ is 33.51, 25 Δ_{RR} is −1.7, and 25 Δ_{Fly} is 0.99.

TABLE 47

| Strike | Exchange Data | Model Data |
|---|---|---|
| 50 | 11.08 | 11.202 |
| 51 | 10.54 | 10.645 |
| 52 | 10.01 | 10.095 |
| 53 | 9.5 | 9.551 |
| 54 | 9 | 9.014 |
| 55 | 8.53 | 8.485 |
| 56 | 8.07 | 7.964 |
| 57 | 7.62 | 7.458 |
| 58 | 7.2 | 6.972 |
| 59 | 6.79 | 6.527 |
| 60 | 6.4 | 6.136 |
| 61 | 6.03 | 5.789 |
| 62 | 5.68 | 5.480 |
| 63 | 5.34 | 5.201 |
| 64 | 5.02 | 4.946 |
| 65 | 4.73 | 4.712 |
| 66 | 4.45 | 4.495 |
| 67 | 4.2 | 4.292 |
| 68 | 3.96 | 4.102 |
| 69 | 3.74 | 3.923 |
| 70 | 3.55 | 3.753 |

For Table 47, expiry is Dec. 21, 2018, the model of the disclosed concept is determined with the forward rate set at 53.205, the ATM volatility σ₀ is 24.15, 25 Δ_{RR} is −4.35, and 25 Δ_{Fly} is 2.51.

TABLE 48

| Strike | Exchange Data | Model Data |
|---|---|---|
| 51 | 15.60 | 15.573 |
| 52 | 15.06 | 15.059 |
| 53 | 14.52 | 14.552 |
| 54 | 13.99 | 14.051 |
| 55 | 13.48 | 13.556 |
| 56 | 12.97 | 13.065 |
| 57 | 12.48 | 12.577 |
| 58 | 12.00 | 12.092 |
| 59 | 11.53 | 11.609 |
| 60 | 11.07 | 11.127 |
| 61 | 10.62 | 10.646 |
| 62 | 10.19 | 10.164 |
| 63 | 9.77 | 9.684 |
| 64 | 9.35 | 9.207 |
| 65 | 8.95 | 8.737 |
| 66 | 8.57 | 8.313 |
| 67 | 8.20 | 7.938 |
| 68 | 7.84 | 7.605 |
| 69 | 7.50 | 7.306 |
| 70 | 7.18 | 7.037 |

For Table 48, expiry is Dec. 23, 2020, the model of the disclosed concept is determined with the forward rate set at 55.805, the ATM volatility σ₀ is 24.28, 25 Δ_{RR} is −3.82, and 25 Δ_{Fly} is 2.92.

Table 49-52 are illustrative tables describing the relationship between the model generated data for an equity option with that stock's actual option prices. Table 49, in particular, corresponds to a one month maturity of an exemplary stock option (e.g., Google®), whereas Tables 50-52 correspond to a three month maturity, a one year maturity, and a two year maturity, respectively. As seen from Tables 49-52, the model generated data is substantially similar to the actual market data and is always between the market bid price and the market ask price.

For Table 49, the expiry is Jan. 15, 2016, the forward rate is 778.879, the ATM volatility σ₀ is 19.8, 25 Δ_{RR} is −4, and 25 Δ_{Fly} is 0.45.

TABLE 49

| Strike | Bid Price | Ask Price | Model Price |
|---|---|---|---|
| 275 | 502.1 | 505.7 | 503.88 |
| 300 | 477.1 | 480.4 | 478.88 |
| 325 | 452.2 | 455.4 | 453.88 |
| 350 | 427.3 | 430.5 | 428.88 |
| 375 | 402 | 405.5 | 403.88 |
| 400 | 377.6 | 380.5 | 378.88 |
| 425 | 352.3 | 355.5 | 353.88 |
| 450 | 327.8 | 330.5 | 328.88 |
| 475 | 302.5 | 305.5 | 303.88 |
| 500 | 277.5 | 280.5 | 278.88 |
| 525 | 252.8 | 255.5 | 253.89 |
| 550 | 227.9 | 230.6 | 228.91 |
| 575 | 202.8 | 205.6 | 203.94 |
| 600 | 177.8 | 180.7 | 178.99 |
| 625 | 152.8 | 155.8 | 154.08 |
| 650 | 127.9 | 130.8 | 129.20 |
| 675 | 103 | 105.9 | 104.41 |
| 700 | 78.2 | 81.1 | 79.77 |
| 725 | 54 | 56.9 | 55.63 |
| 750 | 31.8 | 34.5 | 33.15 |

For Table 50, the expiry is Mar. 13, 2016, the forward rate is 779.474, the ATM volatility σ₀ is 26.33, 25 Δ_{RR} is −4.24, and 25 Δ_{Fly} is 0.4.

TABLE 50

| Strike | Bid Data | Ask Data | Model Data |
|---|---|---|---|
| 350 | 427.8 | 431.4 | 429.76 |
| 360 | 417.6 | 421.4 | 419.78 |
| 370 | 407.9 | 411.5 | 409.81 |
| 380 | 397.9 | 401.5 | 399.84 |
| 390 | 387.7 | 391.5 | 389.87 |
| 400 | 378 | 381.5 | 379.91 |
| 410 | 368 | 371.5 | 369.95 |
| 420 | 357.9 | 361.5 | 359.99 |
| 430 | 348 | 351.5 | 350.04 |
| 440 | 338 | 341.5 | 340.10 |
| 450 | 328.3 | 331.8 | 330.15 |
| 460 | 318.1 | 322 | 320.22 |
| 470 | 308.5 | 312 | 310.29 |
| 480 | 298.5 | 302 | 300.37 |
| 490 | 288.7 | 292 | 290.45 |
| 495 | 283.4 | 287 | 285.50 |
| 500 | 278.9 | 282 | 280.54 |
| 505 | 273.5 | 277.2 | 275.59 |
| 510 | 268.9 | 272.3 | 270.65 |
| 515 | 264.1 | 267.3 | 265.70 |

For Table 51, the expiry is Jan. 20, 2017, the forward rate is 777.776, the ATM volatility σ₀ is 27.67, 25 Δ_{RR} is −5.7, and 25 Δ_{Fly} is 0.7.

TABLE 51

| Strike | Bid Data | Ask Data | Model Data |
|---|---|---|---|
| 260 | 517.50 | 522.5 | 520.08 |
| 270 | 508 | 512.5 | 510.27 |
| 280 | 498 | 502.5 | 500.47 |
| 290 | 488 | 493 | 490.68 |
| 300 | 478.5 | 483 | 480.90 |
| 310 | 468.5 | 473.5 | 471.14 |
| 320 | 459.5 | 464 | 461.38 |
| 330 | 449.8 | 454 | 451.64 |
| 340 | 440.1 | 444.5 | 441.92 |
| 350 | 430 | 434.5 | 432.21 |
| 360 | 420.8 | 425.5 | 422.53 |
| 370 | 411.2 | 415.5 | 412.88 |
| 380 | 401.6 | 406 | 403.25 |
| 390 | 391.5 | 396.5 | 393.65 |
| 400 | 382 | 387 | 384.09 |
| 410 | 372.5 | 377.5 | 374.57 |
| 420 | 363.6 | 368 | 365.08 |
| 430 | 353.5 | 358.5 | 355.63 |
| 440 | 344.8 | 349 | 346.24 |
| 450 | 335 | 339.5 | 336.89 |

For Table 52, the expiry is Jan. 19, 2018, the forward rate is 775.919, the ATM volatility σ₀ is 28.2, 25 Δ_{RR} is −5.28, and 25 Δ_{Fly} is 0.63.

TABLE 52

| Strike | Bid Data | Ask Data | Model Data |
|---|---|---|---|
| 370 | 415.6 | 420 | 417.92 |
| 380 | 406.8 | 411 | 408.85 |
| 390 | 397.7 | 402 | 399.85 |
| 400 | 389.1 | 393 | 390.92 |
| 410 | 380.1 | 384 | 382.06 |
| 420 | 371.1 | 375.5 | 373.28 |
| 430 | 362.2 | 366.5 | 364.58 |
| 440 | 353.7 | 358 | 355.96 |
| 450 | 345.1 | 349.5 | 347.43 |
| 460 | 336.6 | 341 | 339.00 |
| 470 | 328.6 | 332.5 | 330.66 |
| 480 | 320.3 | 325 | 322.43 |
| 490 | 312 | 316.5 | 314.29 |
| 500 | 304 | 308.5 | 306.25 |
| 520 | 288 | 292.5 | 290.47 |
| 540 | 273 | 277.5 | 275.11 |
| 560 | 258.4 | 263 | 260.18 |
| 580 | 243.9 | 248.5 | 245.69 |
| 600 | 229.7 | 234.5 | 231.65 |
| 620 | 216 | 220.5 | 218.06 |

Tables 53-56 are illustrative tables comparing model generated data for the DAX indices to market data for maturities approximately equal to 1 month, 3 months, 1 year, and 2 years.

In Table 53, the expiry is set as Jan. 15, 2016, the forward rate is set as 10769.09, the ATM volatility is set as 20.822, the 25 Δ_{RR} is set at −4.01, and the 25 Δ_{Fly} is set at 0.37.

TABLE 53

| Strike | Exchange Data | Model Data |
|---|---|---|
| 7500.0000 | 3270.5 | 3269.45 |
| 8000.0000 | 2770.6 | 2770.04 |
| 8500.0000 | 2271 | 2271.19 |
| 9000.0000 | 1772.7 | 1773.46 |
| 9500.0000 | 1277.9 | 1278.24 |
| 10000.0000 | 794.1 | 793.44 |
| 10500.0000 | 360.3 | 360.12 |
| 11000.0000 | 81.5 | 81.39 |
| 11500.0000 | 7.5 | 8.07 |
| 12000.0000 | 0.6 | 0.78 |

In Table 54, the expiry is set as Mar. 18, 2016, the forward rate is set as 10763.52, the ATM volatility is set as 21.827, the 25 Δ_{RR} is set at −5.327, and the 25 Δ_{Fly} is set at 0.42.

TABLE 54

| Strike | Exchange Data | Model Data |
|---|---|---|
| 7500.0000 | 3284.2 | 3286.34 |
| 8000.0000 | 2792 | 2794.79 |
| 8500.0000 | 2305.9 | 2307.89 |
| 9000.0000 | 1831.3 | 1831.69 |
| 9500.0000 | 1377.4 | 1375.72 |
| 10000.0000 | 958.4 | 956.54 |
| 10500.0000 | 596.6 | 597.28 |
| 11000.0000 | 317.9 | 320.36 |
| 11500.0000 | 139.7 | 138.22 |
| 12000.0000 | 51.2 | 49.86 |

In Table 55, the expiry is set as Dec. 16, 2016, the forward rate is set as 10825.48, the ATM volatility is set as 21.00, the 25 Δ_{RR} is set at −5.29, and the 25 Δ_{Fly} is set at 0.47.

TABLE 55

| Strike | Exchange Data | Model Data |
|---|---|---|
| 1000.0000 | 9839.4 | 9826.17 |
| 2000.0000 | 8837.1 | 8830.31 |
| 3000.0000 | 7836.7 | 7836.42 |
| 4000.0000 | 6840.6 | 6845.59 |
| 5000.0000 | 5851.9 | 5859.29 |
| 6000.0000 | 4875.4 | 4880.32 |
| 7000.0000 | 3919.4 | 3917.45 |
| 8000.0000 | 3000.9 | 2994.38 |
| 9000.0000 | 2149.8 | 2145.82 |
| 10000.0000 | 1405 | 1405.91 |
| 11000.0000 | 811.6 | 814.53 |
| 12000.0000 | 405 | 401.87 |
| 13000.0000 | 175.4 | 172.68 |

In Table 56, the expiry is set as Dec. 15, 2017, the forward rate is set as 10914.95, the ATM volatility is set as 20.26, the 25 Δ_{RR} is set at −4.51, and the 25 Δ_{Fly} is set at 0.59.

TABLE 56

| Strike | Exchange Data | Model Data |
|---|---|---|
| 2000.0000 | 8925.9 | 8924.05 |
| 3000.0000 | 7930.3 | 7937.60 |
| 4000.0000 | 6946.4 | 6956.98 |
| 5000.0000 | 5978.2 | 5984.25 |
| 6000.0000 | 5031.9 | 5026.04 |
| 7000.0000 | 4119 | 4102.53 |
| 8000.0000 | 3257.3 | 3240.83 |
| 9000.0000 | 2471.1 | 2468.26 |
| 10000.0000 | 1785.2 | 1798.49 |
| 11000.0000 | 1220.7 | 1227.15 |

Tables 57-59 are illustrative tables comparing model generated data for the SPX index to market data for expiries approximately equal to 1 month, 3 months, and 1 year.

In Table 57, the expiry is set as Jan. 15, 2016, the forward rate is set as 2041.841, the ATM volatility is set as 15.42, the 25 Δ_{RR} is set at −4.86, and the 25 Δ_{Fly} is set at 0.06.

TABLE 57

| Strike | Exchange Data | Model Data |
|---|---|---|
| 500 | 1541.65 | 1541.841 |
| 750 | 1291.65 | 1291.841 |
| 1000 | 1041.75 | 1041.841 |
| 1250 | 791.85 | 791.842 |
| 1500 | 541.95 | 541.888 |
| 1750 | 292.55 | 292.530 |
| 2000 | 54.85 | 54.529 |

In Table 58, the expiry is set as Mar. 16, 2016, the forward rate is set as 2032.598, the ATM volatility is set as 16.93, the 25 Δ_{RR} is set at −6.29, and the 25 Δ_{Fly} is set at 0.13.

TABLE 58

| Strike | Exchange Data | Model Data |
|---|---|---|
| 500 | 1532.65 | 1532.672 |
| 750 | 1283.05 | 1282.891 |
| 1000 | 1033.65 | 1033.438 |
| 1250 | 784.65 | 784.522 |
| 1500 | 537.05 | 537.380 |
| 1750 | 295.85 | 297.340 |
| 2000 | 84.75 | 83.681 |

In Table 59, the expiry is set as Dec. 16, 2016, the forward rate is set as 1997.615, the ATM volatility is set as 19.11, the 25 Δ_{RR} is set at −8.84, and the 25 Δ_{Fly} is set at 0.36.

TABLE 59

| Strike | Exchange Data | Model Data |
|---|---|---|
| 500 | 1502.05 | 1501.638 |
| 750 | 1256.25 | 1256.042 |
| 1000 | 1012.45 | 1012.619 |
| 1250 | 773.25 | 774.352 |
| 1500 | 543.05 | 544.874 |
| 1750 | 330.45 | 325.872 |
| 2000 | 151.15 | 152.336 |

Tables 60-63 are illustrative tables comparing model generated data for interests-swaptions to actual market data. For instance, swaptions in USD may be determined. The swaptions, for example, may have maturities ranging between one year and ten years for the underlying swap being 5 years (e.g., 1Y5Y, 2Y5Y, 5Y5Y, 10Y5Y, etc.). Using these swaption values, the implied volatilities may be determined. For a particular maturity, the volatility smile may be determined that most closely replicates the market data using the three volatility inputs, as described previously. As seen from Tables 60-63, the market data and the model generated data are substantially similar.

In Table 60, a 1Y5Y swaption is presented having a forward of 2.065, an ATM volatility σ₀ is 36.7, 25 Δ_{RR} is −10, and 25 Δ_{Fly} is 2.

TABLE 60

| Strike bp | Strike | Market | Model |
|---|---|---|---|
| From Forward | (in %) | Volatility | Volatility |
| −150 | 0.565 | 74.1 | 74.42 |
| −100 | 1.065 | 55.09 | 54.91 |
| −50 | 1.565 | 44.76 | 45.02 |
| −25 | 1.815 | 41.23 | 41.99 |
| 0 | 2.065 | 38.39 | 38.43 |
| 25 | 2.315 | 36.73 | 36.54 |
| 50 | 2.565 | 35.64 | 35.52 |
| 100 | 3.065 | 35.14 | 35.02 |
| 150 | 4.065 | 37.34 | 37.29 |

In Table 61, a 2Y5Y swaption is presented having a forward of 2.300, an ATM volatility σ₀ is 33, 25 Δ_{RR} is −9, 25 Δ_{Fly} is 3.3.

TABLE 61

| Strike bp | Strike | Market | Model |
|---|---|---|---|
| From Forward | (in %) | Volatility | Volatility |
| −150 | 0.8 | 62.48 | 62.07 |
| −100 | 1.3 | 49.32 | 48.12 |
| −50 | 1.8 | 41.27 | 41.27 |
| −25 | 2.05 | 38.34 | 38.72 |
| 0 | 2.3 | 36.04 | 36.01 |
| 25 | 2.55 | 34.2 | 34.11 |
| 50 | 2.800 | 32.90 | 32.73 |
| 100 | 73.3 | 31.61 | 31.98 |
| 150 | 3.8 | 31.54 | 31.69 |

In Table 62, a 5Y5Y swaption is presented having a forward of 2.7090, an ATM volatility σ₀ is 29, 25 Δ_{RR} is −8.65, and 25 Δ_{Fly} is 3.5.

TABLE 62

| Strike bp | Strike | Market | Model |
|---|---|---|---|
| From Forward | (in %) | Volatility | Volatility |
| −150 | 1.209% | 49.35 | 49.02 |
| −100 | 1.709 | 41.93 | 45.51 |
| −50 | 2.209 | 36.79 | 36.61 |
| −25 | 2.459 | 34.76 | 34.64 |
| 0 | 2.709 | 32.99 | 32.74 |
| 25 | 2.959 | 31.51 | 31.32 |
| 50 | 3.209 | 30.23 | 30.13 |
| 100 | 3.709 | 28.29 | 28.11 |
| 150 | 4.209 | 27.05 | 27.21 |

In Table 63, a 10Y5Y swaption is presented having a forward of 2.9840, an ATM volatility σ₀ is 24, 25 Δ_{RR} is −6.2, and 25 Δ_{Fly} is 4.

TABLE 63

| Strike bp | Strike | Market | Model |
|---|---|---|---|
| From Forward | (in %) | Volatility | Volatility |
| −150 | 1.484 | 39.36 | 40.04 |
| −100 | 1.984 | 34.02 | 34.41 |
| −50 | 2.484 | 30.23 | 30.43 |
| −25 | 2.734 | 28.72 | 28.99 |
| 0 | 2.984 | 27.4 | 27.44 |
| 25 | 3.234 | 26.23 | 26.37 |
| 50 | 3.484 | 25.28 | 25.33 |
| 100 | 3.984 | 23.73 | 23.81 |
| 150 | 4.484 | 22.66 | 22.93 |

Tables 64-67 are illustrative tables comparing model generated data for interests-swaptions to actual market data. For instance, swaptions in EUR may be determined. The swaptions, for example, may have maturities ranging between one year and ten years for the underlying swap being 5 years (e.g., 1Y5Y, 2Y5Y, 5Y5Y, 10Y5Y, etc.). Using these swaption values, the implied volatilities may be determined. For a particular maturity, the volatility smile may be determined that most closely replicates the market data using the three volatility inputs, as described previously. As seen from Tables 64-67, the market data and the model generated data are substantially similar.

In Table 64, a 1Y5Y swaption is presented having a forward of 0.5790, an ATM volatility σ₀ of 72.4, a 25 Δ_{RR} of −22, and a 25 Δ_{Fly} of 2.5.

TABLE 64

| Strike bp | Strike | Market | Model |
|---|---|---|---|
| From Forward | (in %) | Volatility | Volatility |
| −25 | 0.329 | 99.68 | 97.12 |
| 0 | 0.579 | 79.47 | 79.32 |
| 25 | 0.829 | 70.53 | 70.42 |
| 50 | 1.079 | 65.80 | 65.83 |
| 100 | 1.1579 | 61.33 | 61.59 |
| 200 | 2.579 | 58.62 | 58.81 |
| 300 | 3.579 | 58.14 | 58.49 |

In Table 65, a 2Y5Y swaption is presented having a forward of 0.8780, an ATM volatility σ₀ of 57.3, a 25 Δ_{RR} of −20, and a 25 Δ_{Fly} of 2.5.

TABLE 65

| Strike bp | Strike | Market | Model |
|---|---|---|---|
| From Forward | (in %) | Volatility | Volatility |
| −25 | 0.628 | 72.99 | 72.04 |
| 0 | 0.878 | 63.22 | 62.98 |
| 25 | 1.128 | 57.32 | 57.13 |
| 50 | 1.378 | 53.46 | 53.39 |
| 100 | 1.878 | 46.54 | 46.51 |
| 150 | 2.378 | 45.17 | 45.03 |
| 200 | 2.878 | 43.89 | 44.02 |

In Table 66, a 5Y5Y swaption is presented having a forward of 1.6940, an ATM volatility σ₀ of 34, a 25 Δ_{RR} of −7.9, and a 25 Δ_{Fly} of 2.6.

TABLE 66

| Strike bp | Strike | Market | Model |
|---|---|---|---|
| From Forward | (in %) | Volatility | Volatility |
| −100 | 0.694 | 63.44 | 62.92 |
| −75 | 0.944 | 49.52 | 49.03 |
| −50 | 1.194 | 45.56 | 45.23 |
| −25 | 1.444 | 43.96 | 44.01 |
| 0 | 1.694 | 41.34 | 41.28 |
| 25 | 1.944 | 38.4 | 38.53 |
| 50 | 2.194 | 35.66 | 35.59 |
| 100 | 2.694 | 32.42 | 32.49 |
| 150 | 3.194 | 30.68 | 29.77 |

In Table 67, a 10Y5Y swaption is presented having a forward of 2.2980, an ATM volatility σ₀ of 27.7, a 25 Δ_{RR} of −6, and a 25 Δ_{Fly} of 3.5.

TABLE 67

| Strike bp | Strike | Market | Model |
|---|---|---|---|
| From Forward | (in %) | Volatility | Volatility |
| −100 | 1.298 | 42.6 | 42.12 |
| −50 | 1.798 | 36.36 | 36.43 |
| −25 | 2.048 | 34.56 | 34.26 |
| 0 | 2.298 | 32.87 | 33.02 |
| 25 | 2.548 | 31.47 | 31.96 |
| 50 | 2.798 | 30.3 | 30.77 |
| 100 | 3.798 | 28.46 | 28.87 |
| 200 | 4.298 | 26.07 | 26.51 |

Tables 68-71 are illustrative tables comparing model generated data for interests-swaptions to actual market data, where a volatility shift is employed. For instance, swaptions having a volatility shift in EUR may be determined. The swaptions, for example, may have maturities ranging between one year and ten years for the underlying swap being 5 years (e.g., 1Y5Y, 2Y5Y, 5Y5Y, 10Y5Y, etc.). Using these swaption values, the implied volatilities may be determined. For a particular maturity, the volatility smile may be determined that most closely replicates the market data using the three volatility inputs, as described previously. As seen from Tables 68-71, the market data and the model generated data are substantially similar.

In Table 68, a 1Y5Y swaption is presented having a shift of 2.6000%, a shifted forward of 3.1790, an ATM volatility σ₀ of 14, a 25 Δ_{RR} of 1.4, and a 25 Δ_{Fly} of 0.7.

TABLE 68

| | | Shifted | | |
|---|---|---|---|---|
| Strike bp | Strike | Strike | Market | Model |
| From Forward | (in %) | (in %) | Volatility | Volatility |
| −150 | −0.921 | 1.679 | 17.75 | 18.51 |
| −100 | −0.421 | 2.179 | 16.49 | 16.98 |
| −50 | −0.079 | 2.679 | 15.19 | 15.31 |
| −25 | 0.329 | 2.929 | 14.59 | 14.42 |
| 0 | 0.579 | 3.179 | 14.12 | 14.09 |
| 25 | 0.829 | 3.429 | 13.89 | 13.92 |
| 50 | 1.079 | 3.679 | 14.02 | 13.83 |
| 100 | 1.1579 | 4.179 | 15.6 | 15.46 |
| 200 | 2.579 | 5.179 | 23.81 | 24.12 |

In Table 69, a 2Y5Y swaption is presented having a shift of 2.6000%, a shifted forward of 3.4780, an ATM volatility σ₀ of 15.5, a 25 Δ_{RR} of 3.9, and a 25 Δ_{Fly} of 0.95.

TABLE 69

| | | Shifted | | |
|---|---|---|---|---|
| Strike bp | Strike | Strike | Market | Model |
| From Forward | (in %) | (in %) | Volatility | Volatility |
| −150 | −0.622 | 1.978 | 16.5 | 17.19 |
| −100 | −0.122 | 2.478 | 15.99 | 16.37 |
| −50 | 0.378 | 2.978 | 15.6 | 15.59 |
| −25 | 0.628 | 3.228 | 15.49 | 15.31 |
| 0 | 0.878 | 3.478 | 15.48 | 15.12 |
| 25 | 1.128 | 3.728 | 15.59 | 15.51 |
| 50 | 1.378 | 3.978 | 15.86 | 16.10 |
| 100 | 1.878 | 4.478 | 16.97 | 17.47 |
| 200 | 2.878 | 5.478 | 22.22 | 22.44 |

In Table 70, a 5Y5Y swaption is presented having a shift of 2.6000%, a shifted forward of 4.2940, an ATM volatility σ₀ of 16.9, a 25 Δ_{RR} of 5.8, and a 25 Δ_{Fly} of 1.

TABLE 70

| Strike bp | | Shifted | | |
|---|---|---|---|---|
| From | Strike (in | Strike | Market | Model |
| Forward | %) | (in %) | Volatility | Volatility |
| −200 | −0.306 | 2.294 | 15.64 | 16.02 |
| −150 | 0.194 | 2.794 | 15.66 | 15.93 |
| −100 | 0.694 | 3.294 | 15.76 | 15.49 |
| −50 | 1.194 | 3.794 | 15.95 | 15.71 |
| −25 | 1.444 | 4.044 | 16.09 | 15.91 |
| 0 | 1.694 | 4.294 | 16.27 | 16.46 |
| 25 | 1.944 | 4.544 | 16.49 | 16.69 |
| 50 | 2.194 | 4.794 | 16.77 | 16.99 |
| 100 | 2.694 | 5.294 | 17.5 | 17.77 |

In Table 71, a 10Y5Y swaption is presented having a shift of 2.6000%, a shifted forward of 4.8980, an ATM volatility σ₀ of 15.8, a 25 Δ_{RR} of 6.75, and a 25 Δ_{Fly} of 1.1.

TABLE 71

| Strike bp | | Shifted | | |
|---|---|---|---|---|
| From | Strike (in | Strike | Market | Model |
| Forward | %) | (in %) | Volatility | Volatility |
| −200 | 0.298 | 2.898 | 13.98 | 14.28 |
| −150 | 0.798 | 3.398 | 14.1 | 13.93 |
| −100 | 1.298 | 3.898 | 14.27 | 14.11 |
| −50 | 1.798 | 4.398 | 14.53 | 14.40 |
| −25 | 2.048 | 4.648 | 14.7 | 14.59 |
| 0 | 2.298 | 4.898 | 14.89 | 14.99 |
| 25 | 2.548 | 5.148 | 15.11 | 15.28 |
| 50 | 2.798 | 5.398 | 15.37 | 15.51 |
| 100 | 3.298 | 5.898 | 16.0 | 16.02 |

Tables 72-75 are illustrative tables comparing model generated data for interests-swaptions to actual market data. For instance, swaptions in JPY may be determined. The swaptions, for example, may have maturities ranging between one year and ten years for the underlying swap being 5 years (e.g., 1Y5Y, 2Y5Y, 5Y5Y, 10Y5Y, etc.). Using these swaption values, the implied volatilities may be determined. For a particular maturity, the volatility smile may be determined that most closely replicates the market data using the three volatility inputs, as described previously. As seen from Tables 72-75, the market data and the model generated data are substantially similar.

In Table 72, a 1Y5Y swaption is presented having a forward of 0.2290, an ATM volatility σ₀ of 74, a 25 Δ_{RR} of −3.5, and a 25 Δ_{Fly} of 0.23.

TABLE 72

| Strike bp From | | Market | Model |
|---|---|---|---|
| Forward | Strike (in %) | Volatility | Volatility |
| 0 | 0.229 | 75.11 | 74.97 |
| 25 | 0.479 | 72.42 | 72.52 |
| 50 | 0.729 | 71.03 | 71.01 |
| 100 | 1.229 | 69.24 | 69.31 |
| 150 | 1.729 | 70.18 | 69.78 |
| 200 | 2.229 | 71.6 | 70.91 |

In Table 73, a 2Y5Y swaption is presented having a forward of 0.3170, an ATM volatility σ₀ of 69, a 25 Δ_{RR} of −3.5, and a 25 Δ_{Fly} of 2.9.

TABLE 73

| Strike bp From | | Market | Model |
|---|---|---|---|
| Forward | Strike (in %) | Volatility | Volatility |
| 0 | 0.317 | 71.24 | 71.98 |
| 25 | 0.567 | 69.14 | 68.96 |
| 50 | 0.817 | 70.33 | 69.93 |
| 100 | 1.317 | 73.02 | 72.89 |
| 150 | 1.817 | 75.08 | 75.12 |
| 200 | 2.317 | 76.62 | 76.95 |

In Table 74, a 5Y5Y swaption is presented having a forward of 0.6810, an ATM volatility σ₀ of 51.9, a 25 Δ_{RR} of −3.5, and a 25 Δ_{Fly} of 2.9.

TABLE 74

| Strike bp From | | Market | Model |
|---|---|---|---|
| Forward | Strike (in %) | Volatility | Volatility |
| −25 | 0.431 | 61.66 | 61.13 |
| 0 | 0.681 | 55.82 | 56.01 |
| 25 | 0.931 | 53.37 | 53.76 |
| 50 | 1.181 | 52.26 | 52.47 |
| 100 | 1.681 | 51.48 | 51.33 |
| 200 | 2.681 | 51.39 | 51.79 |

In Table 75, a 10Y5Y swaption is presented having a forward of 1.4220, an ATM volatility σ₀ of 31.6, a 25 Δ_{RR} of 0.15, and a 25 Δ_{Fly} of 3.

TABLE 75

| Strike bp From | | Market | Model |
|---|---|---|---|
| Forward | Strike (in %) | Volatility | Volatility |
| −100 | 0.672 | 39.25 | 39.03 |
| −50 | 1.172 | 33.7 | 34.01 |
| −25 | 1.422 | 32.67 | 32.89 |
| 0 | 1.672 | 32.18 | 32.43 |
| 25 | 1.922 | 32 | 32.01 |
| 50 | 2.172 | 32 | 31.94 |
| 100 | 2.922 | 32.43 | 32.39 |
| 150 | 3.422 | 32.82 | 32.81 |

Tables 76-79 are illustrative tables comparing model generated data for interests-swaptions to actual market data. For instance, swaptions in CHF, with shifted volatilities, may be determined. The swaptions, for example, may have maturities ranging between one year and ten years for the underlying swap being 5 years (e.g., 1Y5Y, 2Y5Y, 5Y5Y, 10Y5Y, etc.). Using these swaption values, the implied volatilities may be determined. For a particular maturity, the volatility smile may be determined that most closely replicates the market data using the three volatility inputs, as described previously. As seen from Table 76-79, the market data and the model generated data are substantially similar.

In Table 76, a 1Y5Y swaption is presented having a forward of −0.074, an ATM volatility σ₀ of 29.5, a 25 Δ_{RR} of −3, and a 25 Δ_{Fly} of 0.8. The shift is 2.0%, and the shifted forward is 1.926.

TABLE 76

| Strike bp | | | | |
|---|---|---|---|---|
| From | Strike (in | Shifted | Market | Model |
| Forward | %) | Strike | Volatility | Volatility |
| −150 | −1.574 | 0.426 | 58.83 | 58.01 |
| −100 | −1.074 | 0.926 | 40.92 | 41.07 |
| −50 | −0.574 | 1.426 | 33.11 | 32.99 |
| −25 | −0.324 | 1.676 | 31.02 | 31.21 |
| 0 | −0.074 | 1.926 | 29.81 | 29.92 |
| 25 | 0.176 | 2.176 | 29.29 | 29.36 |
| 50 | 0.426 | 2.426 | 29.23 | 29.13 |
| 100 | 0.926 | 2.926 | 29.9 | 29.62 |
| 150 | 1.426 | 3.426 | 30.96 | 30.81 |
| 200 | 1.926 | 3.926 | 32.12 | 32.11 |

In Table 77, a 2Y5Y swaption is presented having a forward of 0.182, an ATM volatility σ₀ of 29.5, a 25 Δ_{RR} of −3.9, and a 25 Δ_{Fly} of 1.4. The shift is 2.0%, and the shifted forward is 2.182.

TABLE 77

| Strike bp | | | | |
|---|---|---|---|---|
| From | Strike (in | Shifted | Market | Model |
| Forward | %) | Strike | Volatility | Volatility |
| −150 | −1.318 | 0.682 | 49.15 | 48.67 |
| −100 | −0.818 | 1.182 | 38.51 | 38.14 |
| −50 | −0.318 | 1.682 | 33.11 | 33.3 |
| −25 | −0.068 | 1.932 | 31.47 | 31.73 |
| 0 | 0.182 | 2.182 | 30.37 | 30.54 |
| 25 | 0.432 | 2.432 | 29.69 | 29.43 |
| 50 | 0.682 | 2.682 | 29.33 | 29.09 |
| 100 | 1.182 | 3.182 | 29.24 | 29.12 |
| 150 | 1.682 | 3.682 | 29.62 | 29.41 |
| 200 | 2.182 | 4.182 | 30.19 | 30.22 |

In Table 78, a 5Y5Y swaption is presented having a forward of 0.79, an ATM volatility σ₀ of 25.6, a 25 Δ_{RR} of −4.5, and a 25 Δ_{Fly} of 2. The shift is 2.0%, and the shifted forward is 2.79.

TABLE 78

| Strike bp | | | | |
|---|---|---|---|---|
| From | Strike (in | Shifted | Market | Model |
| Forward | %) | Strike | Volatility | Volatility |
| −150 | −0.710 | 1.290 | 37.36 | 37.01 |
| −100 | −0.210 | 1.790 | 32.28 | 31.98 |
| −50 | 0.290 | 2.290 | 29.07 | 29.06 |
| −25 | 0.540 | 2.540 | 27.98 | 28.03 |
| 0 | 0.790 | 2.790 | 27.17 | 27.58 |
| 25 | 1.040 | 3.040 | 26.60 | 26.97 |
| 50 | 1.290 | 3.290 | 26.21 | 26.01 |
| 100 | 1.790 | 3.790 | 25.88 | 25.92 |
| 150 | 2.290 | 4.290 | 25.91 | 25.71 |
| 200 | 2.790 | 4.790 | 26.13 | 26.06 |

In Table 79, a 10Y5Y swaption is presented having a forward of 0.79, an ATM volatility σ₀ of 22, a 25 Δ_{RR} of −5.1, and a 25 Δ_{Fly} of 2.25. The shift is 2.0%, and the shifted forward is 2.79.

TABLE 79

| Strike bp | | | | |
|---|---|---|---|---|
| From | Strike (in | Shifted | Market | Model |
| Forward | %) | Strike | Volatility | Volatility |
| −150 | −0.336 | 1.664 | 30.34 | 30.82 |
| −100 | 0.164 | 2.164 | 27.10 | 27.72 |
| −50 | 0.664 | 2.664 | 24.96 | 25.08 |
| −25 | 0.914 | 2.914 | 24.20 | 24.57 |
| 0 | 1.164 | 3.164 | 23.62 | 23.91 |
| 25 | 1.414 | 3.414 | 23.19 | 23.46 |
| 50 | 1.664 | 3.664 | 22.88 | 22.99 |
| 100 | 2.164 | 4.164 | 22.54 | 22.31 |
| 150 | 2.664 | 4.664 | 22.47 | 22.23 |
| 200 | 3.164 | 5.164 | 22.55 | 22.42 |

### VI. The Full Density Grid

In the previous embodiments described above, the vanilla model having the translational invariant assumption was used. In this scenario, three volatility inputs from market data were able to be used to generate the full volatility smile for a given expiry. Here, the translational invariant assumption is removed, and techniques for determining the expectation for an implied local smile at any future time for an underlying spot price for given market data are described. In the illustrative embodiment, the three input values may correspond to: (i) σ₀(t): the volatility for d₁=0 for an option having expiry at time t; (ii) 25 Δ_{RR}(t)=σ(d₁=D₂₅)−σ(d₁=−D₂₅) for expiry at time t; and (iii) 25 Δ_{Fly}(t)=(σ(d₁=−D₂₅)+σ(d₁=D₂₅))/2−σ₀(t) for expiry at time t. D₂₅, for instance, may be determined using Equations 3 or 4 by solving for d₁ using Δ=0.25 or Δ=−0.25, respectively. For example, if the foreign rates/dividend rate/cost of carry is zero, then D₂₅=0.67449, as seen from Table 1. As seen previously, the functions A(d₁, t) and B(d₁, t) may be determined using the three input market data input values as described previously.

In one embodiment, determining the market expectation for a future local smile at time t and expiry T, for underlying spot s, corresponds to finding values for the three quantities of Equation 142:

σ₀=σ₀(T,s,t);25 Δ_{RR}=25 Δ_{RR}(T,s,t);25 Δ_{Fly}=25 Δ_{Fly}(T,s,t) Equation 142.

The forward rate F=F(T, s, t) should also change for non-interest rate options, however for simplicity, it is assumed that F does not change, generally.

Generally, σ₀(T, s, t), 25 Δ_{RR}(T, s, t), and 25 Δ_{Fly}(T, s, t) are all path dependent along s₀ to s. For instance, using an equal temporal interval, from (s₀, 0) to (s, t), σ₀ may be expected to be much smaller than if s remained close to s₀ for most of the temporal duration, and merely jumped to s just prior to time t. As another example, σ₀ may become very large if spot s zig-zags frequently with a large amplitude from s₀ to s at time t. Similarly, the same argument is applicable to 25 Δ_{RR}(T, s, t) and 25 Δ_{Fly}(T, s, t). Thus, the implied local volatility smile may correspond to an expected value of σ₀(T, s, t), 25 Δ_{RR}(T, s, t), and 25 Δ_{Fly}(T, s, t), taking into account a probability of using a different path to go from (s₀, 0) to (s, t).

In some embodiments, an amount of time T−t may be substantially small, such as one day or less, in which case there is little relevance to the path and the local implied smile is more meaningful.

The implied local volatility smile may be determined from one expiry date to another. For a first volatility smile at a first expiry time T₁ and a second volatility smile at a second expiry time T₂, the implied volatility smile at any spot s₁ at the first expiry time T₁ to the second expiry time T₂ may be determined. Using the determined implied volatility smile for s₁, the implied transition probability density g(s₁, T₁, ->s₂, T₂) may be determined. This may be referred to as a “contingent probability density” g(s₂, T₂|s₁, T₁).

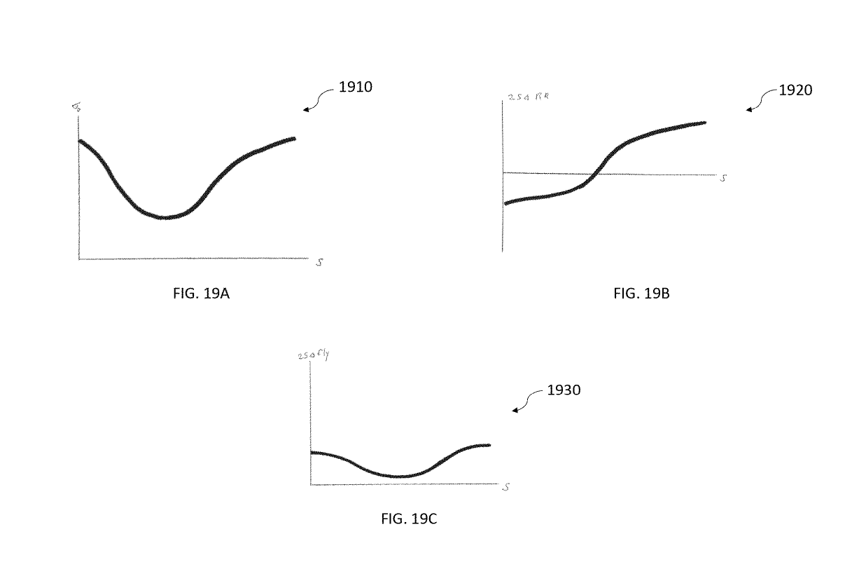

FIGS. 19A-C are an illustrative graphs of the behavior of the forward implied local smile, where FIG. 19A is an illustrative graph of the ATM volatility σ₀(T, s, t), FIG. 19B is an illustrative graph of the behavior of the 25 Δ_{RR}(T, s, t), and FIG. 19C is an illustrative graph of the behavior of the 25 Δ_{Fly}(T, s, t), in accordance with various embodiments. FIG. 19A is an illustrative graph of the behavior of the ATM volatility σ₀(T, s, t), in accordance with various embodiments. In Equation 85, the ATM volatility σ₀(T, s, t) correspond to a function of spot s. The function may be smooth and positive, having one minimum with a turning point at either side of the minimum. For instance, as seen from graph 1910 of FIG. 19A, on a first side of the minimum, the function may be monotonically increasing, and at a large value of spot s, the function may increase at a steadily decreasing rate. At a second side of the minimum in graph 1910, the function may be monotonically decreasing, and at a low value of spot s, the function may decrease at a steadily increasing rate.

FIG. 19B is an illustrative graph of the behavior of the 25 Δ_{RR}(T, s, t), in accordance with various embodiments. A large move in an underlying asset's price, generally, may cause the market to align with the move in the option market, and therefore the risk reversal may tend to favor a direction of such a move. Typically, an amount of overshoot occurs whenever a substantial change to the market occurs, however for very large moves, the overshoot may be smaller. Thus, the behavior of 25 Δ_{RR}, from Equation 85, as seen by graph 1920 of FIG. 19B, may correspond to a monotonically increasing function, having a positive value for large spot s, and having a negative value for very small spot s. The rate of growth, therefore, of graph 1920 may decrease for a very large spot s, and similarly may increase for a very small spot s. As an illustrative example, for no arbitrage situations, |25 Δ_{RR}(s)|<<0.5 σ₀(s), however the ratio of 25 Δ_{RR}(s)/σ₀(s) may tend to decrease at the limits of very large, and very small, values of spot s.

FIG. 19C is an illustrative graph of the behavior of the 25 Δ_{Fly}(T, s, t), in accordance with various embodiments. In some embodiments, 25 Δ_{Fly}(s) of Equation 85 may have a similar behavior as that of the ATM volatility σ₀(s). For instance, graph 1930 of FIG. 19C describes 25 Δ_{Fly}(s), which may have one minimum while also being positive. For very large values of spot s and very small values of spot s, 25 Δ_{Fly}(s) may saturate, as even large changes to the ATM volatility σ₀(s) may correspond to a very small change in 25 Δ_{Fly}(s).

The forward rate F(s) may also be a monotonically increasing function of spot s, and the ratio of the forward rate F(s) to spot s (e.g., F(s)/s) may also increase for very large values of spot s, while decreasing for very small values of spot s. The ratio (e.g., F(s)/s) may correspond to the exponent of the interest rates differential. For example, when a particular currency devaluates sharply, it may be expected that the interest rate will increase. As another example, when a stock price dramatically decreases, it may be expected that the corresponding dividend rate will also decrease. As still yet another example, when a price of a particular commodity (e.g., gold) dramatically decreases, it may be expected that the associated cost of carry will also decrease. Thus, regardless of the asset class, the ratio should increase when there is a drastic increase in price, whereas the ratio should decrease when there is a drastic decrease in price.

Still further, the behavior of all the volatility smile input parameters, as well as the forward rate, depend on the time to maturity. Thus, the longer the temporal duration to maturity, the more moderate the changes of the volatility smile parameters will be for volatility smiles at expiries t₁ and t₂.

In order to determine the implied local volatility smile from t₁ and t₂, the price P may be determined using Equation 143:

P(K,t₂,s₀)=df₁∫ds₁g(s₀,0→s₁,t₁))P(K,t₂,t₁,s₁) Equation 143.

In Equation 143, P(K, t₂, t₁, s₁) may be represented by Equation 144:

P(K,t₂,t₁,s₁)=P(K,t₂,t₁,s₁,σ₀(t₂,t₁,s₁),25 Δ_{RR}(t₂,t₁,s₁),25 Δ_{Fly}(t₂,t₁,s₁)) Equation 144.

Furthermore, in Equation 143, g(s₀, 0, ->s₁, t₁) may corresponded to the volatility smile for time t₁ and discount factor df₁, the discount factor df₁ being from time t=0 to time t=t₁. From Equation 144, the values for σ₀(s₁), 25 Δ_{RR}(s₁), and 25 Δ_{Fly}(s₁) are needed in order to determine P(K, t₂, t₁, s₁). In a non-limiting embodiment, to determine σ₀(s₁), 25 Δ_{RR}(s₁), and 25 Δ_{Fly}(s₁), N spot points sᵢ at time t₁ are selected (e.g., N=9). At each spot sᵢ, σ₀(sᵢ), 25 Δ_{RR}(sᵢ), and 25 Δ_{Fly}(sᵢ) may be determined, the values between each spot sᵢ may then be determined using the interpolation techniques described above. Thus, in this particular scenario, the determination of the smile parameters correspond to 3N input parameters. Similarly, if the forward rate F(sᵢ) is also included, then there are 4N input parameters to determine. After selecting the N spot points sᵢ, M strikes Kⱼ may be selected from both sides of the ATM strike at expiry t₂, covering the entire area from the ATM to small values of delta call/put (e.g., −C≦d₁(t₂)≦C, where d₁(t₂) corresponds to the volatility smile at expiry t₂). For example, C may be 2, and M may be 21.

In some embodiments, the 3N input parameters (or 4N if Forward rate is used) may be determined using LMA techniques, however persons of ordinary skill in the art will recognize that any suitable multi-variable least-squared technique may be used. For instance, using Equation 143 as the target function to be solved as it relates to the known volatility smile at time t₂, the minimum of Equation 143 may be described by Equation 145:

Min Σⱼ{(P(Kⱼ,t₂,s₀)−df₁∫ds₁g(s₀,0→t₁))P(Kj,t₂,t₁,s₁))Vegan(Kj,t₂)}²+ΣᵢCᵢ Equation 145.

For Equation 145, in one embodiment, three conditions are needed to be met for determining a solution. First, 25 Δ_{RR} is to be monotonically increasing. This may be obtained by generating 25 Δ_{RR} such that it only includes positive increments for 25 Δ_{RR}(sᵢ₊₁)−25 Δ_{RR}(sᵢ). Next, σ₀(sᵢ) and 25 Δ_{Fly}(sᵢ) are generated such that they are always positive and have a single minimum. Furthermore, in Equation 145, Σᵢ Cᵢ corresponds to the smoothness of the shape of σ₀(s), 25 Δ_{RR}(s), and 25 Δ_{Fly}(s), and may be related to the 3N (or 4N) input parameters in a similar way as in Equation 111. The Cᵢ's may allow for smoothing of the fluctuations caused by N being large. Thus, the smoothness applies a small amount of weighting to the input parameters such that any fluctuations are reduced, while ensuring that accuracy is maintained. As an illustrative example, N=9 spot price points. For instance, the spot set {sᵢ} may include the ATM strike for expiry t₁ and 4 strikes on either side of the ATM strike up to d₁=3.5. Thus, for N=9, there are 27 variables to determine.

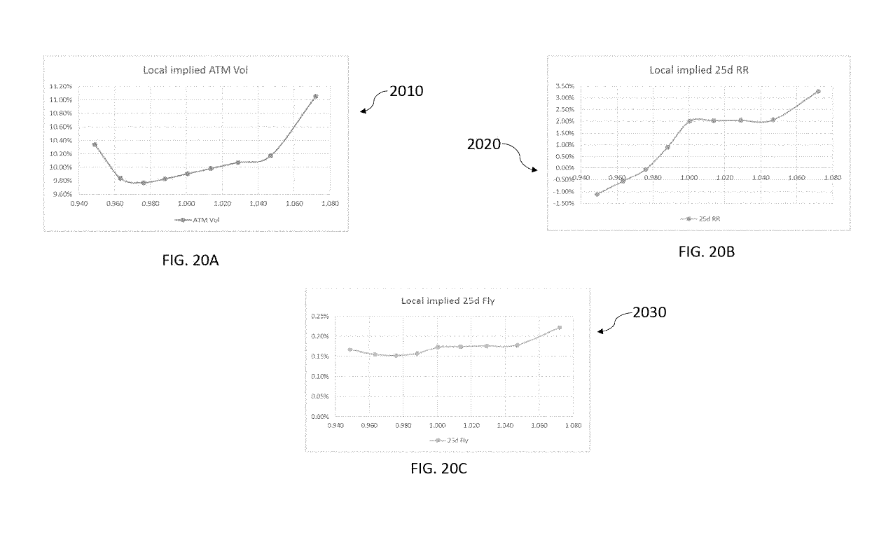

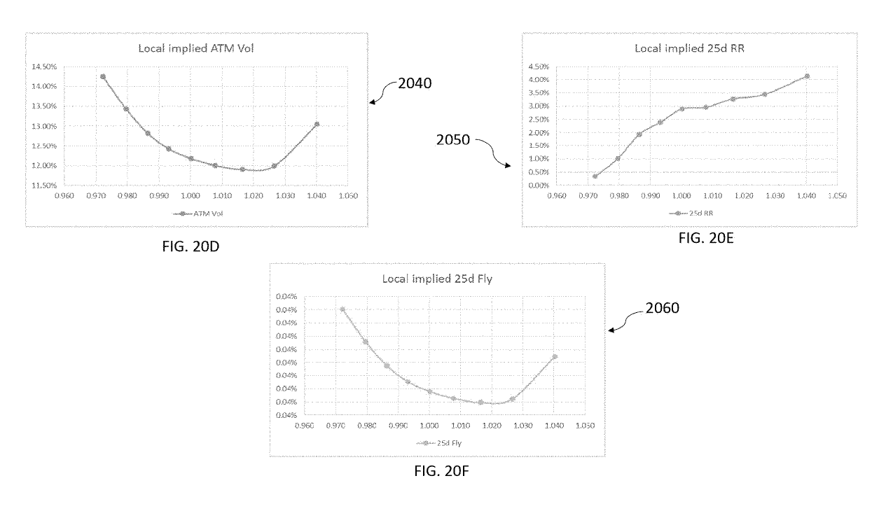

FIGS. 20A-F are illustrative graphs of the various input parameters for N=9 spot price points, in accordance with various embodiments. FIGS. 20A-C, in the exemplary embodiment, describes the implied local volatility smile of the three input parameters for a first expiry t₁ being one month and a second expiry t₂ being two months. For instance, graph 2010 of FIG. 20A describes the implied local ATM volatility, where the term structures used correspond to σ₀=10, 25 Δ_{RR}=1, and 25 Δ_{Fly}=0.25 for both times t₁ and t₂. Graph 2020 of FIG. 20B describes the implied local 25 Δ_{RR}, where the term structures used also correspond to σ₀=10, 25 Δ_{RR}=1, and 25 Δ_{Fly}=0.25 for both expiries t₁ and t₂. Graph 2030 of FIG. 20C describes the implied local 25 Δ_{Fly}, where the term structures used also correspond to σ₀=10, 25 Δ_{RR}=1, and 25 Δ_{Fly}=0.25 for expiries times t₁ and t₂.

FIGS. 20D-F, in the exemplary embodiment, describes the implied local volatility smile of the three input parameters for a first expiry t₁ being one week and a second expiry t₂ being one month. Graph 2040 of FIG. 20D describes the implied local ATM volatility, where the term structure used corresponds to σ₀=12, 25 Δ_{RR}=1.5, and 25 Δ_{Fly}=0.2 at t₁, and for σ₀=12.25, 25 Δ_{RR}=1.65, and 25 Δ_{Fly}=0.22 for t₂. Graph 2050 of FIG. 20E describes the implied local 25 Δ_{RR}, where the term structure used is the same as that of FIG. 20D. Graph 2060 of FIG. 20F describes the implied local 25 Δ_{Fly}, where the term structure used is the same as FIG. 20D. Tables 80 and 81 further describe the values for σ₀, 25 Δ_{RR}, and 25 Δ_{Fly} for each of the N=9 spot price points associated with FIGS. 20A-F, respectively.

TABLE 80

| S | 0.949 | 0.963 | 0.976 | 0.988 | 1.000 | 1.014 | 1.029 | 1.047 | 1.072 |
|---|---|---|---|---|---|---|---|---|---|
| logS | −0.053 | −0.038 | −0.024 | −0.012 | 0.000 | 0.014 | 0.028 | 0.046 | 0.070 |
| ATM Vol | 10.34% | 9.84% | 9.77% | 9.83% | 9.90% | 9.98% | 10.07% | 10.17% | 11.05% |
| 25 d RR | −1.11% | −0.56% | −0.05% | 0.91% | 2.01% | 2.04% | 2.04% | 2.06% | 3.27% |
| 25 d Fly | 0.17% | 0.16% | 0.15% | 0.16% | 0.17% | 0.17% | 0.18% | 0.18% | 0.22% |

TABLE 81

| S | 0.972 | 0.980 | 0.986 | 0.993 | 1.000 | 1.008 | 1.016 | 1.027 | 1.040 |
|---|---|---|---|---|---|---|---|---|---|
| logS | −0.028 | −0.021 | −0.014 | −0.007 | 0.000 | 0.008 | 0.016 | 0.026 | 0.039 |
| ATM Vol | 14.24% | 13.43% | 12.82% | 12.42% | 12.18% | 12.01% | 11.90% | 11.99% | 13.05% |
| 25 d RR | 0.33% | 1.01% | 1.94% | 2.39% | 2.90% | 2.96% | 3.28% | 3.44% | 4.13% |
| 25 d Fly | 0.04% | 0.04% | 0.04% | 0.04% | 0.04% | 0.04% | 0.04% | 0.04% | 0.04% |

As seen by FIGS. 20A-F, as well as Tables 80 and 81, for larger values of t₂−t₁, the shape of σ₀, 25 Δ_{RR}, and 25 Δ_{Fly} is less steep.

The implied volatility smile may be determined from one day to the next, however for large expiries, this may become time consuming. To alleviate this, the number of variables may be reduced, in one embodiment, by performing a Tailor Expansion by N(d₁) for 25 Δ_{RR} and 25 Δ_{Fly}, as seen by Equations 146 and 147:

25 Δ_{RR}(d₁)=r₀+r₁(N(d₁)−0.5) Equation 146; and

25 Δ_{Fly}(d₁)=f₀+f₂(N(d₁)−0.5−f₁)² Equation 147.

An approximation for σ₀(s₁) may be determined either in a similar form of Equation 147 (e.g. σ₀(d₁)=σ₀₀+σ₀₂ (N(d₁)−0.5−σ₀₁)²) or as a valid volatility smile σ*(K) (e.g., σ₀(s₁)=σ*(K=s₁)), where σ*(K) may be determined using a particular set of σ₀*, 25 Δ_{RR}*, and 25 Δ_{Fly}*. Thus, a number of variables may be reduced from 27 (e.g., N=9), to eight variables.

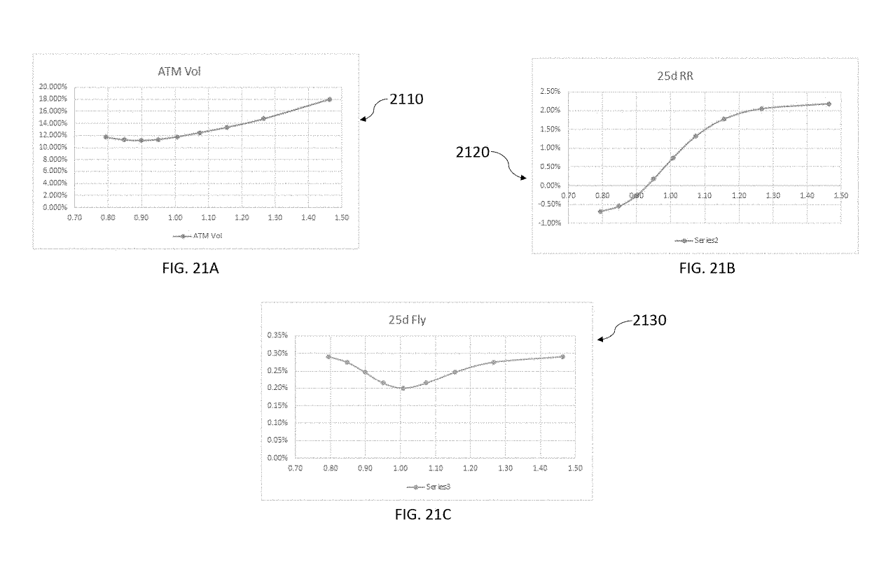

FIGS. 21A-C are illustrative graphs of the reduced number of input parameters variables, in accordance with various embodiments. As seen in FIGS. 21A-C, the implied local volatility smile σ₀(s), 25 Δ_{RR}(s), and 25 Δ_{Fly}(s) for small time intervals (e.g., δt=1 day) may be determined using the variable reduction techniques described above. For instance, graph 2110 of FIG. 21A corresponds to an implied local ATM volatility, where a first set of term structures have time t₁=1 month, σ₀=12, 25 Δ_{RR}=1.5, and 25 Δ_{Fly}=0.2, and a second set of term structures have time t₂=1 month plus 1 day, σ₀=12, 25 Δ_{RR}=1.5, and 25 Δ_{Fly}=0.2. Graph 2120 of FIG. 21B corresponds to an implied local 25 Δ_{RR}, where a first set of term structures also have time t₁=1 month, σ₀=12, 25 Δ_{RR}=1.5, and 25 Δ_{Fly}=0.2, and the second set of term structures also have time t₂=1 month plus one day, σ₀=12, 25 Δ_{RR}=1.5, and 25 Δ_{Fly}=0.2. Graph 2130 of FIG. 21C corresponds to an implied local 25 Δ_{Fly}, where a first set of term structures also have time t₁=1 month, σ₀=12, 25 Δ_{RR}=1.5, and 25 Δ_{Fly}=0.2, and the second set of term structures also have time t₂=1 month plus 1 day, σ₀=12, 25 Δ_{RR}=1.5, and 25 Δ_{Fly}=0.2.

For a given implied local volatility smile at spot s₁ and time t₁ (s₁, t₁) for expiry date t₂ (e.g., σ₀ (s₁), 25 Δ_{RR}(s₁), 25 Δ_{Fly}(s₁)), the transfer density function g(s₁, t₁->s₂, t₂) may be determined from s₁ to any underlying asset spot price s₂ at time t₂. For instance, by determining the option prices at time t₂: P(K, t₂−t₁, s₁)=P(K, t₂−t₁, σ₀ (s₁), 25 Δ_{RR}(s₁), 25 Δ_{Fly} (s₁)), with A(d₁, t₂−t₁) and B(d₁, t₂−t₁) determined as described previously, the transfer density function may be described by Equation 148:

$$g ( {s}_{1} , {t}_{1} -> {s}_{2} , {t}_{2} ) = \frac{df ( {t}_{1} )}{df ( {t}_{2} )} \frac{{\partial }^{2} P ( K , {t}_{2} , {t}_{1} , {s}_{1} )}{\partial {K}^{2}} {\vert}_{K = {s}_{2}} . \qquad Equation 148$$

In some embodiments, Equation 148 may be referred to as the “contingent probability density function” g(s₂, t₂|s₁, t₁). Thus, using just the input information as mentioned previously, the contingent probability density function at any underlying asset spot and time may be determined.

### VII. Exotic Options Prices

In the previous sections, techniques for determining vanilla options prices for various asset classes was provided. Here, the technique may be further expanded to obtain the probability transfer density in pricing path dependent options, otherwise referred to as “Exotic options.” The FX options market, for instance, includes knockout and binary options that trade with relatively high levels of liquidity. Using this as a baseline, a live price may be determined for an exotic option traded in the market using the transfer density function, and then compared to an actual traded price. The comparisons may be made against four different types of exotic options.

The first type of exotic option corresponds to a double no touch (“DNT”) option. In one embodiment, a DNT option has a low barrier and a high barrier. If an underlying spot price remains between two barriers, not touching either barrier during the time from inception to expiry, then the DNT option pays 1 at expiry. If the underlying spot price does not meet these conditions, then it pays 0.

The second type of exotic option corresponds to a one touch (“OT”) option. In one embodiment, the OT option corresponds to a binary option having one barrier that is either above or below the current spot price. If the underlying spot price touches the one barrier one or more times during the time from inception to expiry, then the OT option pays 1. If the underlying spot price does not touch the barrier at least once, then the OT option pays 0.

The third type of exotic option corresponds to a knockout (“KO”) option. In one embodiment, a KO option pays like a European vanilla option (e.g., a put/call with a strike price), so long as the barrier is not touched during the time from inception to expiry, otherwise it pays 0.

The fourth type of exotic option corresponds to a double knockout (“DKO”) option. In one embodiment, the DKO option includes 2 barriers and pays like a European vanilla option (e.g., a put/call with a strike price), so long as neither of the barriers is touched during the time from inception to the expiry, otherwise it pays 0.

In a first example embodiment, a DNT option is used having an expiry T=1 year, with a low barrier B₁ and a high barrier Bₕ. The current spot price s₀, in this particular scenario, is greater than low barrier B₁, while being less than high barrier Bₕ. The term structure may include the temporal periods of 1 day, 1 week, 2 weeks, 1 month, 2 months, 3 months, 6 months, 9 months, and 1 year. The price of the DNT option corresponds to the contingent cumulative distribution between low barrier B₁ and high barrier Bₕ at expiry, such that neither low barrier B₁ or high barrier Bₕ are touched during the time from inception until expiry. This condition may be described by Equation 149:

P_{DNT}(Bₗ,Bₕ,T,s₀)=df∫_{B}_{ₗ}^{B}^{ₕ}ds_{T}g(s₀,0→s_{T},T|Bₗ<sₜ<Bₕ∀t≦T)≡df G(s₀,0→s_{T}T|Bₗ<sₜ<Bₕ∀t≦T) Equation 149.

In Equation 149, df corresponds to the discount factor at expiry T. The contingent cumulative distribution may be determined by first taking the term structures. Using the given term structure, a daily term structure is calculated (e.g., daily market data may be obtained from day one to each day until expiry, which may be determined using a cubic spline or any other suitable standard interpolation technique). Next, an incremental temporal interval δt may be selected. For example, δt may correspond to one day (e.g., 1/365 years). For each t≦T, the probability density function gₜ(s, t->s′, t+δt) may be determined from the volatility smile at expiry t and the volatility smile at expiry time t+δt. This may generate Equation 150:

G(s₀,0→s_{T},T|Bₗ<sₜ<Bₕ∀t≦T)=∫_{Bl}^{Bh}ds₁∫_{Bl}^{Bh}d₂ . . . ∫_{Bl}^{Bh}ds_{N}g₁(s₀,0→s₁,t₁)g₂(s₁,t₁→s₂,t₂) . . . g_{N})s_{N-1},t_{N-1}→s_{N},t_{N}) Equation 150.

In Equation 150, N is the number of time intervals in T. δ=T/N can be as small as desired.

Equation 150, in one embodiment, may be determined numerically on a grid of spot s values and time t values, where low barrier Bₗ is less than spot s, which is less than high barrier Bₕ (e.g., Bₗ<s<Bₕ), and time t is greater than or equal to time t=0, and less than or equal to expiry T (e.g., 0≦t≦T).

For a DKO call option, the price may be determined, for a strike K, by Equation 151:

P_{DKO}(T,K,Bl,Bh)=df∫_{Bl}^{Bh}ds₁∫_{Bl}^{Bh}ds₂ . . . ∫_{Bl}^{Bh}ds_{N}g₁(s₀,0→s₁,t₁)g₂(s₁,t₁→s₂,t₂) . . . g_{N}(s_{N-1},t_{N-1}→s_{N},t_{N})(s_{N}−K)⁺ Equation 151.

For Equations 150 and 151, the difference between low barrier Bₗ and high barrier Bₕ may be divided by M spot points sᵢ. The determination of the exotic option may then correspond to determining, for instance, the 8 parameter local volatility smile for any time t from i (T/N) to (i+1) (T/N). The density grid gᵢ(sⱼ, tᵢ, ->sₖ, tᵢ₊₁) may then be determined for any j and k between low barrier Bₗ and high barrier Bₕ. Thus, by doing this, the integration may be performed numerically over g′ᵢ for s between the barriers. To ensure that N and/or M are not too small, the exotic option may be determined by first using a constant term structure without a volatility smile (e.g., 25 Δ_{RR}=25 Δ_{Fly}=0, σ₀(t)=σ₀(T) for t≦T), and then comparing the option price from Equations 93 or 94 to the BS price with σ₀. If the price obtained via the numerical integration is not close to the BS price, then N and/or M may be increased.

Table 82 is an illustrative table including prices of exotic options that traded in the market, and their corresponding price determined using the model of the disclosed concept. For each option, the term structure during the trade may be taken into account during the calculation of the option using the model. As seen by Table 82, the model of the disclosed concept reflects the actual prices in the market. Table 82, in the illustrative embodiment, corresponds to DNT options. Table 83, in the illustrative embodiment, corresponds to OT options. Table 84, in the illustrative embodiment, corresponds to KO options.

TABLE 82

| Trade | Currency | | | DNT | BS | Market | Model |
|---|---|---|---|---|---|---|---|
| date | Pair | Spot | Expiry | Range | Price | Price | Price |
| 13 Nov. 2015 | EURUSD | 1.079 | 2 M | 1.040-1.1200 | 15 | 21 | 20.6 |
| 22 Mar. 2016 | USDJPY | 113.35 | 2 M | 108.00-115.00 | 15.8 | 29 | 28.1 |
| 22 Mar. 2016 | USDJPY | 111.4 | 2 M | 109.50-115.00 | 5.1 | 17.75 | 16.9 |
| 23 Mar. 2016 | EURUSD | 1.1215 | 2 M | 1.0750-1.1450 | 18.3 | 24.75 | 24.6 |
| 9 Nov. 2015 | EURUSD | 1.074 | 3 M | 1.0250-1.1150 | 11.9 | 18.5 | 18.3 |
| 11 Nov. 2015 | EURUSD | 1.0755 | 3 M | 1.050-1.15 | 12.4 | 19.75 | 20.1 |
| 1 Feb. 2016 | EURUSD | 1.0835 | 3 M | 1.030-1.1300 | 6 | 12.25 | 12.1 |
| 25 Feb. 2016 | USDJPY | 112.05 | 3 M | 106.00-118.00 | 22.2 | 35 | 33.75 |
| 1 Mar. 2016 | EURUSD | 1.086 | 3 M | 1.055-1.1150 | 1.1 | 6.75 | 6.4 |
| 5 Feb. 2016 | EURUSD | 1.1195 | 4 M | 1.060-1.1400 | 2.9 | 8.25 | 7.9 |
| 17 Mar. 2016 | USDJPY | 112.5 | 4 M | 106.00-115.00 | 6.9 | 17.5 | 16.9 |
| 23 Mar. 2016 | USDJPY | 112.3 | 5 M | 104-115.50 | 16.4 | 25.25 | 24.9 |
| 9 Feb. 2016 | USDJPY | 115.3 | 6 M | 110-120 | 1.2 | 10.5 | 10.3 |
| 24 Feb. 2016 | USDJPY | 111.85 | 6 M | 102.5-114.5 | 3.7 | 9.9 | 9.9 |
| 9 Nov. 2015 | EURUSD | 1.077 | 9 M | 1.000-1.1500 | 13.9 | 20 | 19.6 |
| 6 Nov. 2015 | EURUSD | 1.0875 | 1 Y | .97-1.19 | 32.6 | 35.5 | 35.7 |
| 25 Feb. 2015 | EURUSD | 1.105 | 1 Y | 1.0300-1.1700 | 2.3 | 9.5 | 9.4 |
| 29 Feb. 2016 | EURUSD | 1.092 | 1 Y | 1.000-1.1800 | 12 | 20.25 | 20.1 |
| 1 Mar. 2016 | EURUSD | 1.087 | 1 Y | 1.000-1.1800 | 11.4 | 21.25 | 21 |
| 2 Mar. 2016 | EURUSD | 1.0855 | 1 Y | .9600-1.2000 | 34.7 | 40.25 | 39.9 |
| 17 Mar. 2016 | EURUSD | 1.122 | 1 Y | 1.0200-1.1750 | 9.2 | 14 | 14.1 |
| 5 Apr. 2016 | EURUSD | 1.1395 | 1 Y | 1.000-1.2000 | 21.7 | 24 | 24 |
| 5 Apr. 2016 | USDJPY | 110.5 | 1 Y | 100.00-120.00 | 24.5 | 37.75 | 37 |

TABLE 83

| Trade | Currency | | | | OT | BS | Market | Model |
|---|---|---|---|---|---|---|---|---|
| date | Pair | Spot | Expiry | | Barrier | Price | Price | Price |
| 6 Nov. 2015 | USDJPY | 121.8 | 11 | DAYS | 125 | 4.6 | 7.5 | 7.6 |
| 8 Feb. 2016 | EURUSD | 1.117 | 42 | DAYS | 1.06 | 14.3 | 13.25 | 13.1 |
| 14 Apr. 2016 | USDJPY | 109.15 | 49 | DAYS | 107.4 | 68 | 62.25 | 61.9 |
| 10 Feb. 2016 | EURUSD | 1.1295 | 5 | M | 1.000 | 7 | 9.75 | 9.6 |

TABLE 84

| | Currency | | | | KO | | BS | Market | Model |
|---|---|---|---|---|---|---|---|---|---|
| date | Pair | spot | expiry | Strike | Barrier | Call/Put | Price | Price | Price |
| 11 Nov. 2015 | EURUSD | 1.075 | 2 M | 1.0325 | 1.0975 | EUR P | 0.405 | 0.455 | 0.46 |
| 10 Nov. 2015 | EURUSD | 1.0745 | 3 M | 1.03 | 0.97 | EUR P | 0.295 | 0.24 | 0.24 |
| 2 Mar. 2016 | EURUSD | 1.0845 | 3 M | 1.13 | 1.0525 | EUR C | 0.705 | 0.655 | 0.66 |
| 10 Nov. 2015 | USDJPY | 123.2 | 4 M | 116 | 127.5 | USD P | 0.295 | 0.38 | 0.37 |
| 2 Mar. 2016 | EURUSD | 1.086 | 4 M | 1.05 | 1 | EUR P | 0.185 | 0.16 | 0.16 |
| 7 Dec. 2015 | EURUSD | 1.0885 | 6 M | 1.035 | 1.12 | EUR P | 0.705 | 0.78 | 0.77 |
| 2 Feb. 2016 | EURUSD | 1.0905 | 6 M | 1.07 | 1.01 | EUR P | 0.27 | 0.24 | 0.23 |
| 5 Feb. 2016 | EURUSD | 1.12 | 6 M | 1.04 | 1.15 | EUR P | 0.41 | 0.465 | 0.47 |
| 8 Feb. 2016 | EURUSD | 1.1125 | 6 M | 1.18 | 1.075 | EUR C | 0.915 | 0.83 | 0.84 |
| 14 Apr. 2016 | USDJPY | 109.2 | 6 M | 103 | 115 | USD P | 0.965 | 1.21 | 1.19 |

The larger the value of N that is selected, the longer time consuming the determination of the option price may be. To reduce the amount of time, an approximation technique may be employed to extrapolate from small values of N. For instance, the Richardson extrapolation technique may be used for δt=T/N. Typically, at DNT, the price should correspond to Equation 152:

P_{DNT}=P_{DNT}(δt)+P*(δt)^{1/2}+O(δt) Equation 152.

In Equation 152, O(δt) corresponds to higher order functions of δt. For example, the price may then be determined for N=25, 64, and 100, and the price may be approximated to very large N. In Equation 84, P* is a constant. Using the Richardson extrapolation technique, an option's price may be determined fairly accurately up to and including, for instance, an expiry such as T=2 years.

TABLE 85

| Time Period | ATM | 25 Δ_{RR} | 25 Δ_{Fly} |
|---|---|---|---|
| 1 Day | 13.30 | 0.4675 | 0.3475 |
| 1 Week | 10.95 | 0.5375 | 0.2325 |
| 2 Weeks | 12.90 | 0.3675 | 0.2475 |
| 3 Weeks | 12.30 | 0.1675 | 0.2475 |
| 1 Month | 11.80 | −0.015 | 0.2650 |
| 2 Months | 11.34 | −0.355 | 0.3050 |
| 3 Months | 10.90 | −0.6875 | 0.3375 |
| 6 Months | 11.45 | −1.6375 | 0.4075 |
| 1 Year | 11.40 | −1.8725 | 0.4375 |

Table 85 is an illustrative table describing term structure value during a particular trade time. For example, for a DNT option traded in the market on a particular date (e.g., Feb. 29, 2016), the currency pair may be EUR/USD, the low and high barriers may be 1.0000 and 1.1800, the expiry may be 1 year, the spot price may be 1.0920, the forward may be 1.1072, the ATM volatility may be 11.4%, and the BS price may be 12%. The option traded in the market at 20%-20.5%.

TABLE 86

| | | BS Via | |
|---|---|---|---|
| N | (δt)^{1/2} | Integral | Model |
| 10 | 0.316228 | 25.63% | 34.67% |
| 25 | 0.2 | 20.59% | 30.16% |
| 70 | 0.119523 | 17.09% | 25.81% |
| Extrapolation | 0 | 12.0% | 20.35% |

Tables 86 is an illustrative table displaying a price of an exotic option as a function of time intervals δt and the extrapolation of the price using the Richardson method. The BS price (where the same ATM volatility of 11.40, RR=0, and Fly=0 for all time periods) may be used, and the model price is determined for temporal intervals corresponding to N=10, N=25, and N=70. As seen from Table 30, the extrapolation yielded a price of 20.35%, which falls squarely within the bounds of the actual price the option was traded at during that time period (e.g., 20% bid, 20.5% offer).

As mentioned previously, an option price for a double knockout call option with strike K may be represented by Equation 94. If B1 is set to be zero (e.g., B1=0), and Bh is set to be infinite (e.g., Bh=∞), then Equation 94 may be used for Vanilla options. The vanilla option price, therefore, may be determined such that it is independent of the term structure.

Tables 87-90 are an illustrative tables of different term structure values for various benchmark durations for a six month vanilla smile.

Table 90 is an illustrative table of six months of a vanilla smile obtained with three different term structures using Equation 94. As seen from Table 90, the option prices are substantially similar independent of the term structures used, which confirms that in model of the disclosed concept the vanilla price is independent of the term structure but only on the market data at expiry.

TABLE 87

| Benchmark Date | ATM Volatility | 25 Δ_{RR} | 25 Δ_{Fly} |
|---|---|---|---|
| 1 Week | 12.00% | 2.000% | 0.250% |
| 1 Month | 11.73% | 2.000% | 0.250% |
| 3 Months | 11.00% | 2.000% | 0.250% |
| 6 Months | 10.00% | 2.000% | 0.250% |

TABLE 88

| Benchmark Date | ATM Volatility | 25 Δ_{RR} | 25 Δ_{Fly} |
|---|---|---|---|
| 1 Week | 8.00% | 1.000% | 0.150% |
| 1 Month | 8.27% | 1.130% | 0.160% |
| 3 Months | 8.96% | 1.480% | 0.200% |
| 6 Months | 10.00% | 2.000% | 0.250% |

TABLE 89

| Benchmark Date | ATM Volatility | 25 Δ_{RR} | 25 Δ_{Fly} |
|---|---|---|---|
| 1 Week | 10.00% | 2.000% | 0.250% |
| 1 Month | 10.00% | 2.000% | 0.250% |
| 3 Months | 10.00% | 2.000% | 0.250% |
| 6 Months | 10.00% | 2.000% | 0.250% |

TABLE 90

| Strikes | 0.9000 | 0.940 | 0.980 | 1.020 | 1.060 | 1.100 | 1.140 | 1.180 | 1.220 | 1.260 | 1.300 | 1.340 |
|---|---|---|---|---|---|---|---|---|---|---|---|---|
| TS1 | 10.81% | 1.11% | 9.51% | 9.09% | 9.32% | 9.96% | 10.74% | 11.62% | 12.56% | 13.56% | 14.68% | 15.92% |
| TS2 | 10.81% | 10.10% | 9.53% | 9.10% | 9.34% | 9.97% | 10.69% | 11.63% | 12.55% | 13.61% | 14.69% | 15.92% |
| TS3 | 10.80% | 10.11% | 9.52% | 9.13% | 9.33% | 10.01% | 10.72% | 11.63% | 12.56% | 13.54% | 14.71% | 15.94% |
| Market | 10.85% | 10.15% | 9.55% | 9.13% | 9.31% | 9.95% | 10.73% | 11.60% | 12.54% | 13.58% | 14.74% | 15.98% |

In Table 90, Market is a direct calculation of the vanilla price via A and B for expiry 6 months.

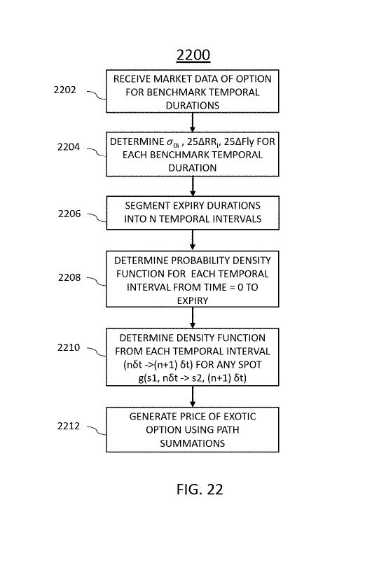

FIG. 22 is an illustrative flowchart of a process for determining an exotic option, in accordance with various embodiments. Process 2200, in one embodiment, may begin at step 2202. At step 2202, market data of an option for benchmark temporal durations may be received at a user device, such as user device 104, from a server, such as server 102. In some embodiments, the market data that is received may include term structures corresponding to at least the expiry of an option whose price is to be determined for various benchmark data associated with various benchmark temporal durations (e.g., Tᵢ=1, 2, . . . , M). As an illustrative example, the benchmark temporal durations may correspond to 1 day, 1 week, 1 month, 2 months, 3 months, 6 months, 9 months, 1 year, and 2 years, however persons of ordinary skill in the art will recognize that any suitable temporal duration may be used.

At step 2204, the pivot volatility σ₀ᵢ, 25 Δ_{RR}, and 25 Δ_{Fly}, for each benchmark temporal interval Tᵢ, may be determined. This may correspond to options starting at time t=0 (e.g., a current day), and expiring at time t=Tᵢ. At step 2206, the expiry time T may be segmented into N temporal intervals, where a temporal interval corresponds to δt=T/N. In some embodiments, N may be selected by first setting 25 Δ_{RR}=0 and 25 Δ_{Fly}=0, and by setting the pivot volatility σₒ=σ₀(T) for each temporal duration, and then determining a price of the exotic option. If the price is different than the BS price for that exotic option, then the value for N is too low. In some embodiments, the option may be priced three times using, for example, N=25, 64, and 100. These three results may be used to in combination with the Richardson extrapolation technique to obtain the exotic option's price.

At step 2208, the probability density function for each temporal interval from time t=0 to expiry may be determined. In some embodiments, this may correspond to first, interpolation may be performed for σ₀ⱼ, 25 Δ_{RRj}, and 25 Δ_{Flyj} to generate data at every time step σ₀(jδt), 25 Δ_{RR}(jδt), and 25 Δ_{Fly}(jδt), for j=1, 2, . . . , N. Next, the implied forward volatility smile may be determined from j(δt) to j+1(δt) for all values of j. After the implied volatility smile is determined, the probability density function may be determined from j(δt) to +1(δt) for all values of s and j (e.g., g(s, j(δt)) to g(s′, (j+1) (δt)). At step 2210, the density function g(s₁, nδt->s₂, (n+1)δt) for each temporal interval (nδt->(n+1)δt) for any spot may be determined.

At step 2212, a price of the exotic option may be generated using path summations. For instance, using the probability density surface grid, the price of the exotic option may be determined by summarizing over each path of the probability density function having the options conditions and payoffs.

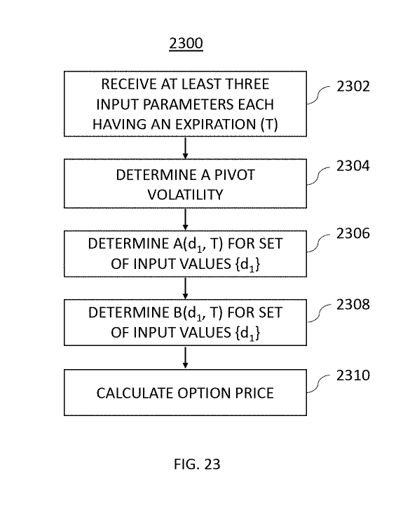

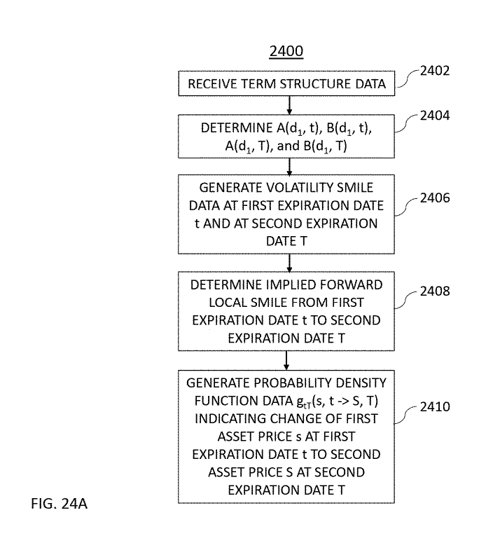

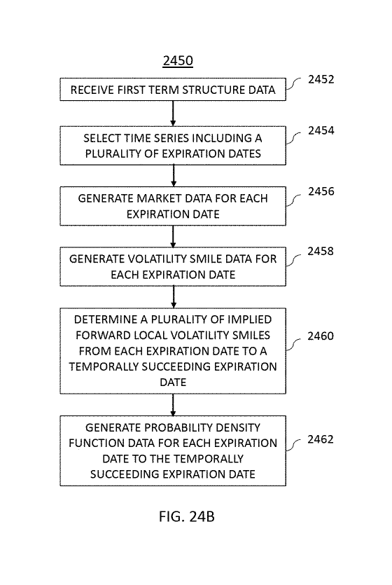

FIG. 23 is an illustrative flowchart of a process for determining a price of a European Vanilla option having an expiration time T, in accordance with various embodiments. Process 2300, in one embodiment, may begin at step 2302. At step 2302, at least three input parameters, each having an expiration T, may be received. For example, the at least three input parameters may corresponding to prices and strikes received by an electronic device, such as user device 104, from a financial data source, such as market data source 108. In some embodiments, first pricing data representing a first strike and a first price for an option may be received, where the first price corresponds to the first strike for the expiration. Second pricing data representing a second strike and a second price for the option may also be received, where the second price corresponds to the second strike for the expiration. Third pricing data representing a third strike and a third price for the option may further be received, where the third price corresponds to the third strike for the expiration. In one embodiment, pricing data representing the first strike and the first price, the second strike and the second price, and the third strike and the third price, may be received.

At step 2304, a pivot volatility may be determined. For example, the pivot volatility σ₀ may correspond to an input value d₁=0. In some embodiments, the pivot volatility may be determined based, at least in part, on the at least three input parameters received. For example, using pricing data, the pivot volatility may be determined.

At steps 2306 and 2308, a first function A(d₁, T) and a second function B(d₁, T) may be determined for a set of input values {d₁}, respectively. The set of input values {d₁} may be substantially large, in some embodiments, and may correspond to any suitable number of input values. In some embodiments, the first function A(d₁, T) and the second function B(d₁, T) may be determined based on the pivot volatility, and the at least three input values. For example, functions A(d₁, T) and B(d₁, T) may be determined using the pivot volatility, the first strike and first price, the second strike and the second price, and the third strike and the third price, for an option having an expiration T. In some embodiments, one or more values for the first function A(d₁, T) and one or more values for the second function B(d₁, T) may be determined based on the functions A(d₁, T) and B(d₁, T) and the set of input values {d₁}. For example, using the set of input values {d₁}, first values for the first function A(d₁, T) may be generated, and second values for the second function B(d₁, T) may be generated.

At step 2310, a price of the option may be calculated. The price of the option at the expiration may be generated based, at least in part, on the first value(s) generated for the first function A(d₁, T) and the second value(s) generated for the second function B(d₁, T). For example, using the values generated for functions A(d₁, T) and B(d₁, T), Equations 40 and 41 may be used to determine a price for the option.

FIG. 24A is an illustrative flowchart of a process for calculating a probability density function from a first time t to a second time T, in accordance with various embodiments. Process 2400 may, in one embodiment, begin at step 2402. At step 2402, a term structure for one or more options may be received. The term structure data may include first market data associated the one or more options and also may be associated with at least one expiration data. For instance, the first term structure data may include first market data associated with a first expiration date corresponding to when the one or more options expire. The first term structure data may further include market data associated with the one or more options for two or more expiration dates. Generally speaking, the term structure data may include information associated with any number of maturities, and therefore the aforementioned is merely exemplary. In one embodiment, the term structure data may be received from financial data source 108 by user device 104. The term structure data, in one embodiment, may correspond to a current ATM volatility σ₀, 25 Δ_{RR}, and 25 Δ_{Fly} for the vanilla options. In some embodiments, multiple term structures may be received.

In some embodiments, the term structure data may be used to obtain second market data. For example, second market data associated with the one or more options for a second expiration date may be extrapolated using the first term structures. In this way, additional market data corresponding to different expirations may be obtained from the first market data and/or the term structure data. For example, additional term structure data may be extrapolated using Equation 95, and/or as seen by Table 85. Generally speaking, market data may include a pivot volatility value, a first delta risk reversal value, and a first delta butterfly value. For two or more sets of market data, the pivot volatility values, delta risk reversal values, and delta butterfly values may differ. For example, the first market data may include a pivot volatility value, a 10 Δ_{RR} or a 25 Δ_{RR}, and a 10 Δ_{RR} or a 25 Δ_{RR}. Using the term structure data and/or the first market data, second market data including a different pivot volatility value, 10 Δ_{RR} or 25 Δ_{RR} value, and 10 Δ_{RR} or 25 Δ_{RR} value may each be obtained.

In some embodiments, the at least one option may correspond to at least three vanilla options. In this particular scenario, the term structure data that is received may correspond to pricing data associated with the at least three vanilla options. For instance, the pricing data may indicate pricing information associated with the at least three vanilla options at the first expiration. In another embodiment, the first market data may include at least three input values that are associated with a first asset price, and the second market data may include at least three input values associated with a second asset price.

In some embodiments, additional term structure data may be received from a financial data source instead of, or in addition to, being extrapolated from the initially received data. For example, additional term structure data comprising additional market data corresponding to a different expiration may be received from the financial data source. In some embodiments, the first market data associated with a first expiration date may include second market data associated with a second expiration date. Additionally, the term structure data may be associated with a plurality of expiration dates, and therefore the term structure data that is received may also be associated each expiration date of the plurality of expiration dates.

At step 2404, a first function A(d₁, t) at a time t, a second function B(d₁, t) at time t, the first function A(d₁, T) at time T, and the second function B(d₁, T) at time T may be determined. For example, using the first market data, the functions A(d₁, t), B(d₁, t), A(d₁, T), and B(d₁, T) may be determined. In one embodiment, second market data associated with a second expiration date may be obtained, either from the financial data source or via calculation using the term structure data and/or the first market data. Therefore, using the first market data first function data representing a first function at the first expiration (e.g., A(d₁, t)), as well as second function data representing a second function at the first expiration date (e.g., B(d₁, t)), may be determined. Using the second market data, third function data representing the first function associated with the second expiration date (e.g., A(d₁, T)), and fourth function data representing a fourth function associated with the second expiration date (e.g., B(d₁, T)), may be determined. For example, the term structure data received from financial data source 108 may be used by user device 104 to determine first function data representing a first function at the first expiration date t (e.g., A(d₁, t)), and second function data representing a second function at the first expiration date t (e.g., B(d₁, t)). After determining and/or receiving the second market data associated with the second expiration date (e.g., expiration date T), user device 104 may determine third function data representing the first function at the second expiration date T (e.g., A(d₁, T)), and fourth function data representing the second function at the second expiration date T (e.g., B(d₁, T)). As described in greater detail above, the first function data, second function data, third function data, and the fourth function data may also be determined based on input values d₁. For example, using a set of input values d₁ (e.g., {d₁}), A(d₁, t), B(d₁, t), A(d₁, T), and B(d₁, T) may be determined.

At step 2406, volatility smile data at time t and at time T may be generated. For instance, using the first function data representing the first function at the first expiration date (e.g., A(d₁, t) at expiration date t) and the second function data representing the second function at the first expiration date (e.g., B(d₁, t) at expiration date t), first volatility smile data representing a first volatility smile associated with the first expiration date may be generated. Similarly, second volatility smile data representing a second volatility smile associated with the second expiration date may be generated using the third function data representing the first function at the second expiration date (e.g., A(d₁, T) at expiration date T) and the fourth function data representing the second function at the second expiration date (e.g., B(d₁, T) at time T). In one embodiment, user device 104 may generate the first volatility smile data, and user device 104 may also generate the second volatility smile data.

At step 2408, an implied forward local volatility smile from time t to time T may be determined. For instance, the implied local volatility smile for two different times, t and T, may be determined using the term structure and the functions A and B at times t and T. In some embodiments, a first implied forward local volatility smile may be determined based, at least in part, on the first volatility smile data representing the first volatility smile at the first expiration date (e.g., expiration t), the second volatility smile data representing the second volatility smile at the second expiration date (e.g., expiration T), and at least one condition associated with the at least one option. The at least one condition, for instance, may include a first requirement for the implied forward local volatility smile that precludes a delta risk reversal value and a delta butterfly value being both being zero at a substantially same time. In one embodiment, the delta risk reversal and/or the delta butterfly values may be zero, however the first requirement may require them to both not be zero at a same time. For example, the at least one condition may be that, for a particular expiration time t₁, both 25 Δ_{RR}≠0 and 25 Δ_{Fly}≠0. A more detailed description of determining the implied forward local smile may be seen with reference to FIGS. 19 and 20.

At step 2410, first probability density function data representing a first probability density function g_{tT}(s, t->S, T) may be generated. The probability density function may indicate a first change of a first asset price s at the first expiration date t to an asset price S at time T. Furthermore, the probability density function data may be generated using the implied forward local volatility smile determined at step 2410. In one embodiment, for a given implied forward local volatility smile at spot s and time t (e.g., (s, t)) for an expiration date (e.g., σ₀ (s), 25 Δ_{RR}(s), 25 Δ_{Fly}(s)), the transfer density function g(s, t->S, T) may be determined from s to any underlying asset spot price S at time T. For example, the density function may be described by Equation 80. In one embodiment, user device 104 may generate the probability density function data representing the probability density function indicating a change of a first asset price at a first expiration (e.g., expiration t) to a second asset price at a second expiration (e.g., expiration T) using the implied forward local volatility smile from expiration t to expiration T.

The first asset price and the second asset price may, in some embodiments, correspond to such entities as interest rates, forward interest rates, stocks, stock prices, stock index prices, energy prices, commodity prices, currency exchange rates, futures, and/or bonds. In particular, if the first asset price and the second asset price correspond to interest rates, the first market data may include pricing data.

In some embodiments, if additional market data is received representing additional term structures having an additional expiration, then an additional density function may be generated indicating a change in asset price from one of the expiration associated with the first density function to the additional expiration. For instance, additional market data representing additional term structures having a third expiration may be received. For example, user device 104 may receive third market data representing third term structures for one or more options (e.g., vanilla options) having a third expiration, where the third market data may be received from financial data source 108. Alternatively, as mentioned above, term structures associated with a different expiration may be extrapolated using the market data associated with the first expiration (e.g., expiration t) and the second expiration (e.g., expiration T). Using the additional market data, fifth function data representing the first function at the additional expiration and sixth function data representing the second function at the additional expiration may be generated. The fifth function data and the sixth function data may then be used to generate third volatility smile data representing a third volatility smile at the third expiration. An additional implied forward local volatility smile may then be determined based, at least in part, on the implied forward local volatility smiles at the first expiration, second expiration, and third expiration, as well as based on the at least one condition. After obtaining the additional implied forward local volatility smile, second density function data representing a second density function may be generated. The second density function may, for instance, indicate a change of either the first asset price at the first expiration to a third asset price at the third expiration, or the second asset price at the second expiration to the third asset price at the third expiration.

In some embodiments, a density function for a small temporal interval between the first expiration and the second expiration may be determined using the density function data. For instance, an amount of time between the first expiration and the second expiration may be determined by subtracting the first expiration from the second expiration (e.g., Δt=T−t). Next, an incremental temporal interval at may be determined, where the incremental temporal interval is less than Δt. Furthermore, the incremental temporal interval may be selected such that t+δt<T, and T−δt>t. In some embodiments, the first incremental temporal interval may be determined by selecting a first number of intervals to divide the first amount of time into. For example, a number N may be selected such that dividing the amount of time Δt by the number N such that δt=Δt/N. However, persons of ordinary skill in the art will recognize that although, in the illustrative example, at is even distributed within the amount of time Δt, that not need always be the case. For example, asymmetric incremental temporal intervals may be selected such that δt₁+δt₂+ . . . +δt_{N}=Δt, where δtᵢ≠δtⱼ.

After obtaining the first incremental interval, third volatility smile data representing a third volatility smile may be generated for a third expiration. Here, the third expiration may correspond to the first expiration t plus the incremental temporal interval δt, or an integer multiplier of the incremental temporal interval (e.g., m δt).

In some embodiments, a first incremental temporal interval (e.g., δt) may be selected. For example, an individual may select at using user device 104, or user device 104 may have a predefined value set for interval δt. Based on the selected incremental temporal interval, the second expiration may be determined to correct to one of the first expiration date plus the incremental temporal interval (e.g., t+δt) or the first expiration date minus the incremental temporal interval (e.g., t−δt).

FIG. 24B is an illustrative flowchart of a processing generating a probability density grid including a plurality of probability density functions, in accordance with various embodiments. Process 2450 may, in a non-limiting embodiment, begin at step 2452. At step 2452, first term structure data may be received. For example, first term structure data may be received by user device 104 from financial data source 108. The first term structure data may, in one embodiment, be associated with at least one option.

At step 2454, a time series may be selected, where the time series includes a plurality of expiration dates. For example, the time series may include expiration dates associated with the at least one option (e.g., expiration dates t₁, t₂, . . . , t_{N}). In some embodiments, the expiration dates that are selected may correspond to expirations included with the term structure data, however this need not always be the case, as any suitable time series may be used. Furthermore, in some embodiments, the time series may be selected by an individual operating user device 104, or the time series may be predefined.

At step 2456, market data for each expiration date of the plurality of expiration dates included by the selected time series may be generated. For instance, using the term structure data received at step 2452, market data for each expiration date may be generated. As an illustrative example, if there are j-expiration dates included within the time series (e.g., {t}=t₁, t₂, . . . , t₁), then j instance so of market data, or market data for each of the j expiration dates, may be generated. In some embodiments, user device 104 may be used to generate the market data for each expiration date. In some embodiments, function date representing first functions and second functions for each expiration date may be calculated (e.g., A(d₁, t₁) and B(d₁, t₁)), however persons of ordinary skill in the art will recognize that this is merely exemplary.

At step 2458, volatility smile data for each expiration date may be generated. For example, using the market data for each expiration date, corresponding volatility smile data may be generated representing a volatility smile associated with each of the expiration dates. Therefore, if there are j-expiration dates, then the volatility smile data may represent j-volatility smiles, each associated with a different one of the j-expiration dates. In some embodiments, step 2458 may be substantially similar to step 2406, and the previous description may apply.

At step 2460, a plurality of implied forward local volatility smiles for each expiration date to a temporally succeeding expiration date may be determined. In some embodiments, if a first expiration date corresponds to expiration date tᵢ, then its temporally succeeding expiration date may correspond to expiration date tᵢ₊₁. Therefore, the volatility smile data associated with expiration dates tᵢ and tᵢ₊₁ may be used to determine an implied forward local volatility smile from expiration date tᵢ to expiration date tᵢ₊₁. The implied forward local volatility smiles may be calculated for each expiration date from t₁ to tⱼ. In some embodiments, the plurality of implied forward local volatility smiles may be determined based, at least in part, on the volatility smile date and at least one condition. For example, the at least one condition may include a first requirement for the implied forward local volatility smile that precludes a delta risk reversal value and a delta butterfly value being both being zero at a substantially same time. In some embodiments, step 2460 may be substantially similar to step 2408, and the previous description may apply.

At step 2462, probability density function data representing probability density functions for each expiration date to its temporally succeeding expiration date may be generated. The probability density function data may, in one embodiment, be generated based, at least in part, on the plurality of implied forward local volatility smiles that were determined at step 2460. Each probability density function may indicate a change of a first asset price at a first expiration date of the plurality of expiration dates to a second asset price at a second expiration date of the plurality of expiration dates such that the second expiration date temporally succeeds the first expiration date (e.g., tᵢ to tᵢ₊₁). Step 2462 may, in one embodiment, be substantially similar to step 2410, and the previous description may apply.

By obtaining the probability density function for each expiration date, a full probability density grid for the at least one option may be generated. In some embodiments, user device 104 may store the probability density function data corresponding to the full probability density grid within storage/memory 204.

In some embodiments, the time series may be selected such that a temporal difference between a first expiration date and a temporally succeeding expiration date is equal for each of the plurality of expiration dates. For example, if the time series includes three expiration dates, t₁, t₂, and t₃, then the temporal difference between t₁ and t₂ may be substantially equal to the temporal difference between t₂ and t₃ (e.g., |t₂−t₁|=|t₃−t₂|).

However, in some embodiments, the time series may be selected such that the temporal difference between a first expiration and its temporally succeeding expiration date is not equal for each expiration date. For example, if the time series includes three expiration dates, t₁, t₂, and t₃, then the temporal difference between t₁ and t₂ may be substantially different than the temporal difference between t₂ and t₃ (e.g., |t₂−t₁|≠|t₃−t₂|).

Still further, in some embodiments, pricing data representing pricing information associated with the at least one option may be generated using the probability density function data. For instance, the pricing data for any expiration date included within the density grid may be obtained.

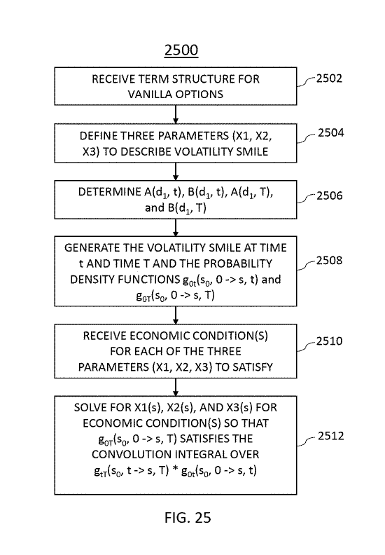

FIG. 25 is an illustrative flowchart of a process for calculating an implied forward local smile from a first time t to a second time T, in accordance with various embodiments. Process 2500, in one embodiment, may begin at step 2502. At step 2502, one or more term structures for vanilla options may be received. In some embodiments, step 2502 of FIG. 25 may be substantially similar to step 2402 of FIG. 24A, and the previous description may apply.

At step 2504, three parameters, X1, X2, and X3, may be defined to describe a volatility smile. In some embodiments, more than three parameters may be defined (e.g., Xᵢ, where i=1, 2, . . . , p). As an illustrative example, the three parameters describing the volatility smile may correspond to the ATM volatility Go, 25 Δ_{RR}, and 25 Δ_{Fly}, however additional and/or alternative parameters may be employed.

At step 2506, a first function A(d₁, t) at a time t, a second function B(d₁, t) at time t, the first function A(d₁, T) at time T, and the second function B(d₁, T) at time T may be determined. For example, using the term structure and/or the three parameters X1, X2, and X3, the functions A(d₁, t), B(d₁, t), A(d₁, T), and B(d₁, T) may be determined.

At step 2508, the volatility smile at time t and at time T, and the probability density functions g₀ₜ(s₀, 0->s, t) and g_{oT}(s₀, 0->s, T) may be generated. In some embodiments, steps 2506 and 2508 of FIG. 25 may be similar to steps 2404-2410 of FIG. 24A, and the previous descriptions may apply.

At step 2510, one or more economic conditions for each of the three parameters X1, X2, and X3 to satisfy may be received. For example, the economic conditions may have to be satisfied by the parameters as a function of the asset price s at time t. In some embodiments, the economic condition(s) may be received by user device 104 from the financial data source 108.

At step 2512, the parameters X1, X2, and X3 as functions of the asset price s (e.g., X1(s), X2(s), X3(s)) may be solved for the economic conditions received at step 2510. The parameters may be solved for such that the probability density function g_{oT}(s₀, 0->s, T) satisfies the convolution integral over g_{tT}(s₀, t->s, T)*g₀ₜ(s₀, 0->s, t). For example, the convolution as described by Equation 66 may be satisfied for time t=0 to time t=T.

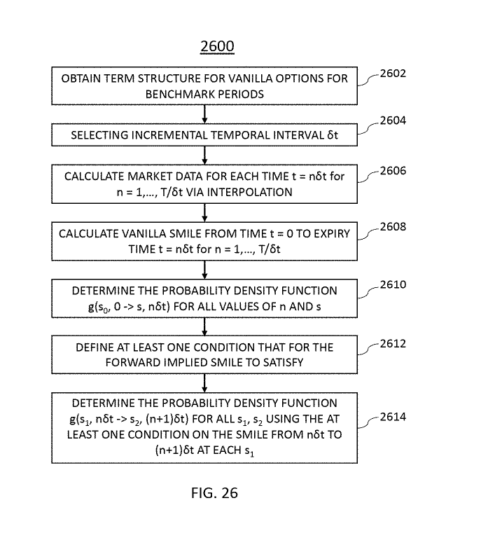

FIG. 26 is an illustrative flowchart of a process for calculating a probability transfer density at any time and for any asset price to another time and another asset price, in accordance with various embodiments. Process 2600 may, in one embodiment, begin at step 2602. At step 2602, a term structure for vanilla options may be obtained for benchmark periods. For example, the term structure may be received from financial data source 108 by user device 104. The term structure, in one embodiment, may correspond to a current ATM volatility σ₀, 25 Δ_{RR}, and 25 Δ_{Fly} for the vanilla options. In one embodiment, the term structures that are received may correspond to one or more particular benchmark temporal periods (e.g., three months, six months, nine months, etc.). For example, various term structures for different benchmark times may be seen by Tables 87-90. In some embodiments, multiple term structures may be received.

At step 2604, an incremental temporal interval δt may be selected. The temporal interval may be selected such that the time to expiry T is segmented into equal and finite steps (e.g., δt=T/N). Thus, N temporal intervals, from t=0 to t=T may be obtained having temporal durations of t₁, t₂, . . . t_{N}=T.

At step 2606, market data for each time t=nδt, where n=1, . . . , T/δt may be calculated via interpolation. For example, a linear interpolation technique, as described in greater detail above with reference to Tables 16-21, may be employed to calculate market data for each time t=nδt. At step 2608, a vanilla smile from time t=0 to expiry time t=nδt for n=1, . . . , I/δt may be calculated. For instance, using the market data obtained at step 2606 for each time t=δt, the vanilla smile may be generated. At step 2610, the probability density function g(s₀, 0->s, nδt) may be determined for all values of n and s. In some embodiments, step 2610 of FIG. 26 may be similar to step 2208 of FIG. 22, and the previous description may apply.

At step 2612, at least one condition that the forward implied smile is to satisfy may be defined. In the illustrative examples of FIGS. 19 and 20, three conditions that the forward smile should satisfy: (i) one minimum to the function σ(s), (ii) one minimum for the function 25 Δ_{Fly}(s), and (iii) the function 25 Δ_{RR}(s) is to be monotonically increasing. In addition, these conditions may be extended to additional conditions on the shape of these functions such that the pace of changing decreases at very large values of s, and the pace of changing increases at very small values of s.

At step 2614, the probability density function g(s₁, nδt->s₂, (n+1)δt) for all s₁, s₂ may be determined using the at least one condition on the forward implied smile from nδt to (n+1)δt at each s₁. For example, the probability density function may be determined using Equation 91. After obtaining the probability density function at all temporal intervals for all spots s, the price of the option at each temporal interval may be determined.

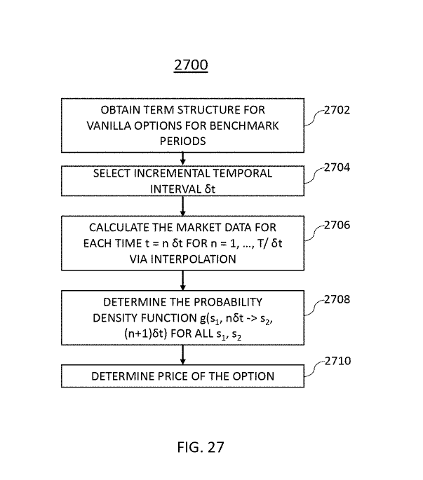

FIG. 27 is an illustrative flowchart of a process for pricing an exotic option, in accordance with various embodiments. At step 2702, a term structure for vanilla options for benchmark periods may be obtained. At step 2704, an incremental temporal interval δt may be selected. At step 2706, the market data for each time t=nδt may be calculated for n=1, 2, 3, . . . , T/δt. In some embodiments, steps 2702, 2704, and 2706 of FIG. 27 may be substantially similar to steps 2602, 2604, and 2606 of FIG. 26, and the previous descriptions may apply.

At step 2708, the probability density function g(s₁, δt 0->s₂, (n+1)δt) may be determined for all s₁ and s₂. For example, the probability density function may be determined using Equation 153. In some embodiments, step 2708 of FIG. 27 may be substantially similar to step 2210 of FIG. 22, and the previous description may apply. At step 2710, the price of the option may be determined. In some embodiments, step 2710 of FIG. 27 may be substantially similar to step 2212 of FIG. 22, and the previous description may apply.

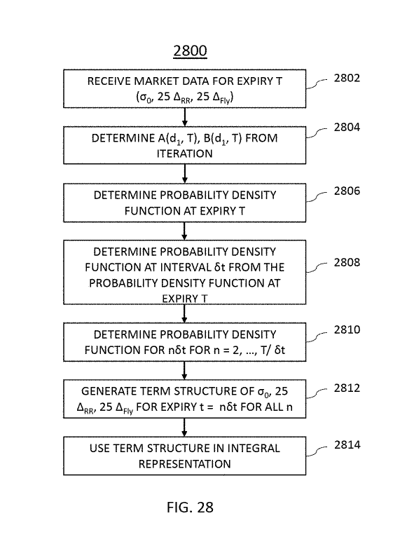

FIG. 28 is an illustrative flowchart of a process for determining term structures for an integral representation for determining an option's price in each step of the iteration process, in accordance with various embodiments. In some embodiments, process 2800 may begin at step 2802. At step 2802, market data for an expiry T may be received. For example, user device 104 may receive market data, such as an ATM volatility σ₀, 25 Δ_{RR}, and 25 Δ_{Fly}, from financial data source 108. At step 2804, first function A(d₁, T) and second function B(d₁, T) may be calculated. For example, first function A(d₁, T) and second function B(d₁, T) may be determined based, at least partially, on the received market data to be used in the current portion of the iteration. Therefore, the volatility smile at expiry T may be constructed using the received σ₀, A(d₁, T), and B(d₁, T)

At step 2806, the probability density function at expiry T may be determined. The probability density function g_{T} at expiry T, for example, may be determined using the received market data for expiry T (e.g., σ₀, 25 Δ_{RR}, and 25 Δ_{Fly}) and the volatility smile at expiry T using Equation 7. At step 2808, the probability density function at a temporal interval δt may be determined using the probability density function at expiry T. At step 2810, the probability density function for nδt may be determined, where n=2, . . . , T/δt. For instance, after determining g_{T}, the probability density function gᵢ may then be determined using a recursion process, such that determining g₁(s₀, 0->s₁, t₁) also encompasses determining the probability density function for all powers of 2 (e.g., g₂^{m-1}(s₀, 0→s₂^{m-1}, t₂^{m-1}), . . . , g₄(s₀, 0→s₄, t₄), g₂ (s₀, 0→s₂,t₂)). Using Equation 79, a full range of probability density functions may be generated (e.g., g₁, g₂, . . . , g_{N}).

At step 2812, a term structure of σ₀, 25 Δ_{RR}, and 25 Δ_{Fly} for expiry t=nδt may be generated for all values of n. The probability density functions of steps 2806, 2808, and 2810 may be used to generate for σ₀(nδt), 25 Δ_{RR}(nδt), 25 Δ_{Fly}(nδt), A(d₁, nδt), and B((d₁, nδt), for example. At step 2814, the generated term structure may be used for the integral representation. For instance, A(d₁, nδt) and B((d₁, nδt) may be determined from the density function gₙ. Using the implied term structure and the forward term structure in the integral representation for j=1, 2, . . . N−1, A(d₁, T) and B(d₁, T) may be determined using Equations 42 and 43.

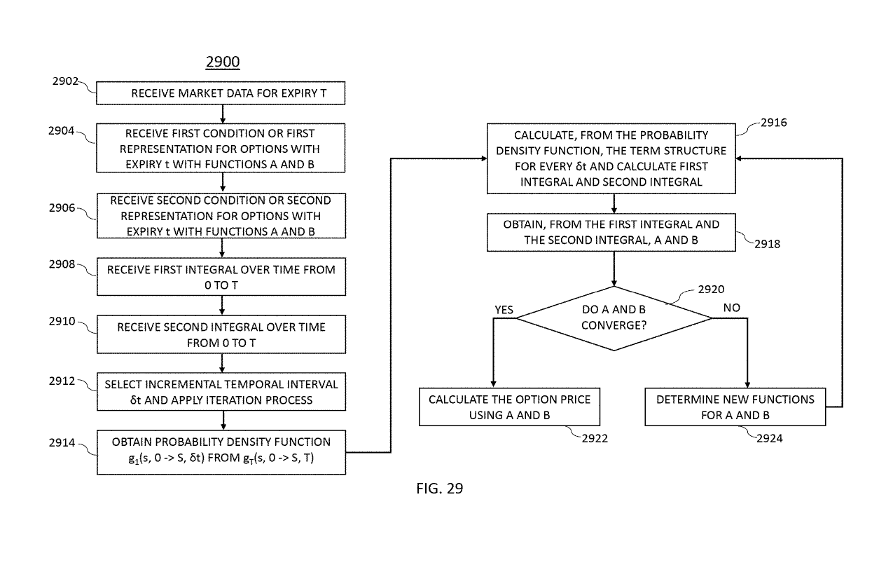

FIG. 29 is an illustrative flowchart of a process for calculating a smile from conditions on the smile and integrals over time until expiration, in accordance with various embodiments. Process 2900, in one embodiment, may begin at step 2902. At step 2902, market data for an expiry T may be received. For example, market data may be received by user device 104 from financial data source 108. At step 2904, a first condition or a first representation for options with expiry t with functions A and B may be received. For example, the condition or the representation may correspond to that defined by Equations 26 and 27, which shall apply for any expiry time t with different functions A and B. In one embodiment, functions A and B of Equations 26 and 27 may correspond to a ratio between the zetas ζ to

$$\frac{dVega}{d σ} and \frac{dVega}{dS} ,$$

respectively, rather than a single condition, and the same may apply here as well. At step 2906, a second condition or a second representation for options with expiry t with functions A and B may be received. Persons of ordinary skill in the art will recognize that more than two conditions and/or representations may be received, and the aforementioned is merely exemplary.

At step 2908, a first integral over time from time t=0 to time t=T may be received. At step 2910, a second integral over time from time t=0 to time t=T may be received. In some embodiments, the first integral over time and the second integral over time may also be over the asset price as well.

At step 2912, an incremental temporal interval δt may be selected, and an iteration process may be applied. The iterative process may begin, in one embodiment, by a first assumption for A(d₁, T) and B(d₁, T). For example, the zero-level approximation values for A(d₁, T) and B(d₁, T), as determined previously with constant term structure and forward term structure, may be used. At step 2914, the probability density function g₁(s, 0->S, δt) may be obtained from g_{T}(s, 0->S, T). In one embodiment, the probability density function that is obtained may satisfy the first condition and the second condition (if the first condition and second condition are received at steps 2904 and 2906, respectively). At step 2916, the term structure for every nδt may be calculated from the probability density function, and the first integral and the second integral may also be calculated. For instance, after determining g_{T}, the segmentation of temporal intervals may be determined. The probability density function may then be determined using a recursion process, such that determining g₁(s₀, 0->s₁, t₁) also encompasses determining the probability density function for all powers of 2 (e.g., g₂^{m-1} (s₀, 0→s₂^{m-1}, t₂^{m-1}), . . . , g₄ (s₀, 0→s₄ t₄), g₂ (s₀, 0→s₂, t₂)). Using Equation 79, a full range of probability density functions may be generated (e.g., g₁, g₂, . . . , g_{N}). Alternatively, all the gᵢ functions may be obtained approximately directly from the mapping between log S and the normal variable X_{N} that satisfied N(X_{N})=G(log S) without the need to implement the recursion process.

The implied term structures and shape functions correspond to each of the probability density functions g₁, g₂, . . . , g_{N} may be determined next. For instance, using gⱼ, the option prices expiring at time tⱼ may be determined for any strike by using, for example, Equation 6. Having the smile at time tⱼ therefore allows for σ₀(tⱼ), 25 Δ_{RR}(tⱼ), 25 Δ_{Fly}(t), A(d₁, tⱼ), and B((d₁, tⱼ) to be determined. Therefore, σ₀ (t₁) 25 Δ_{RR}(t) 25 Δ_{Fly}(tⱼ), A(d₁, tⱼ), and B((d₁, tⱼ) may each be determined for j=1, 2, . . . , N. Furthermore, this calculation automatically provides the forward term structure from time t=tⱼ to time

$$t = T , {A}_{{t}_{j}} ( {d}_{1} , T - {t}_{j} ) , {B}_{{t}_{j}} ( {d}_{1} , T - {t}_{j} ) , \\ {σ}_{{0}_{{t}_{j}}} ( T - {t}_{j} ) , 25 {Δ}_{{RR}_{{t}_{j}}} ( T - {t}_{j} ) , and 25 {Δ}_{{Fly}_{{t}_{j}}} ( T - {t}_{j} ) , \\ for j = 1 , 2 , … , N - 1.$$

At step 2918, A and B may be obtained using the first integral and the second integral. For instance, using the implied term structure and the forward term structure in the integral representation for j=1, 2, . . . N−1, A(d₁, T) and B(d₁, T) may be determined using Equations 87 and 88.

At step 2920, a determination may be made as to whether or not A and B converge. As seen by Equation 88, converge occurs when A and B stop changing for input values d₁. If, at step 2920, it is determined that A and B do converge, then process 2900 may proceed to step 2922. At step 2922, the option price may be calculated using A and B. For instance, upon reaching convergence, the self-consistent values of A and B are determined for the probability consistent approach. If, however, at step 2920 converge for A and B does not occur, then process 2900 may proceed to step 2924. At step 2924, new functions for A and B may be determined. After obtaining the new values for A and B, process 2916 may return to step 2916, where the term structures, first integral, and second integral may be recalculated, and the process may repeat until convergence is reached. For example, new values of A(d₁, T) and B(d₁, T), which were obtained from the integrals, may be used to recalculate the probability density functions g₁, g₂, . . . , g_{N} that correspond to the volatility smile generated by the new values of A(d₁, T) and B(d₁, T). The probability density functions may then be used to determine the term structure of the smile, σ₀ (tⱼ), 25 Δ_{RR}(tⱼ), 25 Δ_{Fly}(tⱼ) A(d₁, tⱼ), and B(d₁, tⱼ) for all j=1, 2, . . . , N−1, which may then be used in the integral representation to determine A(d₁, T) and B(d₁, T). In some embodiments, the number of temporal intervals N may be increased through the iterations to achieve faster calculations. For instance, N may initially be set at a low value (e.g., N=2 or 3), and may be increased later at subsequent iterations.

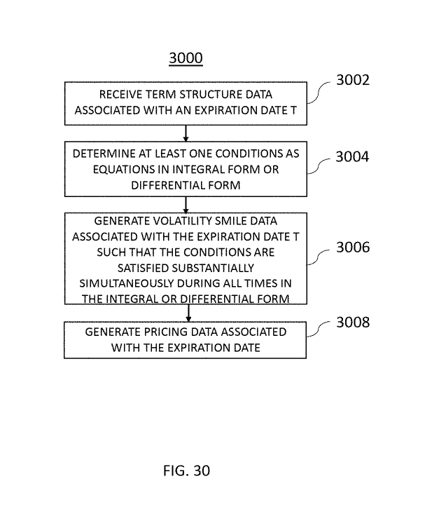

FIG. 30 is an illustrative flowchart of a process for calculating a volatility smile from self-consistency conditions, in accordance with various embodiments. Process 3000, in one embodiment, may begin at step 3002. At step 3002, term structure data for at least one option having an expiration date T may be received. For example, user device 104 may receive market data for an option having an expiry T from financial data source 108. In some embodiments, step 3002 of FIG. 30 may be substantially similar to step 2402 of FIG. 24, and the previous description may apply.

At step 3004, one or more conditions for options with an expiry T may be determined. The one or more conditions may be in integral form, or they may be in differential form. Furthermore, the at least condition may be configured such that the at least one condition, in integral form or in differential form, is satisfied from inception of the at least one option to the first expiration date T.

At step 3006, volatility smile data associated with the expiration date T may be generated such that the conditions for the options with expiry T are satisfied substantially simultaneously during all times in the integral or differential form. The volatility smile data may, in one embodiment, be generated based, at least in part, on the term structure data received at step 3002, as well as based on the at least one condition. In some embodiments, step 3006 of FIG. 30 may be substantially similar to step 2406 of FIG. 24, and the previous description may apply.

At step 3008, pricing data associated with the at least one option for the expiration date T may be generated. In some embodiments, first function data representing a first function at the expiration date T may be received, as well as second function data representing a second function at the expiration date. For example, first function data and second function data representing functions A(d₁, T) and B(d₁, T), respectively, may be received. The first function data and the second function data may be based, at least in part, on the term structure data that was received, and the condition(s) that was received may include the first function data and the second function data. For example, the conditions may include A(d₁, T) and B(d₁, T). In this particular scenario, the pricing data may be obtained using Equations 40 and 41, for example.

In some embodiments, the term structure data received at step 3002 may be used to determine first market data associated with the expiration date T. Using the first market data, first probability density function data representing the first probability density function may be generated. In this particular scenario, the probability density function may satisfy the at least one condition from inception of the at least one option to the expiration date T.

Furthermore, in one embodiment, the term structure data may be used to generate first function data representing a first function associated with the expiration date T. The term structure data may also be used to generate second function data representing a second function associated with the expiration data T. For example, first function data corresponding to the function or representation A(d₁, T) may be generated using the term structure data, and second function data correspond to the function or representation B(d₁, T) may be generated using the term structure data. Furthermore, using the first function data and the second function data, the first function and the second function may be determined to converge for a first input value d₁. For example, Equation 122 may be used to determine an input value d₁ where the first function and the second function converge.

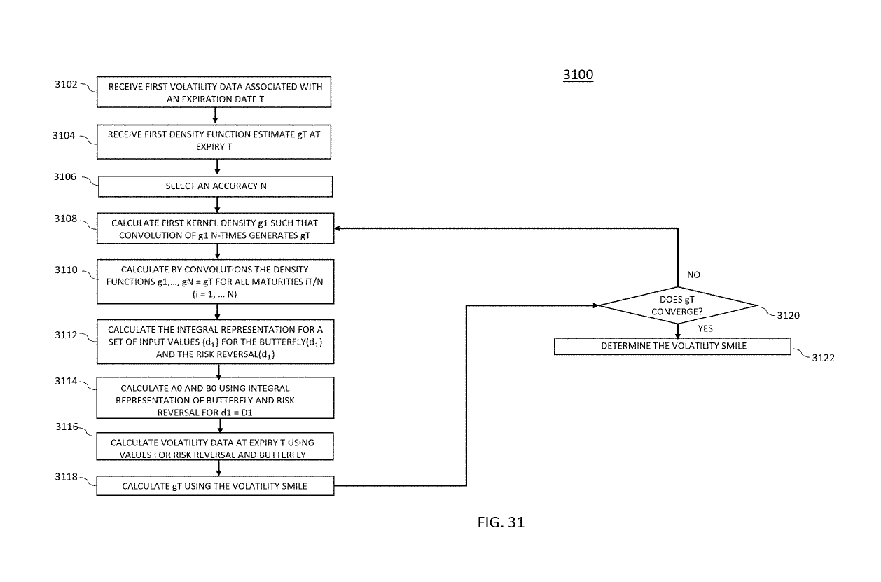

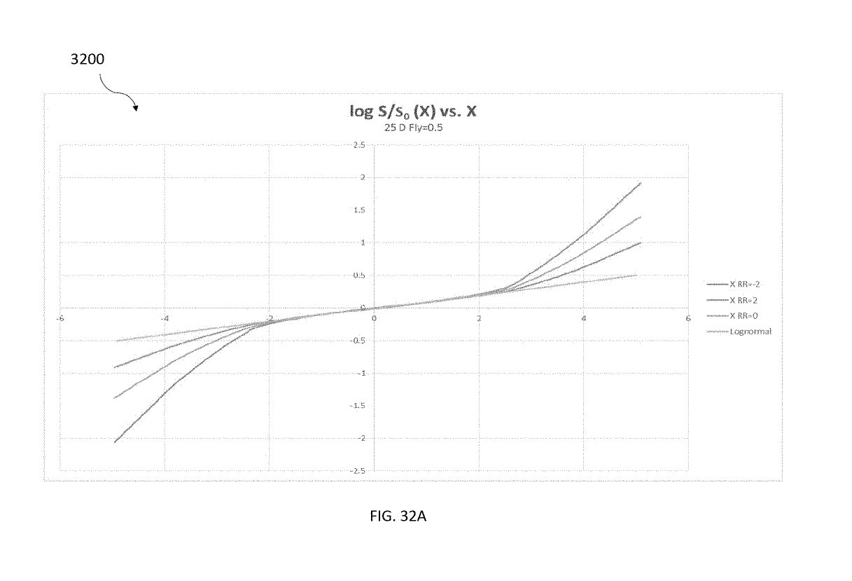

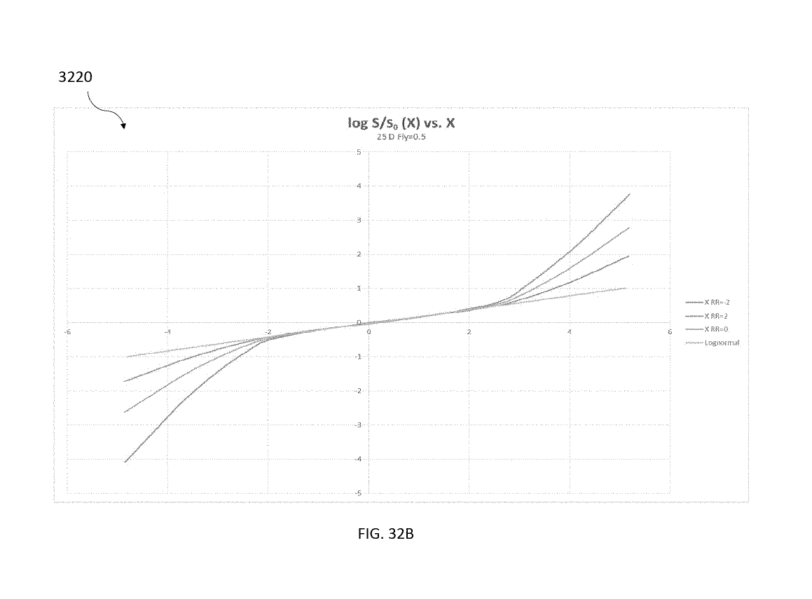

FIG. 31 is an illustrative flowchart of a process for determining functions the volatility smile without using A or B, but by directly using the density function, in accordance with various embodiments. Process 3100 may, in one embodiment, begin at step 3102. At step 3102, first volatility data representing a first volatility associated with a first input value (e.g., d₁=D1), a second volatility associated with a second input value (e.g., d₁=−D1), and a pivot volatility associated with a first expiration date for at least one option may be received. For example, a zeta strangle with d₁=D1, a zeta risk reversal with d₁=D2, and a σ₀ for expiry T may be received. The data may be received as prices of the strangle with d₁=D₁, and the risk reversal with d₁=D₂, or in volatilities. The zetas, ζ_{RR} and Strangle may be calculated by subtracting the BS prices with σ₀. For example, Equations 97 and 98 may correspond to exemplary zeta strangle and zeta risk reversal functions. In some embodiments, the zeta strangle, zeta risk reversal, and σ₀ may be received by user device 104 from financial data source 108.

At step 3104, a first density function estimate g_{T} at expiration date T may be received. The first density function may be determined, in some embodiments, in response to receiving the first volatility data. However, in another embodiment, the first probability density function estimate may be received at a substantially same time as the first volatility data. At step 3106, an accuracy N may be selected. For instance, the larger the value of N, the greater the number of gᵢ terms.

At step 3108, a first kernel density function g₁ may be calculated such that the convolution of g₁ N-times generates g_{T}. For instance, the first density function convolved the first number of time (e.g., the selected accuracy level) may produce the first density function estimate. At step 3110, the density functions g₁, . . . , g_{N}=g_{T} may be calculated for all maturities iT/N, where i=1, . . . , N. For example, Equation 82 may be employed. In some embodiments, a first plurality of expiration dates may be determined by calculating an amount of time from inception of the at least one option to the first expiration data T, and then dividing the amount of time by the selected accuracy level N. A second plurality of density functions for each of the expiration dates, such as iT/N for i=1, . . . , N, may be determined. The second plurality may be determined such that the convolution of the second plurality of density functions generates the first density function estimate (e.g., g₁*g₂* . . . *g_{N}=g_{T}).

At step 3112, the integral representation for a set of input values {d₁} may be calculated for the butterfly(d₁) and the risk reversal(d₁). The set of input values {d₁} may correspond to any suitable amount of input values, having an suitable range. In some embodiments, a first integral representation for a first set of input values {d₁} may be calculated, and a second integral representation for the first set may also be calculated. For example, the integral representation for butterfly(d₁) and risk reversal(d₁) may be determined.

At step 3114, global scaling factors A₀ and B₀ may be calculated using the integral representations of the butterfly and risk reversal for d₁=D1. Additional input values may also be employed to determine values for the scaling factors. For example, zeta strangle and zeta risk reversal may be proportional to their integral representations, and the coefficients of the proportionality are A₀ and B₀, and therefore A₀ and B₀ may be calculated using the obtained integral representations. For example, A₀=zeta strangle(D1)/Integral representation of Butterfly(D1), and B₀=zeta RR′ (D2)/Integral representation of RR(D2)). In some embodiments, a first scaling factor may be determined based at least in part on the volatility data received at step 3102, as well as based on the first integral representation. Furthermore, a second scaling factor may be determined based at least in part on the volatility data received and the second integral representation.

At step 3116, volatility data at the expiration date T may be calculated using the values for the risk reversal and the butterfly for all input values {d₁}. These values may be used to calculate the smile at expiry T, and from this, the new density function g_{T} may be generated. For example, a zeta butterfly and zeta risk reversal may be used to generate the volatility smile data. In some embodiments, the volatility smile data may represent a volatility smile at the first expiration date T, and may be based, at least in part, on the first and second integral representations, as well as the first and second scaling factors.

At step 3118, probability density function data representing a first probability density function g_{T}, associated with the expiration date T, may be generated using the volatility smile. For example, using the volatility smile data generated at step 3116, the probability density function g_{T} may be generated.

At step 3120, a determination may be made as to whether the function g_{T} converges. For example, a determination may be made as to whether the density function g_{T} stops changing for various input values d₁ (e.g., |g_{T}^{M+1}(log s)−g_{T}^{M}(log s)|<0.001). If so, then process 3100 may proceed to step 3122, where the volatility smile may be determined directly from g_{T} using, for example, Equation 6. If not, then process 3100 may return to step 3108, where the process is repeated with the new density function g_{T} obtained from the recent volatility smile derived from the zetas until convergence is obtained.

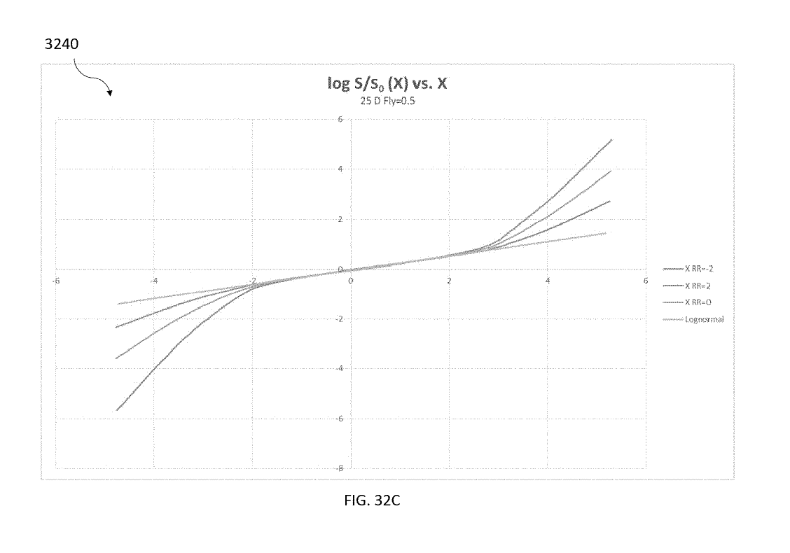

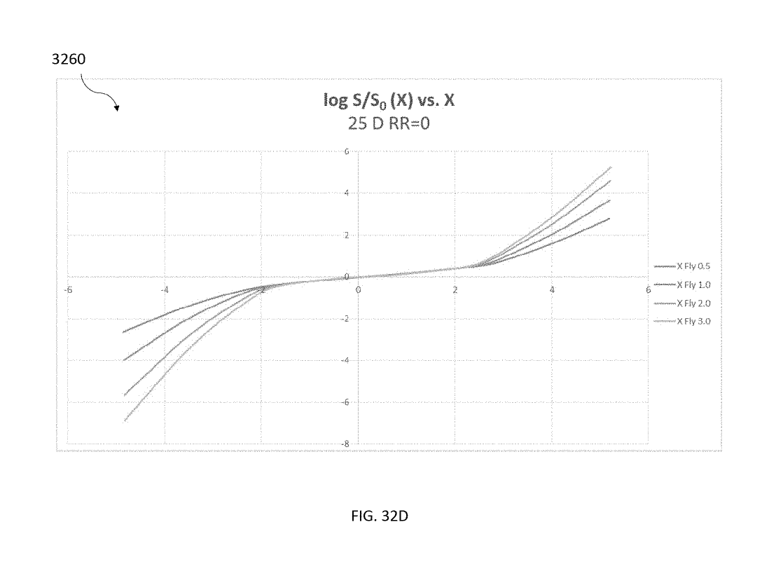

FIGS. 32A-D are illustrative graphs illustrating how log(S) versus X behaves, in accordance with various embodiments. As seen by Equation 83, a one-to-one mapping to a Normal cumulative distribution function N(x) may be used such that Gⱼ(log(sⱼ/s₀)≡N(Xⱼ).

FIG. 32A includes an illustrative graph 3200 mapping between the probability density function g of log (S_{T}/S₀) to a normal distribution. In graph 3200, σ₀=20, 25 Δ_{RR}=0.5, and 25 Δ_{Fly}=−2, 0, and 2. The expiration is set at T=3 months, and the interest rates are zero.

FIG. 32B includes an illustrative graph 3220 mapping between the probability density function g of log (S_{T}/S₀) to a normal distribution. In graph 3220, σ₀=20, 25 Δ_{Fly}=0.5, and 25 Δ_{RR}=−2, 0, and 2. The expiration is set at T=1 year, and the interest rates are zero.

FIG. 32C includes an illustrative graph 3240 mapping between the probability density function g of log (S_{T}/S₀) to a normal distribution. In graph 3240, σ₀=20, 25 Δ_{Fly}=0.5, and 25 Δ_{RR}=−2, 0, and 2. The expiration is set at T=2 years, and the interest rates are zero.

FIG. 32D includes an illustrative graph 3260 mapping between the probability density function g of log (S_{T}/S₀) to a normal distribution. In graph 3260, σ₀=20, 25 Δ_{RR}=0, and 25 Δ_{Fly}=0.5, 1, 2, and 3. The expiration is set at T=1 year, and the interest rates are zero.

The various embodiments described herein may be implemented using a variety of means including, but not limited to, software, hardware, and/or a combination of software and hardware. The embodiments may also be embodied as computer readable code on a computer readable medium. The computer readable medium may be any data storage device that is capable of storing data that can be read by a computer system. Various types of computer readable media include, but are not limited to, read-only memory, random-access memory, CD-ROMs, DVDs, magnetic tape, or optical data storage devices, or any other type of medium, or any combination thereof. The computer readable medium may be distributed over network-coupled computer systems. Furthermore, the above described embodiments are presented for the purposes of illustration are not to be construed as limitations.

What is claimed is:

1. A method for pricing an option with an expiration, comprising:
receiving, at an electronic device, first pricing data representing a first strike and a first price for an option, the first price corresponding to the first strike for the expiration, and the first pricing data being received from a financial data source;
receiving, at the electronic device, second pricing data representing a second strike and a second price for the option, the second price corresponding to the second strike for the expiration, and the second pricing data being received from the financial data source;
receiving, at the electronic device, third pricing data representing a third strike and a third price for the option, the third price corresponding to the third strike for the expiration, and the third pricing data being received from the financial data source;
generating at least one first value for a first function, the at least one first value being determined based, at least in part, on a plurality of input values, the first pricing data, the second pricing data, and the third pricing data;
generating at least one second value for a second function, the at least one second value being determined based, at least in part, on the plurality of input values, the first pricing data, the second pricing data, and the third pricing; and
generating a price for the option at the expiration based, at least in part, on the at least one first value and the at least one second value.

2. The method of claim 1, further comprising:
determining a first volatility for a first input value of the plurality of input values.

3. The method of claim 2, wherein determining the first volatility comprises:
determining a pivot volatility.

4. The method of claim 1, wherein the at least one first value and the at least one second value are determined at a substantially same time as a pivot volatility is determined.

5. The method of claim 1, further comprising:
generating a full volatility smile for the option based, at least in part, the at least one first value, the at least one second value, and a pivot volatility.

6. The method of claim 1, wherein:
the first function comprises a first scaling function multiplied by a first shape function, the first shape function comprising first information corresponding to a first shape of the first function, and the first shape function being determined based, at least in part, on the plurality of input values; and
the second function comprises a second scaling function multiplied by a second shape function, the second shape function comprising second information corresponding to a second shape of the second function, and the second shape functions being determined, based at least in part, on the plurality of input values.

7. The method of claim 6, further comprising:
generating a first normalized shape function by normalizing the first shape function for a second input value of the plurality of input values; and
generating a second normalized shape function by normalizing the second shape function for a third input value of the plurality of input values.

8. The method of claim 1, wherein:
generating the at least one first value comprises:
determining a first estimate for the first function based, at least in part, on the plurality of input values;
generating a second estimate for the first function by normalizing the first estimate for the first functions; and
determining that the second estimate for the first function converges for a second input value of the plurality; and
generating the at least one second value comprises:
determining a third estimate for the second function, based, at least in part, on the plurality of input values;
generating a fourth estimate for the second function by normalizing the third estimate for the second function; and
determining that the fourth estimate for the second function converges for the second input value of the plurality.

9. The method of claim 1, further comprising:
determining a first delta risk reversal value based, at least in part, on the first strike, the second strike, and the third strike;
determining a first delta butterfly value based, at least in part, on the first strike, the second strike, and the third strike; and
generating a full volatility smile based, at least in part, on the first delta risk reversal value, the first delta butterfly value, and a pivot volatility.

10. The method of claim 9, wherein the pivot volatility is determined at a substantially same time as the first delta risk reversal value and the first delta butterfly value.

11. The method of claim 9, wherein the first delta risk reversal value comprises one of: a twenty-five delta risk reversal value, a fifteen delta risk reversal value, and a ten delta risk reversal value.

12. The method of claim 9, wherein the first delta butterfly value comprises one of: a twenty-five delta butterfly value, a fifteen delta butterfly value, and a ten delta butterfly value.

13. The method of claim 1, further comprising:
receiving, at the electronic device, at least fourth pricing data representing at least a fourth strike and a fourth price, the fourth price corresponding to the fourth strike for the expiration, and the fourth pricing data being received from the financial data source; and
assigning at least a first weight, a second weight, a third weight, and a fourth weight to the first strike, the second strike, the third strike, and the fourth strike, respectively, wherein generating the at least one first value and generating the at least one second value is further based, at least in part, on the first weight, the second weight, the third weight, and the fourth weight.

14. The method of claim 13, further comprising:
determining that one of the first strike, the second strike, the third strike, or the fourth strike is proximate to an at-the-money (“ATM”) strike; and
assigning a highest weight of one of the first weight, the second weight, the third weight, or the fourth weight to the one of the first strike, the second strike, the third strike, or the fourth strike.

15. An electronic device for pricing an option having an expiration, comprising:
memory;
communications circuitry operable to:
receive, from a financial data source, first pricing data representing a first strike and a first price for an option, the first price corresponding to the first strike for the expiration;
receive, from the financial data source, second pricing data representing a second strike and a second price for the option, the second price corresponding to the second strike for the expiration; and
receive, from the financial data source, third pricing data representing a third strike and a third price for the option, the third price corresponding to the third strike for the expiration; and
at least one processor operable to:
generate at least one first value for a first function, the at least one first value being determined based, at least in part, on a plurality of input values, the first pricing data, the second pricing data, and the third pricing data;
generate at least one second value for a second function, the at least one second value being determined based, at least in part, on the plurality of input values, the first pricing data, the second pricing data, and the third pricing; and
generate a price for the option at the expiration based, at least in part, on the at least one first value and the at least one second value.

16. The electronic device of claim 15, wherein the at least one processor is further operable to:
determine a first volatility for a first input value of the plurality of input values.

17. The electronic device of claim 16, wherein the first volatility being determined comprises the at least one processor being further operable to:
determine a pivot volatility.

18. The electronic device of claim 15, wherein the at least one first value and the at least one second value are determined at a substantially same time as a pivot volatility is determined.

19. The electronic device of claim 15, wherein the at least one processor is further operable to:
generate a full volatility smile for the option based, at least in part, the at least one first value, the at least one second value, and a pivot volatility.

20. The electronic device of claim 15, wherein:
the first function comprises a first scaling function multiplied by a first shape function, the first shape function comprising first information corresponding to a first shape of the first function, and the first shape function being determined based, at least in part, on the plurality of input values; and
the second function comprises a second scaling function multiplied by a second shape function, the second shape function comprising second information corresponding to a second shape of the second function, and the second shape functions being determined, based at least in part, on the plurality of input values.

21. The electronic device of claim 20, wherein the at least one processor is further operable to:
generate a first normalized shape function by normalizing the first shape function for a second input value of the plurality of input values; and
generate a second normalized shape function by normalizing the second shape function for a third input value of the plurality of input values.

22. The electronic device of claim 15, wherein:
the at least one first value being generated comprises the at least one processor being further operable to:
determine a first estimate for the first function based, at least in part, on the plurality of input values;
generate a second estimate for the first function by normalizing the first estimate for the first functions; and
determine that the second estimate for the first function converges for a second input value of the plurality; and
the at least one second value being generated comprises that least one processor being further operable to:
determine a third estimate for the second function, based, at least in part, on the plurality of input values;
generate a fourth estimate for the second function by normalizing the third estimate for the second function; and
determine that the fourth estimate for the second function converges for the second input value of the plurality.

23. The electronic device of claim 15, wherein the at least one processor is further operable to:
determine a first delta risk reversal value based, at least in part, on the first strike, the second strike, and the third strike;
determine a first delta butterfly value based, at least in part, on the first strike, the second strike, and the third strike; and
generate a full volatility smile based, at least in part, on the first delta risk reversal value, the first delta butterfly value, and a pivot volatility.

24. The electronic device of claim 23, wherein the pivot volatility is determined at a substantially same time as the first delta risk reversal value and the first delta butterfly value.

25. The electronic device of claim 23, wherein the first delta risk reversal value comprises one of: a twenty-five delta risk reversal value, a fifteen delta risk reversal value, and a ten delta risk reversal value.

26. The electronic device of claim 23, wherein the first delta butterfly value comprises one of: a twenty-five delta butterfly value, a fifteen delta butterfly value, and a ten delta butterfly value.

27. The electronic device of claim 15, wherein communications circuitry is further operable to receive, from the financial data source, at least fourth pricing data representing at least a fourth strike and a fourth price, the fourth price corresponding to the fourth strike for the expiration, the at least one processor is further operable to:
assign at least a first weight, a second weight, a third weight, and a fourth weight to the first strike, the second strike, the third strike, and the fourth strike, respectively, wherein generating the at least one first value and generating the at least one second value is further based, at least in part, on the first weight, the second weight, the third weight, and the fourth weight.

28. The electronic device of claim 27, wherein the at least one processor is further operable to:
determine that one of the first strike, the second strike, the third strike, or the fourth strike is proximate to an at-the-money (“ATM”) strike; and
assign a highest weight of one of the first weight, the second weight, the third weight, or the fourth weight to the one of the first strike, the second strike, the third strike, or the fourth strike.
